(19) United States
(12) Patent Application Publication
(10) Pub. No.: US 2025/0139571 A1
(43) Pub. Date: May 1, 2025

(54) Pickup Automation System and Related Method for Orders and/or Merchandise Pickup Using Smart Locks

(71) Applicant: QR Automation Technologies, Inc., Temple, TX (US)

(72) Inventor: Gopal Nandakumar, Temple, TX (US)

(21) Appl. No.: 18/934,828

(22) Filed: Nov. 1, 2024

Related U.S. Application Data
(60) Provisional application No. 63/595,087, filed on Nov. 1, 2023.

(51) Int. Cl. G06Q 10/0836; G06K 7/14; G07C 9/00

(52) U.S. Cl. CPC G06Q 10/0836; G07C 9/00896; G06K 7/1417; G07C 2009/0092

(57) ABSTRACT

The present invention relates to fully secured parking lot order pickup automation for online orders placed in advance and for orders placed at locations where orders can be picked up by customers, while staying inside their vehicles, from pickup lockers installed at parking spaces in parking lots. The present invention also relates to fully secured electronic bins accessible from secured or unsecured area for merchants to leave orders and accessible from unsecured area for customers to pick up orders. The present invention also relates to fully secured self-checkout of products using pass-thru lockers accessible in secured area to drop products inside pass-thru lockers and accessible from unsecured area to pick up products from pass-thru lockers.

### CROSS-REFERENCES TO RELATED APPLICATIONS

This application claims the benefit of U.S. Provisional Application Ser. No. 63/595,087, filed Nov. 1, 2023 entitled Pickup Automation System and Related Method for Orders and/or Merchandise Pickup Using Smart Locks, which is incorporated by reference herein.

### STATEMENT REGARDING FEDERALLY SPONSORED RESEARCH OR DEVELOPMENT

Not applicable.

### BACKGROUND OF THE INVENTION

### 1. Field of the Invention

The present invention relates to fully secured parking lot order pickup automation for online orders placed in advance and for orders placed at locations where orders can be picked up by customers, while staying inside their vehicles, from pickup lockers installed at parking spaces in parking lots. The present invention also relates to parking lot touchless ordering & sign-in stations where customers can place new orders or sign-in to pick up already placed orders. Since parking lot touchless ordering and sign-in stations use posters with QR Codes printed on any medium, parking lot touchless ordering and sign-in stations are also referred to as self-serv stations. The present invention also relates to item level scan & add from Scan & Add menus to check-out. This present invention also relates to manual order stations where orders are accepted by merchants with face-to-face contact with the customer where manual order stations are not placed in any order pickup lane.

The present invention also relates to fully secured electronic bins accessible from secured or unsecured area for merchants to leave orders and accessible from unsecured area for customers to pick up orders.

The present invention also relates to fully secured self-checkout of products using pass-thru lockers accessible in secured area to drop products inside pass-thru lockers and accessible from unsecured area to pick up products from pass-thru lockers.

### 2. Background of Related Art

Currently, for order pick up in stores, shoppers are asked to pick up orders from Smart lockers located inside physical stores or located at curbside or located at drive-thru lanes. Smart lockers are any individual secured temporary storage boxes that are fitted with cloud based and wi-fi enabled smart locks instead of mechanical locks or electric locks that are not cloud based where a merchant can leave the products inside the temporary storage box and customers can pick up the products from the temporary storage box using a one-time code or fingerprint or face id or any biometric identifier. Smart lockers are individual units that can be joined and stacked together. Each individual smart locker will have an access point, a drop-off point and a pickup point and operate independently unlike hub lockers. Hub lockers may also be cloud based and wi-fi enabled but a central unit with a single access point controls all drop-off and pickup points in the hub. Access point is the area where the customers enter the security code or authenticate, drop-off point is the area where merchants drop-off the orders and pickup point is the area where the customers pick up the orders. Hub lockers cannot be used for order pickup at drive-through lanes or at the parking lots because customers from a parked vehicle cannot access the access point and the pickup point without moving the vehicle. In contrast, smart lockers can be used for order pickup at drive-thru lanes because customers from a parked vehicle can access the access point and the pickup point without moving the vehicle. Shoppers may also be asked by merchants who do not install smart lockers to pick up orders over the counter inside the store or through a window placed at the drive-thru lanes to present an identification. Smart lockers placed inside physical stores or located at curbside or at drive-thru lanes will be for online orders and for orders placed at the location. When smart lockers are located inside physical stores or located at curbside, the shoppers are asked to park the vehicles and walk to the lockers. When a drive-thru window or drive-thru smart lockers are located at drive-thru lanes, the shoppers are asked to drive through a drive-thru lane. Multiple drive-thru lockers may be installed at each drive-thru lane whereas only one drive-thru window will be installed at each drive-thru lane. Even though pickup from drive-thru lockers are automated and faster than pickup from manually operated drive-thru windows, still the number of lockers that can be installed at each drive-thru lane is very much limited.

Smart lockers with a door at the top can also be used as drone lockers where orders can be transported above the ground between a secured building to any drone locker located at any point within the perimeter of the location. But operation of drones requires special permission from government agencies like Federal Aviation Authority and licensed drone operators are required to operate drones. The cost of drone lockers may be prohibitive for many merchants. Many merchants may not have a drive-thru lane or dedicated parking lot. Examples are merchants in strip mall, strip center or strip plaza where the stores are arranged in a row, with a sidewalk in front.

Smart lockers with a door at the top can also be used in multi-story locations where the order preparation area is above the order pickup area.

For quick service restaurant dining customers opt to takeout orders from physical quick service restaurants, instead of dining-in. Most take-out customers also prefer to takeout from drive-thru lane rather than from inside. Merchants also encourage shoppers to ‘Order Ahead’ to keep the orders ready, but unfortunately because of uncertainty of pick-up times, hot food can be cold, cold food can be hot and cooked food can be soggy. According to 2022 QSR® Drive-Thru Report, published by QSR magazine, the total wait time from entering a location until leaving the location may be up to 10 minutes with an order accuracy as low as 80%. The total wait time is waiting time to wait in the line to place the order plus service time waiting to pick up the order. Even though the wait time can be reduced significantly with 100% order accuracy by using drive-thru lockers instead of drive-thru windows still the customers must go through drive-thru lanes. Drive-thru lanes take up a considerable amount of space and building and maintaining drive-thru lanes are expensive. When the number of vehicles waiting in the drive-thru lanes exceeds the drive-thru lane capacity, the customers may be forced to park the vehicles in the street causing traffic jam. Merchants without drive-thru lane also provide ‘Buy Online Pickup In Store’ (BOPIS) service. Some merchants direct their BOPIS customers to come inside the store to pick up the orders, while others offer curbside side delivery where the merchants use human resources to make the curbside delivery.

In today's in-store shopping, shoppers are asked to use a self-service kiosks where only one customer can use the kiosk at a time. So, customers wait at kiosks instead of waiting at the counters. Shoppers may also be asked to scan a QR Code to place an order to skip the kiosks and counters. But unfortunately, the display area in mobile phones are so small that the customers miss important menu items.

Merchants without smart lockers for in-store pickup use unprotected bins or racks for customers to pick up the orders. The unprotected bins or racks may also include a surveillance camera to monitor the unsecured bins or racks. Merchants may view the videos from surveillance cameras to find unauthorized order pickups, but only after orders are picked up by unauthorized persons. The surveillance cameras may deter unauthorized pickup of orders but will not prevent unauthorized pickup of orders Some merchants may also place the bins or racks inside protected areas and manually verify the customers before handing over the orders personally to the customers. This will require merchants to use additional human resources and will require customers to wait for merchants to hand over the orders.

In today's in-store shopping, shoppers are asked to wait in line and exit through self-check-out or employee managed checkout counters. When there are not enough check-out counters free, the wait time increases. Unfortunately, the self-check-out counters rely on weight of individual item being placed inside the shopping bags rather than the content and value of the individual item being placed inside the shopping bags. The shopping bags are placed on top of a weighing scale and the weighing scales are not covered or protected. This opens the possibility for shop lifting and requires additional manpower to monitor self-checkouts. Even employees managed checkout counters are vulnerable to fraud unless being monitored constantly. Shoppers can also scan and pay to bypass self-checkout and employee managed checkout counters. To verify that the shoppers are scanning all the items, employees verify the scanned items at random before the shoppers leave the secured area. Scan and pay is vulnerable to fraud unless all the items in the shopping carts leaving the secured area are scanned and monitored constantly which required additional manpower to monitor carts leaving secured area. It is obvious, customers in a grocery or convenient store may want to skip the check-out lane for faster shopping and grocery and convenience store operators may want to close all the check-out counters to save money.

Given the fundamentally flawed state of the art with respect to drive-thru order pickup or to pick up in store or curbside pickup it is therefore the overriding object of the present invention is to improve over the prior art, in at least some implementations of the present invention, the Parking Lot Pickup method comprises the step of utilizing smart locks, by providing a system and related method by which online and store orders can be picked up from parked vehicles from lockers installed at parking spaces in parking lots instead of from drive-thru windows or drive-thru lockers or in store or curbside. Parking Lot Pickup method can be used at all locations without drive-thru lane.

Given the fundamentally flawed state of the art with respect to using mobile phones to place in-store or parking lot orders the overriding object of the present invention is to improve over the prior art, in at least some implementations of the present invention, the Item Level Ordering comprises the step of utilizing ‘Scan & Add’ menus printed on any physical medium or displayed on any digital medium, by providing a system and related method by which individual items can be scanned and added to shopping carts using physical or digital ‘Scan & Add’ menus instead of accepting orders from displayed menus on mobile phones. Item Level Ordering can be used at all locations. Moreover orders can be placed in piece meal as required instead of a placing the entire order at one time.

Given the fundamentally flawed state of the art with respect to employee managed and self-served check-out counters in physical stores, it is therefore the overriding object of the present invention to improve over the prior art, in at least some implementations of the present invention, the Pickup Automation further comprises the step of utilizing smart locks, by providing a system and related method by which shoppers can pass products through pass-thru lockers fitted with readers, sensors and scales at check-out counters.

Given the fundamentally flawed state of the art with respect to usage of in-store or curbside order pickup bins or racks, it is therefore the overriding object of the present invention to improve over the prior art, in at least some implementations of the present invention, the Pickup Automation further comprises the step of utilizing smart bins or racks for in-store or curbside order pickups, by providing a system and related method by which merchants can pass orders to customers through electronic bins or racks fitted with readers, sensors and scales.

Given the fundamentally flawed state of the art with respect to employee managed and self-served check-out counters in physical stores, it is therefore the overriding object of the present invention to improve over the prior art, in at least some implementations of the present invention, the Pickup Automation further comprises the step of utilizing smart locks, by providing a system and related method by which shoppers can pass products through pass-thru lockers fitted with readers, sensors and scales at check-out counters.

Additionally, it is an object of the present invention to provide such a system and related method that is robust in specific implementation and readily usable by any manner of person, entity, device, or the like. Finally, it is an object of the present invention to provide such a system and method that is economical in implementation and therefore readily accessible to virtually any application.

This invention in part and referred to as Parking Lot Pickup Automation provides a means for customers to pick up orders from lockers placed at parking spaces in parking lots accessible from parked vehicles. Customers are not only buyers, but also delivery persons picking up orders on behalf of buyers.

This invention in part and referred to as Self Ordering Automation provides a means for shoppers to use ‘Scan & Add’ manus while placing orders using mobile phones.

This invention in part and referred to as Bin Pickup Automation provides a means for merchants to pass orders to customers through electronic bins or racks placed in unsecured areas.

This invention in part and referred to as Self-Check-Out Automation provides a means for shoppers to pass products through pass-thru lockers at self-check-out stations from inside of the store and pickup products from pass-thru lockers from outside of the store

### SUMMARY OF THE INVENTION

One embodiment of the present invention is a Parking Lot Pickup Automation having smart locks and providing order pickup points installed at parking lots for order pickup from inside of vehicles, smart or mechanical locks and providing order drop-off points accessible to merchants to drop-off orders in a box or a bin which will act as an order transporter, the order transporter installed on a mover where the mover will move order transporter from order drop-off point to order pickup point and vice versa, where the merchant will place orders in the order transporter when the order transporter is empty and at the order drop-off point, where authenticated or verified persons will pick up orders when the order transporter is loaded and at the order pickup point—generally comprises a means for merchants to access the list of available order pickup points, a means for the merchant to select an available order pickup point, a means to scan or enter an order identifier such as order number or tracking number and the like, a means to drop orders inside order transporter that will transport the orders to the selected order pickup point and automatically or manually start the order transporter to move the orders to the selected order pick up point, a means for an authenticated or verified person to pick up the orders from a parked vehicle at the order pickup point, a means for the authenticated or verified person to move up or down the order transporter, a means for the order mover to move order transporter automatically from order pick up point to order drop-off point when the orders are picked up at order pickup point.

Another embodiment of the present invention is a Bin Pickup Automation having smart bins installed on order pickup racks placed at the stores for self-order pickup, a drop-off point accessible only to merchants leaving orders inside the bins, a pickup point accessible to customers picking up orders from the bins, a QR code scanner and/or a QR code near drop-off point accessible only to merchants leaving orders inside the bins, a QR code scanner and/or a QR code near pickup point accessible to customers picking up orders, an electronic weighing scale and one or more sensors inside the bins, a means for merchants to scan an order identifier printed on a receipt using the QR code scanner and/or a means for merchants to scan a QR code displayed near the drop-off point, a means for customers to scan a QR code provided to the customers using the QR code scanner and/or a means for customers to scan a QR code displayed near the pickup point.

Another embodiment of the present invention is a Self-Ordering Automation having ‘Scan & Add’ menus printed on physical medium and/or displayed on digital medium and providing in-store and parking lot access to ‘Scan & Add’ menus printed on physical medium and/or displayed on digital medium for customers to view full or oversized menus and place orders.

Another embodiment of the present invention is a Self-Check-Out Automation having smart locks and providing self-check-out machines installed at the check-out areas inside secured areas of stores for self-check-out, a product incoming chamber at the drop-off point of self-check-out machines and accessible only from protected area of the store, a product holding chamber at the drop-off point of self-check-out machines and accessible only from unprotected area of the store, where product incoming chamber is fitted with sensors and an electronic horizontal sliding door at the top, readers, weighing scale, and a product pusher at the bottom, where product holding chamber is fitted with a smart door that can be accessed only at a pickup point located outside of the store and can be accessed only by authenticated or verified person—generally comprises a means for the customer to start dropping products one at a time into incoming chamber from protected area of a store, a means to sense an item is dropped inside the incoming chamber, a means to automatically open a sliding door in the incoming chamber, a means to automatically close the sliding door after an item is dropped, a means to automatically scan bar code printed on a dropped item, a means to automatically weigh the dropped product, a means to automatically pull product from incoming chamber to holding chamber, a means to automatically weigh all the products moved into holding chamber, a means to display scanned item details on a screen installed outside of the self-check-out machines and above the incoming chamber, a means for the customer to stop dropping items into the incoming chamber, a means for the customer to make payments, a means to let an authenticated or a verified person to pick up products from holding chamber from a pickup point located in unprotected area of a store. Smart doors are any secured door fitted with cloud based and wi-fi enabled smart locks instead of mechanical locks or electric locks that are not cloud based. Doors fitted with smart locks can be attached to any temporary storage box that can be accessed by a customer using a one-time code or fingerprint or face id or any biometric identifier.

A smart lock as disclosed herein, may have a unique smart lock internal identifier provided by smart lock manufacturer or by smart lock management service provider and known to the operators such as merchants. At a minimum smart lock management service provider will host a smart lock management server where all the smart locks will be registered using smart lock internal identifier. At a minimum each smart lock will be able to communicate with a smart lock management server using smart lock internal identifier as an identifier. At a minimum each smart lock will have 2 positions namely locked status and unlocked position and the position can be changed by the smart lock only with the permission from smart lock management server to change. At a minimum each smart lock will have a keypad to accept one-time code and an unlock button to send unlock request to smart lock management server. At a minimum each smart lock will also be able to send an auto-lock request after a pre-determined time from the time a smart lock position is changed to an unlock position. At a minimum, smart locks will always be in locked position except for a brief period to be in unlocked position during which orders from transporters having the smart locks can be picked up. At a minimum the smart lock management server will have a database to store unique smart lock internal identifier, the current lock position and current value of one-time code of each registered smart lock. At a minimum smart lock management service provider will host online web sites or provide apps for merchants to inquire the lock status and/or set one-time code of any smart lock. Smart locks can also have QR Code where an app provided by the smart lock management service provider or interfaced with smart lock management server or any generic QR Code reader app can be used to scan the QR Code instead of entering a one-time code in the key pad. Some smart lock management server can also save one-time authenticated identifier such as mobile number, customer identifier and the like instead of or in addition to one-time code. One-time authenticated identifiers are the mobile numbers or customer identifiers of customers making payments for the orders using secured web sites or mobile payment apps. It is also possible for smart lock management server to generate a random number, use the generated random number as one-time code and text the one-time code to the mobile number that smart lock management server received, if the one-time code received by smart lock management server is blank. At a minimum when an auto-lock request is approved, each smart lock will also be able to clear one-time code if one-time code is stored in smart lock database and/or one-time authenticated identifier, if one-time authenticated identifier is stored in smart lock database. When a smart lock is in locked position and if the value of stored one-time code and/or one-time authenticated identifier is not blank then the locker to which the smart lock is attached will be considered loaded. When a smart lock is in locked position and if the value of stored one-time code and one-time authenticated identifier are blank then the locker to which the smart lock is attached to will be considered empty.

### BRIEF SUMMARY OF THE DRAWINGS

FIGS. 1A & 1B show, in an overview use case diagram, the various basic functionality implemented for some of the preferred embodiments of the present invention for parking lot order pickup.

FIGS. 2A and 2B shows, in a class diagram, a high-level schema for a representative parking lot we database as may be implemented in accordance with the present invention.

FIG. 3A shows, in a sideview, the various options to install enclosed locker mounted at the ground level.

FIG. 3B shows, in a sideview, the various types of movers used in enclosed locker mounted at the ground level.

FIG. 3C shows, in a sideview, to install enclosed locker mounted overhead.

FIG. 3D shows, in a sideview, the various types of movers used in enclosed locker mounted overhead.

FIG. 3E shows, in a topview, the various installation types used for enclosed locker.

FIG. 3F shows, in a sideview, the various types of movers used in open locker.

FIG. 3G shows, in a sideview, the various steps of a robot placing the transporter at pickup point in an open locker.

FIG. 3H shows, in a sideview, the various steps of an overhead crane placing the transporter at pickup point in an open locker.

FIG. 31 shows, in a topview, the various installation types used in an enclosed locker in an attached parking lot.

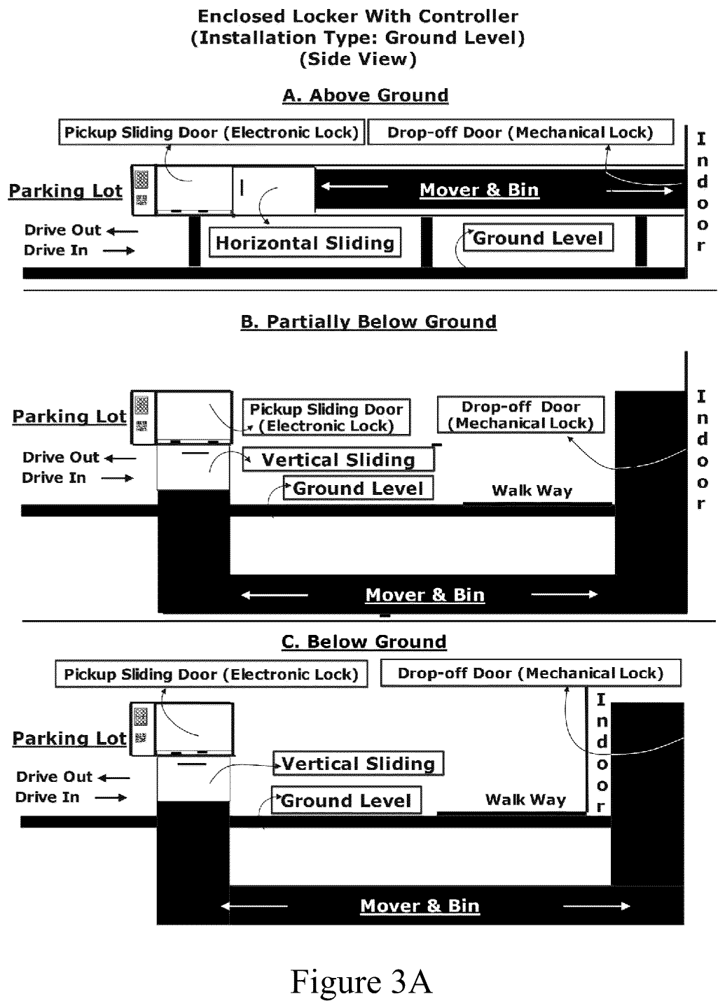

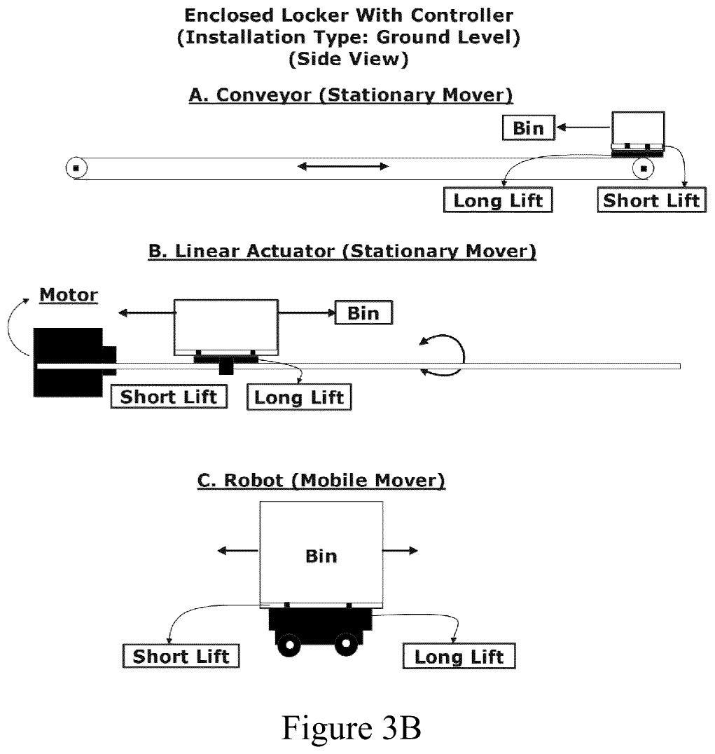

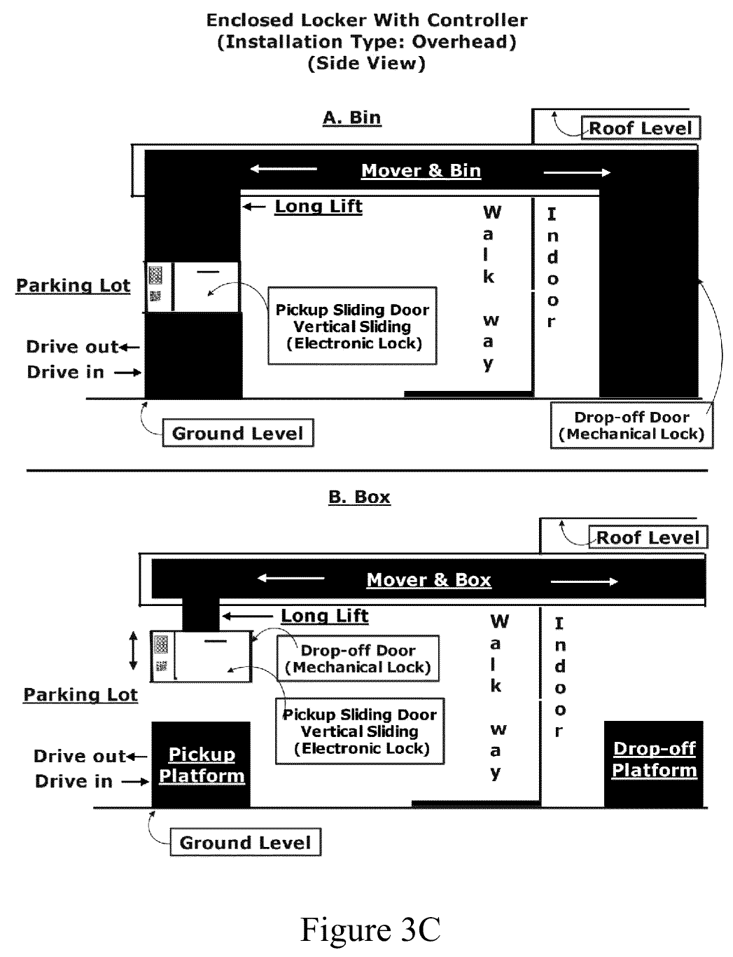

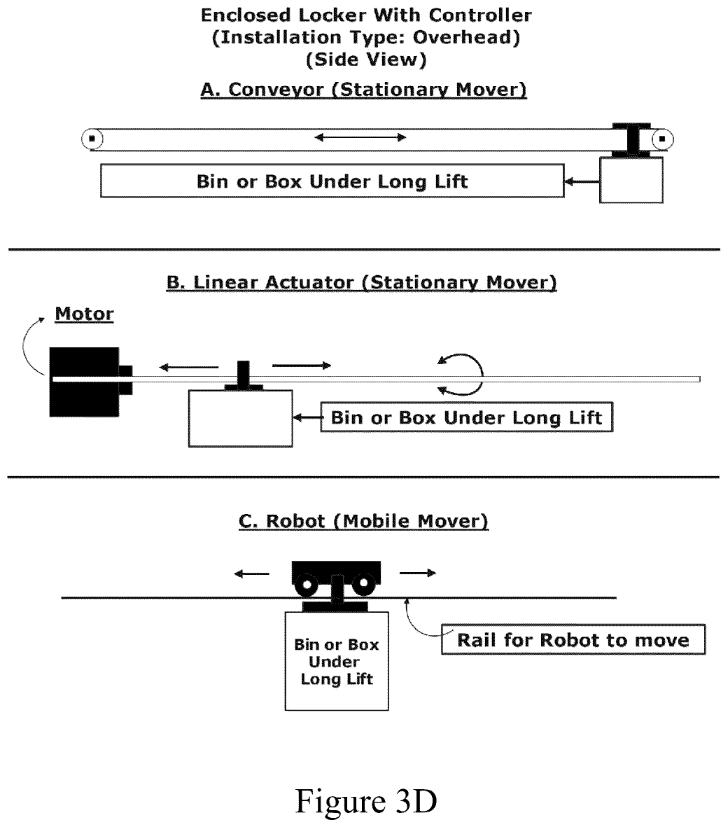

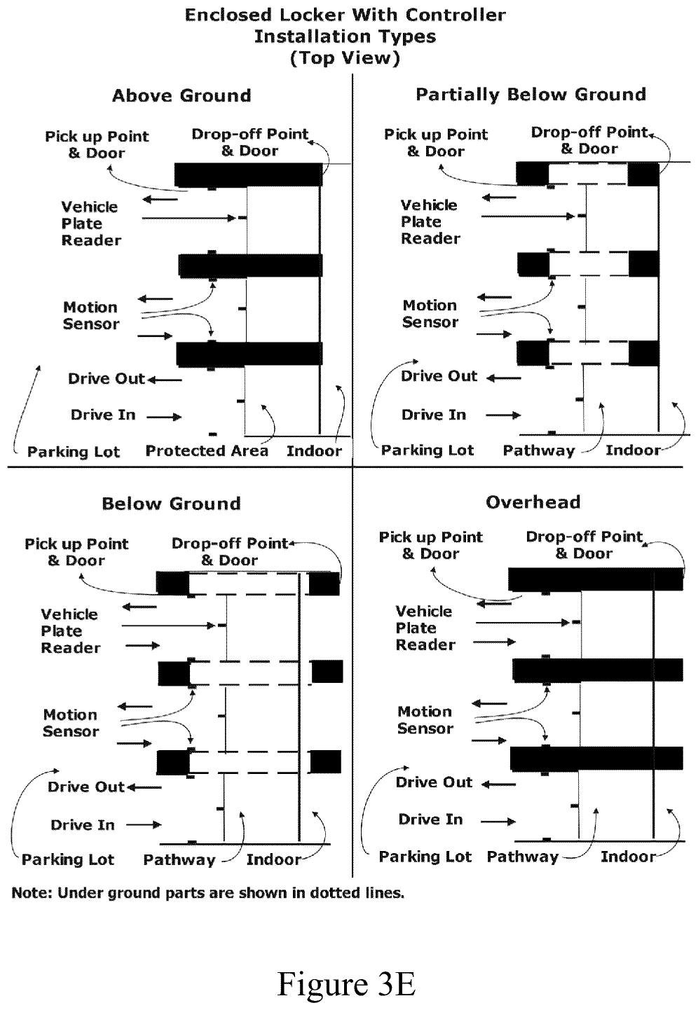

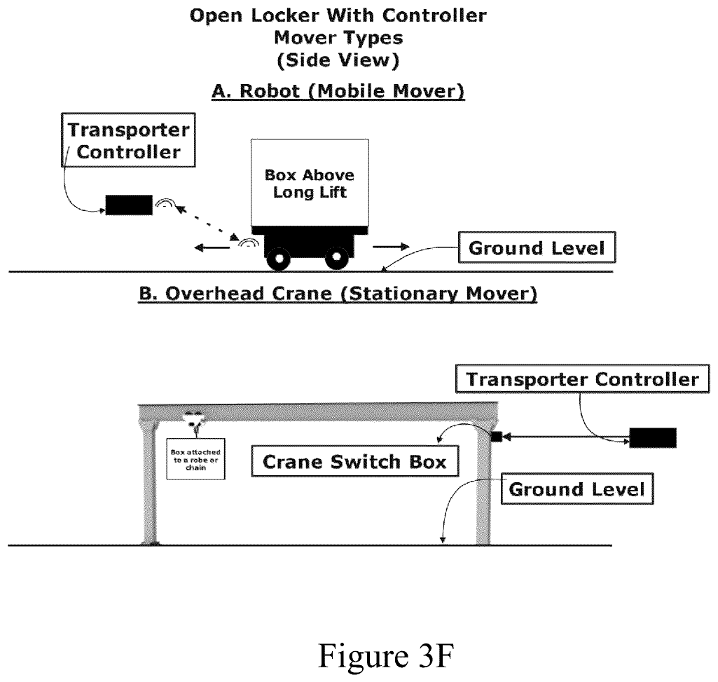

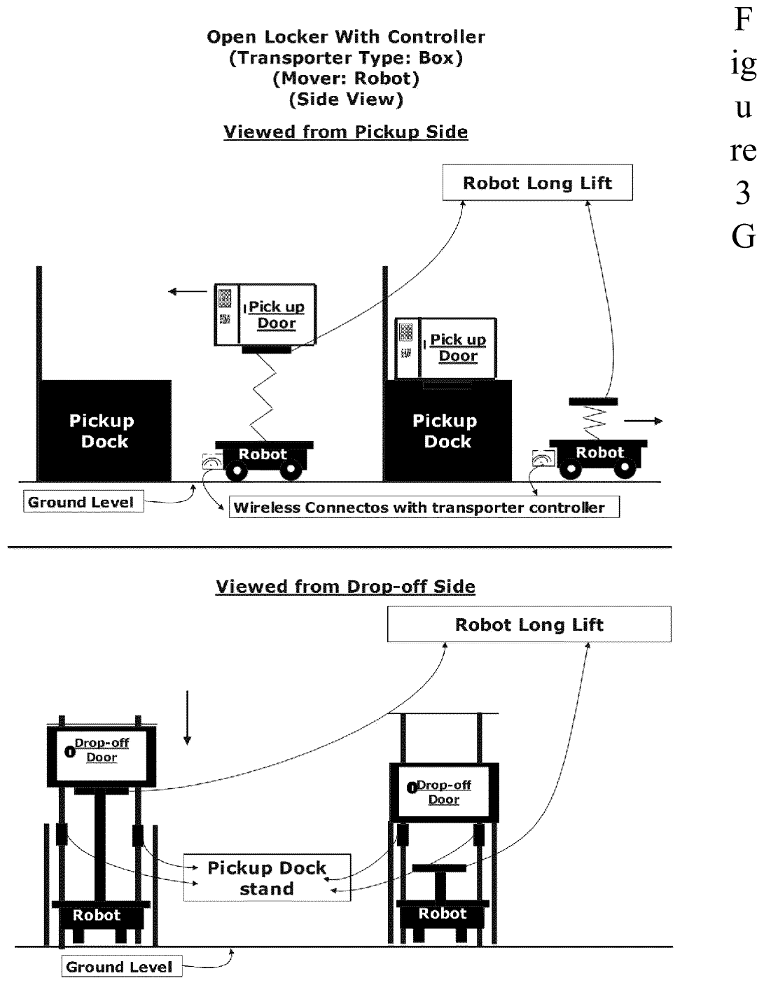

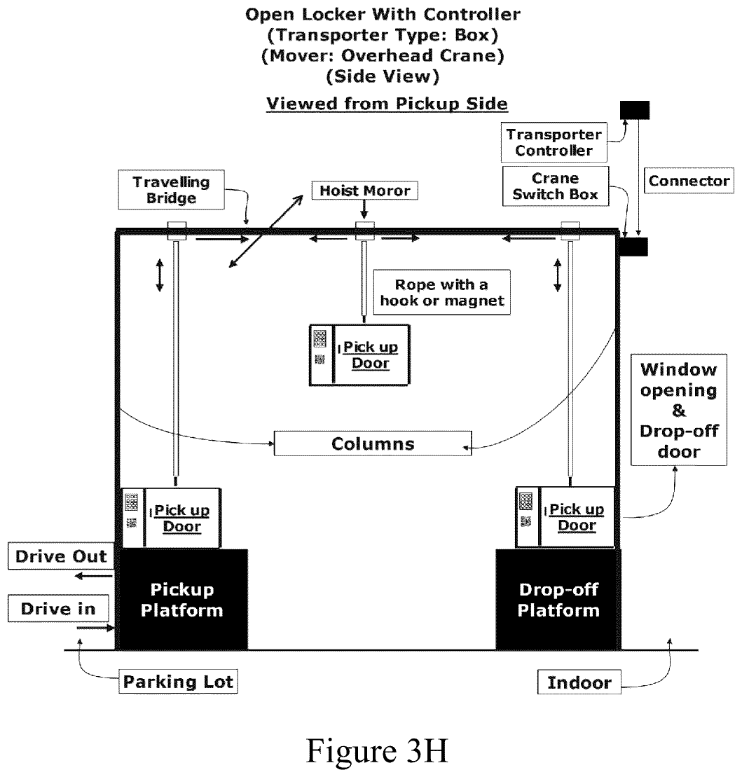

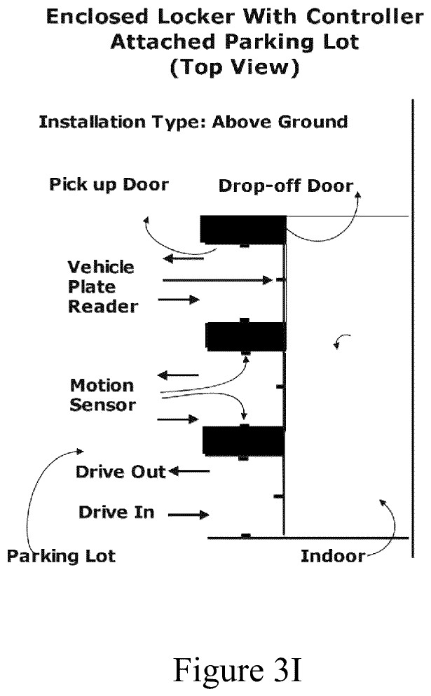

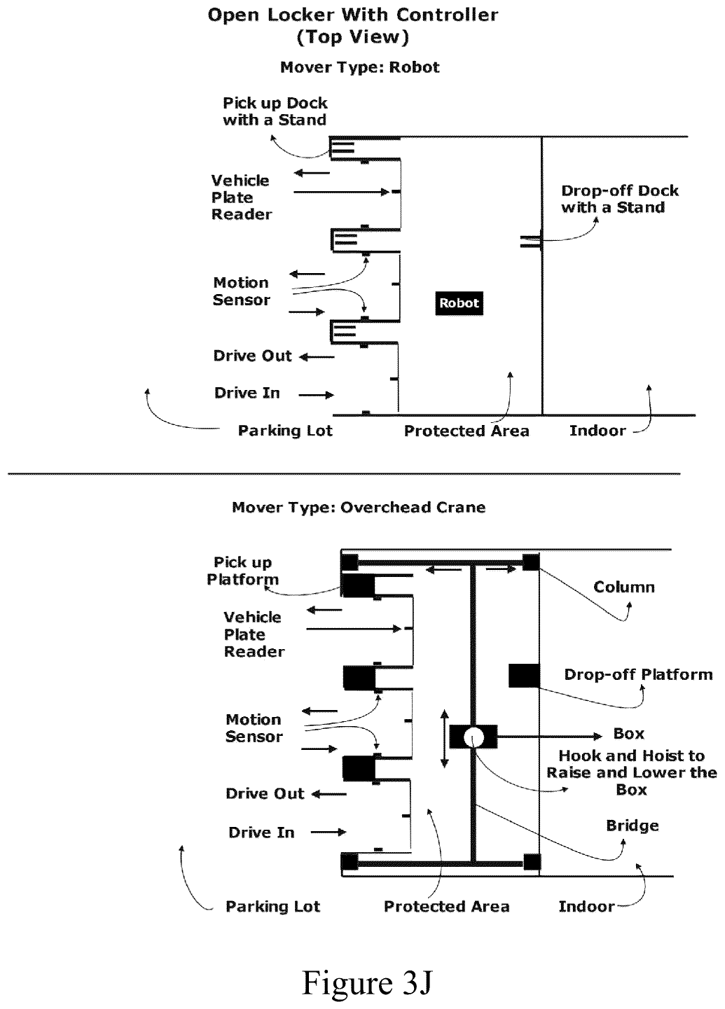

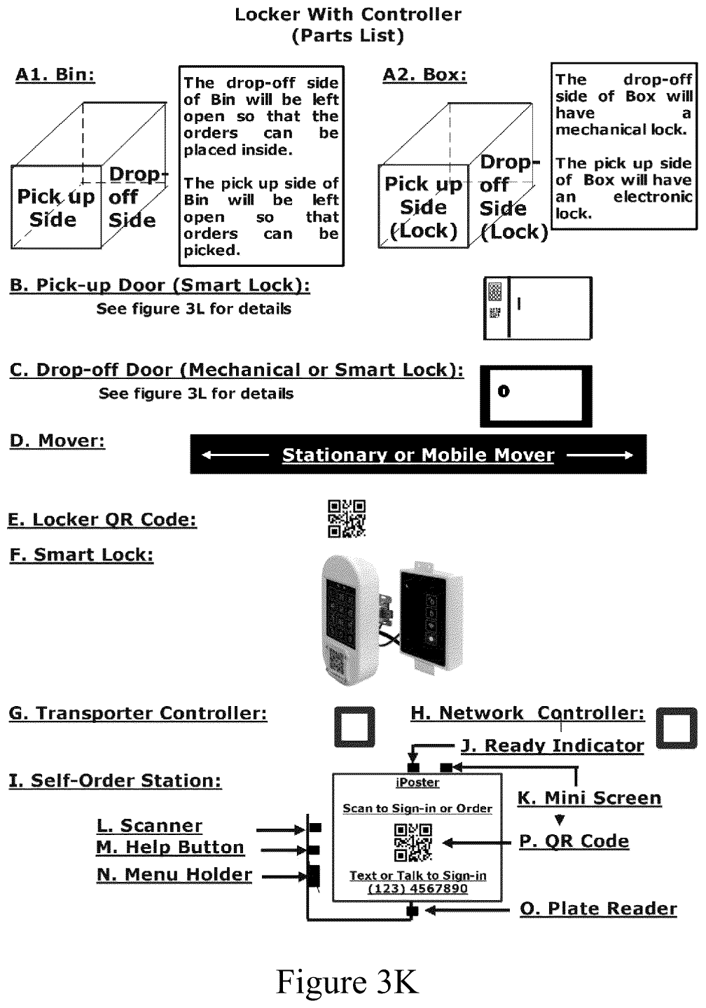

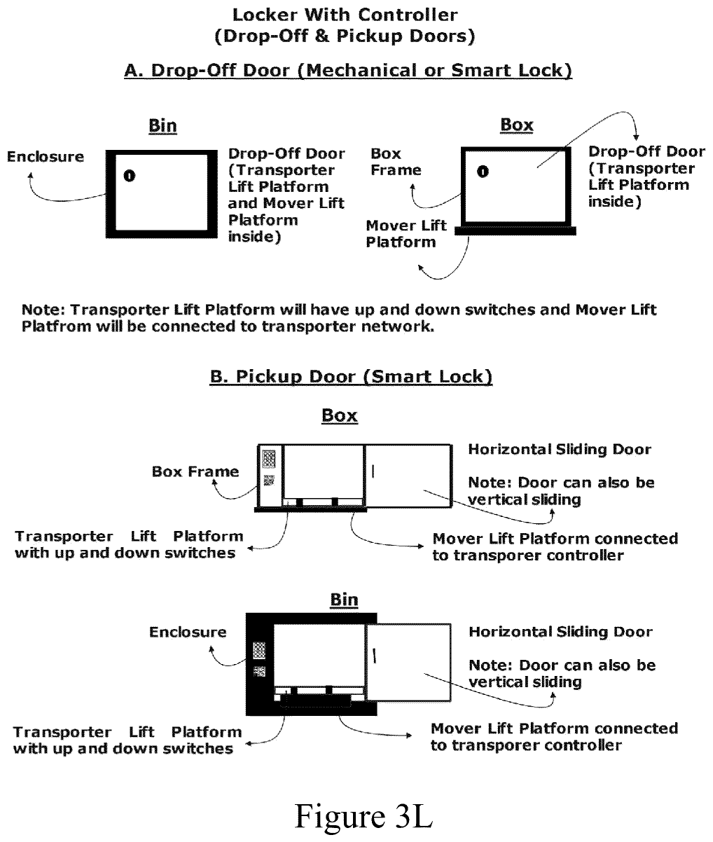

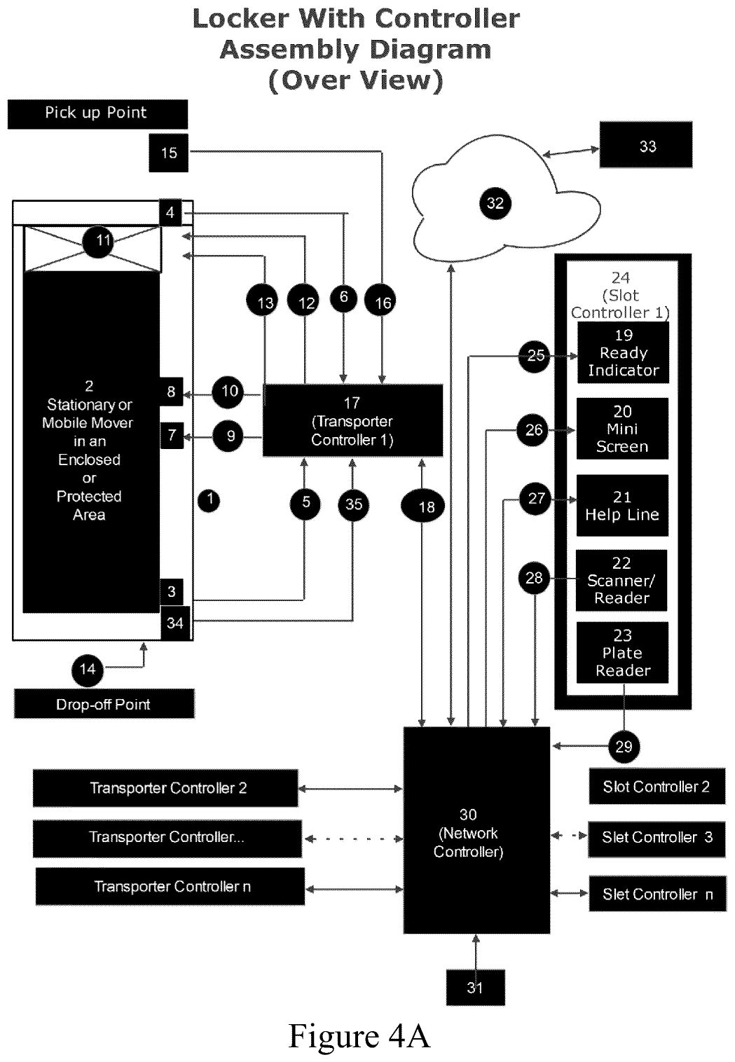

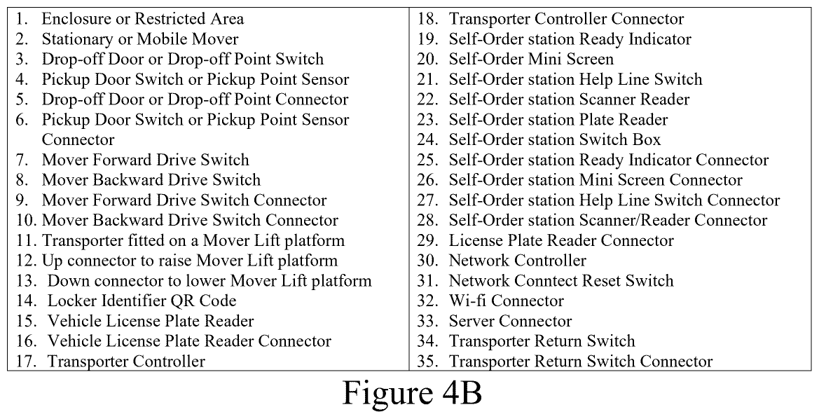

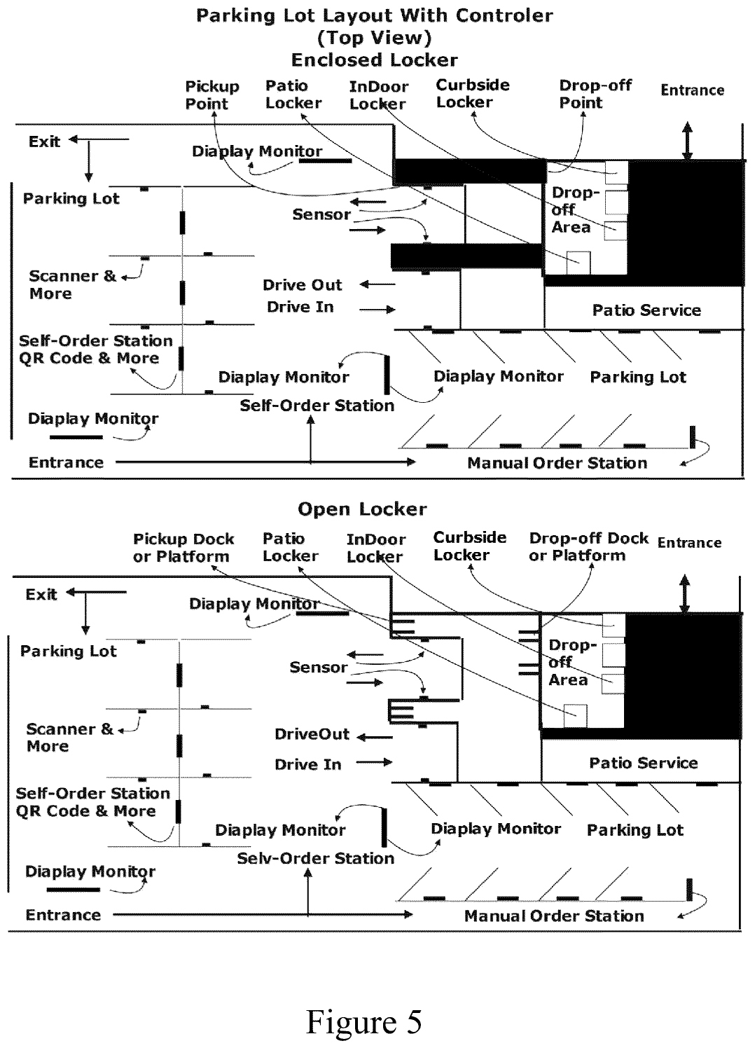

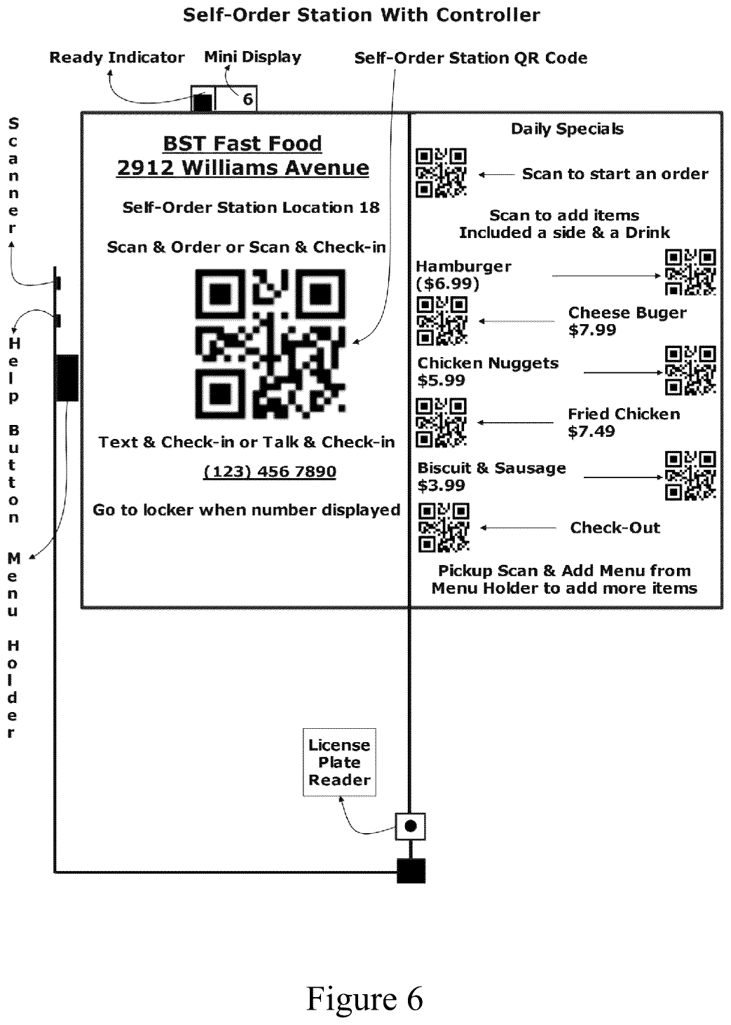

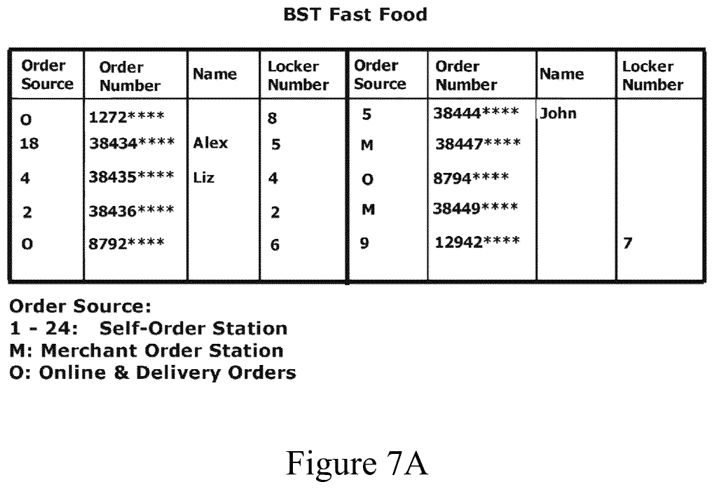

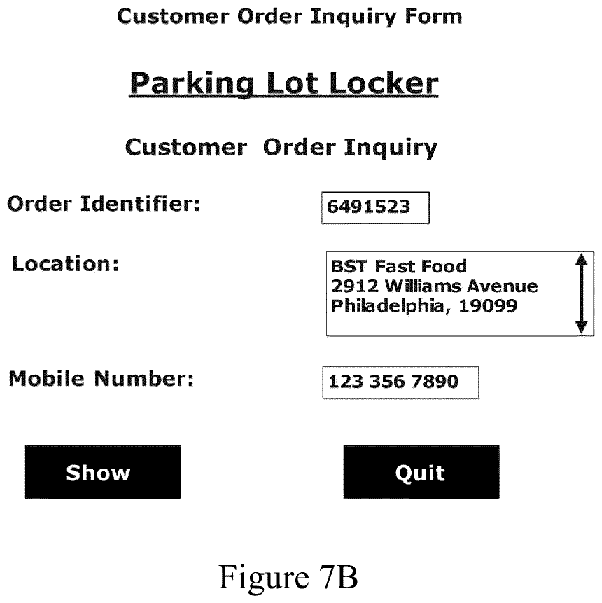

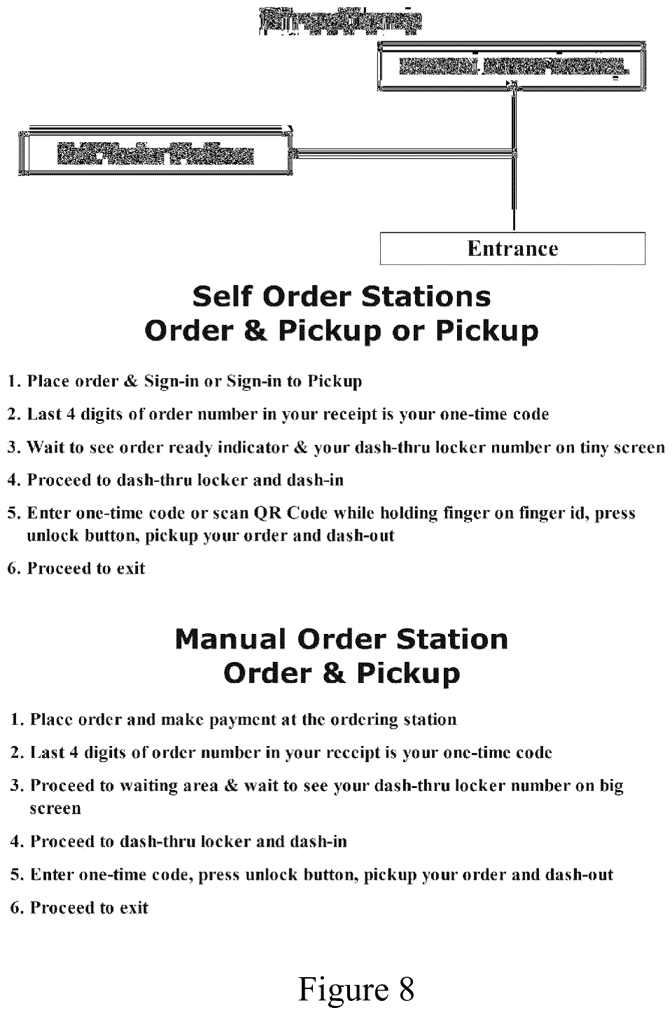

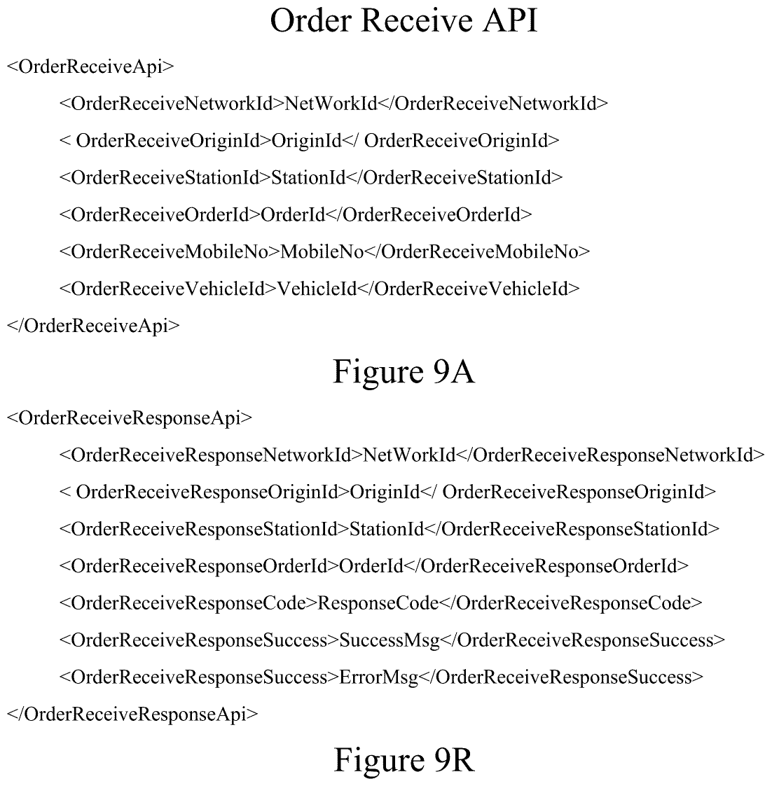

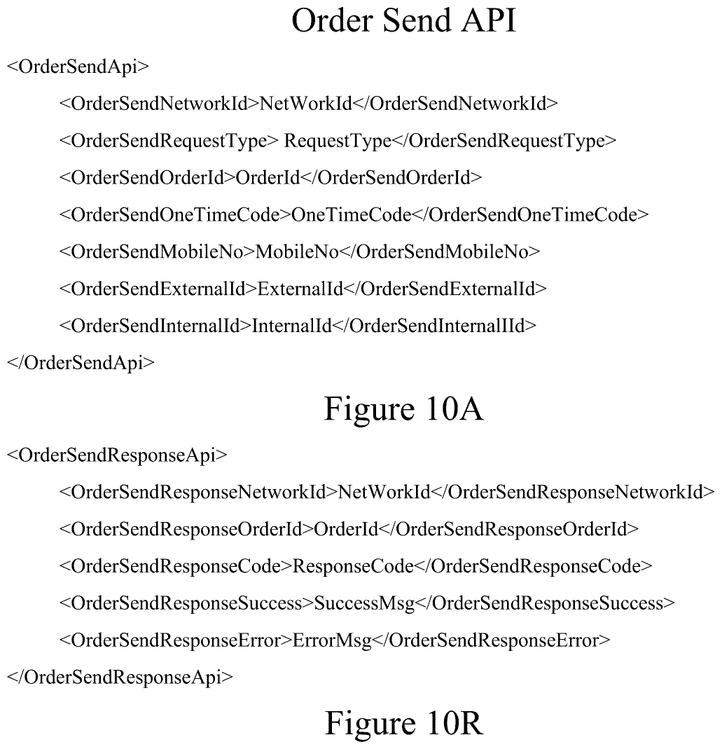

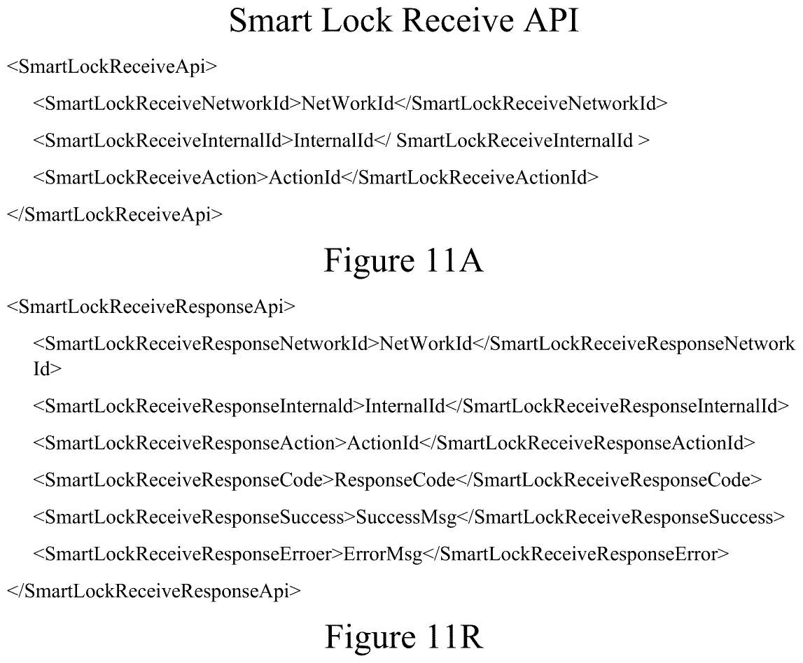

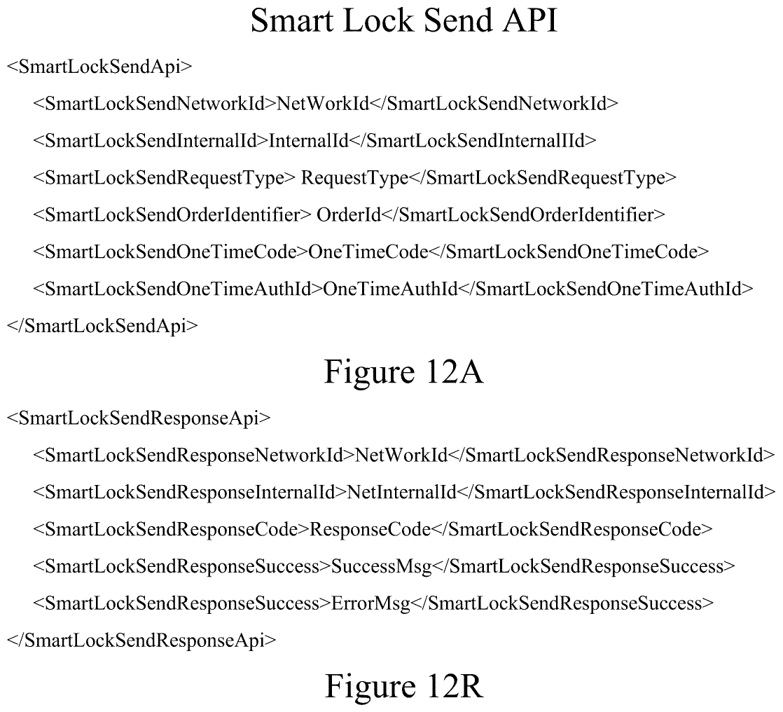

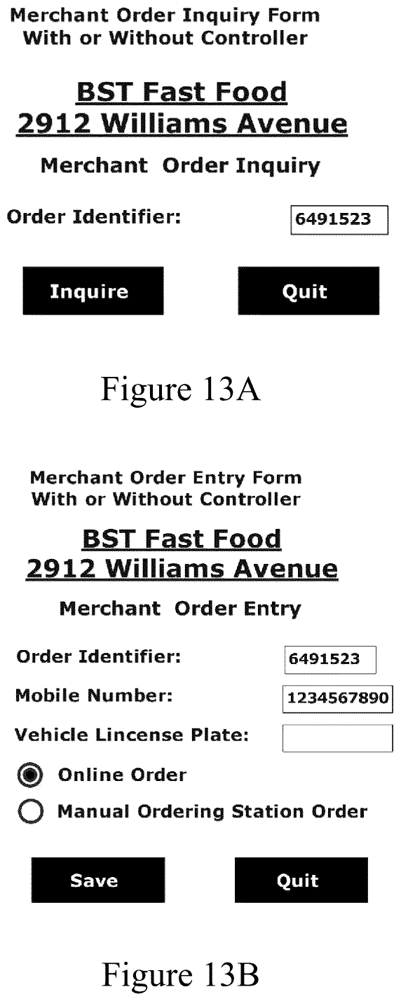

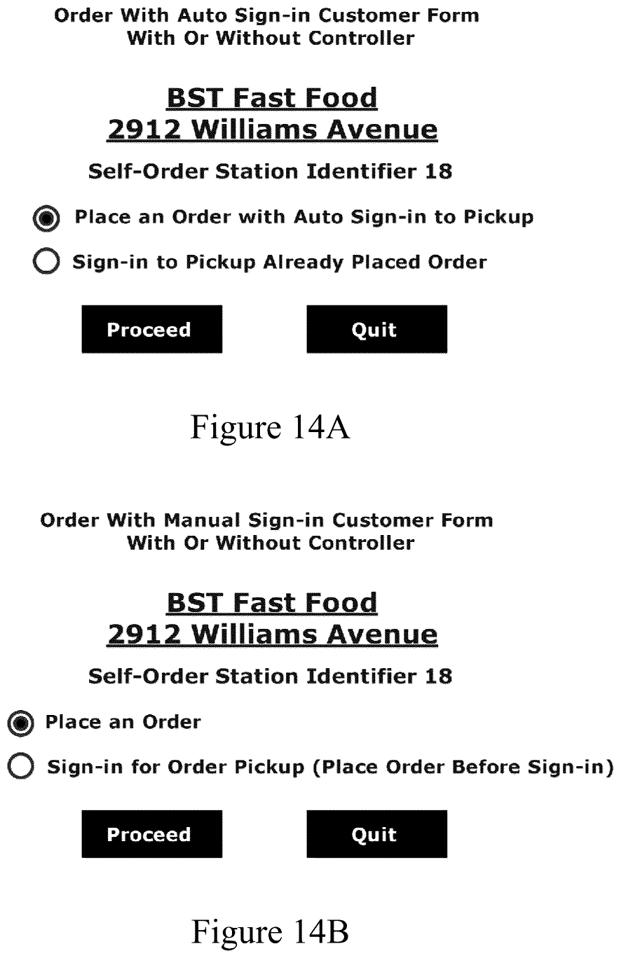

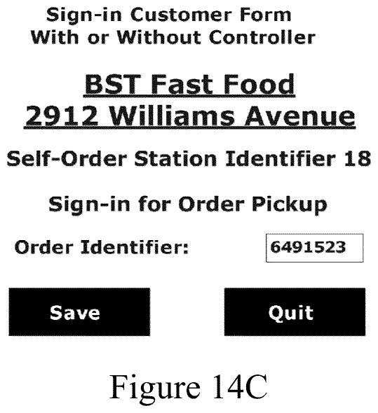

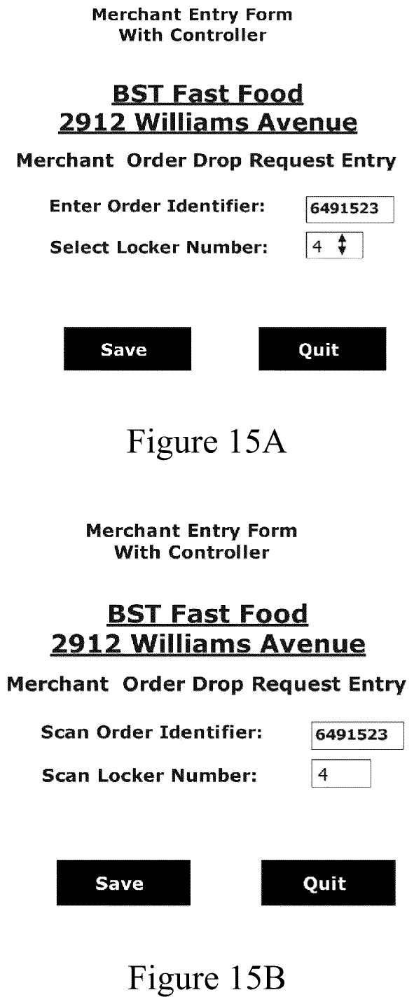

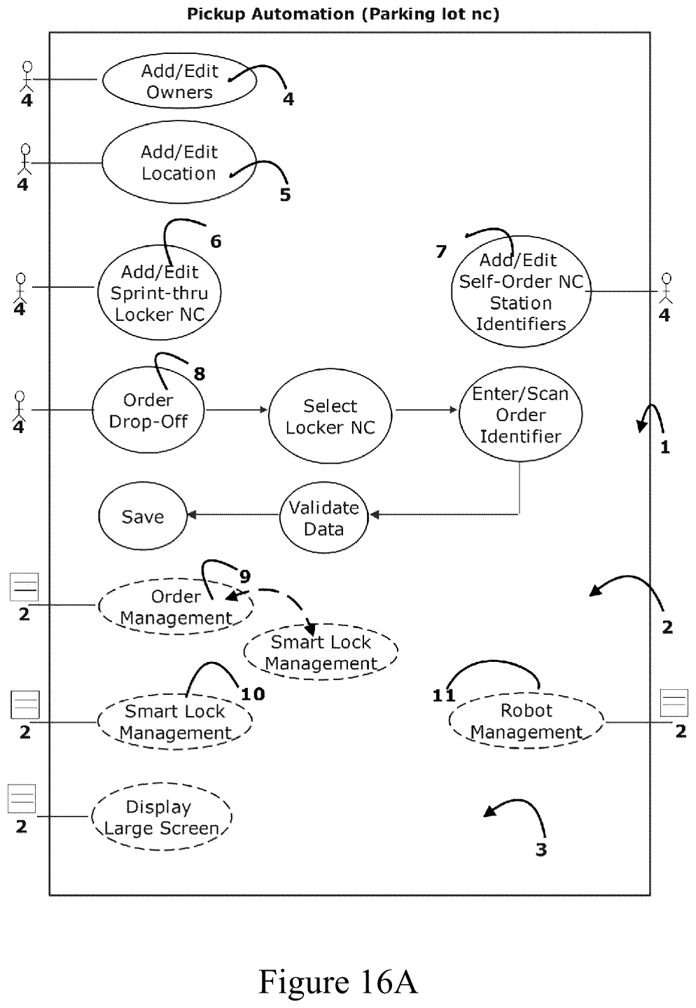

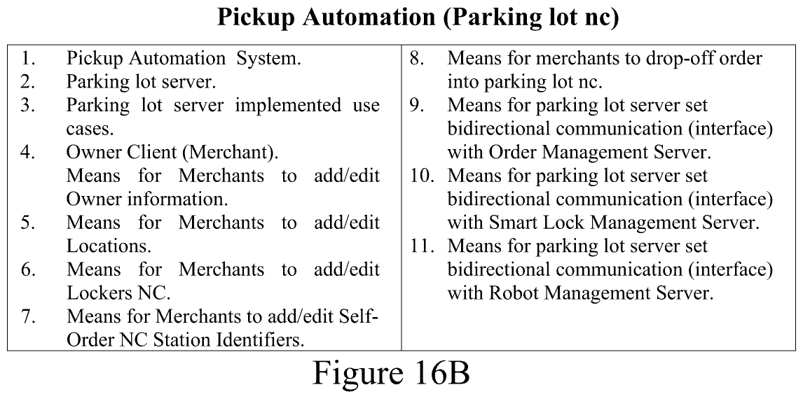

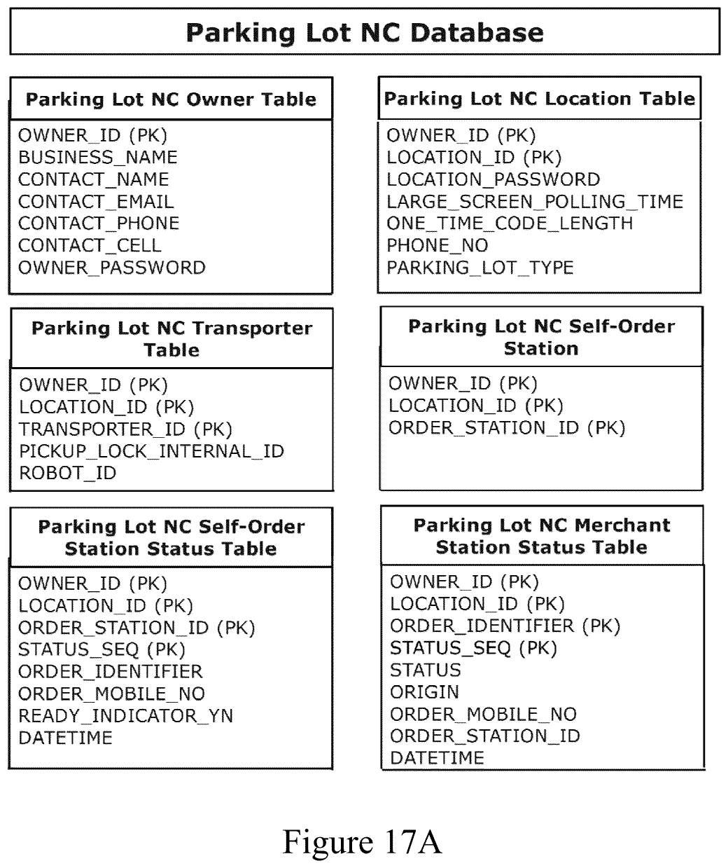

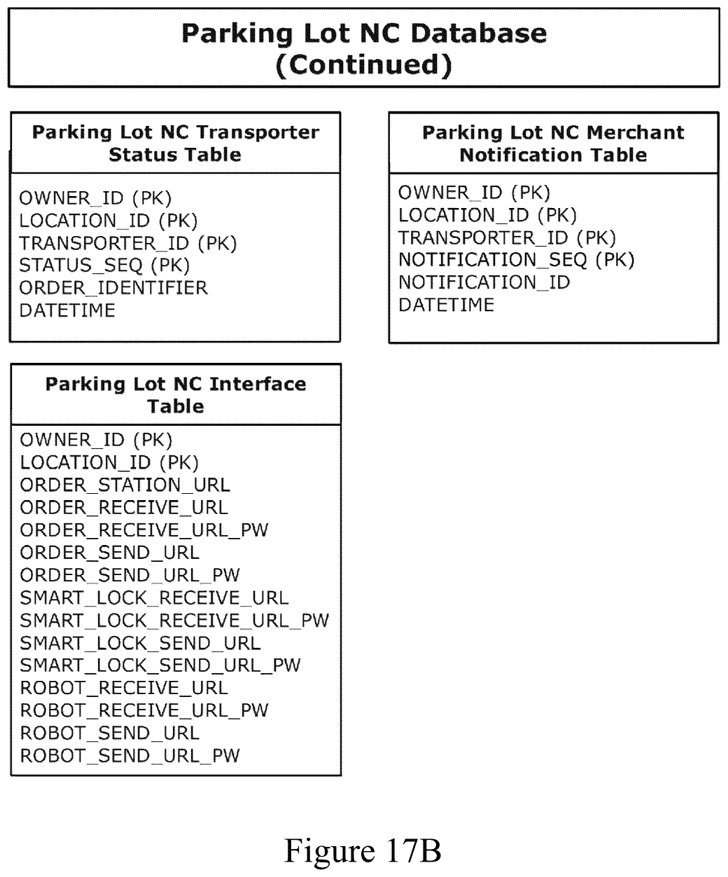

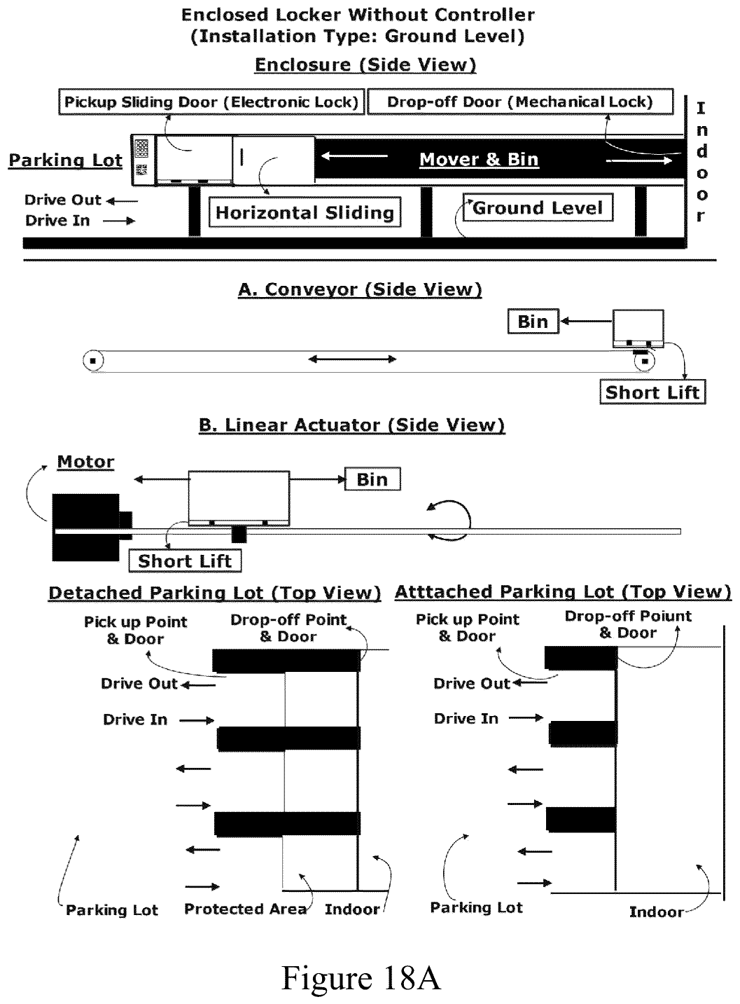

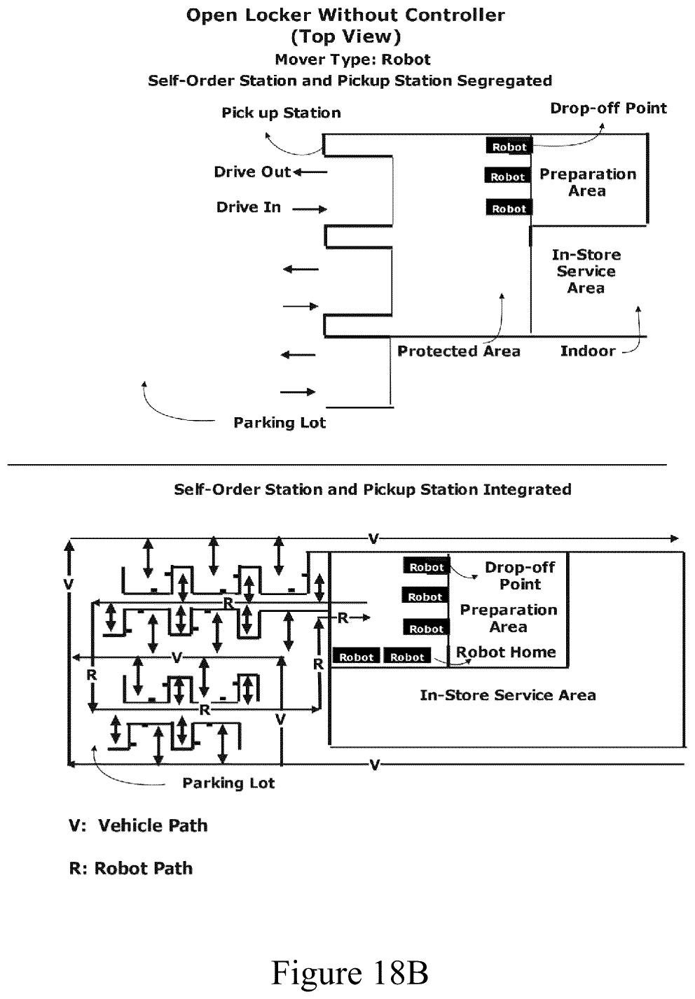

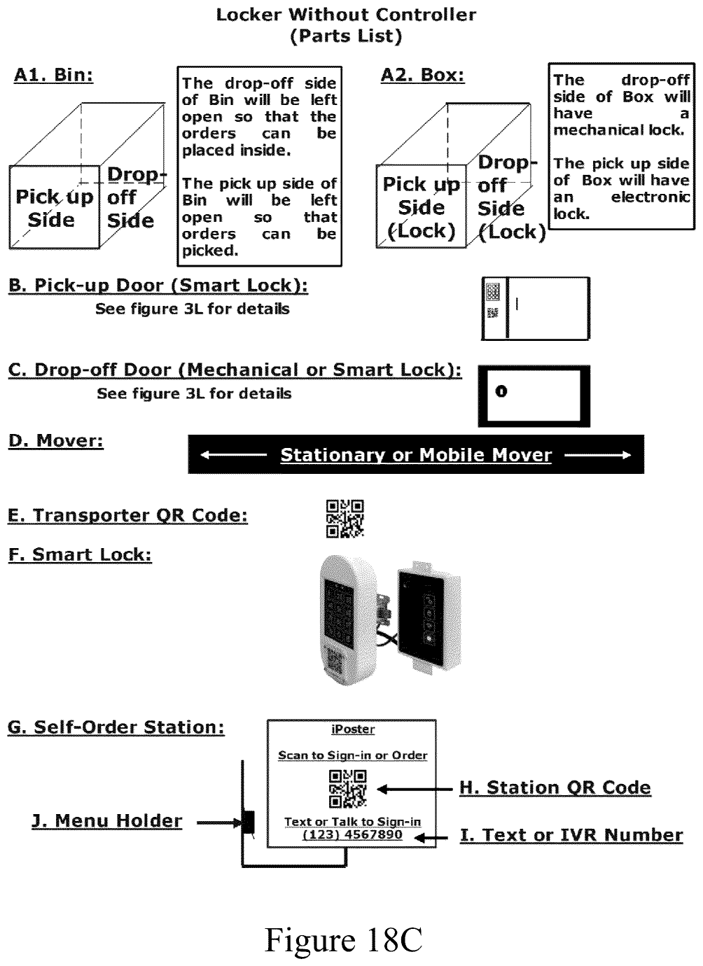

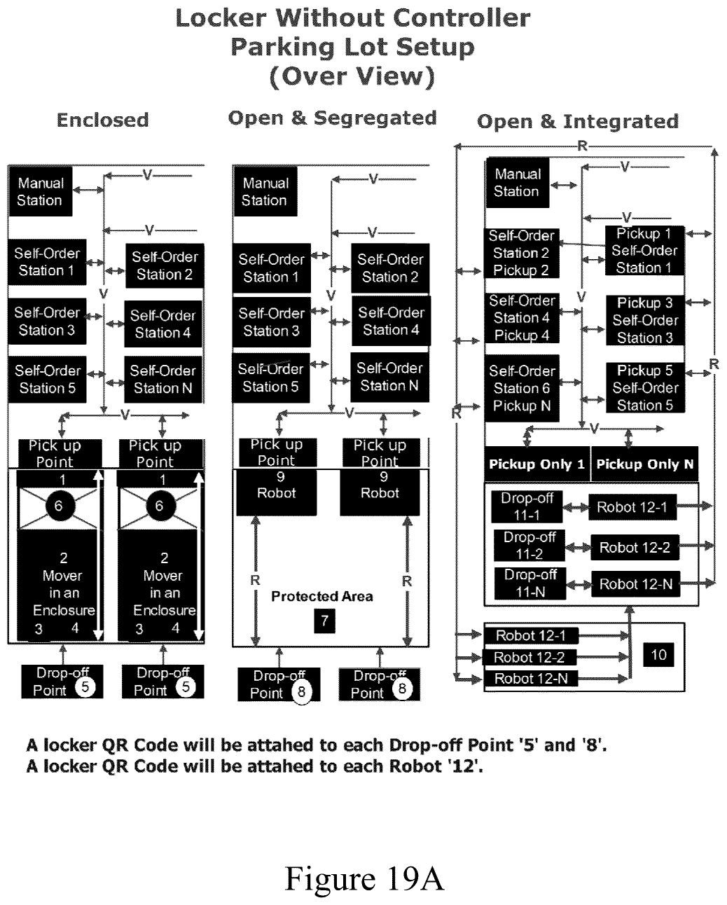

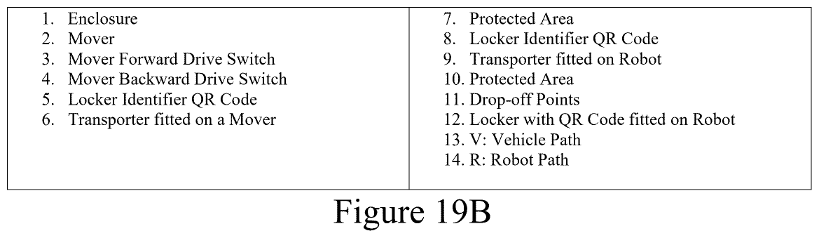

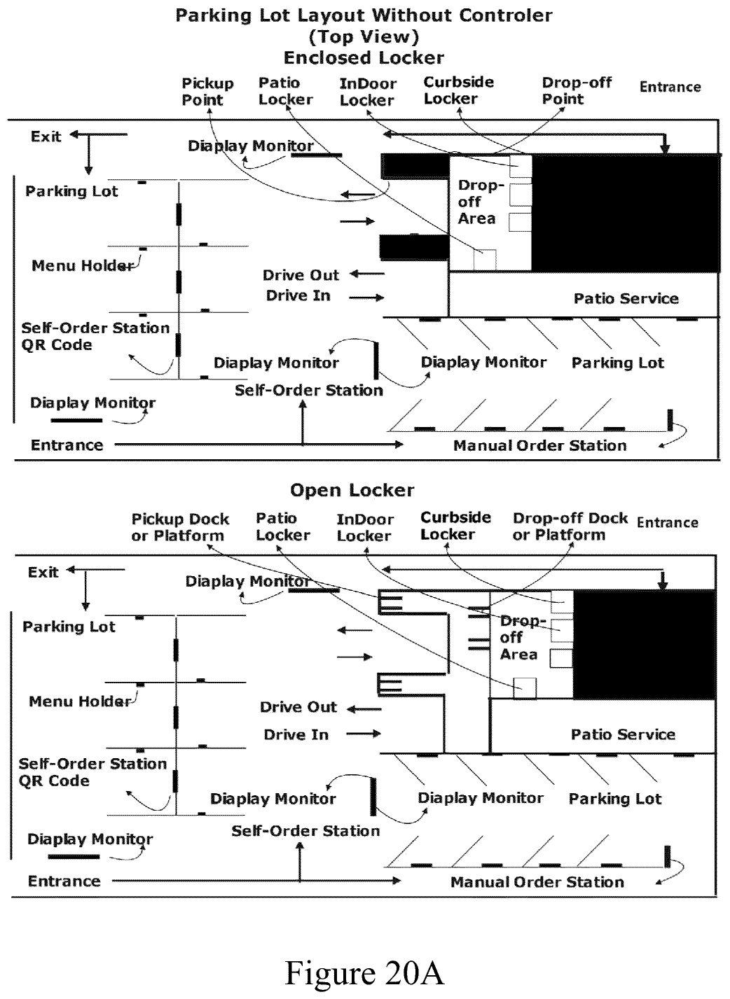

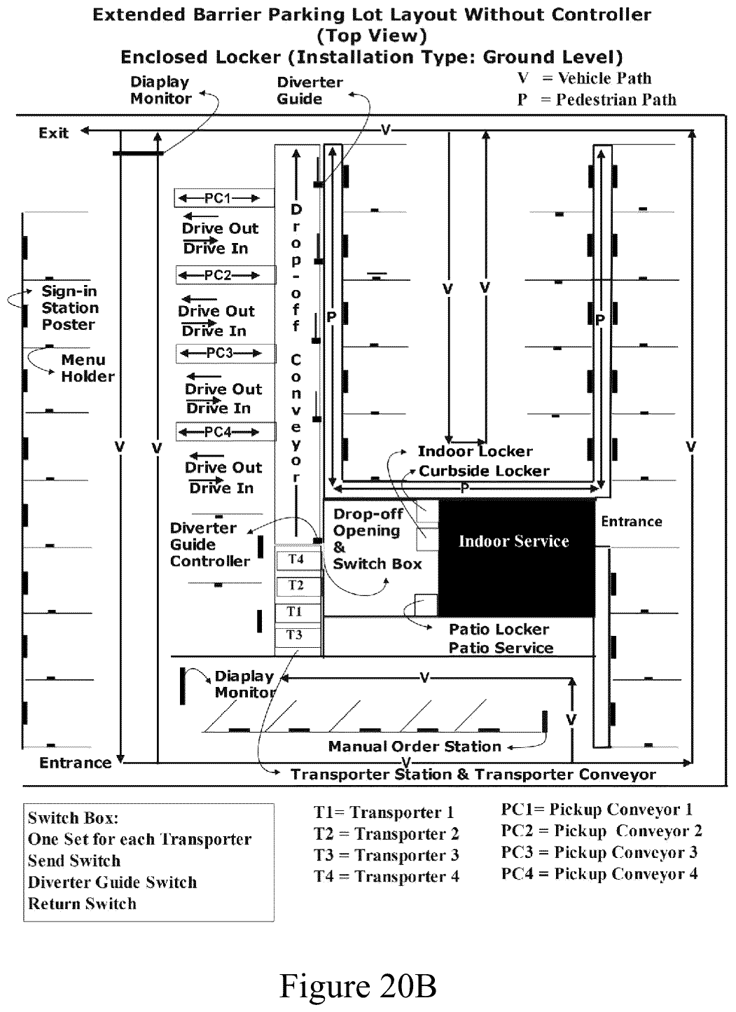

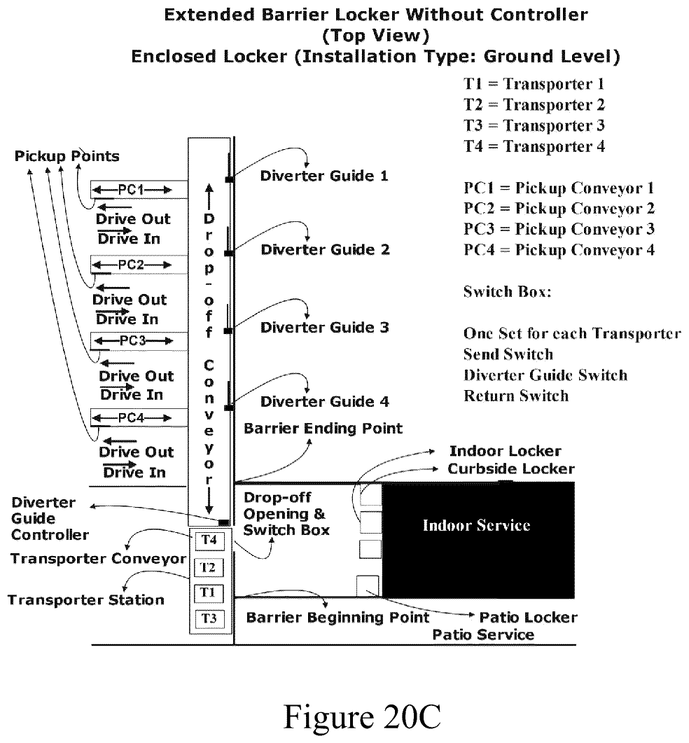

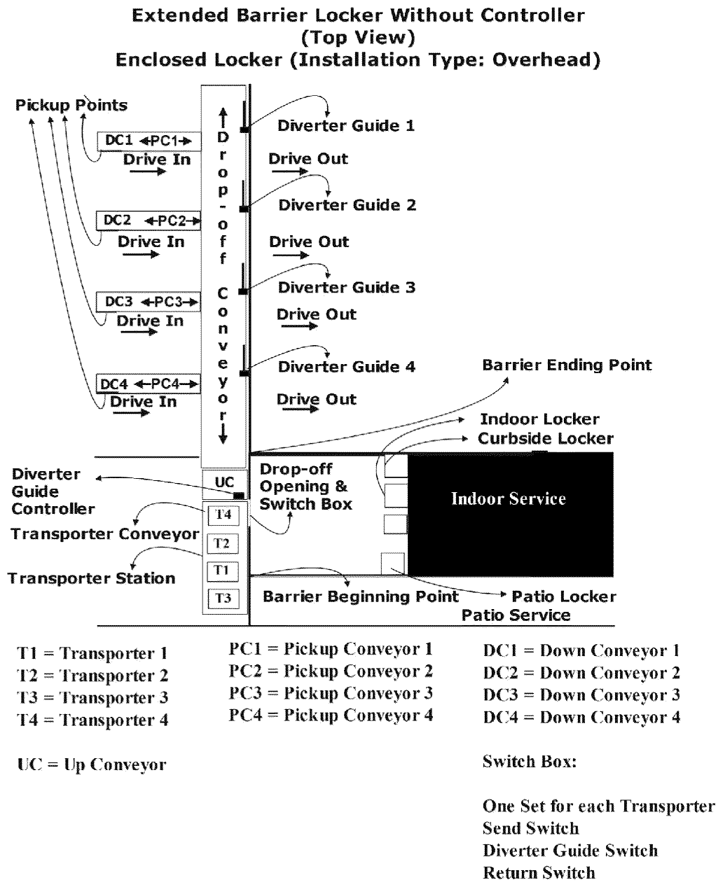

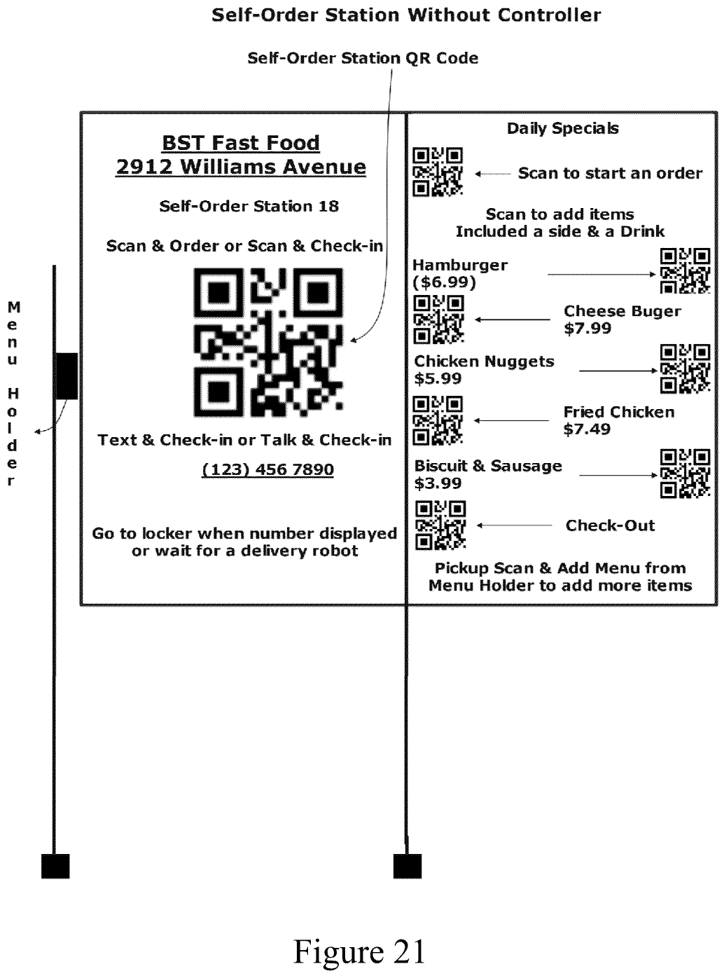

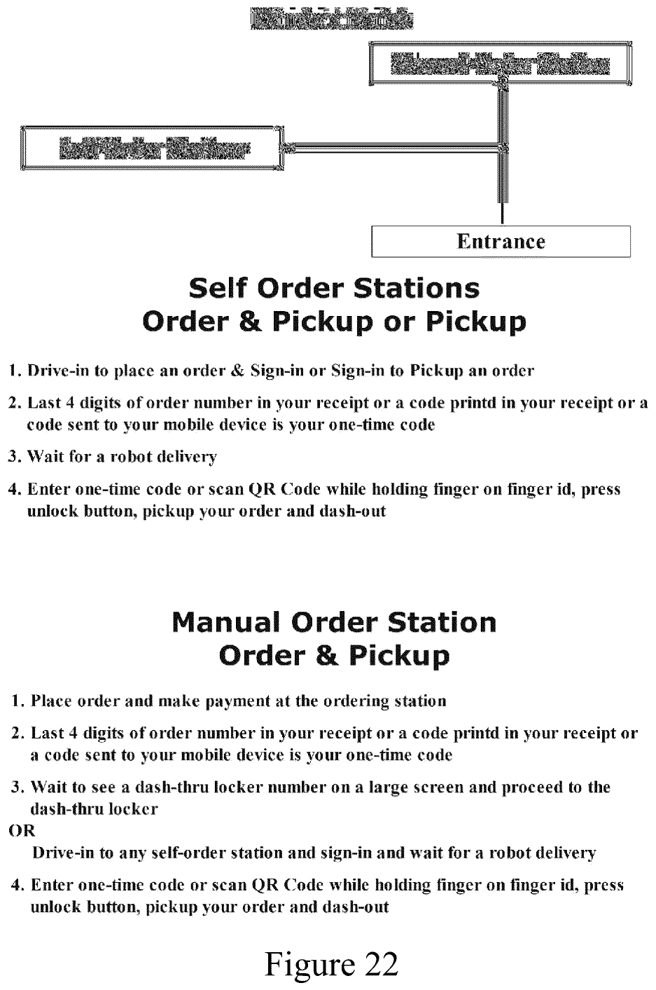

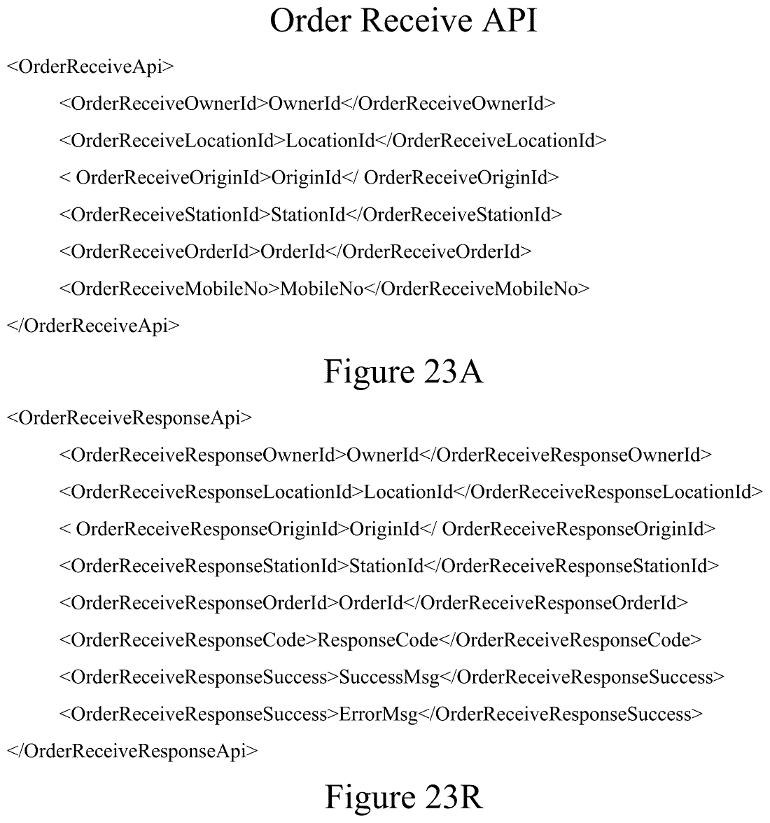

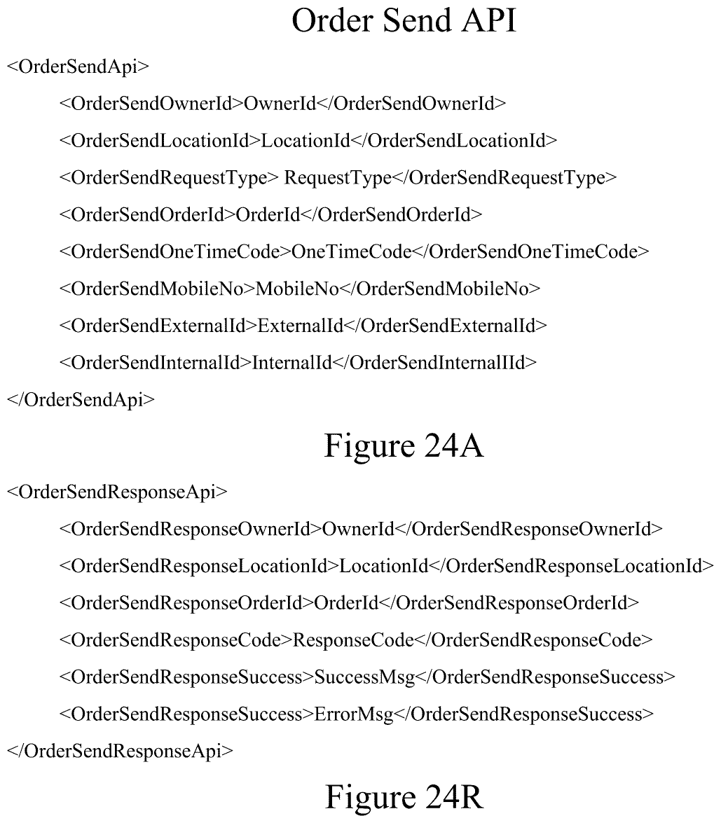

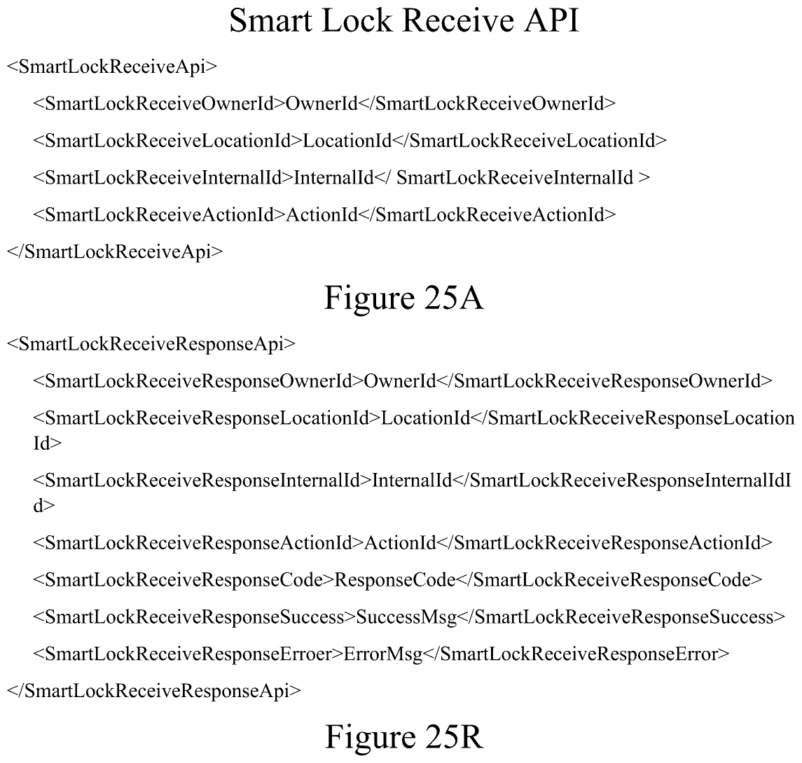

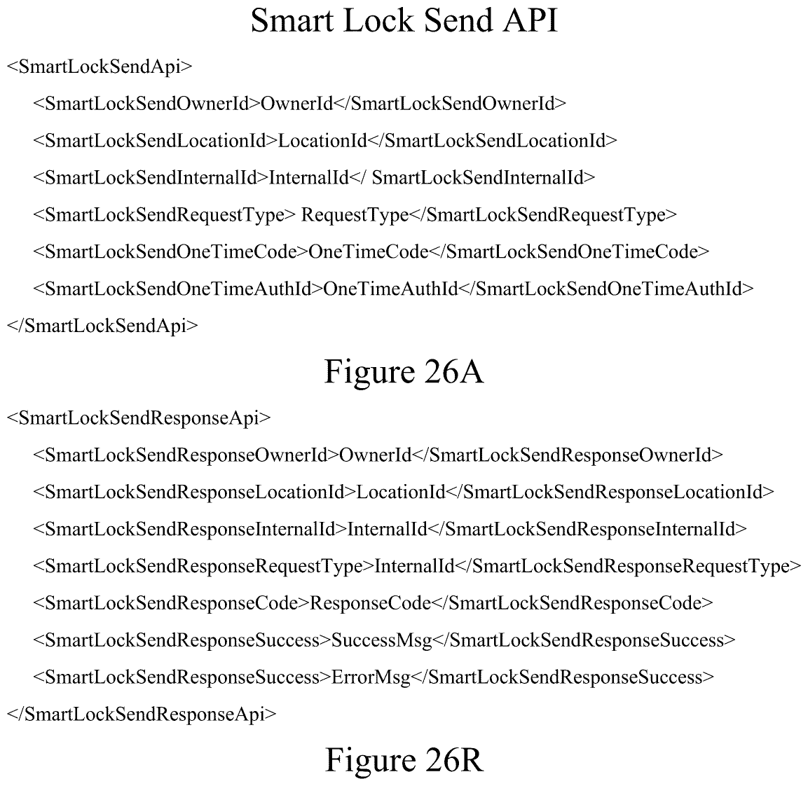

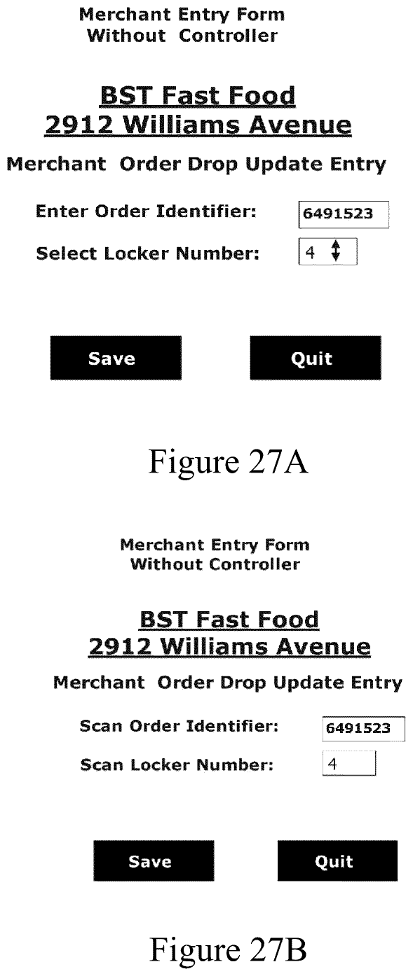

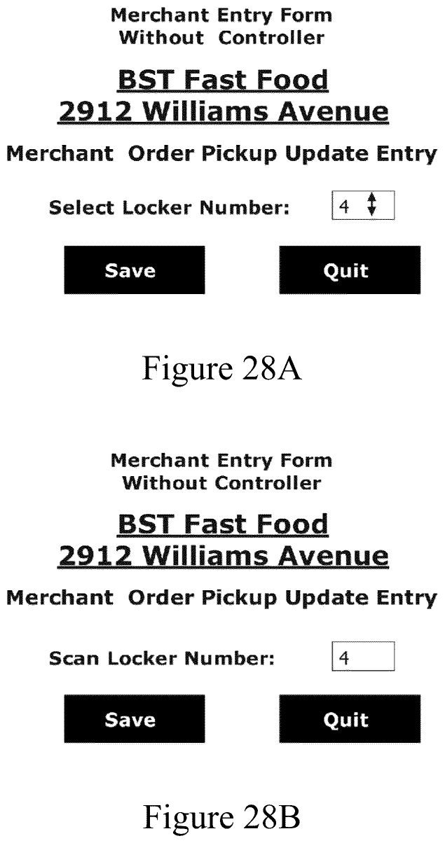

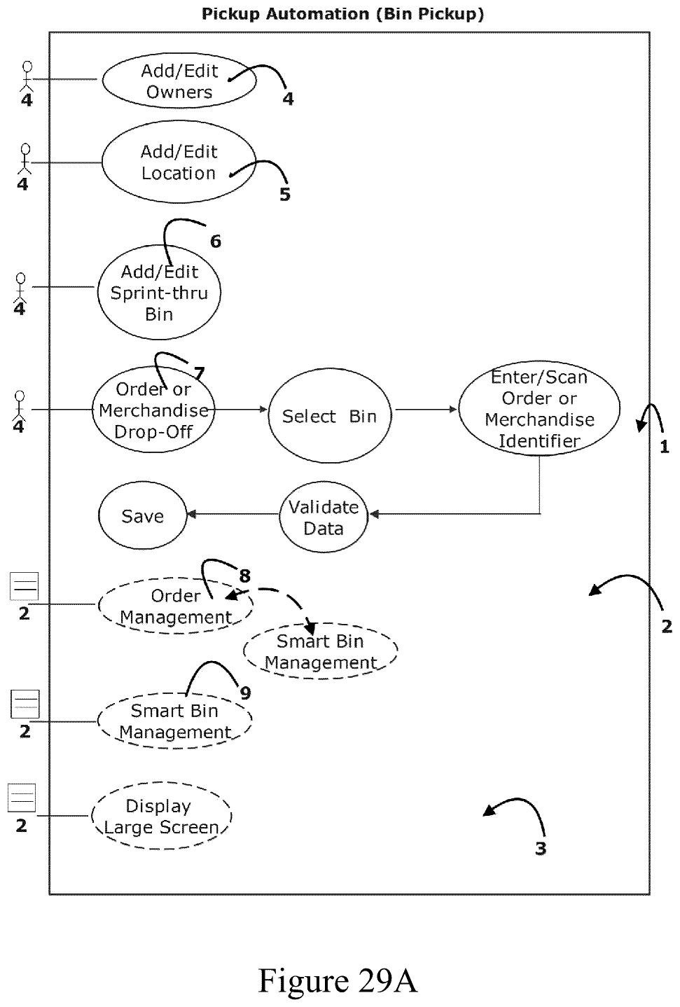

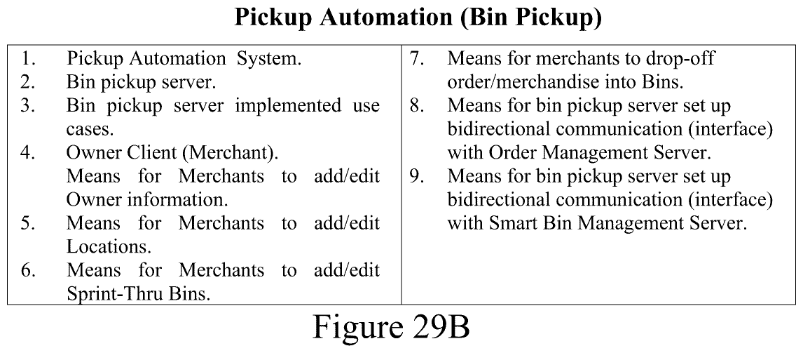

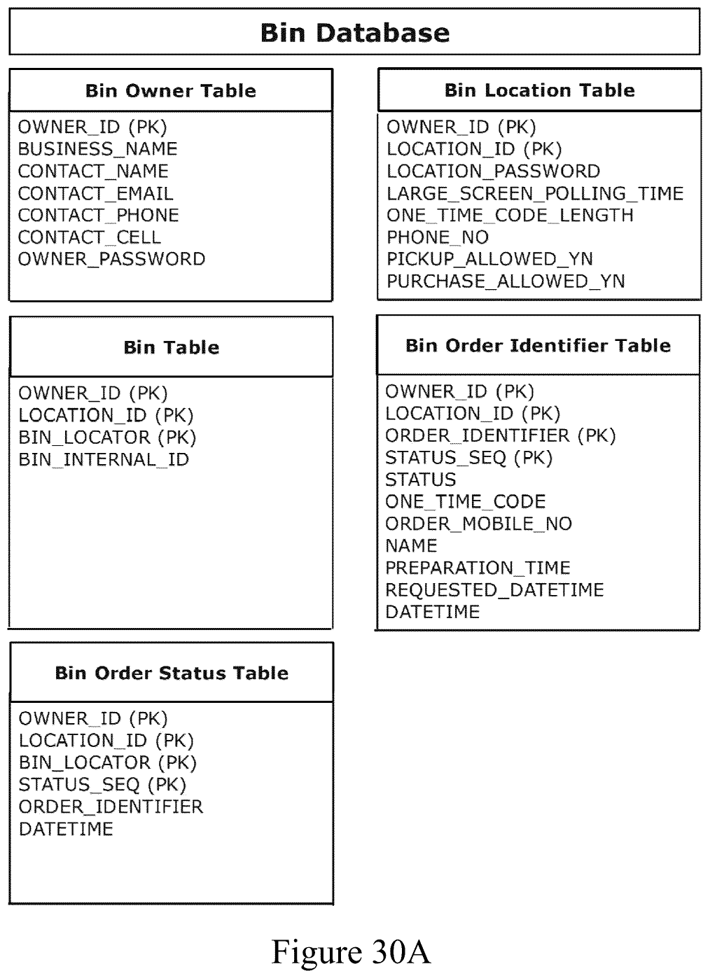

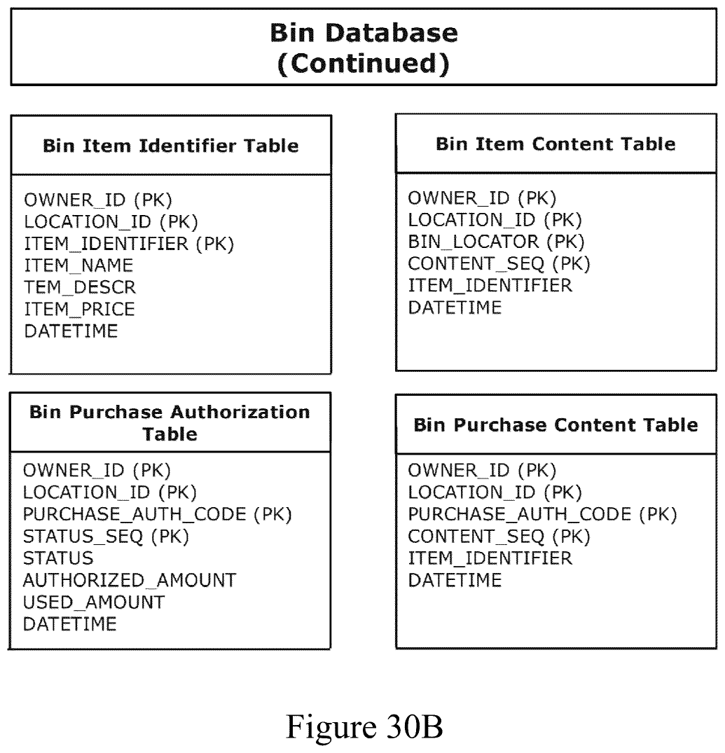

FIG. 3J shows, in a top view the various installation types used in an open locker.

FIG. 3K shows a general list of parts used in locker.

FIG. 3L shows, in a side view the bin and box transporters used in locker.

FIGS. 4A & 4B show, in an overview, the assembly diagram to assemble various parts of a locker and their inter connection.

FIG. 5 shows, parking lot layout in a location to use enclosed or open locker.

FIG. 6 shows, Self-Order station

FIG. 7A shows, large screen with order status

FIG. 7B shows, global customer form to inquire order status.

FIG. 8 shows, Directions to Self-Order & Manual Order stations and instructions for Order & Pickup or Pickup at Self-Order stations and Order & Pickup at Manual Order Stations.

FIGS. 9A and 9R show, in a class diagram, a high level schema for a representative Order Receive API for the parking lot server to receive data from order management server and to send response to order management server respectively.

FIGS. 10A and 10R show, in a class diagram, a high level schema for a representative Order Send API for the parking lot server to send data to order management server and to receive response from order management server respectively.

FIGS. 11A and 11R show, in a class diagram, a high level schema for a representative Smart Lock Receive API for the parking lot server to receive data from smart lock management server and to send response to smart lock management server respectively.

FIGS. 12A and 12R show, in a class diagram, a high level schema for a representative Smart Lock Send API for the parking lot server to send data to smart lock management server and to receive response from smart lock management server respectively.

FIG. 13A shows, data inquiry page for merchants to inquire orders.

FIG. 13B shows, data entry page for merchants to enter manual orders or online orders.

FIG. 14A shows, data entry page for customers to select an option to place an order with auto sign-in or to sign-in to pick up an already placed order.

FIG. 14B shows, data entry page for customers to place an order and sign-in to pick up an already placed order.

FIG. 14C shows, data entry page for customers to enter an order identifier to sign-in to pick up an already placed order.

FIG. 15A shows, data entry page for merchant to submit a request to drop an order using a web site.

FIG. 15B shows, data entry page for merchant to submit a request to drop an order using an app.

FIGS. 16A & 16B show, in an overview use case diagram, the various basic functionality implemented for some of the preferred embodiments of the present invention for parking lot order pickup without controllers.

FIGS. 17A and 17B shows, in a class diagram, a high-level schema for a representative parking lot nc database as may be implemented in accordance with the present invention for parking lot order pickup without controllers.

FIG. 18A shows, in a sideview, the various options to install enclosed locker without controllers mounted at the ground level for detached and attached parking lots.

FIG. 18B shows, in a sideview, the various options to install open locker without controllers for segregated and integrated parking lots.

FIG. 18C shows a general list of parts used in locker without controllers.

FIGS. 19A & 19B show, in an overview, the parking lot set up diagram to set up parking lots using lockers without controllers.

FIG. 20A shows, segregated parking lot for enclosed and open in a location to use enclosed or open locker without controllers.

FIG. 20B shows, segregated parking lot for extended barrier in a location to use enclosed locker without controllers installed at ground level.

FIG. 20D shows, details of extended barrier for enclosed locker without controllers installed overhead.

FIG. 20C shows, details of extended barrier for enclosed locker without controllers.

FIG. 21 shows, Self-Order station without controllers.

FIG. 22 shows, Directions to Self-Order & Manual Order stations and instructions for Order & Pickup or Pickup at Self-Order stations and Order & Pickup at Manual Order Stations in a Parking Lot without controllers.

FIGS. 23A and 23R show, in a class diagram, a high level schema for a representative Order Receive API for the parking lot server without controllers to receive data from order management server and to send response to order management server respectively.

FIGS. 24A and 24R show, in a class diagram, a high level schema for a representative Order Send API for the parking lot server without controllers to send data to order management server and to receive response from order management server respectively.

FIGS. 25A and 25R show, in a class diagram, a high level schema for a representative Smart Lock Receive API for the parking lot server without controllers to receive data from smart lock management server and to send response to smart lock management server respectively.

FIGS. 26A and 26R show, in a class diagram, a high level schema for a representative Smart Lock Send API for the parking lot server without controllers to send data to smart lock management server and to receive response from smart lock management server respectively.

FIG. 27A shows, data entry page for merchant to submit an update to drop an order using a web site.

FIG. 27B shows, data entry page for merchant to submit an update to drop an order using an app.

FIG. 28A shows, data entry page for merchant to submit an update order pick up using a web site.

FIG. 28B shows, data entry page for merchant to submit an update order pick up using an app.

FIGS. 29A & 29B show, in an overview use case diagram, the various basic functionality implemented for some of the preferred embodiments of the present invention for bin pickup.

FIGS. 30A and 30B shows, in a class diagram, a high-level schema for a representative bin database as may be implemented in accordance with the present invention for bin pickup.

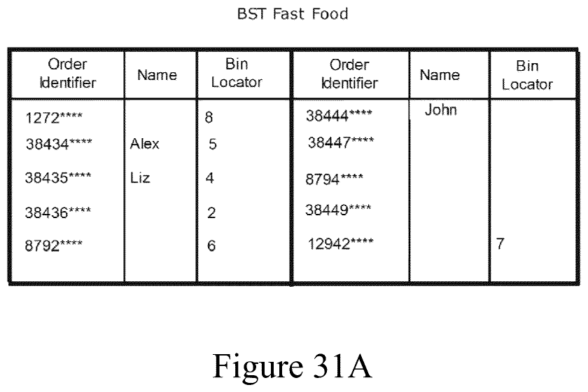

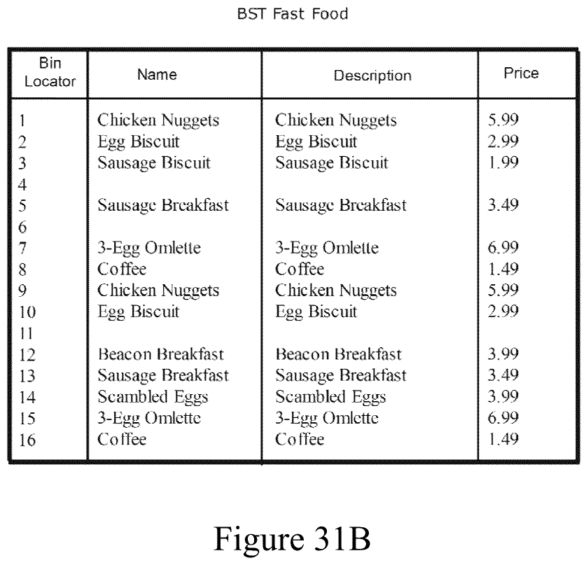

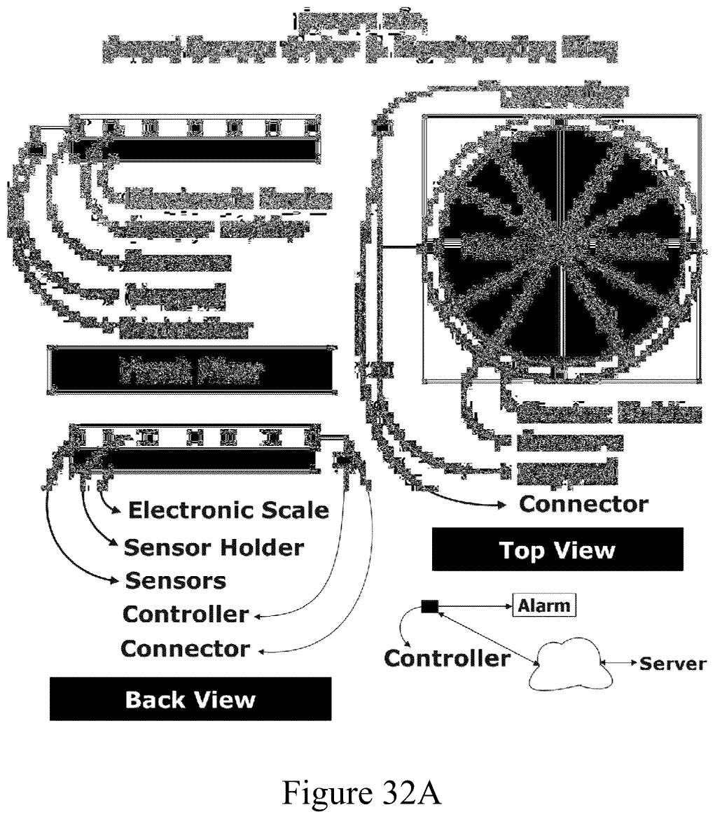

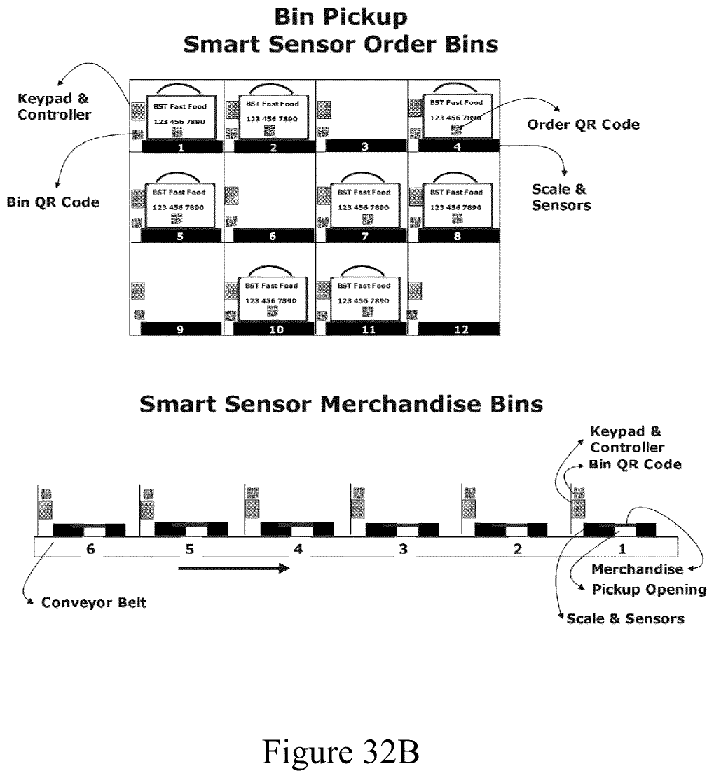

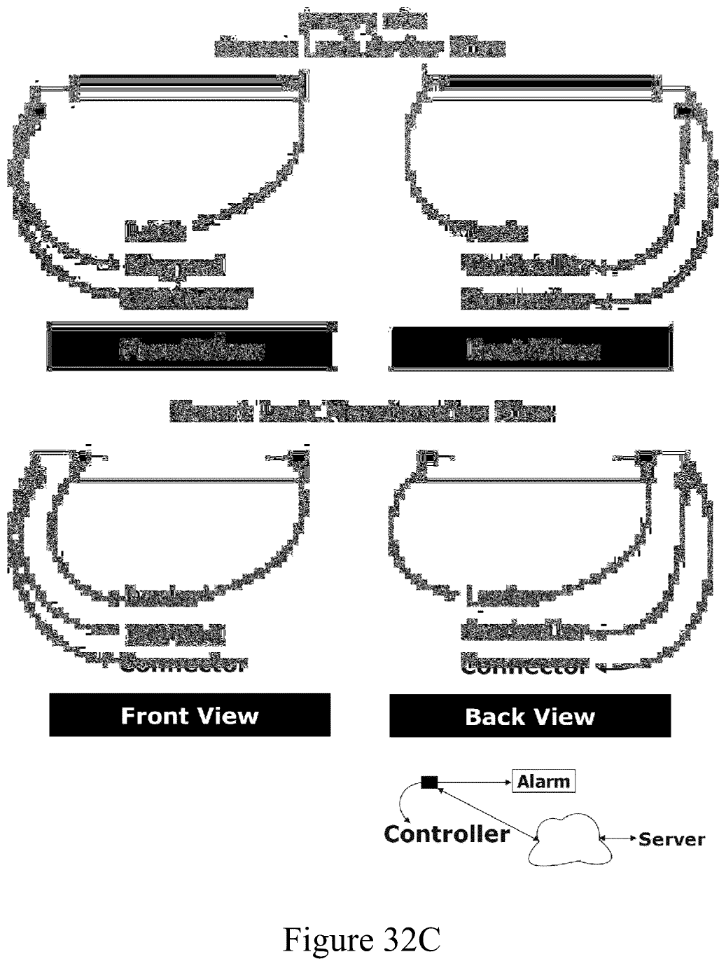

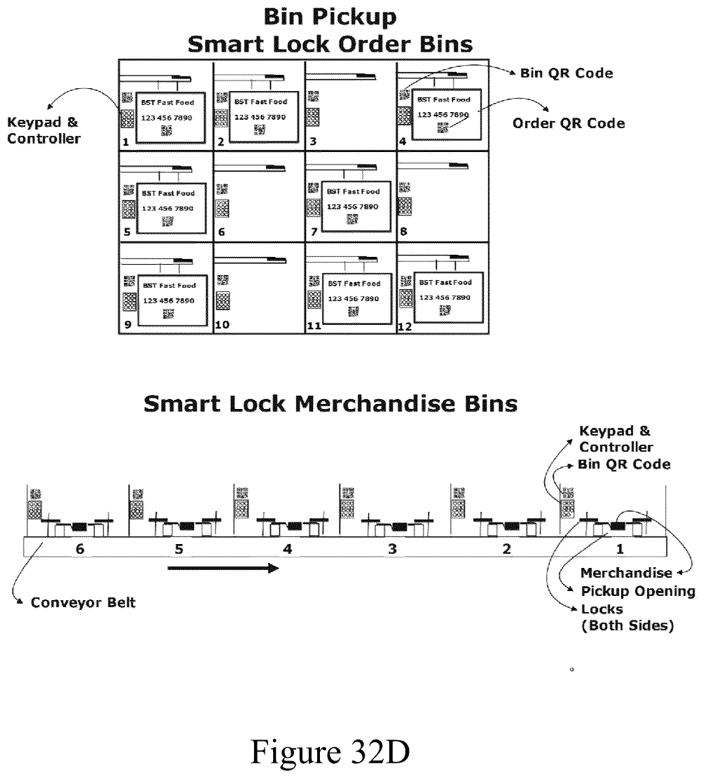

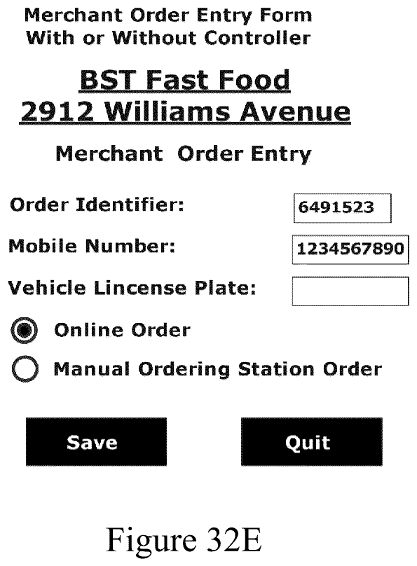

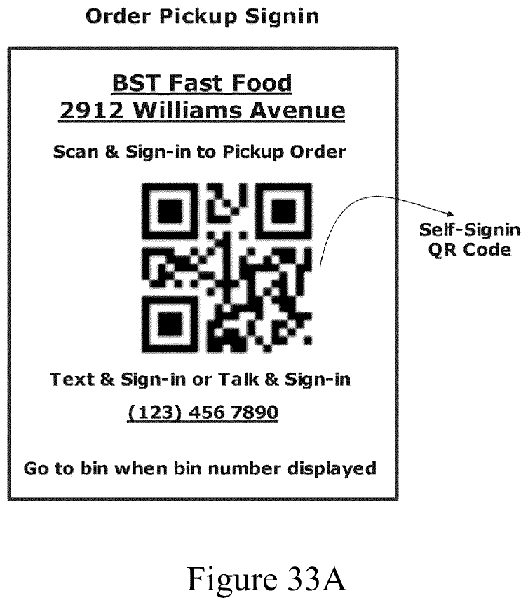

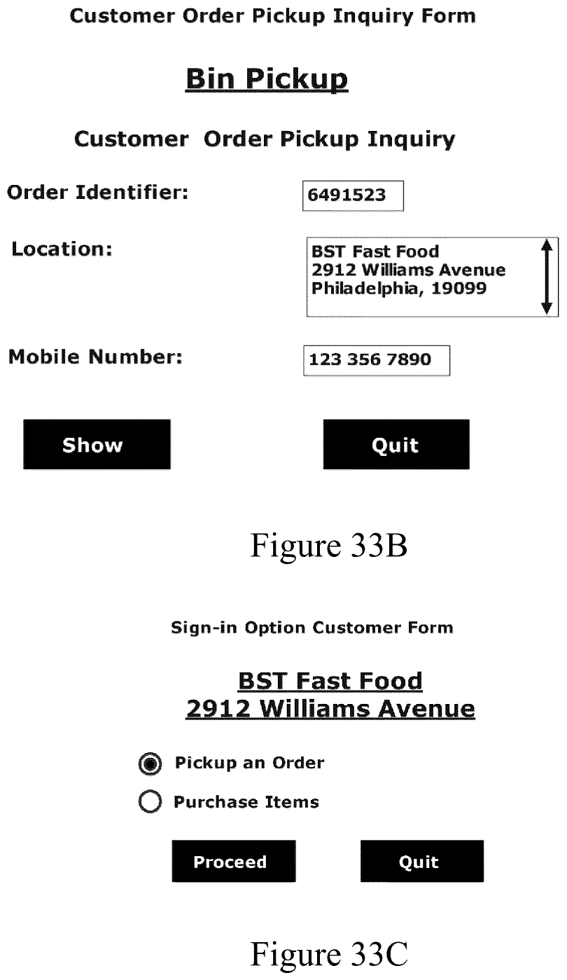

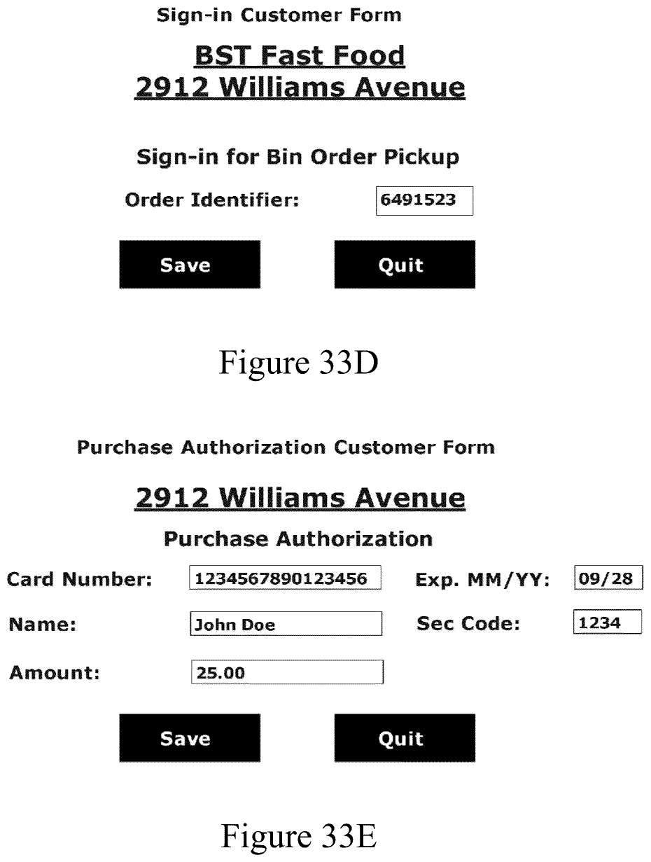

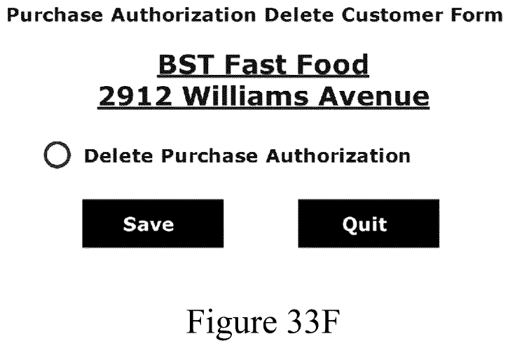

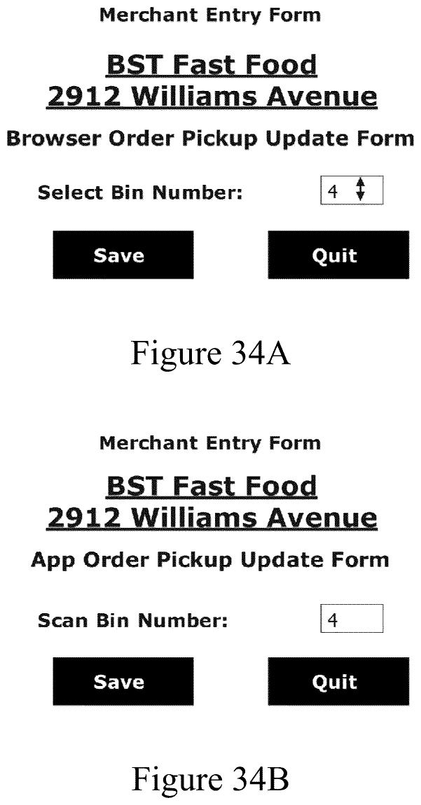

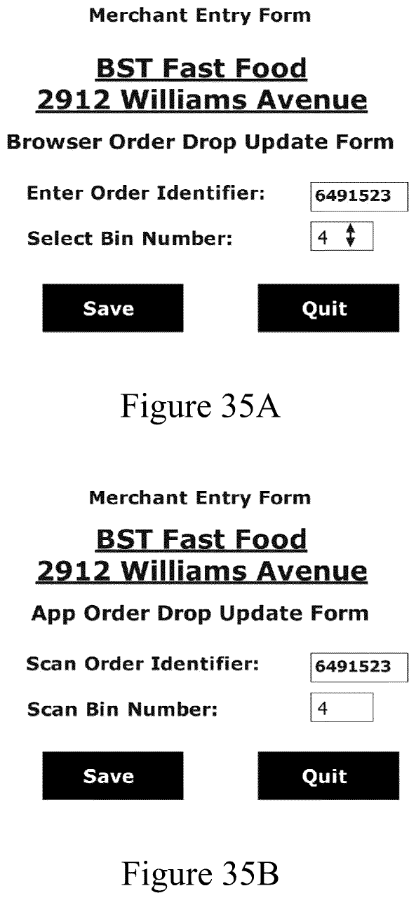

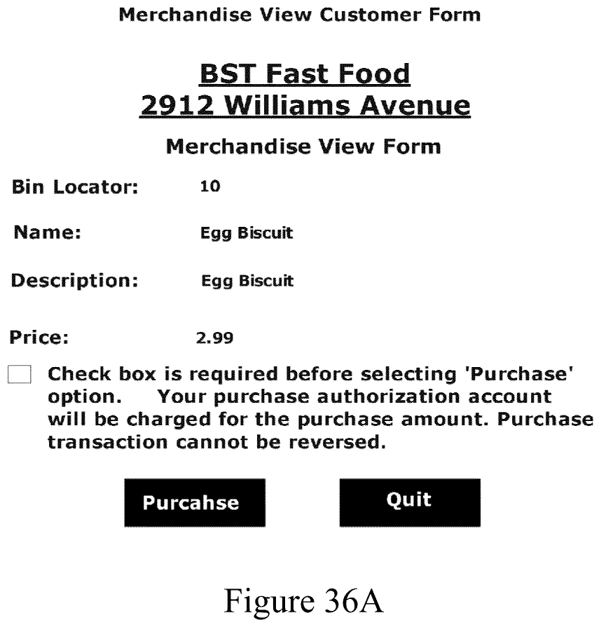

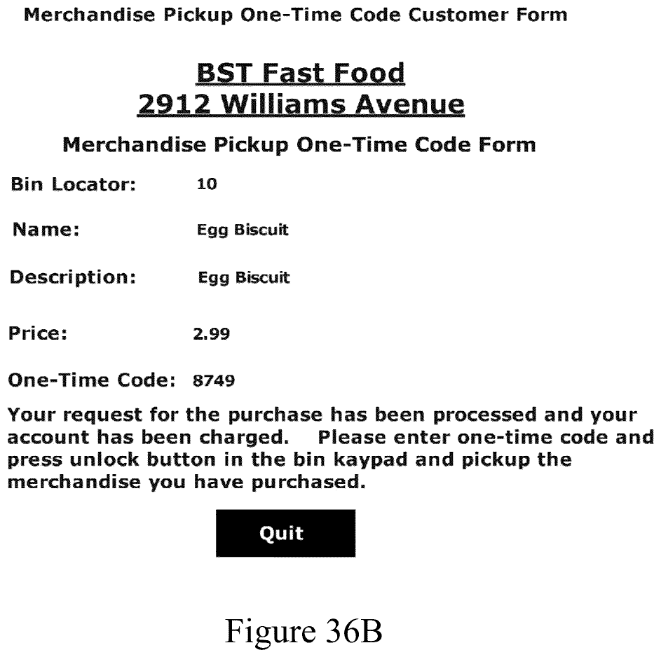

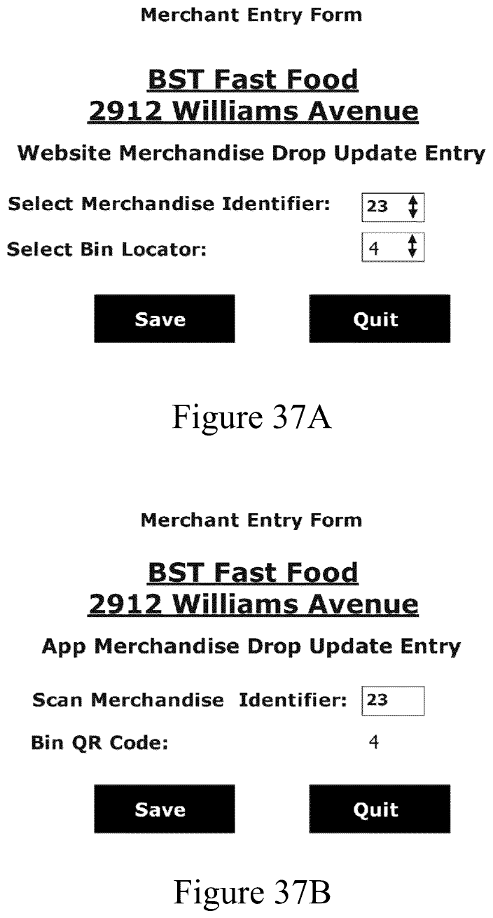

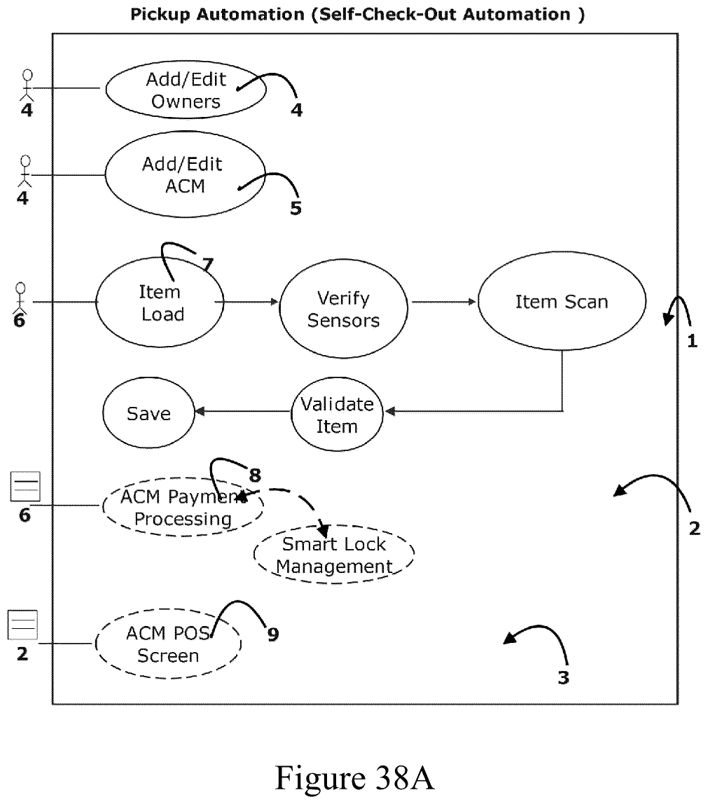

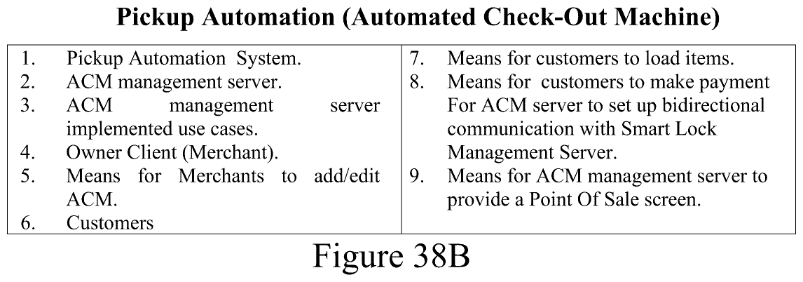

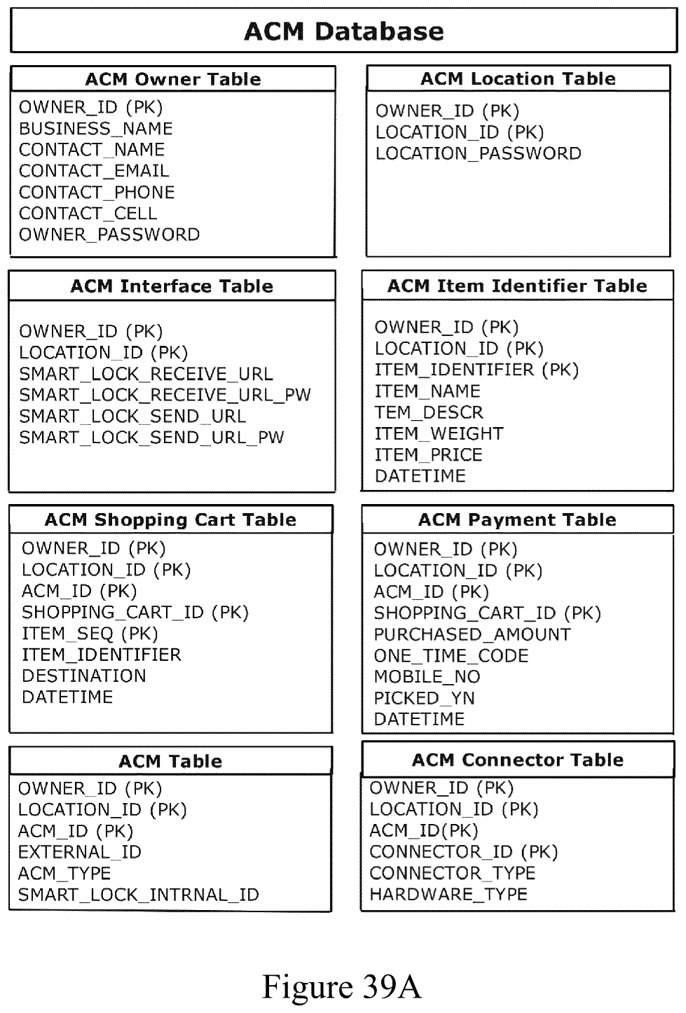

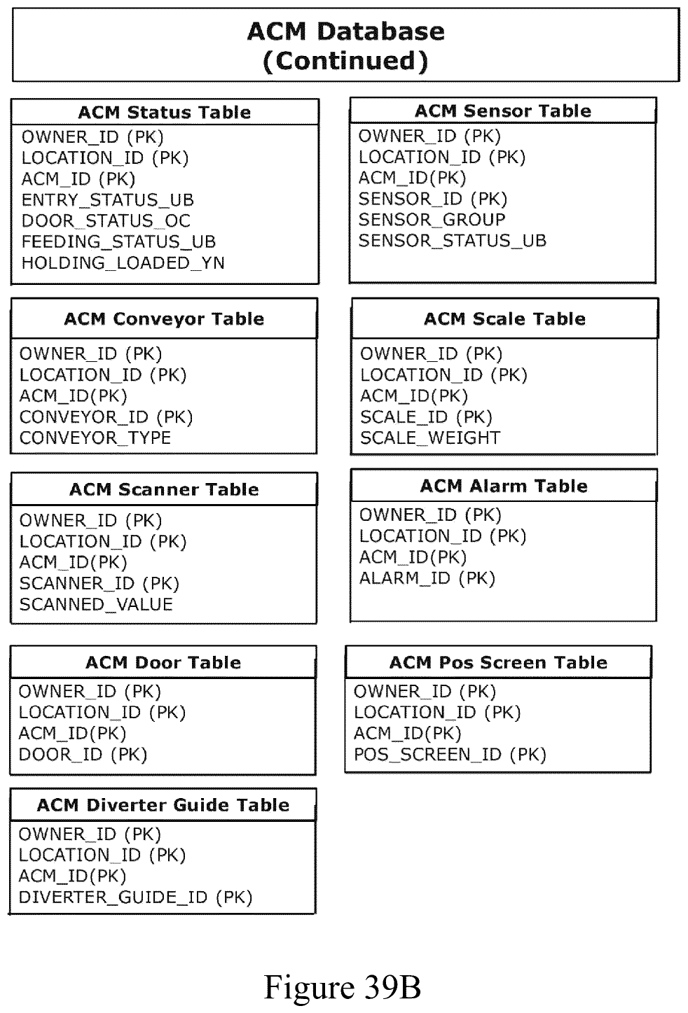

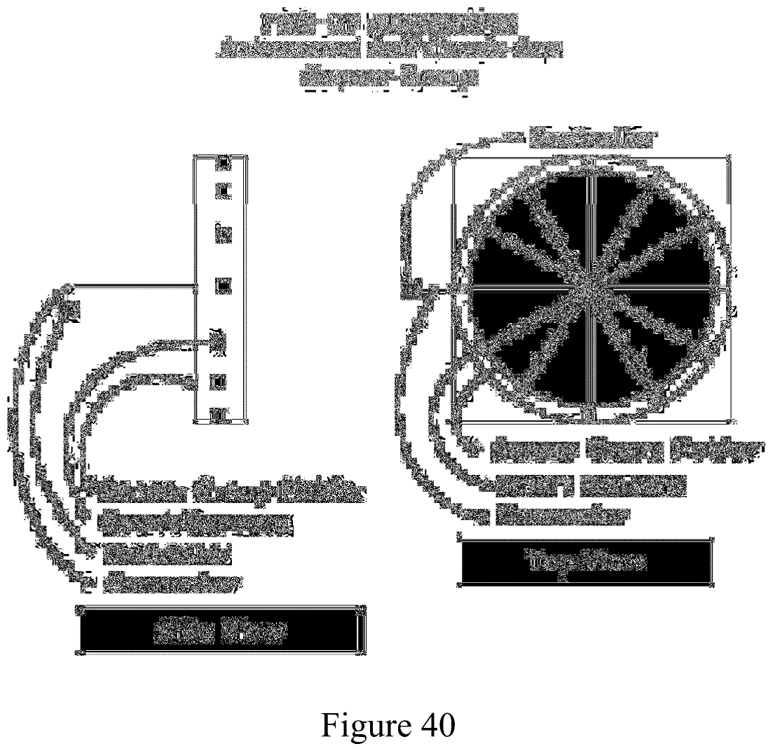

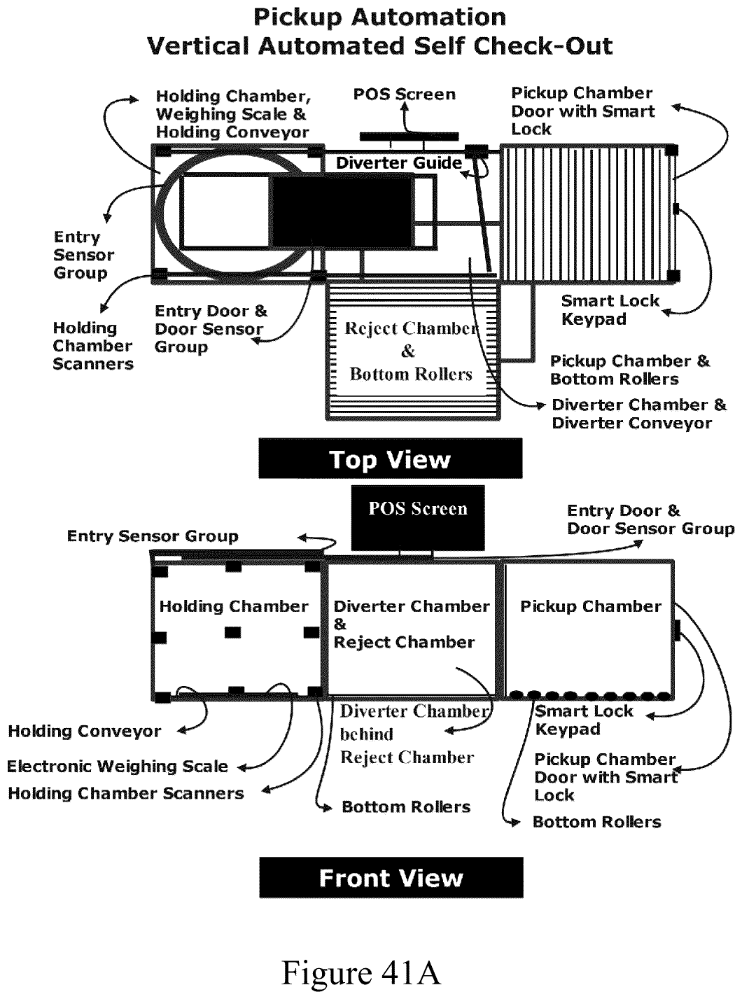

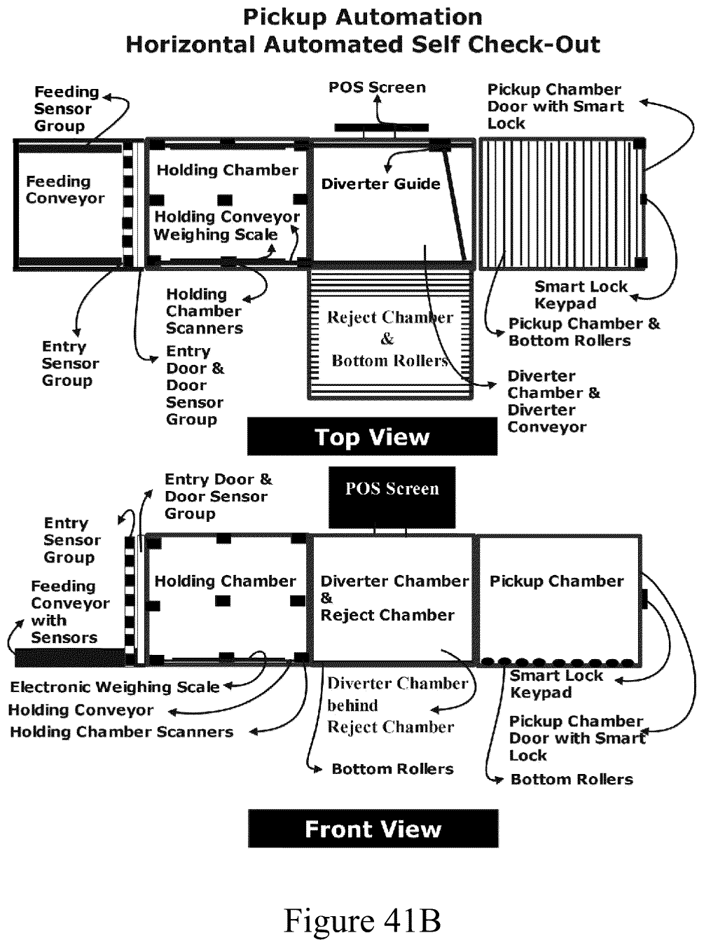

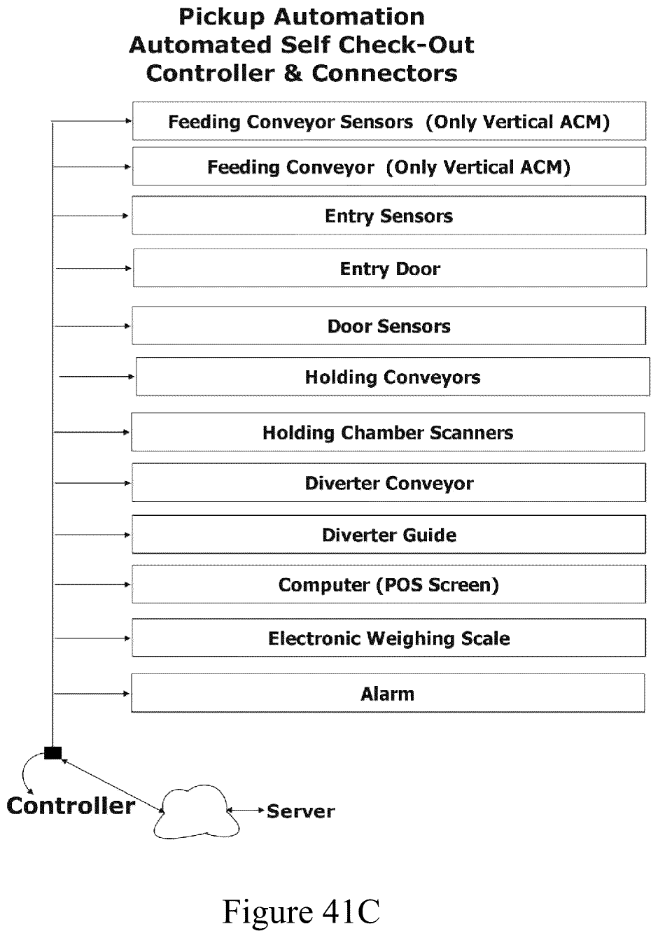

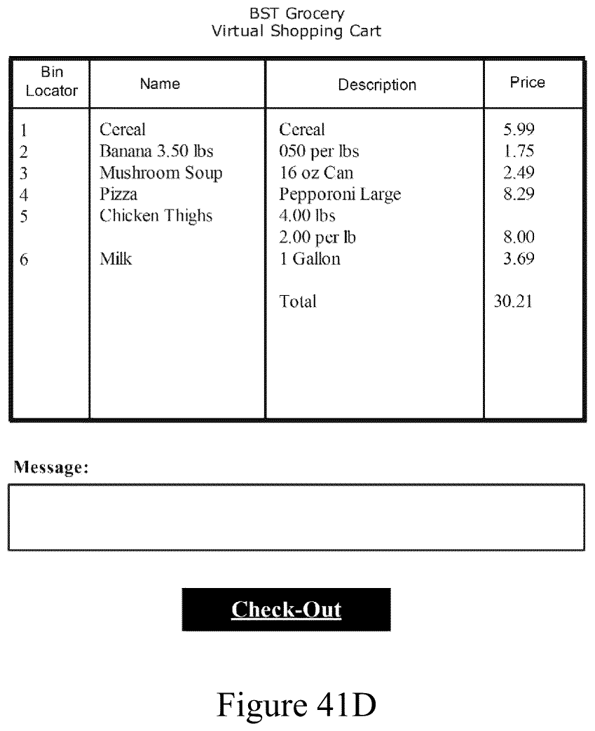

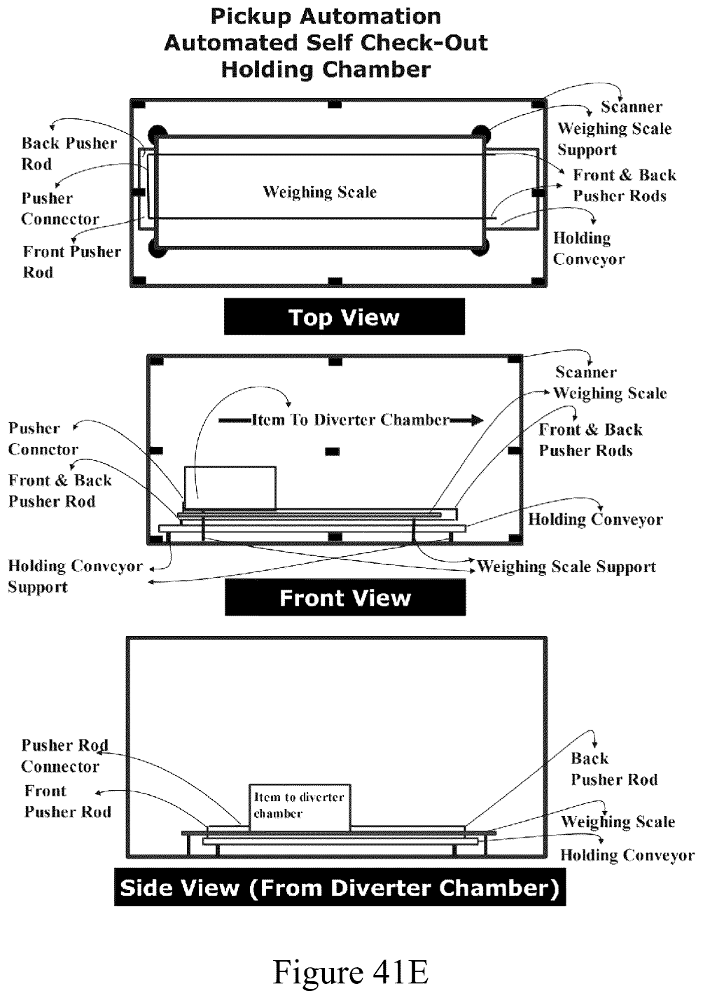

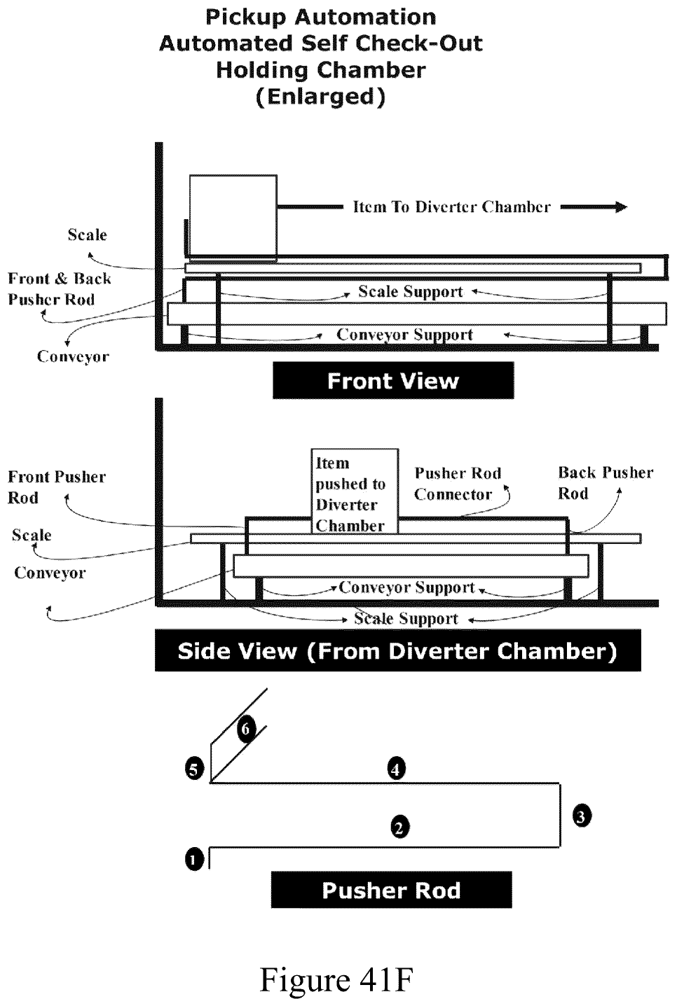

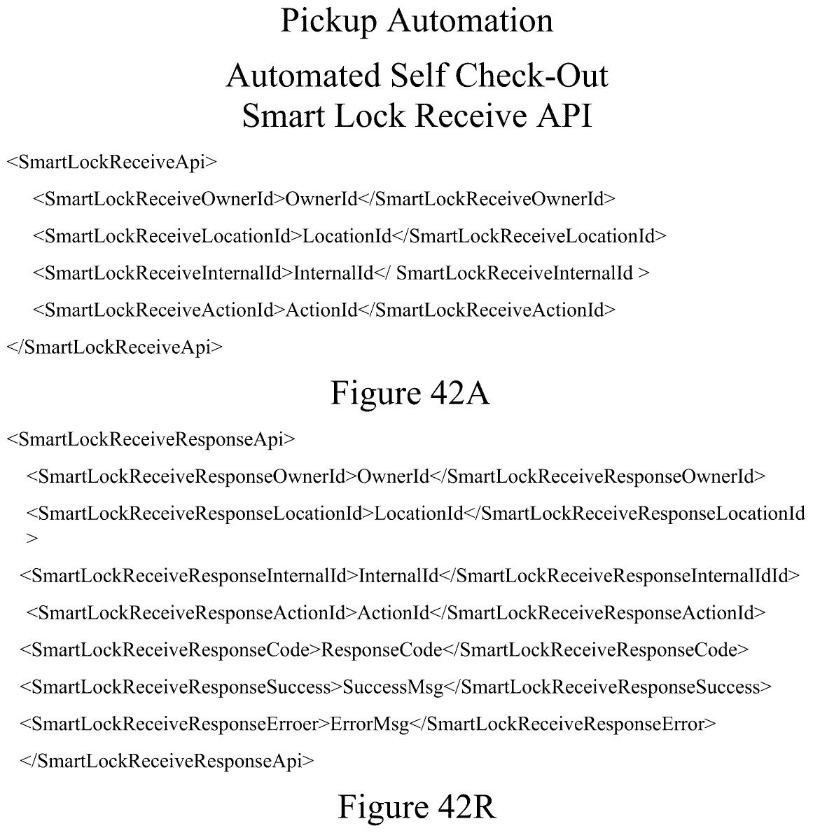

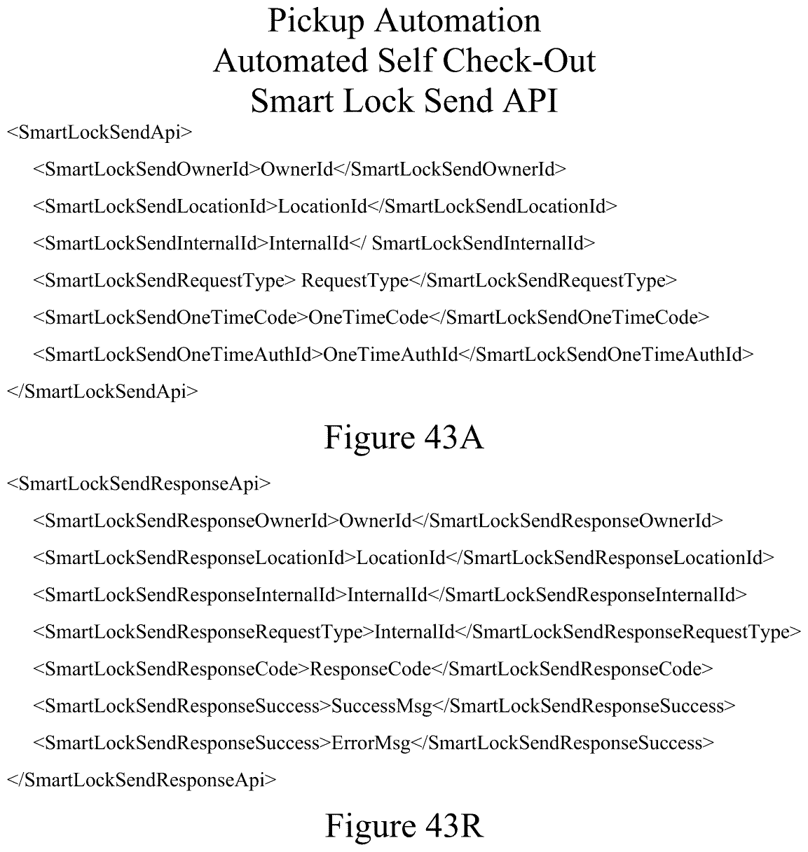

FIG. 31A shows, large screen with order status for bin pickup.

FIG. 31B shows, large screen with merchandise details loaded into bins.

FIG. 32A shows, smart sensor for order and merchandise bins.

FIG. 32B shows, smart sensor order bins & smart sensor merchandise bins.

FIG. 32C shows, smart locks for order bins & merchandise bins.

FIG. 32D shows, smart locks order bins & smart lock merchandise bins.

FIG. 32E shows, merchant order entry form.

FIG. 33A shows, order pickup signin poster for bin pickup.

FIG. 33B shows, customer order pickup inquiry form.

FIG. 33C shows, customer form to choose sign-in option.

FIG. 33D shows, customer form to sign-in for bin order pickup.

FIG. 33E shows, customer form for purchase authorization.

FIG. 33F shows, customer form to delete purchase authorization.

FIG. 34A shows, data entry page for merchant to submit an order pick up update using a web site.

FIG. 34B shows, data entry page for merchant to submit an order pick up update using an app.

FIG. 35A shows, data entry page for merchant to submit an order drop update using a web site.

FIG. 35B shows, data entry page for merchant to submit an order drop update using an app.

FIG. 36A shows, data entry page for customers to view merchandise details before making a purchase.

FIG. 36B shows, data entry page for customers to view merchandise details and one-time code after making a purchase.

FIG. 37A shows, data entry page for merchant to submit merchandise drop update using a web site.

FIG. 37B shows, data entry page for merchant to submit merchandise drop update using an app.

FIGS. 38A & 38B show, in an overview use case diagram, the various basic functionality implemented for some of the preferred embodiments of the present invention for automated self-check-out.

FIGS. 39A and 39B shows, in a class diagram, a high-level schema for a representative ACM database as may be implemented in accordance with the present invention for automated self-check-out.

FIG. 40 shows, smart sensor for automated self-check-out machine.

FIG. 41A shows, assembly diagram to assemble vertical automated self-check-out machine.

FIG. 41B shows, assembly diagram to assemble horizontal automated self-check-out machine.

FIG. 41C shows, controller and connectors to various parts in an automated self-check-out machine.

FIG. 41D shows, details of point of sale screen.

FIG. 41E shows, details of holding chamber with the pusher mechanism.

FIG. 41F shows, enlarged view of details of holding chamber with the pusher mechanism.

FIGS. 42A and 42R show, in a class diagram, a high level schema for a representative Smart Lock Receive API for the automated self-check-out machine server to receive data from smart lock management server and to send response to smart lock management server respectively.

FIGS. 43A and 43R show, in a class diagram, a high level schema for a representative Smart Lock Send API for the automated self-check-out machine server to send data to smart lock management server and to receive response from smart lock management server respectively.

### DETAILED DESCRIPTION OF THE INVENTION

Although those of ordinary skill in the art will readily recognize many alternative embodiments, especially considering the illustrations provided herein, this detailed description is exemplary of the preferred embodiments of the present invention, the scope of which is limited only by the claims appended hereto.

When data is exchanged between hosting server and external server and/or between forms hosted by hosting server and functions executing the data received from the forms, the exchanged data may be in any of a plurality of message formats such as, and not limited to, a comma or special character delimited message, an XML formatted message, a JASON formatted message, over any of a plurality of languages such as and not limited to, HTML (HTTP or HTTPS or SOAP), JavaSclipt, (C) programs, C++ programs, .NET and based on the Application Programming Interfaces (API) specification provided by the hosting service provider.

For example, the request and response can be in XML format as shown in FIGS. 9A, 9R, 10A, 10R, 11A, 11R, 12A, 12R, 23A, 23R, 24A, 24R, 25A, 25R, 26A, 26R, 42A, 42R, 43A and 43R.

### Pickup Automation

### Parking Lot Pickup Automation

The purpose of any drive-thru order pickup system is to let the shoppers (buyers or customers) buy and receive products (goods or orders) without leaving out of their vehicles. For the sake of convenience, especially for quick service restaurants and for pharmacies, most prefer drive-thru pickup instead of in-store pickup. For the most part drive-thru system is a manual process, where the buyers would place orders verbally with employees at an ordering station using an intercom, drive to a window to meet an employee, hand over payment, receive the products and drive to the exit. For employees to receive payment and for buyers to receive products, both employees and buyers must be near each other. Because the employees were performing simultaneously multi-tasks namely taking orders, preparing orders, waiting for customers to show up, accepting payments, and handing over orders, the order accuracy is always much below 100%. Because only one order can be accepted at a time at the ordering station in a drive-thru lane, the wait time, which is the time between the time the customer entering the location and the customer reaching the ordering station, will always be significant. Because only one window is installed in a drive-thru lane, the service time, which is the time between the customer reaching the ordering station and the customer picking up the order, will always be significant. According to 2022 QSR® Drive-Thru Report, the range of average service time was between 221.99 and 325.47 seconds with the range of average order accuracy was between 79.40 and 89.60 percent. So, the total time, which is the time between location entering time and order pickup time, spent by customers is much more than what was reported in the report as service time. Slower the service more loss in the revenue. Because the drive-thru lanes are built for one lane traffic, often the customers are stuck within the single lane until they reach the drive-thru lane exit. Because drive-thru lanes can only serve customers in an orderly manner one after the other, ‘First Come First Served’ methodology is used. Even customers whose orders are ready must wait behind customers whose orders are not ready waiting at the drive-thru lane ahead of them. Employees may also request the customers waiting at the drive-thru window to move over to a parking space and hand over the orders at the parking space later. This is an unproductive use of human resources and bad customer support. To get the orders in advance and to deliver them through one or more dedicated drive-thru lanes, merchants are promoting ‘Order Ahead’ concept and building additional drive-thru lanes. But unfortunately, hot food become cold, cold food become hot and cooked food become soggy, because orders were prepared ahead of time. Even with ‘Order Ahead’ option, arriving customers still must wait behind the ‘Order Ahead’ customers ahead of them in the drive-thru lane and must wait longer to pick up the orders from a single drive-thru window. Moreover, the cost of building additional drive-thru lanes may be cost prohibitive for many merchants. Also, additional land may not be available to build additional drive-thru lanes. The total wait time spent by customers is still significantly more than order preparation time.

At any event, it is worth noting that customers spend significant amount of time at drive-thru and with an order accuracy as low as 80%.

To reduce the service time to be almost zero for previously placed mobile orders MySingleLink introduced drive-thru lockers where several lockers can be installed in a single drive-thru lane. MySingleLink also introduced drone-lockers where orders will be dropped from drones into a smart locker known as drone-locker. Drone-lockers will have a top door with a smart lock so that the drone can open and drop the orders inside the drone lockers. The customers were also able to place mobile orders in advance and proceed to any one of the available lockers. This invention did not require merchants to build additional new drive-thru lanes. Drive-thru lockers also introduced the concept of multi-level location where the drive-thru lane and the order preparation area can be at different levels. Because of the introduction of multiple drive-thru lockers in a single drive-thru lane, customers could pick up mobile and online orders immediately upon arriving at merchant locations. But customers must place orders in advance and still a drive-thru lane is required to install drive-thru lockers. At any event today's drive-thru technology is several decades old and even with newer add-on technologies, it is still a slow process and drive-thru lanes occupy a large portion of the location and significant portion of investment.

If drive-thru lockers can be stretched from the order drop-off point where the orders are placed inside the drive-thru lockers to the order pickup point where the orders are picked up from the drive-thru lockers, if self-service ordering stations and/or employee managed ordering stations with a waiting area are provided and if order ready customers can by-pass order waiting customers, then the drive-thru lanes can be eliminated, unlimited number of orders can be accepted simultaneously, unlimited number of orders can be handed over simultaneously and total wait time can be reduced to order preparation time which may be less than 2 minutes (120 seconds) with 100% order accuracy.

When many self-service ordering stations are to be installed at the parking lot, then the self-service ordering stations cannot be face to face ordering stations. As an alternative or in addition to face to face ordering stations which are referred to employee managed ordering stations or manual ordering stations, touchless self-order stations can be used. Any touchless ordering station that incorporates a mechanism to accept orders and/or let customers sign-in to pick up already placed orders without face to face meeting between customers and merchants is called self-serv ordering station. Since self-serv ordering stations use posters with QR Codes printed on any medium, self-serv ordering stations are also referred to as self-order stations. Self-order stations would enable order ready customers to by-pass order waiting customers.

The employee managed ordering stations installed in a parking lot would also include a waiting area for the customers to wait until their orders are ready after placing the orders. The waiting area past the manual ordering station and before reaching the locker would enable order ready customers to by-pass order waiting customers.

When drive-thru lockers are stretched beyond a certain depth then merchants and/or buyers will not be able to reach out to the orders left inside the drive-thru lockers. For both merchants and buyers to reach out the orders left inside drive-thru lockers, an order mover will be required to move the orders from order drop-off point where the orders are placed inside the drive-thru lockers to the order pickup point where the orders are picked up from the drive-thru lockers. As an alternative, a transportable drive-thru locker with a mechanism to transport the drive-thru locker can also be used. Individual secured temporary storage boxes having order drop-off point and order pick-up point, secured with cloud based and wi-fi enabled smart lock that incorporates a bin riding on a transporter inside the secured temporary storage boxes to move a dropped off order from order drop-off point to order pickup point or individual secured temporary storage boxes having order drop-off point and order pick-up point, secured with cloud based and wi-fi enabled smart lock that can be mounted on a transporter where the transporter can move individual secured temporary storage boxes loaded with an order from order drop-off point to order pickup point is called parking lot locker or simply locker.

By using parking lot servers, self-serv stations, pickup stations and lockers, the total wait time can be reduced to be just order preparation time with 100% order accuracy and drive-thru lanes can be eliminated.

Parking lots having self-serv stations and/or manual ordering stations, pickup stations and lockers that are extended from merchant order drop-off point to customer pick up point where a transporter is used to move the orders from merchant order drop-off point to customer pick up is referred to as parking lot automation.

Parking lot automation is supported by parking lot servers. Each parking lot server can have unlimited number of business owners, each business owner can have unlimited number of locations, each location can unlimited number of parking lot lockers, unlimited number of curbside lockers and unlimited number of indoor lockers.

Lockers can be with transporter controllers or without transporter controllers.

Lockers can also be classified as enclosed locker and open locker. Enclosed lockers use an enclosure to enclose parts of lockers whereas open lockers do not use any enclosure. Lockers can use a bin or a box as a transporter to transport orders from drop-off point to pick up point. Lockers use movers to move the transporter from drop-off point to pick-up point and vice versa. Drop-off point is the place where orders are dropped-off by merchants and pickup point is the place where orders are picked up by intended recipients such as buyers, delivery service providers and the like.

The object of this invention is to provide a method for shoppers to place an order or sign-in to pick up already placed orders at self-order stations and pickup orders at self-serv pick up stations without leaving vehicles where self-serve stations and self-serv pick up stations are connected thru a drive-way which is not a drive-thru lane with a drive-thru window. Self-serv pick up stations are also referred to as pick up points or pick up stations.

The object of this invention is to provide a method for shoppers to place an order at a manual ordering station and pickup orders at self-serv pick up stations without leaving vehicles where manual ordering stations and self-serv pick up stations are connected thru a drive-way which is not a drive-thru lane with a drive-thru window. Self-serv pick up stations are also referred to as pick up points or pick up stations.

The object of this invention is to provide a method for drop-off stations with drop-off points accessible for merchants to drop-off orders at drop-off points and for shoppers to pick up orders at pick up points and use transporters to transport orders from drop-off points to pick up points. Drive-thru lanes are one-way lanes having drive-thru window or at least one drive-thru locker where drive-thru window or drive-thru lockers do not have a means to transport orders from order drop-off point to order pick-up point.

The object of this invention is to provide a method for shoppers to sign-in to pick up already placed orders or to place orders using self-order stations placed at parking spaces inside dedicated or shared parking lots. Customers can scan the QR code displayed at self-order stations to sign-in to pick up already placed orders or to place orders. Customers can also send text or talk to sign-in to pick up already placed orders.

The object of this invention is to provide a method for shoppers to pick up orders with 100% order accuracy.

The object of this invention is to provide a method for shoppers to be able to receive orders significantly faster than before.

The object of this invention is to provide a method for merchants to deliver freshly prepared orders faster than before.

The object of this invention is to provide a method for merchants to automate order hand over process and to reduce the use of human resource.

The object of this invention is to design and build automated lockers using rails, conveyors, robots and smart locks which are electronic locks that can deliver products for pickup faster with 100% order accuracy.

The object of this invention is to provide a means for shoppers to have access to lockers placed in parking lots to pick up orders.

The object of this invention is to provide a means for order ready shoppers to by order not ready shoppers.

The object of this invention is also to display phone numbers where shoppers can text or use an interactive voice response (IVR) system to sign-in to pick up already placed orders.

The object of this invention is to display order number or name and order pick up location number on electronic large screens.

The object of this invention is to provide lockers for order pickup to be portable and easy to install in parking lots.

The object of this invention is to deliver a method that is easy to use without any special training.

The object of this invention is to eliminate drive-thru lanes.

Parking Lot Pickup Automation can replace drive-thru lanes and curbside delivery/pickup for driving-in customers and reduce the number of tasks performed by employees who are responsible for handing out orders to customers. The barrier that separates indoor from outdoor is referred to as barrier.

Parking Lot Pickup Automation can be classified as parking lot we automation or parking lot we meaning that the parking lot uses network controllers and lockers with transporter controllers and parking lot nc automation or parking lot nc meaning that the parking lot does not use network controllers and uses lockers without transporter controllers.

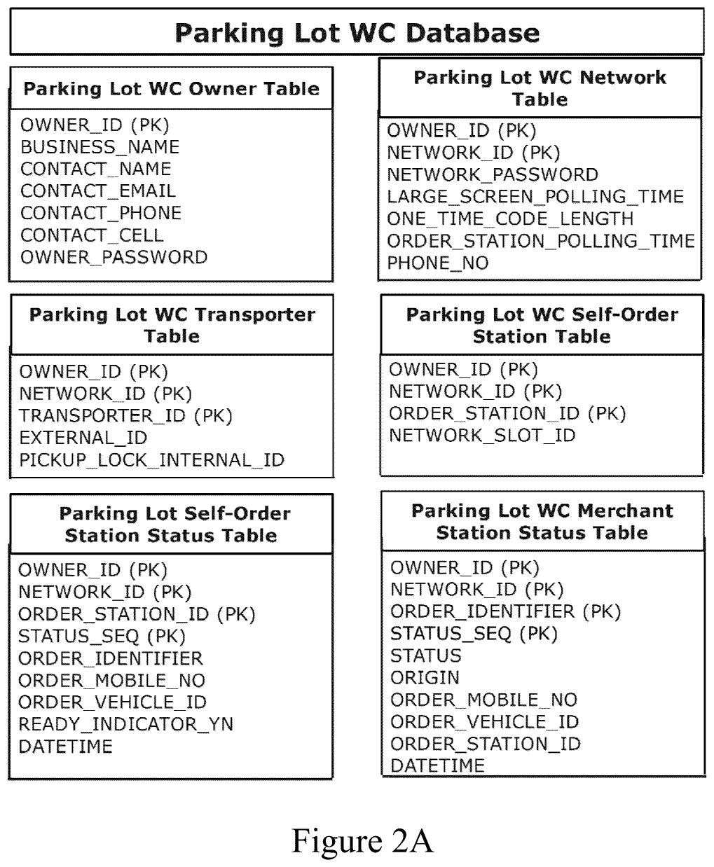

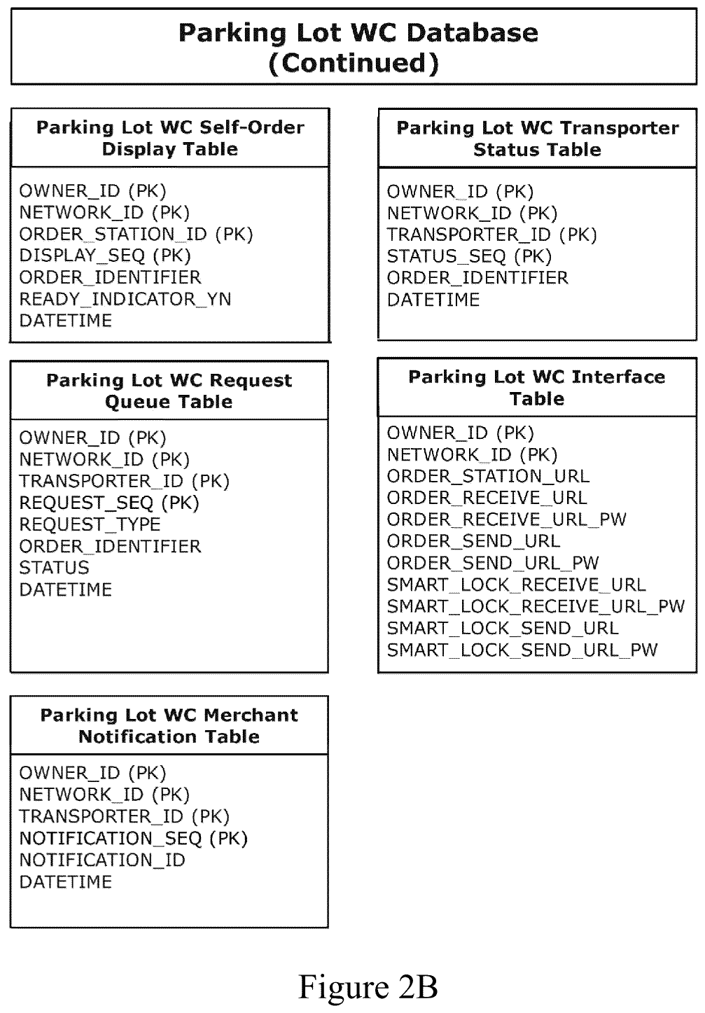

Parking lot we automation can use memory to store transient data and can use a database to store transaction data such as parking lot we database with various tables such as parking lot we owner table, parking lot we network table, parking lot we transporter table, parking lot we self-order station table, parking lot we self-order station status table, parking lot we merchant station status table, parking lot we self-order display table, parking lot we transporter status table, parking lot we request queue table, parking lot we interface table and parking lot we merchant notification table as shown in a class diagram in FIGS. 2A and 2B.

Parking lot nc automation can use memory to store transient data and can use a database to store transaction data such as parking lot nc database with various tables such as parking lot nc owner table, parking lot nc location table, parking lot nc transporter table, parking lot nc self-order station table, parking lot nc self-order station status table, parking lot nc merchant station status table, parking lot nc transporter status table, parking lot nc merchant notification table and parking lot nc interface table as shown in a class diagram in FIGS. 17A and 17B.

Any merchant to install a parking lot we automation would follow at least a minimum of 4 steps namely setting up the database in FIGS. 2A and 2B, setting up the parking lot as shown in FIG. 5, setting up the lockers as shown in FIGS. 3A through 3J and setting up transporter controllers and network controller as shown in FIGS. 4A and 4B. The parts used for installing parking lot we automation are listed in FIG. 3K. Any merchant to install a parking lot nc automation can use lockers without controllers as shown in FIG. 19A would follow at least a minimum of 3 steps namely setting up the database, setting up the parking lot, and setting up the lockers.

Setting up database, parking lot and lockers and controllers if any, can be done concurrently.

All lockers use smart locks at pickup points to protect goods left inside the lockers. Some lockers may also use smart locks at drop-off points for the sake of convenience.

Forms provided by parking lot server can be used to save data in parking lot we database or in parking lot nc database. Even though sample forms are not provided in this document, those of ordinary skill in the art providing locker services will readily be able to create forms based on the data to be saved in parking lot we database or in parking lot nc database. Those of ordinary skill in the art providing locker services will also readily be able to modify and/or create additional tables as needed in parking lot we database or parking lot nc database to suit the needs of individual merchants.

For the sake of clarity, the description for parking lot we automation and for parking lot nc automation are separated. Parking lot we automation is described first, and then parking lot nc automation is described. The number of options available with parking lot we automation is much more than the options available with parking lot nc automation. The title in each FIG. is clearly marked as “Parking Lot WC” or “Parking Lot With Controller” and “Parking Lot NC” or “Parking Lot No Controller”.

Parking lot we automation and parking lot nc automation use many functions that are common. Even though the functionality of the common functions are same, they use different versions because the structure of tables in parking lot we database and in parking lot nc database are different. Parking lot we database uses owner identifier and network identifier as part of primary key where as parking lot nc database uses owner identifier and location identifier as primary key in tables.

Before continuing, however, it is noted that while the database shown in class diagrams in FIGS. 2A and 2B is exemplary of the preferred embodiments of the present invention related to parking lot we automation, it is in no manner meant to be all encompassing or otherwise limiting of the wide range of implementations as are possible.

Before continuing, however, it is noted that while the database shown in class diagrams in FIGS. 17A and 17B is exemplary of the preferred embodiments of the present invention related to parking lot nc automation, it is in no manner meant to be all encompassing or otherwise limiting of the wide range of implementations as are possible.

### Parking Lot Pickup Automation

### With Network Controller

Parking lot we automation is a parking lot automation that uses parking lots with network controller and lockers with transporter controllers.

When parking lot we automation is used, the object of this invention is to provide scanners for scanning QR Codes displayed on shoppers' mobile phone or on any medium to sign-in to pick up already placed orders.

When parking lot we automation is used, the object of this invention is to provide alerts to shoppers through order ready indicators placed at self-order stations.

When parking lot we automation is used, the object of this invention is to display pick up station numbers to shoppers through mini displays placed at self-order stations.

When parking lot we automation is used, the object of this invention is to provide a help button to shoppers at self-order stations.

When parking lot we automation is used, the object of this invention is to provide a method for shoppers to sign-in automatically to pick up previously placed orders based on vehicle license plates.

When parking lot we automation is used, the object of this invention is to provide a method for shoppers to sign-in automatically to pick up previously placed orders using a text message.

When parking lot we automation is used, the object of this invention is to provide a method for shoppers to sign-in automatically to pick up previously placed orders using an IVR system.

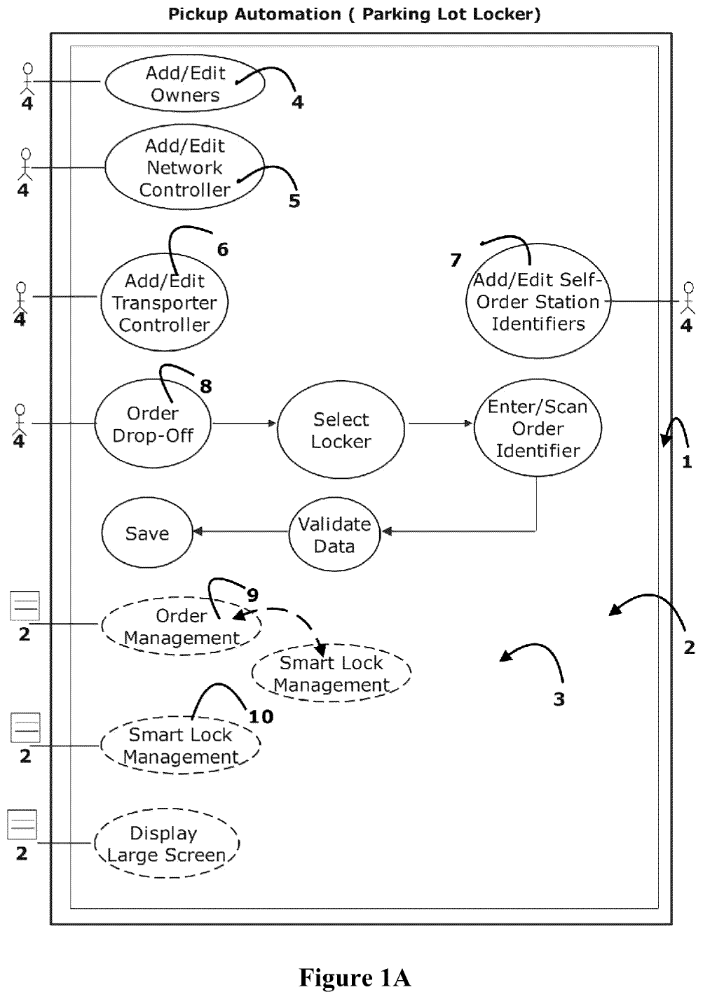

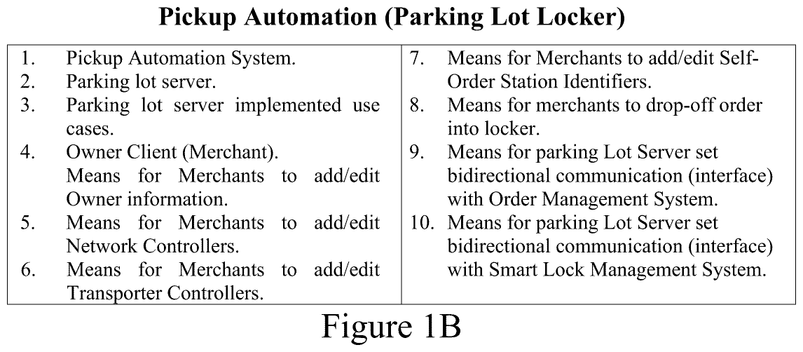

Referring now to the FIGS. , and to FIG. 1A, the parking lot we automation (1) of the present invention is shown to generally comprise a plurality of parking lot server (2) implemented use cases (3).

In particular, the parking lot server (2) provides a means (4) for the owner client (4) to add or edit owner client (4) information. Owner clients are also referred to as merchants (4).

Additionally, parking lot server (2) provides a means (5) for merchants (4) to add and edit network controllers.

Additionally, parking lot server (2) provides a means (9) for bidirectional communication with order management systems. Order management systems can in turn communicate with smart lock management systems.

Additionally, parking lot server (2) provides a means (10) for bidirectional communication with smart lock management systems, if parking lot server (2) is not able to interface with order management systems or order management systems cannot interface with smart lock management systems.

Additionally, parking lot server (2) provides a means (6) for merchants (4) to add and edit transporter controllers.

Additionally, parking lot server (2) provides a means (7) for merchants (4) to add and edit self-order station identifiers.

Additionally, parking lot server (2) provides a means (8) for merchants (4) to drop-off orders into lockers.

Enclosed lockers use an enclosure to enclose parts of lockers as shown in FIGS. 3A, 3B, 3C, 3D, 3E and 3I whereas open lockers do not use any enclosure as shown in FIGS. 3F, 3G, 3H and 3J. Lockers can use a bin or a box as a transporter to transport orders from drop-off point where orders are dropped-off by merchants to pick up point where orders are picked up by customers such as buyers, delivery persons and the like. Lockers use movers to move the transporter from drop-off point to pick-up point and vice versa. Enclosed lockers can use movers such as conveyor, linear actuator, robot and the like. Open lockers can use movers such as robot, crane and the like. Parking lot we automation can use both enclosed lockers and open lockers. Parking lot we automation can use enclosed lockers with various types of installations or open lockers whereas parking lot nc automation can use enclosed lockers only with above ground installation as shown in FIG. 18A and can use open lockers only with robots as shown in FIG. 18B.

All installation types in enclosed locker and in open locker work the same way except for minor variations. Some installation types may require digging one or more tunnels below the ground outside and/or inside the building barrier. Installation types that require digging tunnel inside the building barrier may not be suitable for existing merchant locations. For example, the installation type ‘Partially Below Ground’ with an option ‘Below Ground’ for ‘Enclosed Locker’ as shown in FIG. 3A would require digging tunnel below ground level inside the building barrier. To install ‘Open Locker’ with an option to use open space below the ground level would require digging tunnel below ground level inside the building barrier. Installations with digging of ground inside barrier may be possible only for new locations.

Parking lot server (2), merchants (4), network controller (5), transporter controller (6) self-order station identifiers (7), order drop-off (8), order management (9) and smart lock management (10) as shown in FIG. 1A are also referred as parking lot server, merchants, network controller, transporter controller, self-order station identifier, order drop-off, order management and smart lock management respectively.

A location can have unlimited number of lockers. Each locker will have a unique internal identifier and a unique external identifier. Internal identifiers are unique transporter controller identifiers assigned by transporter controller manufacturers. External identifiers are unique identifiers assigned by merchants. The external identifiers are also referred to as locker numbers and will be displayed on each locker and will be clearly visible to customers.

Each parking lot can have one or more self-order stations for customers to place an order and sign-in or to sign-in to pick up an already placed order as shown in FIG. 5. Each self-order station will have a set of hardware consisting of a ready indicator, mini screen, help line, scanner/reader and plate reader that will be connected to similar set of hardware in a slot controller that will be connected to a network controller. Eash self-order station will also have phone numbers for customers to signin to pick up already placed order using a text message or using an IVR system. Eash self-order station will also have menu holders, holding ‘Scan & Add’ menus. A part or full ‘Scan & Add’ will also be displayed at the self-order station. Customer can use ‘Scan & Add’ menu picked up from the menu holder or can use ‘Scan & Add’ menu displayed at the self-order station. Customers can scan start an order QR Code to start an ordering process, scan item QR Codes to add items and scan check-out QR Code to complete the ordering process and get an order identifier and a one-time code or just a one-time code where last few digits of order identifier would be a one-time code.

Merchants can use unlimited number of computers loaded with virtual terminal software to display order status on unlimited number of large screens and a user screen, visible only to merchants. Using the user screen merchants can access merchant forms, view merchant notifications, setup filters to control the content displayed on the large screens and to manage refresh rate. When the virtual terminal is started the refresh rate will be the LARGE_SCREEN_POLLING_TIME saved in parking lot we network table. Upon starting the virtual terminal refresh rate can be changed for the current session as needed.

Customers can use any desktop or mobile browser to view order status just by accessing a web page known to the merchant and provided to customers as shown in FIG. 7B, entering an order identifier and selecting a merchant, if necessary. When the order is ready even before the customers visit the merchant location, the merchant can place the orders inside a locker so that the locker number will be visible in the order status screens. For example, a person picking up delivery orders or a buyer picking up a purchased order can view the order status before even coming to the merchant location and can directly go to the locker to pick up the order.

Following is a step-by-step procedure to setup the database for parking lot we automation:
1. Merchant would register as owner with the parking lot server using a merchant form provided by parking lot server. Merchant will provide business name, contact name, contact email, contact phone, and contact cell information and parking lot service provider would provide a unique owner identifier and a password. Parking lot server will save the information in parking lot we owner table. Merchant would use owner identifier and owner password to access any merchant form provided by parking lot server.
2. Merchants can add network identifiers through a merchant form provided by parking lot server. The network identifier is embedded in the network controller and provided by the parking lot service provider to the merchant. Each network identifier is linked to a single merchant who is the owner identifier of the network. An owner identifier can have multiple network identifiers, but a network identifier can have only one owner identifier.
Merchants can also set up a network password for the network identifier which could be used by the network controller to connect with the parking lot server. In addition to setting up a network password, the merchant can also set up a large screen polling time, one time code length and self-order station polling time. The large screen polling time is the interval set for the parking lot server to display up to date order status on large screen as shown in FIG. 7A. The one-time code length is the number of characters at the end in the order identifier used as one time code to access the locker pickup door. When displaying the order number in the large screen, the parking lot server would hide one time code. If the one-time code length is 0, then the entire order-identifier will be displayed on the large screen. The self-order station polling time is the interval set for the network controller to communicate with the parking lot server to get information needed to manage the ready indicator marked as ‘J’ in FIG. 3K and the data displayed on the mini screen marked as ‘K’ in FIG. 3K as shown in FIG. 6. The parking lot server would save network password, large screen polling time, one time code length and self-order station polling time in parking lot we network table. Each network controller will have its own internal database known as network database. When the user activates the network reset switch as shown in FIG. 4A and marked as 31, the network controller would download the network password, one time code length and self-order station polling time and save it in the network database.
3. Merchants can add transporter controller identifiers through a merchant form provided by parking lot server. The transporter controller identifier cannot be added before adding network controller identifier. The transporter controller identifier is embedded in the transporter controller and provided by the parking lot service provider to the merchant. Network controller identifier is also referred to as network identifier. Transporter controller identifier is also referred to as transporter identifier. A network identifier can have multiple transporter identifiers, but a transporter identifier can have only one network identifier. Each transporter identifier will be linked to a locker where the locker could be an enclosed locker or open locker. For each transporter identifier the merchant would also provide an external identifier which will be referred to as locker number and displayed for customers to view. The external identifier will be displayed at the order pickup point, and also will be displayed on large order status screen as shown in FIG. 7A and on mini screens provided at self-order station as shown in FIG. 6 to broadcast that a particular order bas been dropped off into a particular locker. Customers would use the locker number to locate the locker to pick up the orders. Each transporter controller would control the movement of a transporter and a smart lock would control the access to the transporter. The parking lot server would save network controller identifier, transporter controller identifier, external identifier and smart lock internal identifier in NETWORK_ID, TRANSPORT_ID, EXTERNAL_ID and PICKUP_LOCK_INTERNAL_ID respectively in parking lot we transporter table. Merchants can add an unlimited number of transporter controller identifiers in a location.
4. Merchants can add self-order station identifierss through a merchant form provided by parking lot server. Self-order station identifiers cannot be added before adding network controller identifier. Self-order station identifiers are assigned by the merchants. Self-order station identifiers is same as parking space identifier where the customers can park to place an order or to sign-in to pick up an already placed order. Merchants can add an unlimited number of self-order station identifierss in each location. The hardware used in self-order station namely, ready indicator, mini screen, help line, scanner/reader and plate reader will be connected to corresponding plugs in a self-order station slot controller which will be connected to a network controller as shown in FIGS. 4A, 4B and 6. A self-order station slot controller connected to a network controller will be dedicated to a single self-order station identifiers. The number of self-order station identifiers cannot exceed the number of self-order station slot controllers connected to the network controller. Each self-order station slot controller connected to the network controller will be assigned with a unique network self-order station slot number as shown in FIGS. 4A and 4B and will be clearly marked in the network controller. The parking lot server would save the information in parking lot we self-order station table. Merchants would save network identifier as NETWORK_ID, self-order station identifiers as ORDER_STATION_ID and network self-order station slot controller number as NETWORK_SLOT_ID in parking lot we self-order station table.
5. Merchants can use a form provided by parking lot server to download a unique QR Code which is also referred to as self-order station QR code for each self-order station. Self-Order station QR codes can be printed on any medium such as paper, plastic, metal and the like. A sample self-order station is shown in FIG. 3K and marked as ‘I’ and in FIG. 6. A sample self-order station QR Code is shown in FIG. 3K and marked as ‘P’ and in FIG.
6. The content of the self-order station QR code will be an url as a link of a page hosted by parking lot server and required parameters. An example of the content of a self-order station QR code may be https://www.parkinglotautomation.com?QAT_Code=202-920393-18 where https://www.parkinglotautomation.com_is the parking lot server location and 202-920393-18 is the value of the parameter QAT_Code. The QAT_Code is a ‘-’ delimited string with 3 nodes and the value in the first node of QAT_Code is an application identifier which is ‘202’ in the example, the value in the second node of QAT_Code is network controller identifier which is ‘920393’ in the example and the value in the third node of QAT_Code is self-order station identifiers which is ‘18’ in the example.
The link in the self-order station QR Code will open a page which will be referred to as server self-order station page and will be hosted or powered by parking lot server. At least one parameter included in url will be unique for each self-order station. Server self-order station page would use the value in the second node in the parameter QAT_Code as network identifier which can be used to get owner identifier from parking lot we network table and to get owner information from parking lot we owner table. Server self-order station page would also use the value in the third node in the parameter QAT_Code as self-order station identifiers which can be used to verify self-order station using parking lot we self-order station table. Based on the setup in parking lot we interface table, the server self-order station page can display a customer form as shown in FIG. 14A or 14B or 14C which are referred to as form 14A, 14B and 14C respectively. Customers can use the form 14A as shown to place an order with automatic sign-in to pick up the placed order or can use the form 14B to place an order without automatic sign-in to pick up the placed order or can use the form 14C to sign-in to pick up an already placed order.
The self-order station can also have a phone number for text messaging and for interactive voice response system (IVR) as shown in FIG. 3K and marked as ‘I’ and in FIG. 6. Customers who do not have an internet connection can send the order identifier and self-order station identifiers thru a text message or verbally hand over through an IVR (Interactive Voice Response) system to sign-in to pick up an order already placed.
6. Parking lot server has a built-in module to send data to order management server and/or to receive data from order management server. To activate/inactivate the module, merchants must add/update order send url, order send url password, order receive url and order receive url password in parking lot we interface table. Order send url, order send url password, order receive url and order receive url password will be saved as ORDER_SEND_URL, ORDER_SEND_URL_PW, ORDER_RECEIVE_URL and ORDER_RECEIVE_URL_PW respectively in parking lot we interface table. Merchants can receive order send_url and order send_password from order management server for parking lot server to send data to order management server. Merchants can also provide an order receive_url and order receive_password to order management server for parking lot server to receive order data from order management server. The order receive url will be provided by the parking lot service provider and the order receive_url password will be set by the parking lot service provider or by the merchant. The order receive url is a page hosted by parking lot server to receive data from order management server. The order send_url, order send_password, order receive_url and order receive_password will be saved in parking lot we interface table. Merchants would also provide NETWORK_ID saved in parking lot we network table to order management service provider which will be used by order management server to send data to parking lot server and to receive data from parking lot server. If the value for order send_url and order send_password are not blank, then the module to send data to order management server will be activated. If the value for order send_url or order send_password is blank, then the module to send data to order management server will be inactivated. If the value for order receive_url and order receive_password are not blank, then the module to receive data from order management server will be activated. If the value for order receive_url or order receive_password is blank, then the module to receive data from order management server will be inactivated.
7. Parking lot server has a built-in module to send data to smart lock management server and/or to receive data from smart lock management server. To activate/inactivate the module, merchants must add/update smart lock send url, smart lock send url password, smart lock receive url and locker receive password in parking lot we interface table. Smart lock send url, smart lock send url password, smart lock receive url and smart lock receive url password will be saved as SMART_LOCK_SEND_URL, SMART_LOCK_SEND_URL_PW, SMART_LOCK_RECEIVE_URL and SMART_LOCK_RECEIVE_URL_PW respectively in parking lot we interface table. Merchants can receive a locker send_url and locker send_password from smart lock management service provider for parking lot server to send data to smart lock management server. Merchants can also provide a locker receive_url and locker receive_password to smart lock management server for parking lot server to receive data from smart lock management server. The smart lock receive url will be provided by the parking lot service provider and the locker receive_password will be set by the parking lot service provider or by the merchant. The smart lock receive url is a page hosted by parking lot server to receive data from smart lock management server. The locker send_url, locker send_password, locker receive_url and locker receive_password will be saved in parking lot we interface table. Merchants would also provide NETWORK_ID saved in parking lot we network table to smart lock management service provider which will be used by smart lock management server to send data to parking lot server and to receive data from parking lot server. If the value for locker send_url and locker send_password are not blank, then the module to send data to smart lock management server will be activated. If the value for locker send_url or locker send_password is blank, then the module to send data to smart lock management server will be inactivated. If the value for locker receive_url and locker receive_password are not blank, then the module to receive data from smart lock management server will be activated. If the value for locker receive_url or locker receive_password is blank, then the module to receive data from smart lock management server will be inactivated.
8. The request and response can be in any format, but only XML format is shown, as an example, in FIGS. 9A, 9R, 10A, 10R, 11A, 11R, 12A and 12R.
For example, order management server would send the data as shown in FIG. 9A to order receive url using order receive url password to send order identifier to parking lot server and receive a response as shown in FIG. 9R.
For example, parking lot server would send the data as shown in FIG. 10A to order send url using order send url password to send pickup ready to order management server and receive a response as shown in FIG. 10R.
For example, smart lock management server would send the data as shown in FIG. 11A to smart lock receive url using smart lock receive url password to send smart lock identifier and smart lock status to parking lot server and receive a response as shown in FIG. 11R.
For example, parking lot server would send the data as shown in FIG. 12A to smart lock send url using smart lock send url password to send pickup ready to smart lock management server and receive a response as shown in FIG. 12R.
9. If the values for ORDER_STATION_URL, ORDER RECEIVE_URL and ORDER_RECEIVE_URL_PW in parking lot we interface table are not blank, then the customers can place an order with order management service provider at the self-order station and the parking lot server would automatically receive order identifier from order management server where the process is known as order with auto sign-in. For the customers to place an order with auto sign-in, the server self-order station page would display a customer form as shown in FIG. 14A. When the customer selects “Place an Order with Auto Sign-in to Pickup” and clicks or tabs on “Proceed” button in the server self-order station page as shown in FIG. 14A, the customer would be directed to ORDER_STATION_URL which will be an order entry page hosted by order management server. When the order entry is complete, the parking lot server would automatically receive order identifier, order mobile number and self-order station identifiers from order management server and will insert a row in parking lot we self-order station status table.
10. If the values for ORDER_STATION_URL is not blank, but the value of ORDER RECEIVE_URL or ORDER_RECEIVE_URL_PW is blank in parking lot we interface table, then the customers can place an order with order management service provider but the parking lot server would not automatically receive order identifier from order management server where the process is known as order without auto sign-in. For the customers to place an order without auto sign-in, server self-order station page would display a customer form as shown in FIG. 14B. When the customer selects “Place an Order” and clicks or tabs on “Proceed” button in the server self-order station page as shown in FIG. 14B, the customer would be directed to ORDER_STATION_URL which will be an order entry page hosted by order management server. When the order entry is complete, the parking lot server would not automatically receive order identifier from order management server. The customer would then select “Sign-in for Order Pickup (Place Order Before Sign-in)” and tap on “Proceed” button in the server self-order station page as shown in FIG. 14B for server self-order station page to display a customer form as shown in FIG. 14C.
11. If the values for ORDER_STATION_URL is blank in parking lot we interface table, then the customers can sign-in to pick up an already placed order. For the customers to sign-in to pick up an already placed order server self-order station page would display a customer form as shown in FIG. 14C. When the customer enters an order identifier and clicks or tabs on “Save” button in the server self-order station page as shown in FIG. 14C the parking lot server insert a row in parking lot wc self-order station status table.
12. In addition to placing an order using server self-order station page, customers can also use scan and add menu to place an order using an app provided by the order management service provider or using a mobile browser. Customers can pick up a scan and add menu from menu holder or use scan and add menu displayed at the self-order station. Customers can scan ‘Start an Order’ QR Code to start the ordering process, then scan ‘Add Item’ QR Code to add individual items and then scan ‘Check-out’ QR Code to complete the ordering process. If an app is used, when ‘Start an Order’ QR Code is scanned, the app would create and save a new unique identifier as a shopping cart. If an app is used, when ‘Add Item’ QR Code is scanned, the app would save the scanned item in the shopping cart, if the shopping cart still exists in the app. If an app is used, when ‘Check-out’ QR Code is scanned, the app would accept the payment and save the order using a new order identifier, if the shopping cart still exists in the app. The shopping cart would be deleted in the app when the order is saved or when the order is not saved within a specified time.
If a mobile browser is used, when ‘Start an Order’ QR Code is scanned, the mobile browser would create and save a unique identifier as a shopping cart cookie and also as a shopping cart in a database. If a mobile browser is used, when ‘Add Item’ QR Code is scanned, the mobile browser would save the scanned item in the shopping cart in the database, if a shopping cart still exists as a cookie. If a mobile browser is used, when ‘Check-out’ QR Code is scanned and if the shopping cart still exists as a cookie, the mobile browser would accept the payment and save the order using a new order identifier in the database. The shopping cart would be deleted as a cookie and in the database when the order is saved or when the order is not saved within a specified time.
The customer would get the order identifier when an order is placed using scan and add menu displayed at the self-order station and the order will be considered as a location order, if the order management server captures the current self-order station identifiers from the customer, otherwise the order will be considered as an online order. If the order management server is interfaced with parking lot server to send order identifier information, then the order management server would send the order identifier to the parking lot server using the format as shown in 9A.
Then the order management server would use an order receive url, order receive url password and network identifier provided to the order management service provider by the merchant or by the parking lot service provider in advance and use a secure communication channel such as https post method. The order receive url is also referred to as server order receive page.
The order management server would use network identifier for OrderReceiveNetworkId, ‘Q’ for OrderReceiveOriginID and self-order station identifier for OrderReceiveStationId if self-order station identifier is known to the order management server or ‘O’ for OrderReceiveOriginId and blank for OrderReceiveStationId if current self-order station identifiers is not known to the order management server or current self-order station identifiers for OrderReceiveStationId if current self-order station identifiers is known to the order management server, order identifier for OrderReceiveOrderId, blank for OrderReceiveMobileNo if buyer mobile number is not known to the order management server or buyer mobile number for OrderReceiveMobileNo if buyer mobile number is known to the order management server and blank for OrderReceiveVehicleId if buyer vehicle license plate is not known to the order management server or buyer vehicle license plate for OrderReceiveVehicleId if buyer vehicle license plate is known to the order management server. When the server order receive page receives the order identifier data, the server order receive page will verify the values and insert a row into parking lot we self-order station status table, if OrderReceiveStationId is not blank or insert a row into parking lot we merchant station status table if OrderReceiveStationId is blank. If the row is inserted into parking lot we merchant station status table, then the customer would sign-in to pick up the order identifier and the data will be moved from parking lot we merchant station status table to parking lot we self-order station status table. The ready indicator and mini screen at the self-order station and order status in large screens will be updated when they are refreshed.
13. In addition to placing orders at the location, customers can also place orders online through order management service provider or through one or more third-party delivery service providers. Persons entering the location to pick up already placed orders may be not only buyers, but also can be employees or contractors of third-party order handlers. Customers can request freshly prepared orders or pre-prepared orders. In the case of freshly prepared orders, the merchant will start preparing the orders only when the customers sign-in at the self-order station. In the case of pre-prepared orders, the merchant will prepare the orders in advance based on the requested pick up time and leave them inside lockers. In the case of freshly prepared orders, customers must sign-in at a self-order station to pick up an already placed order. In the case of pre-prepared orders, customers can go directly to the locker displayed on the order status display screen without signing in at self-order station. If the locker number for a pre-prepared order is not displayed on the order status display screen, then the customer would sign-in to pick up the previously placed order at the self-order station. Customers can also view the order status by accessing a web page that can display the order status of all merchant locations supported by the parking lot server as shown in FIG. 7B. Customers simply access the web page and enter the order identifier to view the status. If there is more than one order with the same order identifier, then the customer would be requested to select a merchant. Then customers can view the status of the requested order identifier. This would help the customers to know the order status in advance for pre-prepared order instead of visiting the merchant location without knowing the order status. Customers can also leave a mobile number to receive a text or voice notification, if the pre-prepared order number is not already in a locker.
14. Persons (customers) picking up already placed orders, would select “Sign-in to Pickup Already Placed Order” as shown in FIG. 14A or “Sign-in for Order Pickup (Place Order Before Sign-in)” as shown in FIG. 14B or would use the form as shown in 14C.
15. When the customer selects “Sign-in to Pickup Already Placed Order” and clicks or tabs on “Proceed” button in server self-order station page as shown in FIG. 14A or when the customer selects “Sign-in for Order Pickup (Place Order Before Sign-in)” and clicks or tabs on “Proceed” button in server self-order station page as shown in FIG. 14B, the customer will be presented with a page with customer entry form for customers to sign-in with an order identifier to pick up an already placed order as shown in FIG. 14C. Depending on the merchant setup, the customers may not be presented with forms shown in FIG. 14A or in FIG. 14B but be presented with the from 14C. When the customer enters an order number and clicks or tabs on “Save” button in the form as shown in FIG. 14C, the parking lot server would receive the order identifier and self-order station identifiers, verify the order input and insert a row in parking lot we self-order station status table. If the order also exists in parking lot we merchant station status table, then a row also will be inserted in parking lot we merchant station status table to indicate that the order is moved to parking lot we merchant station status table.
16. In addition to placing an order and sign-in or signing in to pick up an already placed order at self-order stations, customers can also place orders at manual order stations. If ORDER RECEIVE_URL and ORDER_RECEIVE_URL_PW are not blank, then the order identifier data will be automatically added into parking lot we database, otherwise merchants would use merchant order entry form as shown in FIG. 13B, enter order identifier, use the option “Manual Ordering Station Order” and tap on “Save” button. Merchants can also use merchant order inquiry form as shown in FIG. 13A to inquire whether an order already exists in parking lot server.
17. Merchants can start one or more self-updating virtual terminals provided by parking lot server using a computer. The virtual terminal would display the order status information on all the large screens connected to the desktop computer. The virtual terminal would also provide a user screen visible only to merchants to access merchant forms and view merchant notifications. Virtual terminals use a pre-determined url, which is a page hosted by parking lot server and referred to as server virtual terminal page, to retrieve order status information, manage merchant forms and merchant notification from parking lot server. The server virtual terminal page will be programmed to receive requests and generate a response. The request would include the owner identifier and network identifier. The response would be order status to be displayed on large screens, merchant notification displayed on a screen only visible to merchant and merchant forms. Each virtual terminal can have its own user-maintained filters. For example, the large screen placed at the waiting area of manual order station can display only orders placed at manual order station. For example, the large screens placed at drive aisles can display only orders placed at self-order stations within the drive aisle. It is recommended to use a desktop computer instead of a mobile device. The virtual terminal would refresh itself automatically any time any information related to order status has changed in the parking lot server. For example, when an order is placed using a self-order station, the order management system would automatically upload order identifier and the self-order station identifier to the parking lot server, if order management system is interfaced with parking lot server or when an order number and a self-order station identifiers is manually entered the parking lot server would receive order identifier and the self-order station identifiers. When this occurs, the parking lot server would insert a row into parking lot we self-order station status table. For example, when an order is placed at manual order station, the order management system would automatically upload order identifier to the parking lot server if the order management server is interfaced with parking lot server or when an order number is manually entered the parking lot server would receive order identifier. When this occurs, the parking lot server would insert a row into the parking lot we merchant station status table. For example, when an order is moved from drop-off point to pick up point, the network controller would automatically send order identifier to the parking lot server. When this occurs, the parking lot server would insert a row into parking lot we merchant station status table or parking lot we self-order station status table and a row in parking lot we transporter status table. So, any time a change occurs in the data stored in parking lot we merchant station status table or in parking lot we self-order station status table or in parking lot we transporter status table, the information displayed on the large screens will not be valid. Any time a change occurs in parking lot we merchant notification table, the notification displayed on the user screen will not be valid. So, the virtual terminal would use scripts to monitor the changes in parking lot we merchant station status table, in parking lot we self-order station status table and in parking lot we transporter status table. If the virtual terminal finds any new data since the last large screen display, then the virtual terminal would retrieve the data from parking lot we merchant station status table, parking lot we self-order station status table, parking lot we transporter status table and parking lot we merchant notification table using https get method or any other method or methods to retrieve up to date information regarding any order status and refresh the digital large screen/s. In addition to refreshing the content in the large screens automatically whenever the content in the locker database changes, the virtual terminal would also refresh the content in the large screens periodically based on LARGE_SCREEN_POLLING_TIME saved in parking lot we network table or based on the refresh rate set by the merchant. An example of large screen is shown in FIG. 7A.
To include the merchant notification in the response, server virtual terminal page will also be programmed to retrieve notification information from parking lot we merchant notification table. Then the server virtual terminal page would retrieve all rows from parking lot we merchant notification table using owner identifier for OWNER_ID, network identifier for NETWORK_ID, TRANSPORTER_ID is not blank, the maximum value of NOTIFICATION_SEQ for the same OWNER_ID, for the same NETWORK_ID and for the same TRANSPORTER_ID for NOTIFICATION_SEQ and ‘P’ for NOTIFICATION_ID. Value ‘P’ for NOTIFICATION_ID is to indicate that an order from a specific transporter has been picked up. If the server virtual terminal page retrieves one or more rows then the server virtual terminal page would save the values of TRANSPORTER_ID from each retrieved row in an array in column transporter identifier.
Then the server virtual terminal page would access the value of transporter identifier from each row in the array and save as current transporter identifier. Then server virtual terminal page would get the external value of current transporter identifier by retrieving one row from parking lot we transporter table using owner identifier for OWNER_ID, network identifier for NETWORK_ID and current transporter identifier for TRANSPORTER_ID and saving the value of EXTERNAL_ID in the retrieved row as current external identifier. Then the server virtual terminal page would form current notification message by concatenating current external identifier with a text where the text could be ‘needs to be moved from pick-up point.’ Then the server virtual terminal page would add current notification message to the response to be returned by server virtual terminal page.
Then server virtual terminal page would process the next row in the array until all the rows in the array are processed.
18. In addition to hosting server virtual terminal page, parking lot server also host a server universal page as shown in FIG. 7B. Server virtual terminal page can be accessed by merchants while server universal page can be accessed by customers. Server virtual terminal page can display order status of all order identifiers specific only to a single merchant, server universal page can display order status specific only for a single order identifier of all merchants from the entire parking lot server. Customers can access the server universal page using only the order identifier that is known to the customers. For example, when buyers place online orders an order identifier will be provided to the buyer and when the delivery person receives the request to pick up an order from a merchant location, an order identifier will be provided to the delivery person. This would enable customers (buyers and delivery persons) to view the status of a single order identifier even before visiting the merchant location.
Customers can access a server universal page hosted by parking lot server for example https://www.parkinglotautomation.com/universalorderinquiry.cfm to access server universal order inquiry form as shown in FIG. 7B to view the status of any order in the entire parking lot server. When the customer enters an order identifier and clicks or taps on ‘Show’ button, the form would display the status of the order. If there are more than one order with the same order identifier, then the customer would also be asked to select a merchant from a drop-down list. If the order is found and displayed on the page and if the order has not been placed in a locker then the customer can enter a mobile number or any communication method and click or tap ‘Notify’ button and the parking lot server would save the mobile number and send a notification when the order is placed in the locker. If the order is found and displayed on the page, the displayed information would include the date and time of the order received by the merchant, the date and time of the order placed in the locker and the date and time of the order picked up from the locker. This would ensure the freshness of the order delivered to a customer who placed the order.
19. When the network controller is powered, the network self-order station display routine residing inside programmable firmware that is embedded in the network controller would manage the display of ready indicator and mini screen in self-order stations. A black color on the ready indicator would accompany a blank space displayed on the mini screen and would indicate that the self-order station is available for customers to use. A red color on the ready indicator would accompany an order identifier displayed on the mini screen and would indicate that a customer has already placed an order or signed-in to pick up an already placed order and waiting to receive locker number. A green color on the ready indicator would accompany a locker number displayed on the mini screen and would indicate that the order is ready for pick up from the displayed locker number. The network self-order station display routine would use a pre-determined url to send request and receive a response that would direct the network self-order station display routine to send the required color and the required data to ready indicator and to mini screen respectively through a specific slot controller attached to the network controller. The pre-determined url, referred to as server slot display page would be a page hosted by the parking lot server to receive the request and generate the response. The network self-order station display routine would fetch the network controller identifier, network password and self-order station polling time from the network database. The network self-order station display routine would send the request through the server slot display page at intervals based on self-order station polling time and receive a response. The response would be a number and 3 delimited texts which may be referred to as update count, slot number string, ready indicator string and mini screen string. The delimiter used in the delimited texts could be any character or string that may not be generally used in slot number string, ready indicator string and mini screen string, for example ‘-’ could be a delimiter. The delimiter would be pre-determined and known to the network self-order station display routine, so that the network self-order station display routine can parse the response. The pre-determined delimiter would also be known to the server slot display page, so that the server slot display page can format the response.
The number of delimited segments in slot number string, ready indicator string and mini screen string would be same as the update count. The network self-order station display routine would retrieve one segment of data at a time from slot number string, ready indicator string and mini screen string in the same order and save them as ready indicator data, mini screen data and slot number data respectively. Then the network self-order station display routine would send the saved ready indicator data and mini screen data to the self-order station thru the saved slot number data. As an example, the network self-order station display routine may receive 3 as update count, 20-8-15 as slot number string, Green-Black-Red as ready indicator string and 4- -34892 as mini screen string. In the above example, the network self-order station display routine would use slot number 20 to display green color in ready indicator and display 4 in mini screen. Then network self-order station display routine would use slot number 8 to display black color in ready indicator and display a blank space in mini screen. Then network self-order station display routine would use slot number 15 to display red color in ready indicator and display 34892 in mini screen.
The network self-order station display routine would use server slot display page that will have the routines to accept the request from self-order station display routine, verify the request, build a response and return the response. If the server slot display page received a network identifier and a network password then the server slot display page would start the process of building a response, otherwise the server slot display page will not build a response and will not return a response. If the process of building the response continues, then the server slot display page would verify the network identifier and network password by retrieving a row from parking lot we network table using network identifier for NETWORK_ID and network password for NETWORK_PASSWORD. If the server slot display page retrieves a row from parking lot we network table, then the server slot display page would save the value of OWNER_ID from the retrieved row into owner identifier, otherwise the server slot display page would abandon the process of building the response and will not return a response.
The process of building the response involves retrieving the rows from we self-order station status table where the values of ORDER_IDENTIFIER and READY_INDICATOR_YN in the most recent row based on STATUS_SEQ for the same OWNER_ID, NETWORK_ID and ORDER_STATION_ID in parking lot we self-order station status table are not equal to the values of ORDER_IDENTIFIER and READY_INDICATOR_YN in the most recent row based on STATUS_SEQ, for the same OWNER_ID, NETWORK_ID and ORDER_STATION_ID in parking lot we self-order station display table. The values of ORDER_IDENTIFIER and READY_INDICATOR_YN in parking lot we self-order station status table are the result of customer activities whereas the values of ORDER_IDENTIFIER and READY_INDICATOR_YN in parking lot we self-order station display table are the result of updates sent to order indicator and the display in mini screen in the self-order station by the network controller.
The server slot display page would start the process by saving 0 for update count and blanks for slot number string, ready indicator string and mini screen string. The server slot display page would use a delimiter that is pre-determined and known to network controller as response delimiter. The server slot display page would also create an array with column names self-order station identifier and network slot identifier. Then the server slot display page would retrieve all rows from parking lot we self-order station table using owner identifier for OWNER_ID, network identifier for NETWORDK_ID and save the values of ORDER_STATION_ID and NETWORK_SLOT_ID from each retrieved row in a row in the array into array columns self-order station identifier and network slot identifier respectively.
Then the server slot display page would retrieve one row at a time from the array and use the values from the retrieved row to build the response. The server slot display page would repeat this process of retrieving one row from the array and building the response will continue until all the rows in the array are processed. To build the response the server slot display page would update the value of update count, content of ready indicator string, content of mini screen string and insert new rows into parking lot we self-order station display table as required.
The server slot display page would save the values of columns self-order station identifier and network slot identifier from each retrieved row from the array as current self-order station identifier and current network slot identifier respectively to process each row.
Then the server slot display page would retrieve one row from parking lot we self-order station status table using owner identifier for OWNER_ID, network identifier for NETWORK_ID, current self-order station identifier for ORDER_STATION_ID and the maximum value of STATUS_SEQ for the same OWNER_ID, for the same NETWORK_ID and for the same ORDER_STATION_ID for STATUS_SEQ. If the server slot display page retrieves one row then the server slot display page would save the values of ORDER_IDENTIFIER and READY_INDICATOR_YN from the saved row into self-order station order identifier and self-order station ready indicator respectively, otherwise the parking lot server would save blanks for self-order station order identifier and self-order station ready indicator.
Then the server slot display page would retrieve one row from parking lot we self-order station display table using owner identifier for OWNER_ID, network identifier for NETWORK_ID, current self-order station identifier for ORDER_STATION_ID and the maximum value of DISPLAY_SEQ for the same OWNER_ID, for the same NETWORK_ID and for the same ORDER_STATION_ID for DISPLAY_SEQ. If the server slot display page retrieves one row, then the server slot display page would save the values of ORDER_IDENTIFIER and READY_INDICATOR_YN from the saved row into displayed order identifier and displayed ready indicator respectively, otherwise the server slot display page would save blanks for displayed order identifier and displayed ready indicator.
If the self-order station order identifier is not equal to displayed order identifier or if the self-order station ready indicator is not equal to displayed ready indicator, then the server slot display page would continue processing the current row retrieved from the array, otherwise the parking lot server would skip processing the current row.
The server slot display page would increment the update count by 1.
If the slot number string is blank then the server slot display page would concatenate current network slot identifier to slot number string, otherwise the server slot display page would concatenate the response delimiter and current network slot identifier to slot number string.
If self-order station order identifier is blank, then the server slot display page would save ‘Black’ as current ready indicator and a blank space as current mini display.
If self-order station order identifier is not blank and self-order station ready indicator is ‘N’, then the server slot display page would save ‘Red’ as current ready indicator and self-order station order identifier as current mini display.
If self-order station order identifier is not blank and self-order station ready indicator is ‘Y’, then the server slot display page would save ‘Green’ as current ready indicator and current self-order station identifier as current mini display.
If the ready indicator string is blank then the parking lot server would concatenate current ready indicator to ready indicator string, otherwise the server slot display page would concatenate the response delimiter and current ready indicator to ready indicator string.
If the mini screen string is blank then the server slot display page would concatenate current mini display to mini screen string, otherwise the server slot display page would concatenate the response delimiter and current mini display to mini screen string.
Then the server slot display page would insert a new row into parking lot we self-order station display table using owner identifier for OWNER_ID, network identifier for NETWORK_ID, current self-order station identifier for ORDER_STATION_ID, 1 or the maximum value of DISPLAY_SEQ for the same OWNER_ID, for the same NETWORK_ID, for the same ORDER_STATION_ID plus 1 for DISPLAY_SEQ, self-order station order identifier for ORDER_IDENTIFIER and self-order station ready indicator for READY_INDICATOR_YN and server date and time for DATETIME.
Once all the rows from the array are processed, the server slot display page will send the response which will be update count, slot number string, ready indicator string and mini screen string.
The request received and the responses sent by server slot display page may be based on the Application Programming Interfaces (API) specification provided by the parking lot service provider.
20. When the network controller is powered, the network self-order station scanner routine residing inside programmable firmware that is embedded in the network controller would process the input from the scanner installed in self-order stations. If the scanned data is valid, then the customer will be signed in to pick the order placed in advance.
When the network controller is powered, the network self-order station license plate routine residing inside programmable firmware that is embedded in the network controller would process the vehicle identifier from the license plate reader installed in self-order stations.
If the vehicle identifier is valid the customer will be signed in to pick the order placed in advance.
The server text message routine stored in the parking lot server would receive the text messages sent to the phone number displayed at the self-order station. If the text message is valid the customer will be signed in to pick the order placed in advance.
The server IVR message routine stored in the parking lot server would interact with the customers calling the phone number displayed at the self-order station. If the information received from the customer is valid the customer will be signed in to pick the order placed in advance.
21. When the network controller is powered, the network mover routine residing inside programmable firmware that is embedded in the network controller would process the input from the transporter controller. The network controller would receive the transporter identifier and a request type from transporter controller whenever a drop-off point switch or scanner or pick up point switch or scanner is activated. Whenever a drop-off point switch or scanner is activated, the value in the request type would be ‘D’ and whenever a pick up point switch or scanner is activated, the value in the request type would be ‘P’. The network mover routine would use a server mover url hosted by the parking lot server that will have the routines to accept the request from network mover routine, verify the request, build a response and return the response. The network mover routine may receive a success or error message or may not receive any response. The network mover routine would forward the response to the transporter controller. The type of response, whether the response is an error response or success response would depend on the value of the first node in the response which may be a comma delimited string. If the value of the first node in the return response is 1, then the type of response will be a success response otherwise the type of response will be an error response.
If the transporter controller receives a success response and if the request type is ‘D’, then the transport controller would activate ‘Move Forward’ switch to move the order from dtop-off point to pick up point.
It the transporter controller receives a success response and if the request type is ‘P’, then the transport controller would activate ‘Move Backward’ switch to move the transporter from pick up point to drop-off point.
The inputs received by the server mover url from network mover routine and the response returned by the server mover url may be based on the specification provided by the parking lot service provider in buidling the network mover routine residing inside programmable firmware and in creating the server mover url page in the parking lot server.

There are many ways for merchants to pass locker one-time access code to customers such as text message, voice message, web site, printed on receipts, embedded in the order identifier and the like. It is also possible for merchants to pass customer mobile number to smart lock management server so that the customers can use an app provided by smart lock management server or an app interfaced with smart lock management server to scan the QR Code displayed on the smart lock and use biometric identifier such as finger print, face id, voice identifier and the like to access the locker. It is also possible for merchants to pass customer mobile number to smart lock management server so that the customers can use any generic QR Code reader app to scan the QR Code displayed on the smart lock and use a 2-factor authentication to access the locker. It is also possible for smart lock management server to generate a random number, use the generated random number as one-time code and text the one-time code to the mobile number that smart lock management server received, if the one-time code received by smart lock management server is blank. If the locker one-time access code is embedded within order identifier then it will not be safe to display the order identifier that would include the locker one-time access code in the large screen. The virtual terminal can exclude locker one-time access code from the order identifier when the order identifier is displayed on the large screen/s. For the virtual terminal to exclude locker one-time access code embedded in the order identifier, the merchants can specify the length of locker one-time access code which will be at the end of the order identifier. If delivery persons are allowed to pick up orders, then the only option for the delivery persons to use a one-time access code would be to use an order identifier embedded with a one-time access code. If the locker one-time access code is embedded into the order identifier then the value of ONE_TIME_CODE_LENGTH in parking lot we network table would be greater than 0, otherwise it will be 0.

It is beyond the scope of this invention to provide all the details about authentication and verification methods that customers can use to access the locker. It is sufficient to note that parking lot server can hide one-time access code embedded in the order identifier. Merchant provided values for password, large screen polling time, one-time access code length and self-order station polling time will be saved in NETWORK_PASSWORD, LARGE_SCREEN_POLLING_TIME, ONE_TIME_CODE_LENGTH and ORDER_STATION_POLLING_TIME respectively in parking lot we network table.

Merchants can use a form provided by parking lot server to download a locker QR Code to print on any medium to be placed near the drop-off point of each locker. Merchants can scan the locker QR code or can select a locker from a list of available lockers while dropping off orders at drop-off points. As an example, the content of locker QR code can be 201-920393-382984. The value in the first node is application identifier which is in the example 201, the value in the second node is network controller identifier which is in the example ‘920393’ and the value in the third node is transporter controller identifier which is in the example ‘382984’.

While setting up the database, the merchants can also set up the parking lot as shown in FIG. 5. parking lots can be set up for both enclosed locker and open locker.

Each parking lot can have one or more self-order stations for customers to place an order and sign-in or to sign-in to pick up an already placed order as shown in FIG. 6. Each self-order station will have a QR code for the customers to scan using their mobile devices, one or more phone numbers for texting and/or for calling to get help. Each self-order station can have optional attachments such as a ready indicator to indicate when the order is ready for pickup, a mini screen to display locker number when the order is ready for pickup, a help button for the customers to receive help, a scanner/reader for the customers to scan a QR code displayed on their mobile devices or to transmit data from their mobile devices to the reader and a license plate reader to read the vehicle license plate entering the self-order station. When used the ready indicator, mini screen, help button, scanner/reader and license plate reader will be connected to a self-order station slot in the network controller as shown in FIG. 4A. A sample self-order station with additional texts and additional hardware are shown in FIG. 6. Merchants would select the self-order station slot in the network controller based on the information saved in ORDER_STATION_ID which is the self-order station identifiers and NETWORK_SLOT_ID which is the self-order station slot identifier in the network controller saved in parking lot we self-order station table. The devices from the self-order station would be connected to the corresponding plugs in the self-order station slot marked by self-order station slot identifier and connected to the network controller.

Each parking lot can have one or more manual order stations equipped with a two-way communication system, a card reader and/or a currency acceptor for payment for the customers to place an order verbally with a remote merchant associate and make the payment. The manual order station can also be manned by live operators with or without two-way communication system or card reader or currency acceptor. Each manual order station will have a waiting line before reaching manual order station and a waiting area after manual order station. Customers waiting in a waiting line before reaching manual order station will not be able to bypass each other. All customers in the waiting area after placing orders at manual order station can bypass each other.

Each parking lot can have one or more lockers. Each locker will have a drop-off door at a drop-off point accessible to merchants dropping off orders and a pick-up door at a pickup point accessible to customers for picking up orders. Each locker will be designated by the merchant with a unique locker number generally known as locker number and will be displayed at pickup point easily visible to customers. Customers can drive in and drive out of order pick up stations to pick up the orders at pickup points.

Each parking lot can have one or more large screens to display the status of orders. The order may be identified by order identifiers. If the order is identified by order identifiers and if the order identifier also includes a one-time code, then the order identifier without the one-time code will be displayed on the large screens. If the payment for the order was made using a mobile wallet such as apple pay, google pay, samsung pay, msl wallet and the like then the customer's name will also be displayed in addition to order identifier. An example of a large screen is shown in FIG. 7A. Only orders received by the parking lot server will be displayed on the large screens. The orders will be displayed on the large screens until the orders are picked up.

Each parking lot can have one or more displays to direct the customers to manual order stations, self-order stations, lockers and exit.

Although those of ordinary skill in the art will readily recognize many alternative parking lot layouts, especially considering the illustrations provided herein, this detailed description with the FIG. 5 is exemplary of the preferred embodiments of the present invention, the scope of which is limited only by the claims appended hereto.

The installation of lockers in a parking lot will depend on the type of locker and the type of movers that move the bin or a box carrying the order from drop-off point to pick-up point and move the bin or a box from pick-up point to a drop-off point. To use a locker, a parking lot can be set up as shown in FIG. 5 with minor modifications in the set up of locker depending on the type or locker and the type of mover as shown in FIGS. 3E, 3I and 3J.

While setting up the database and/or the parking lot, the merchants can also set up the network controller, transporter controller and self-order station slot as shown in FIGS. 4A and 4B. Each parking lot can have only one network controller, each locker can have only one transporter controller, all the transporter controllers will be connected to a single network controller and each self-order station slot in the self-order station can be connected to one self-order station slot in the network controller using wired connectors or wireless connectors.

The various parts in the assembly diagram as shown in FIG. 4A and numbered between 1 and 33 are briefly described in FIG. 4B. Merchants can use installation guide received from parking lot service provider that will include the assembly diagram as shown in FIG. 4A, a brief description of numbered items as shown in FIG. 4B, step by step instructions to assemble lockers, step by step instructions on loading the required software and step by step instructions on the operation of lockers in parking lot we automation. The procedure to assemble lockers will vary depending on type of lockers, type of installation, type of transporters and type of movers.

Each locker will be controlled by a unique transporter controller where various parts from locker will be connected to the transporter controller. All transporter controllers will be connected to a single network controller. All hardware in each self-order station will be controlled by a unique self-order station slot in the network controller. All connectors from plug-ins in a single self-order station slot in the network controller will be connected to corresponding hardware in a single self-order station.

Each transporter controller can have a number of hardware and connectors that are referred to numbers as shown in FIG. 4A and FIG. 4B. In an enclosed locker the item number 1 will be an enclosure, item number 2 can be a conveyor or a linear actuator or a robot as shown in FIGS. 3A, 3B, 3C, 3D, 3E and 3I. In an open locker the item number 1 will be a protected area, item number 2 can be a robot or a crane as shown in FIGS. 3F, 3G, 3H and 3J. Each transporter controller (17) can have a drop-off point switch (3) to indicate that an order is dropped off, drop-off point connector (5) to connect the drop-off switch to the transporter controller, pick-up point switch or sensor (4) to indicate that an order has been picked up, pickup point switch or sensor connecter (6) to connect the pickup point switch or sensor to transporter controller, mover forward drive switch (7) to move the transporter from drop-off point to pick-up point, mover backward drive switch (8) to move the transporter from pick-up point to drop-off point, mover forward drive connector (9) to connect mover forward drive switch to transporter controller, mover backward drive connector (10) to connect mover backward drive switch to transporter controller, mover lift platform (11) to raise or lower transporter platform and the transporter, mover lift platform up connector (12) to raise mover lift platform, mover lift platform down connector (13) to lower mover lift platform, locker QR Code (14) can be downloaded from the parking lot server and displayed at the drop-off point, vehicle license plate reader (15) to capture vehicle license plate, vehicle license plate reader connector (16) to connect vehicle license plate reader to transporter controller and network controller connector (18) to connect transporter controller to network controller.

The transporter lift is also referred to as short lift and the mover lift is also referred to as long lift. The connectors can be wired or wireless. Whan a robot is used as a mover, the mover forward drive connector (9), mover backward drive connector (10), mover lift platform up connector (12) and mover lift platform down connector (13) will be wireless.

In an enclosed locker the installation procedure for both bin and box would be same except for item number 3, 4, 5 and 6. When a bin is used as transporter the drop-off point switch (3) will be attached to the door that is attached to the enclosure. When a box is used the drop-off point switch (3) will be attached to the indoor side of the barrier and near the drop-off point, because the drop-off door is attached to the box and not to the enclosure. Item number 5 will be a connector connecting item number 3 (drop-off point switch) to transporter controller. When a bin is used as transporter the pickup point switch or sensor (4) will be a pickup point switch and the pickup point switch or sensor connector (6) will be pickup point switch connector. When a box is used as transporter the pickup point switch or sensor (4) will be a pickup point sensor and the pickup point switch or sensor connector (6) will be a pickup point sensor connector.

Each transporter controller will be connected to the network controller (30) using network controller connector (18). For merchants to identify each locker, a QR code (14) and locker external number will be attached to each locker at the drop-off point.

When a bin is used as a transporter, the pickup door attached to the enclosed locker will have a switch marked as 4 in FIG. 4A and connected to transporter controller through switch connector marked as 6 in FIG. 4A. When the pickup door is closed the switch will be activated and the transporter controller would know that the order has been picked up from the locker.

When a box is used any switch attached to the box pick-up door cannot be connected with wires to transporter controller because the pick-up door connected to the box will be moving whereas the pick-up door attached to the transporter enclosure will be stationary and a switch attached to the pick-up door can be connected with wires to the transporter controller. So, when a box is used as a transporter a sensor attached to the pick-up point will be used. When a box is used as a transporter, a sensor attached to the pick-up point marked as 4 in FIG. 4A and connected to transporter controller through sensor connector marked as 6 in FIG. 4A will be used. When a vehicle leaves the pick-up point the sensor will be activated and the transporter controller would know that the order has been picked up from the locker.

When a box is used to move the orders from drop-off point to pick-up point then the drop-off point and pick-up point can also have platforms as shown in FIG. 3C and marked as “B. Box”, in FIG. 3F and marked as “B. Overhead Crane” and as shown in FIG. 3H.

When a box is used to move the orders from drop-off point to pick-up point then the drop-off point and pick-up point can also have docks as shown in FIG. 3F and marked as “A. Robot” and as shown in FIG. 3G. For robots to leave the box at the pick-up or at the drop-off point, the box must be lifted and placed on the dock. So, a dock is used instead of a platform.

Each self-order station slot (24) can have a ready indicator (19) and mini screen (20) that are signal outputs from network controller. Each self-order station slot (24) can have a scanner/reader (22) and license plate reader (23) that are signal inputs into network controller. Each self-order station slot (24) can have a help line (21) that is signal inputs and outputs to and from network controller. Appropriate connectors are used to connect each hardware in the self-order station and in the self-order station slot in the network controller.

A parking lot we automation can have an unlimited number of enclosed lockers as shown in FIGS. 3A, 3B, 3C, 3D, 3E and 3I and open lockers as shown in FIGS. 3F, 3G, 3H and 3J. Parts used in lockers are shown in FIGS. 3K and 3L. Each locker will have 3 major components namely drop-off point or drop-off platform or drop-off dock, pick-up point or pick-up platform or pick-up dock and a transporter that is controlled by transporter controller which is connected to a network controller as shown in FIGS. 4A and 4B. In addition to having a locker, the parking lot we automation will also have a self-ordering/self-sign-in station which is also referred to as self-order station. The self-order station can have a self-order station identifiers, a QR Code, additional text and additional hardware as shown in FIGS. 6. The self-order station can be installed in any parking space in the parking lot for both enclosed and open locker as shown in FIG. 5 for just open locker. Similar parking lot layout can also be used for enclosed lockers. In the case of enclosed locker a drop-off point can be used as shown in FIGS. 3E and 3I. In the case of open locker a drop-off dock or a drop-off platform will be used as shown in FIG. 3J. The drop-off point or the drop-off dock or the drop-off platform will be in a secured area and accessible for merchants to drop-off orders through a secured entry point which could be a door installed with a mechanical lock or with a smart lock. The door installed as an entry point at the drop-off point or drop-off dock will be referred to as drop-off door. In the case of enclosed locker a pickup point will be used as shown in FIGS. 3E and 3I. In the case of open locker a pickup dock or a pickup platform will be used as shown in FIG. 3J. The pickup point or pickup dock or pickup platform may be in a secured area and accessible for customers to pick up orders through a secured entry point which could be a door installed with a smart lock. The door installed as an entry point at the pickup point or pickup dock or pickup platform will be referred to as pick up door. In an enclosed locker, the transporter will be enclosed in an enclosure and in an open locker the transporter will be left open in a secured area. If the transporter is enclosed in an enclosure, then the transporter can be referred to as enclosed transporter. If the transporter is enclosed in an enclosure, then the enclosure can be referred to as transporter enclosure. If the transporter is left open in a secured area, then the transporter can be referred to as open transporter. If the transporter is left open in a secured area, then the secured area can be referred to as transporter secured area. The enclosed transporter can be a bin or a box as shown in FIG. 3E. The open transporter can have only be a box because bins will have openings and the order placed inside the bin will not be protected without an enclosure. Each locker will have various connecting points that are connected to a transporter controller using connectors. Each transporter controller will be connected to a network controller using a connector. There will be one or more transporter controllers and only one network controller in each location. The network controller can communicate with parking lot server using an internet connection as shown in FIG. 4A and marked as 32. The internet connection (32) can be a dedicated ethernet cable or a wire-less connection to communicate with the parking lot server. The parking lot server will be hosted in a cloud based server as shown in FIG. 4A and marked as 33.

The enclosed transporters can be installed at the ground level as shown in FIGS. 3A and 3E and marked as “Above Ground”, “Partically Below Ground” and “Below Ground”. The enclosure of enclosed transporters installed at ground level can be fully above the ground or partially below the ground or fully below the ground as shown in FIG. 3A. The enclosed transporters installed at the ground level can have mover types such as conveyor, linear actuator, robot and the like as shown in FIG. 3B and marked as “A. Conveyor”, “B. Linear Actuator” and “C. Robot”.

The enclosure of enclosed transporters can be installed overhead as shown in FIGS. 3C and 3E and the installation type is marked as “Overhead”. The enclosed transporters installed overhead can have mover types such as conveyor, linear actuator, robot and the like as shown in FIG. 3D and marked as “A. Conveyor”, “B. Linear Actuator” and “C. Robot”. The enclosed transporters installed overhead will be fully above the ground as shown in FIG. 3C.

For safety reasons, the enclosed transporters installed at the ground level and fully above the ground can only be in a protected area and other enclosed transporters can be in an unprotected area as shown in FIG. 3E. The open transporters can be installed at the ground level or below ground level. Open transporters installed above ground level as shown in FIG. 3J can only be in protected areas.

The transporters can be a bin or a box. If the transporter is a bin, then the transporter will be attached to a short lift platform also referred to as transporter lift platform with up and down switches so that the customers can raise or lower the bin using up and down switches respectively as shown in FIG. 3K and marked as B and as shown in FIG. 3L. If the transporter is a bin, then the transporter lift platform to which the bin is attached will be attached to a long lift platform also referred to as mover lift platform where the mover lift platform can be raised or lowered by transporter controller using up connector 12 and down connector 13 respectively as shown in FIGS. 4A and 4B. If the transporter is a bin, then the transporter lift platform can be permanently or temporarily attached to the mover lift platform so that the mover can move the mover lift platform, the mover lift platform can move the transporter lift platform and the transporter lift platform in turn can move the transporter from drop-off point to the pickup point and vice versa as shown in FIGS. 3B and 3D for enclosed lockers. The mover can be a stationary mover or a mobile mover. In a stationary mover only the media that is attached to the transporter will move and not the whole mover. For example, a belt in a conveyor or a holder in a linear actuator or a robe or chain in an overhead crane attached to the transporter, as shown in FIGS. 3B, 3D, 3F and 3H, will move the transporter and not the conveyor or the linear actuator or the crane. In a mobile mover, the whole mover will move, for example, a robot in an enclosed locker as shown in FIG. 3D where the robot will move.

If the transporter is a box, then the plate inside the transporter where the orders are placed for transport will be attached to a short lift platform also referred to as transporter lift platform with up and down switches so that the customers can raise or lower the plate using up and down switches respectively as shown in FIG. 3K and marked as B and as shown in FIG. 3L. If the transporter is a box, then the bottom of the box will be attached to a long lift platform also referred to as mover lift platform where the long lift platform can be raised or lowered by transporter controller using up connector 12 and down connector 13 respectively as shown in FIGS. 4A and 4B. If the transporter is a box, then the box can be permanently or temporarily attached to the mover lift platform so that the mover can move the mover lift platform, the mover lift platform can move the box, the box in turn can move the transporter lift platform and the transporter lift platform in turn can move the transporter from drop-off point to the pickup point and vice versa as shown in FIGS. 3B and 3D for enclosed lockers and as shown in FIGS. 3F and 3G for open lockers. The mover can be a stationary mover or a mobile mover. In a stationary mover only the media that is attached to the box will move and not the whole mover. For example, a belt in a conveyor or a holder in a linear actuator or a robe or chain in an overhead crane attached to the box, as shown in FIGS. 3B, 3D, 3F and 3H, will move the transporter and not the conveyor or the linear actuator or the crane. In a mobile mover, the whole mover will move, for example, a robot in an open locker as shown in FIG. 3F where the robot will move.

If a bin is used in an enclosed transporter, then the drop-off door and the pickup door will be attached to the enclosure as shown in FIGS. 3E and 3L. When an enclosed transporter is installed above overhead and if the dropping portion at the pickup point of the enclosed transporter is to be left open then a box will be used as transporter and the pickup door will be attached to the box as shown in FIGS. 3H and 3L. The dropping portion of an enclosed transporter installed overhead will be left open only for aesthetic reasons and not for any functional reasons. If a box is used in an enclosed transporter, then the drop-off door and the pickup door will be attached to the box as shown in FIG. 3L.

Enclosed lockers installed at ground level can have a bin and the mover that moves the bin can be above ground level, pickup door can be outside the building and drop-off door can be flush with the barrier as shown and marked as ‘A. Above Ground’ in FIG. 3A.

Enclosed lockers installed at ground level can have bin and the mover that moves the bin can be below ground level, pickup door can be outside the building and drop-off door can be flush with the barrier as shown and marked as ‘B. Partially below Ground’ in FIG. 3A.

Enclosed lockers installed at ground level can have bin and the mover that moves the bin can be below ground level, pickup door can be outside the building and drop-off door can be inside the building as shown and marked as ‘C. Below Ground’ in FIG. 3A.

Enclosed lockers installed at ground level can have a bin and the mover that moves the bin can be a conveyor as shown and marked as ‘A. Conveyor (Stationary Mover)’ in FIG. 3B.

Enclosed lockers installed at ground level can have a bin and the mover that moves the bin can be an actuator as shown and marked as ‘B. Linear Actuator (Stationary Mover)’ in FIG. 3B.

Enclosed lockers installed at ground level can have a bin and the mover that moves the bin can be a robot as shown and marked as ‘C. Robot (Mobile Mover)’ in FIG. 3B.

Enclosed lockers installed overhead can have a bin and the mover that moves the bin can be overhead, pickup door can be outside the building and drop-off door can be inside the building as shown and marked as ‘A. Bin’ in FIG. 3C.

Enclosed lockers installed overhead can have a box and the mover that moves the box can be overhead, pickup door can be outside the building, drop-off door can be inside the building and dropping segment of the enclosed transporter can be open as shown and marked as ‘B. Box’ in FIG. 3C.

Enclosed lockers installed overhead can have a bin or a box and the mover that moves the bin or box can be a conveyor as shown and marked as ‘A. Conveyor (Stationary Mover)’ in FIG. 3D.

Enclosed lockers installed overhead can have a bin or a box and the mover that moves the bin or box can be a linear actuator as shown and marked as ‘B. Linear Actuator (Stationary Mover)’ in FIG. 3D.

Enclosed lockers installed overhead can have a bin or a box and the mover that moves the bin or box can be a robot as shown and marked as ‘C. Robot (Mobile Mover)’ in FIG. 3D.

In an enclosed locker, if the installation is above ground the space between the barrier and the pickup point will be protected and cordoned off, if the installation is partially below ground the space between the barrier and the pickup point will be partially protected and cordoned off, and if the installation is below ground the space between the barrier and the pickup point will not be protected or cordoned off as shown in FIG. 3E.

Open lockers can have a box and the mover that moves the box can be in a protected area, pickup door can be outside the building, and drop-off door can be flush with the building barrier as shown in FIG. 3E.

Open lockers can have a box and the mover that moves the box can be a robot as shown and marked as ‘A. Robot (Mobile Mover)’ in FIG. 3F.

Open lockers can have a box and the mover that moves the box can be a overhead crane as shown and marked as ‘B. Ovehead Crane (Stationary Mover)’ in FIG. 3F.

In an open locker, the transporter will be a box and the mover type can be a robot or an overhead crane as shown in FIGS. 3F, 3G and 3H. In an open locker, the space between the barrier and the pickup dock or the pickup platform and the pickup dock or pickup barrier will be protected and cordoned off as shown in FIG. 3J. In an open locker, the mover will be a shareable mover whereas in an enclosed locker the mover will be a dedicated mover. As a shareable mover the mover can be shared by more than one transporter as shown in FIGS. 3F, 3G and 3H. As a shareable mover the mover will have one mover forward switch and one mover backward switch for each open locker that is sharing the shareable mover and will be connected to the transporter controller controlling the individual open locker. For example, if a shareable mover is being shared by 4 open lockers, then the shareable mover will have 4 mover-forward switches and 4 mover backward switches where each set of forward and back ward switch will be controlled by a transporter controller.

The enclosed lockers may be placed in parallel and the distance between merchant drop-off points would be same as the distance between customer pickup points. Enough space must be provided between customer pickup points for the customers to park their vehicles. Whereas open lockers may not be placed in parallel and merchant drop-off points may be closer to each other than customer pickup points and more open lockers than enclosed lockers can be installed in the same space available for merchant drop-off points.

In an open locker having a robot as the mover the item number 1 will be a protected and cordoned off area, item number 2 will be a robot, item number 3 can be a switch attached to indoor side of the barrier and near the drop-off point, item number 4 will be a one or more sensors attached to the pickup dock as shown in FIG. 3G, item number 5 will be a connector connecting item number 3 to transporter controller, item number 6 will be a connector connecting item number 4 to transporter controller, item 7 will be a mover forward switch will move the transporter from drop-off point to pick up point, item 8 will be a mover back ward switch will move the transporter from pickup point to drop-off point, item number 9 will be a wireless connector connecting number 7 to an appropriate transporter controller, item number 10 will be a wireless connector connecting number 8 to an appropriate transporter controller, item number 11 will be a transporter, item number 12 will be a wireless connector connecting the robot to mover lift platform up switch, item number 13 will be a wireless connector connecting the robot to mover lift platform down switch, item 14 is the locker QR Code that can be downloaded from the parking lot server and displayed at the drop-off point, item 15 is the vehicle license plate reader, item 16 will be a connector connecting 15 to transporter controller, item 17 is the transporter controller and item 18 is the connector connecting transporter controller 17 to network controller 30.

In an open locker having an overhead crane as the mover the item number 1 will be a protected and cordoned off area, item number 2 will be an overhead crane, item number 3 can be a switch attached to indoor side of the barrier and near the drop-off point, item number 4 will be a one or more sensors attached to the pickup platform as shown in FIG. 3H, item number 5 will be a connector connecting item number 3 to transporter controller, item number 6 will be a connector connecting item number 4 to transporter controller, item 7 will be a mover forward switch will move the transporter from drop-off point to pick up point, item 8 will be a mover back ward switch will move the transporter from pickup point to drop-off point, item number 9 will be a wired connector connecting number 7 to an appropriate transporter controller, item number 10 will be a wired connector connecting number 8 to an appropriate transporter controller, item number 11 will be a transporter, item number 12 will not be used, item number 13 will not be used, item 14 is the locker QR Code that can be downloaded from the parking lot server and displayed at the drop-off point, item 15 is the vehicle license plate reader, item 16 will be a connector connecting 15 to transporter controller, item 17 is the transporter controller and item 18 is the connector connecting item number 17 to network controller 30.

Enclosed lockers can also use a box as a transporter when the enclosed locker is mounted overhead and dropping side of the enclosed locker is left open as shown in FIG. 3C under the section ‘B. Box’. The box will have a door on the drop-off side and will have a door on the pickup side as shown in FIG. 3G. The door attached to the pickup side may be riding on a slider that can move horizontally or vertically instead of being attached to the frame of the door with hinges. When a box is used as a transporter, the box will land on a platform at the pickup point and at the drop-off point. For security reasons, the platforms will have sensors so that the box will not land on the platform when the sensor indicates that an object is close by the platform.

In an enclosed locker, mounted at the ground level or below ground level the bottom of the transporter will be attached to the top of a transporter lift platform as shown in FIG. 3B. In an enclosed locker mounted overhead the top of the transporter will be attached to the bottom of a transporter lift platform as shown in FIG. 3D. In both cases, the transporter can be raised or lowered manually for a very short distance using up and down buttons attached to the transporter lift platform respectively as shown in FIGS. 3B and 3D. When the transporter is at the pickup point and when the pickup door is in an open position, then the transporter can be moved up or down manually using the up or down buttons attached to the frame of the lift platform. This would help the customers at the pickup point to raise or lower the transporter for an easy reach from their vehicles to the content inside the transporter. The transporters can also be raised or lowered to the full extent by the transporter controller using up and down connectors marked as 10 and 11 respectively as shown in FIG. 4A. As the mover moves, the transporter will also move. When the mover is not moving, the transporter will be at the drop-off or at the pickup point. Before moving the transporter, the transporter controller would always fold the mover lift platform fully so that the transporter will be inside the enclosure when the transporter is moved horizontally.

The mover can be operated by switches where the forward drive switch can move the transporter from the drop-off point to the pickup point, backward drive switch can move the transporter from the pickup point to the drop-off point. The pickup door switch installed to the frame of the pickup door will be connected to the transporter controller through the pickup door connector. The drop-off door switch installed to the frame of the drop-off door will be connected to the transporter controller through the drop-off door connector. If the transporter is a box then the pickup door and the drop-off door will be connected to the box and the wiring for the connectors will be attached to the lift platform, otherwise the pickup door and drop-off door will be connected to the enclosure and the wiring for the connectors will be attached to the enclosure.

The merchant would display the locker identifier QR code near the drop-off door.

Once all the hardware is assembled as per the assembly diagram, all the data in various setup tables has been setup, the virtual terminal displaying the order status on one or more display large screens, the transporter controller and network controller programs have been loaded, the parking lot we automation would be ready for merchants and for customers to use.

Before every time the parking lot server is set to be available to customers and/or merchants, the merchant would start the virtual terminal/s.

Before continuing, however, it is noted that while the enclosed locker installed at ground level and corresponding mover types as shown in FIGS. 3A and 3B, the enclosed locker installed overhead and corresponding mover types as shown in FIGS. 3C and 3D, the open locker and corresponding mover types as shown in FIGS. 3E and 3F, the parts list shown in FIG. 3K, the transporter lift platform and mover lift platform shown in FIG. 3L and assembly instructions shown in FIGS. 4A and 4B are exemplary of the preferred embodiments of the present invention related to lockers, it is in no manner meant to be all encompassing or otherwise limiting of the wide range of implementations as are possible. It is also noted that assembly instructions shown in FIGS. 4A and 4B would vary and depend on the types of locker and type of movers being used.

Note that all installation types in enclosed locker and in open locker work the same way except for minor variations.

To manage the parking lot we automation, parking lot server may provide merchant forms to access from mobile web sites and apps. To access merchant forms, the merchants must log into parking lot server using a password set by the merchant. The merchants can also use an authentication method instead of using a password. It is beyond the scope of this invention to provide all the details about authentication and verification methods. It is sufficient to note that merchants can use fingerprint or face id or a password or two-factor authentication or any other method to log into parking lot server.

Persons entering the location to pickup orders may be not only customers (buyers), but also can be third-party order handlers. All the persons entering the location will be referred to as customers.

In addition to accepting online orders through order management service provider, merchants can also accept orders from one or more third-party delivery service providers. Merchants can also accept offline orders through order management service provider at merchant locations.

Customers entering the location could be buyers who have already placed online orders in advance using order management service provider or delivery service provider web site or app or customers placing orders at the location or delivery service providers directed to pick up orders. In case of orders placed by buyers with delivery service providers, the employees of delivery service providers will be picking up the orders and they will also be considered as customers. Online orders placed with delivery service providers would be automatically added into order management server or will be added manually by merchants into order management server. How orders placed with delivery service providers are added into order management server is beyond the scope of this invention. Orders placed at the location also will be added into order management server.

When customers place orders in advance using a web site, or an app provided by order management service provider or using a web site, or an app provided by delivery service provider, the customers would receive at a minimum an order identifier (order number). The merchant may receive order identifier, mobile number and details of the orders through any number of mediums such as digital screen, printed receipt, computer through interface, app interface and the like. When the order information is received, the merchant may prepare the order based on pickup date and time and whether the customer prefers freshly prepared orders or orders prepared in advance. If the customer prefers orders prepared in advance, then the merchant would prepare the orders and leave the order in the locker even before the customer arrives at the merchant location and the customers need not sign-in at the self-order station. If the customer prefers freshly prepared orders, then the merchant would wait until the customer sign-in at the self-order station at the location to pick up the orders.

When a buyer places an online order with a delivery service provider, the order management server would receive order details and a unique tracking number programmatically or order management server would receive order details and a unique tracking number thru a digital screen and merchant would manually enter the information into order management server. Since only the unique tracking number will be known to the delivery person picking up the order, the unique tracking number will be used as order identifier. If the value of ONE_TINE_CODE_LENGTH saved in parking lot we network table is greater than 0, then the last few digits in the order identifier as set in the ONE_TINE_CODE_LENGTH will be the one-time code to access the locker. Since the tracking number is common identifier for delivery service providers and merchants to set a one-time code, it is important to use a value of more than 0 for ONE_TINE_CODE_LENGTH and the number of characters in the order identifier is more than the value of ONE_TINE_CODE_LENGTH. If delivery service provider can provide a one-time code to the merchant or if the merchant can provide a one-time code to the delivery service provider, then ONE_TINE_CODE_LENGTH can be 0.

When a buyer places an online order with an order management service provider, the order management server would receive order details and may also receive buyer's mobile phone number and/or vehicle license plate number. When an order is received directly from a buyer the order management server would create unique order numbers. If the value of ONE_TINE_CODE_LENGTH saved in parking lot we network table is greater than 0, then the last few digits in the order identifier as set in the ONE_TINE_CODE_LENGTH will be the one-time code to access the locker. So, if unique order numbers are sequential, then it is important to concatenate the sequential order numbers with unique random numbers with a length equal or greater then the value of ONE_TINE_CODE_LENGTH and save as order identifiers, otherwise save order numbers as order identifiers. Also, it is important to make sure the length of order identifier is more than the value of ONE_TINE_CODE_LENGTH.

If an interface has been set up, the order management server can programmatically send the order identifier and other details to the parking lot server, otherwise merchant would enter the information using a form provided by parking lot server.

The order management server would format the data to be sent as shown in FIG. 9A as an example. The details of the information sent to the parking lot server will be determined by parking lot service provider. Then the order management server would use order receive url, order receive url password and network identifier provided to the order management service provider by the merchant or by the parking lot service provider in advance and use a secure communication channel such as https post method.

The order receive url and order receive url password provided to the order management service provider are saved as ORDER_RECEIVE_URL and ORDER_RECEIVE_URL_PW in parking lot we interface table respectively and the order receive url is also referred to as server order receive page.

The order management service provider would use network identifier for OrderReceiveNetworkld, ‘O’ for OrderReceiveOriginId because the order is placed online with the order management service provider or with the delivery service provider, blank for OrderReceiveStationId because the self-order station identifiers from where the customer is going to sign-in at the location is not known, order identifier for OrderReceiveOrderId, blank for OrderReceiveMobileNo if buyer mobile number is not known to the order management server or buyer mobile number for OrderReceiveMobileNo if buyer mobile number is known to the order management server and blank for OrderReceiveVehicleId if buyer vehicle license plate is not known to the order management server or buyer vehicle license plate for OrderReceiveVehicleId if buyer vehicle license plate is known to the order management server.

When the server order receive page receives the order identifier data, the server order receive page will verify the value of OrderReceiveNetworkId by retrieving one row from parking lot we network table using OrderReceiveNetworkId for NETWORK_ID. If server order receive page retrieves one row, then server order receive page would save the value of OWNER_ID from the retrieved row as owner identifier, otherwise the server order receive page will terminate the process. Then the server order receive page will insert a row into parking lot we merchant station status table using owner identifier for OWNER_ID, OrderReceiveNetworkId for NETWORK_ID, OrderReceiveOrderId for ORDER_IDENTIFIER, 1 for STATUS_SEQ, ‘W’ for STATUS indicating that the order is in waiting status for the customer to sign-in to pick up, using OrderReceiveOriginId for ORIGIN, OrderReceiveMobileNo for ORDER_MOBILE_NO, OrderReceiveVehicleId for ORDER_VEHICLE_ID, OrderReceiveStationld for ORDER_STATION_ID and server datetime for DATETIME. A value of 1 is used for STATUS_SEQ, because a row with the values of owner identifier for OWNER_ID, OrderReceiveNetworkId for NETWORK_ID and OrderReceiveOrderId for ORDER_IDENTIFIER would not have existed in parking lot we merchant station status table or in parking lot we self-order station status table at the time of inserting the row.

If the order identifier data is not sent to server order receive page at the time of placing an online order, the merchant would use a merchant order entry form provided by parking lot server as shown in FIG. 13B, use the option ‘Online Order’ and tap or click on “Save” button to send order identifier data to parking lot server. Merchants can also use a merchant order inquiry form as shown in FIG. 13A provided by parking lot server to inquire whether an order identifier already exists in parking lot server. The merchant order inquiry form or merchant order entry form will be presented to the merchant only after a successful log into parking lot server by the merchant. Merchant would use owner identifier, network identifier and password that are already known to the merchant to log into parking lot server.

When a value for ‘Order Identifier’ is entered and when the “Inquire” button is clicked or tapped the order inquiry form would send owner identifier as Ownerld, network identifier as NetworkId and the order identifier entered by the merchant as OrderId to the parking lot server. Upon receiving the data from the merchant order inquiry form, the parking lot server would validate the data. If the values of Ownerld and NetworkId received from the order entry form are valid based on the data stored in parking lot we network table, if the received OrderId exists in parking lot we self-order station status table or in parking lot we merchant station status table, then the parking lot server would display the message ‘Order Identifier Found’, buyer's mobile phone number if available and buyer's vehicle identifier if available otherwise the parking lot server would display the message ‘Order Identifier Not Found’.

Using merchant order entry form, merchants could select the option “Online Order” for origin because the order was placed online, enter order identifier, mobile number, vehicle license plate and click on “Save” button. The order identifier is same as the order identifier that the merchant received from order management service provider when a buyer placed an order with order management service provider or delivery service provider. The mobile number is same as the mobile number that the merchant received from order management service provider when a buyer placed an order with order management service provider. The vehicle license plate is the same as the vehicle license plate that the merchant received from order management service provider when a buyer placed an order with order management service provider. If the merchant did not receive a buyer mobile number, then the mobile number will be blank. If the merchant did not receive a buyer vehicle license plate, then the vehicle license plate will be blank. When the “Save” button is clicked or tapped the order entry form would send owner identifier as Ownerld, network identifier as NetworkId, origin selected by the merchant as OriginId, the order identifier entered by the merchant as OrderId, the mobile number entered by the merchant as MobileNo, the vehicle license plate entered by the merchant as VehicleId and blank for StationId to the parking lot server. If origin selected by the merchant is “Online Order”, then the order entry form would send “O” as OriginId. Blank value for StationId is used because self-order station identifier is not known at the time of adding an online order.

Upon receiving the data from the merchant order entry form 13B, the parking lot server would validate the data. If the values of Ownerld and NetworkId received from the order entry form are valid based on the data stored in parking lot we network table, if the received OriginId is “O” or “M”, if the received OrderId does not exist in parking lot we merchant station status table and if the received OrderId does not exist in parking lot we self-order station status table, then the parking lot server would insert a row into parking lot we merchant station status table using Ownerld for OWNER_ID, NetworkId for NETWORK_ID, OrderId for ORDER_IDENTIFIER, 1 for STATUS_SEQ, ‘W’ for STATUS, OriginId for ORIGIN, MobileNo for ORDER_MOBILE_NO, VehicleId for ORDER_VEHICLE_ID, StationId for ORDER_STATION_ID and current server date and time for DATETIME. The value ‘W’ for STATUS indicates that the order is in waiting status. The value of ‘O’ for OriginId indicates that the order is an online order whereas the value of ‘M’ for OriginId indicates that the order is from manual ordering station at the location order. If the OriginId is “O”, then OrderId in the parking lot we merchant station status table will be in ‘W’ status until the buyer or a delivery person sign-in to pick up the order at self-serv station. If the OriginId is “M”, then order identifier in the parking lot we merchant station status table will be in ‘W’ status until the merchant drops off the order at a drop-off point of a locker.

If the data validation is successful and the row insert in parking lot we merchant station status table is successful, then the parking lot server would respond with a successful message. An example of a successful message may be “Order is accepted”. If the data validation is not successful or the row insert into parking lot we merchant station status table is not successful, then the dah-thru parking lot service provider would respond with an error message depending on the type of error. An example of an error message may be “Order identifier already exists”.

If the data validation is successful and the row insert in parking lot we merchant station status table is successful, then the order identifier will be visible on the large screen/s, when the virtual terminal refreshes itself next time.

When the buyer or delivery service provider sign-in to pick up an online order at a self-order station and if the order identifier exists in parking lot we merchant station status table with a STATUS of ‘W’ and with an origin of ‘O’, then the order identifier will be copied from parking lot we merchant station status table to parking lot we self-order station status table by inserting a new row into parking lot we self-order station status table with a READY_INDICATOR_YN of ‘N’ indicating that the customer is waiting at a self-order station to pick up the order and by inserting a new row into parking lot we merchant station status table with a STATUS of ‘M’ indicating that the order identifier has been moved to we self-order station status table.

When the buyer or delivery service provider sign-in to pick up an online order at a self-order station and if the order identifier exists in parking lot we merchant station status table with a STATUS of ‘L’ and with an origin of ‘O’, then the order identifier will be copied from parking lot we merchant station status table to parking lot we self-order station status table by inserting a new row into parking lot we self-order station status table with a READY_INDICATOR_YN of ‘Y’ indicating that the customer can pick up the order from the specified locker and by inserting a new row into parking lot we merchant station status table with a STATUS of ‘M’ indicating that the order identifier has been moved to we self-order station status table.

Customers entering the location will be presented with the choice of proceeding to manual order station or to a self-order station which is a parking space with a self-order station number, QR Code, additional text and additional hardware or to a locker which is a parking space where the customers can pick up the orders or to a curbside or to a dining area or to a patio area to place an order and pickup or to pick up an order already placed. Customers placing orders at curbside or signing-in at curbside to pick up orders already placed will pick up orders from curbside lockers. Customers placing orders inside the dining area at the table or signing-in inside the dining area at a dining table to pick up orders already placed will pick up orders from in-store lockers. Customers placing orders inside the patio at the table or signing-in inside the patio area at a table to pick up orders already placed will pick up orders from patio lockers. The details of order pick up from curbside lockers, in-store lockers and patio lockers can be similar to the order pick up from parking lot locker, but they are beyond the scope of this invention. This invention relates only to lockers where customers can pick up orders from the parking lot while being inside their vehicles.

Customers entering the location, whose orders are ready for pick up as displayed on one or more large screens installed in the parking lot can directly go to the pick up locker to pick up the orders. Customers, entering the location, whose orders are not ready for pick up as displayed on one or more large screens installed in the parking lot can only drive to a self-order station. Buyers who have not yet placed orders can drive to self-order station or to manual order station to place an order. Buyers opted to drive to a manual order station can only move forward slowly because the lane leading to manual order station may be a single lane and the process of taking orders is verbal and merchants can accept only one order at a time. If the ordering station is managed by more than one live person, then merchants can accept more than one order simultaneously. Buyers opted to drive to a self-ordering station can move forward quickly without any traffic ahead of them blocking the driveway because many self-ordering stations will be available, and merchants can accept many orders simultaneously. Merchants can also have a choice of providing a skip lane at the manual ordering station lane, so that the customers can bypass the manual order station and proceed to a self-ordering station.

Customers at the manual order station can place an order and make a payment through a credit/debit card reader or through a cash acceptor. The manual order station may be a remote ordering station where the customers use an intercom to place an order and pay using a credit or debit card reader or using a cash acceptor. The manual order station may also be an employee managed ordering station where the customers can use one or more real people to place an order and make the payment. Upon placing an order customers would wait in a waiting area to get a locker number from a large screen and proceed to the locker to pick up the order.

When the order is accepted the customer will be provided with an order receipt. The order receipt will include an order identifier. The order receipt may also include a one-time code to pick up the order. The customer may also be required to provide a mobile number. If the order management server is set up to send order identifier programmatically to parking lot server using order receive url and order receive url password provided to order management server, then the order management server would use a secured communication channel such as https post method to send order identifier.

The order management server would format the data as shown in FIG. 9A. The order management server would use an url, url password and network identifier provided to the order management service provider by the merchant or by the parking lot service provider in advance and order management server would use a secure communication channel such as https post method.

The url and url password provided to the order management service provider by the parking lot service provider are saved as ORDER_RECEIVE_URL and ORDER_RECEIVE_URL_PW in parking lot we interface table respectively and the url is also referred to as server order receive page.

For security reasons, if the order management server uses an unsecured communication channel such as http post, then the order management server may not be able to send the data. The order management server would format the data, for example as shown in FIG. 9A. Order management server would use merchant provided network identifier for OrderReceiveNetWorkId, ‘M’ for OrderReceiveOriginId, blank value for OrderReceiveStationId, order identifier for OrderReceiveOrderId and blank for OrderReceiveMobileNo if buyer mobile number is not known to the order management server or buyer mobile number for OrderReceiveMobileNo if buyer mobile number is known to the order management server and blank for OrderReceiveVehicleId if buyer vehicle license plate is not known to the order management server or buyer vehicle license plate for OrderReceiveVehicleId if buyer vehicle license plate is known to the order management server. Because the order was accepted from a merchant managing ordering station remotely or at the location, the value for OrderReceiveOriginId will be ‘M’ and the value for OrderReceiveStationId will be blank. If the order was sent by the order management server using the valid url and url password, then the server order receive page would receive the data. Upon receiving the data, the server order receive page will validate the received data. If the value of OrderReceiveNetWorkId received from the order management service provider is valid based on the data stored in parking lot we network table, if the received OrderReceiveOrderId does not exist in parking lot we merchant station status table and if the received OrderReceiveOrderId does not exist in parking lot we self-order station status table, then the server order receive page would insert a row into parking lot we merchant station status table using owner identifier for OWNER_ID, OrderReceiveNetWorkId for NETWORK_ID, OrderReceiveOrderId for ORDER_IDENTIFIER, 1 for STATUS SEQ, ‘W’ for STATUS, OrderReceiveOriginId for origin, OrderReceiveStationld for ORDER_STATION_ID, OrderReceiveMobileNo for ORDER_MOBILE_NO, OrderReceiveVehicleld for ORDER_VEHICLE_ID and current server date and time for DATETIME. The value of ‘M’ for ORIGIN would indicate that the order was received from merchant at the manual order station and the value of ‘O’ for ORIGIN would indicate that the order was an online order. The value of ‘W’ for STATUS would indicate that the order is in waiting status. If the data validation is successful and if the row insert in parking lot we merchant station status table is successful, then the server order receive page would respond with a return code ‘1’ and with a successful message. An example for a successful message may be “Order is accepted”. If the data validation is not successful or the row insert into parking lot we merchant station status table is not successful, then the server order receive page would respond with return code other than ‘1’ depending on the error and with an error message. An example for an error message may be “Order identifier already exists”. An example of response is shown in FIG. 9R.

Merchants can also add order identifier to parking lot server using order entry form provided by parking lot server as shown in FIG. 13B. The merchant order entry form will be presented to the merchant only after a successful log into parking lot server by the merchant. Merchant would use owner identifier, network identifier and password that are already known to the merchant to log into parking lot server.

Merchant would select the option “Manual Ordering Station Order” for origin because the order was placed at manual ordering station at the location, enter Order Identifier in the input button and click or tap on “Save” button. The order identifier is same as the order identifier that the merchant received from order management service provider when the merchant placed an order with order management service provider. When the “Save” button is clicked or tapped the form would send owner identifier as Ownerld, network identifier as Networld, origin selected by the merchant as OriginId, the order identifier entered by the merchant as OrderID and blank value for StationId to the parking lot server. If origin selected by the merchant is “Manual Ordering Station Order”, then the form would send “M” as OriginId. Blank value for StationId is used because self-order station identifier is not known at the time of adding an online order or self-order station identifier is not valid for orders placed at manual ordering station at the location.

Upon receiving the data from the order entry form 13B, the parking lot server would validate the data. If the values of Ownerld and NetworkId received from the form are valid based on the data stored in parking lot we network table, if the received OrderId does not exist in parking lot we merchant station status table, if the received OrderId does not exist in parking lot we self-order station status table, if the received OrderId is not blank and if the received StationId is blank then the parking lot server would insert a row into parking lot we merchant station status table using received Ownerld for OWNER_ID, received NetworkId for NETWORK_ID, received OrderId for ORDER_IDENTIFIER, 1 for STATUS_SEQ, ‘W’ for STATUS, received OriginId for ORIGIN, received MobileNo for ORDER_MOBILE_NO, received StationId for ORDER_STATION_ID and current server date and time for DATETIME. The value for ‘W’ for STATUS would indicate that the order is in waiting status. The value of ‘M’ for ORIGIN would indicate that the OrderId was received at manual order station. The value of ‘O’ for ORIGIN would indicate that the OrderId was received online. If the data validation is successful and the row insert in parking lot we merchant station status table is successful, then the parking lot server would respond with a successful message. The example for a successful message may be “Order is accepted”. If the data validation is not successful or the row insert into parking lot we merchant station status table is not successful, then the dah-thru parking lot service provider would respond with an error message depending on the type of error. The example for an error message may be “Order identifier already exists”.

After placing the order at the manual order station, the customers would be directed to a parking space in a waiting area where the customers would be able to see the status of their orders on one or more large screens. If the order is not displayed in the large screen then the customer would wait to see the order identifier displayed in the large screen. If the one-time code to pick up the order from the locker is the last few digits of the order identifier, then the order identifier without the last few digits used for one-time code will be displayed, otherwise the full order identifier will be displayed on the large screen.

When the order identifier and the locker number are displayed on the large screen, the customer would drive to the locker and pick up the order. If the one-time code to access the locker is the last few digits of the order identifier, then the customer would use the last few digits to access the locker. If the one-time code to access the locker is not the last few digits of the order identifier, then the customer would use a one-time code printed on the receipt. If the one-time code to access the locker is not the last few digits of the order identifier and if a one-time code is not printed on the receipt, then the customer would receive a one-time code as a text message to their mobile device or as a email message to their email. If the customer has made the payment using a mobile wallet such as apple pay, google pay, samsung pay, msl wallet and the like then the customer may use a biometric id such as fingerprint or face id and the like instead of using an one-time code. The method in which the customer would receive the one-time code or how the customer would unlock the smart lock attached to the pick up door is beyond the scope of this invention. It is sufficient to note that the parking lot server will not display the one-time code, if the one-time code is included in the order identifier.

When the order is accepted the merchant would receive the order information from order management server including order identifier on a receipt or on a digital screen and the merchant would process the order based in the order in which the order receipt was printed or in the order in which the order is displayed in the digital screen or in any other order. Merchants may be able to process unlimited number of orders simultaneously.

Customers at the self-order station (self-ordering station) can place an order and/or sign-in to pick up an order already placed. Customers entering any self-order station will view a self-order station identifiers, QR Code, additional text and additional hardware as shown in FIG. 6. When the customer scans the QR Code displayed at the self-order station using a mobile device as shown in FIG. 6, server self-order station page hosted by parking lot server would receive the parameter QAT_Code which will have the values for application identifier, network identifier and self-order station identifiers and then the server self-order station page will decide, based on merchant setup, whether to present order with auto sign-in customer form to the customer to make a selection between placing an order with an auto sign-in or picking up an already placed order as shown in FIG. 14A also referred to as form 14A or to present order with manual sign-in customer form to the customer to make a selection between placing an order or to pick up an order already placed order as shown in FIG. 14B also referred to as form 14B or to present a sign-in customer form to the customer to enter an order identifier of an order already placed order as shown in FIG. 14C also referred to as form 14C. When a customer chooses ‘Sign-in to Pickup Already Placed Order’ in form 14A or choose ‘Sign-in for Order Pickup (Place Order Before Sign-in)’ in form 14B, customers will be directed to a sign-in customer form which is form 14C.

When the customer scans the QR Code displayed at the self-order station using a mobile device as shown in FIG. 6, the server self-order station page would receive the parameter QAT_Code which is a ‘-’ delimited string having 3 nodes with values for application identifier, network identifier and self-order station identifier respectively. The application identifier ‘202’ would direct the server self-order station page to process the QR Code displayed at the self-order station. Then the server self-order station page would retrieve a single row from parking lot we network table using network identifier. If the server self-order station page retrieves a single row then the server self-order station page would save the value of OWNER_ID in the retrieved row as owner identifier and process the request, otherwise the server self-order station page will not process the request.

Then server self-order station page will try to retrieve a single row from parking lot we self-order station using owner identifier for OWNER_ID, network identifier for NETWORK_ID and self-order station identifier for ORDER_STATION_ID. If the server self-order station page retrieves a single row, then the server self-order station page will process the request, otherwise the server self-order station page will not process the request.

The server self-order station page will try to retrieve a single row from parking lot we interface table using owner identifier for OWNER_ID and network identifier for NETWORK_ID. If the server self-order station page retrieves a single row and the values of ORDER_STATION_URL, ORDER RECEIVE_URL and ORDER_RECEIVE_URL_PW in the retrieved single row are not blank, then the customers will be presented with form 14A to make a selection between placing an order with an auto sign-in or picking up an already placed order. If the server self-order station page retrieves a single row and the values of ORDER_STATION_URL is not blank, but the values of ORDER RECEIVE_URL or ORDER_RECEIVE_URL_PW is blank in the retrieved single row, then the customers will be presented with form 14B to make a selection between placing an order or picking up an already placed order. If the server self-order station page is not able to retrieve a single row or if the values of ORDER_STATION_URL is blank in the retrieved single row, then the customers will be presented with form 14C to enter an order number to sign-in to pick up an already placed order. ORDER_STATION_URL is also referred to as order url.

When the customer is directed to form 14A or to form 14B or form 14C, the forms would receive the values for owner identifier, network identifier and self-order station identifier. When the customer clicks or tabs on ‘PROCEED’ button in form 14A or ‘PROCEED’ button in form 14B or ‘SAVE’ button in form 14C, the forms will also forward the values of owner identifier, network identifier and self-order station identifier to process the form.

When the customer selects ‘Place an Order with Auto Sign-in to Pickup’ and clicks or tabs ‘PROCEED’ button in form 14A or when the customer selects ‘Place an Order’ and clicks or tabs ‘PROCEED’ button in form 14B, the server self-order station page would redirect the customer to order url with the parameters ownerid, networkid, stationed and originid. The values of owner identifier, network identifier and self-order station identifier will be used to populate the parameters ownerid, networkid, and stationid respectively. Since the customer was redirected from a self-order station, ‘Q’ will be used to populate the parameter originid.

When the order entry is complete, the order management server would create a unique order identifier and the customer would be presented with an electronic receipt that would include the order identifier. The customer may also receive the order identifier electronically as a text message or through an email or any other means. The way in which an order identifier is passed on to customers by the order management server is beyond the scope of this invention. It is sufficient to note that when the order entry is complete, the order management server would create a unique order identifier that will be passed on to customers.

When an order entry is complete and if the order management server is provided by the order management service provider with an order receive url, an order receive url password and a network identifier, if the networkid received by the order management server as parameter of the order url is equal to network identifier provided to the order management server in advance then the order management server would send order identifier to order receive url using order receive url password.

The data being sent by the order management server would include the value of networkid as OrderReceiveNetworkld, originid as OrderReceiveOriginId, stationid as OrderReceiveStationld, order identifier as OrderReceiveOrderId, blank for OrderReceiveMobileNo if buyer mobile number is not known to the order management server or buyer mobile number for OrderReceiveMobileNo if buyer mobile number is known to the order management server and blank for OrderReceiveVehicleId if buyer vehicle license plate is not known to the order management server or buyer vehicle license plate for OrderReceiveVehicleId if buyer vehicle license plate is known to the order management server as shown in FIG. 9A. The order identifier is the order number created by the order management server.

If the order receive url and order receive url password are valid url and valid password respectively to access order receive url hosted by the parking lot server to receive order data from order management server, then order receive url will receive the data. The order receive url is also referred to as server order receive page. The server order receive page would receive OrderReceiveNetworkld, OrderReceiveOriginId, OrderReceiveStationld, OrderReceiveOrderId and OrderReceiveMobileNo as shown in FIG. 9A. The server order receive page would verify the value OrderReceiveOriginId based on the value of OrderReceiveStationld. Value of ‘Q’ for OrderReceiveOriginId and a value other than blank for OrderReceiveStationId or value of ‘M’ for OrderReceiveOriginId and a blank for OrderReceiveStationId or value of ‘O’ for OrderReceiveOriginId and blank for OrderReceiveStationId would be valid. If the values of OrderReceiveOriginId and of OrderReceiveStationId are valid, then server order receive page will process the input, otherwise the server order receive page will terminate the process.

Then the server order receive page would verify the value of OrderReceiveNetworkId by retrieving one row from parking lot we network table using OrderReceiveNetworkId for NETWORK_ID. If the server order receive page retrieves one row then server order receive page would save the value of OWNER_ID from the retrieved row as owner identifier, otherwise the server order receive page will terminate the process.

If the value of OrderReceiveOriginId is ‘Q’ then the server order receive page would verify the value OrderReceiveStationld, otherwise the server order receive page would not verify the value of OrderReceiveStationld. The server order receive page would verify the OrderReceiveStationId by retrieving one row from parking lot we self-order station table using owner identifier for OWNER_ID, OrderReceiveNetworkld for NETWORK_ID and OrderReceiveStationId for ORDER_STATION_ID. If the server order receive page retrieves one row, then the input will be processed, otherwise the input will not be processed.

Since, the the order management server will be creating unique order identifier for each order, the OrderReceiveOrderId will not exist in parking lot we self-order station status table or in parking lot we merchant station status table.

If OrderReceiveOriginld is ‘Q’, then the server order receive page will insert a new row into parking lot we self-order station status table using owner identifier for OWNER_ID, OrderReceiveNetworkId for NETWORK_ID, OrderReceiveStationld for ORDER_STATION_ID, 1 or the maximum value of STATUS_SEQ for the same OWNER_ID, for the same NETWORK_ID, for the same ORDER_STATION_ID plus 1 for STATUS_SEQ, OrderReceiveOrderId for ORDER_IDENTIFIER, OrderReceiveMobileNo for ORDER_MOBILE_NO, ‘N’ for READY_INDICATOR_YN and current data and time for DATETIME. The value of 1 for STATUS_SEQ will be used when a row does not exist in parking lot we self-order station status table where OWNER_ID is equal to owner identifier, NETWORK_ID is equal to OrderReceiveNetworkId and ORDER_STATION_ID is equal to OrderReceiveStationId at the time of inserting the row. The value of ‘N’ for READY_INDICATOR_YN would indicate that the order is not yet ready for pickup.

If OrderReceiveOriginId is not ‘Q’, then the server order receive page will insert a new row into parking lot we self-order station merchant station status table using owner identifier for OWNER_ID, OrderReceiveNetworkId for NETWORK_ID, OrderReceiveOrderId for ORDER_IDENTIFIER, 1 for STATUS_SEQ, ‘W’ for STATUS indicating that the order is in waiting status for the customer to sign-in to pick up, using OrderReceiveOriginId for ORIGIN, OrderReceiveMobileNo for ORDER_MOBILE_NO, OrderReceiveStationld for ORDER_STATION_ID and server datetime for DATETIME. A value of 1 is used for STATUS_SEQ, because a row with the values of owner identifier for OWNER_ID, OrderReceiveNetworkId for NETWORK_ID and OrderReceiveOrderId for ORDER_IDENTIFIER would not have existed in parking lot we merchant station status table at the time of inserting the row.

When an order entry is complete and if the order management server is not provided by the order management service provider with an order receive url or an order receive url password or a network identifier, then the consumer after completing the order entry would be presented with form 14B. Then the customer could select the option ‘Sign-in for Order Pickup (Plae Order Before Sign-in)’ and tap or click on ‘Proceed’ button to access the form 14C.

At the time of presenting form 14C to the customer, form 14C would also receive the values for owner identifier, network identifier and self-order station identifiers. When the customer enters an order identifier and clicks or tabs on “Save” button in form 14C, the form 14C would execute server signin process stored in the parking lot server using the values of owner identifier, network identifier, self-order station identifier and order identifier as input and receive a response. Order identifier is the data entered by the customer for order identifier in form 14C.

The customer can also send self-order station location displayed at the self-order station as shown in FIG. 6 and an order identifier that the customer wants to pick up thru a text message to a phone number displayed at the self-order station. The text message may be in a particular format such as a ‘-’ delimited text having 2 nodes and the first node will be for self-order station location and the second node will be for order identifier. The self-order station may display instructions on how to format the text message. Incoming and outgoing text messages will be processed by server text message routine stored in the parking lot server. Since the phone number is unique for each location, the server text message routine stored in the parking lot server would verify the to phone number of the text message by retrieving one row from parking lot we network table using to phone number of the text message for PHONE_NO. If the server text message routine retrieves one row, then the server text message routine would save OWNER_ID and NETWORK_ID as owner identifier, network identifier respectively, otherwise the input will not be processed. Then the server text message routine would parse the received text and save the value in the first node as self-order station identifiers and the value in the second node as order identifier. Self-order station identifiers is same as self-order station location.

If the parsing of the received text is successful and values for self-order station identifiers and order identifier are saved then the server text message routine would verify the self-order station identifiers by retrieving a row from parking lot wc self-order station table using owner identifier for OWNER_ID, network identifier for NETWORK_ID and self-order station location for ORDER_STATION_ID.

If the server text message routine retrieves a row from parking lot we self-order station table, then the server text message routine would execute server signin process stored in the parking lot server using the values of owner identifier, network identifier, self-order station identifier (self-order station location) and order identifier as input and receive a response, otherwise the server text message routine will return an error message and terminate. Then the server text message routine may forward the response as a response to the text message received.

The customer can also send self-order station location displayed at the self-order station as shown in FIG. 6 and an order identifier that the customer wants to pick up thru an IVR (Interactive Voice Response) system to a phone number displayed at the self-order station. Incoming and outgoing IVR messages will be processed by server IVR message routine stored in the parking lot server. Since the phone number is unique for each location, the server IVR message routine would verify the to phone number of the IVR call by retrieving one row from parking lot we network table using to phone number of the IVR call for PHONE_NO. If the server IVR message routine retrieves one row, then the server IVR message routine would save OWNER_ID and NETWORK_ID as owner identifier, network identifier respectively, otherwise the input will not be processed. Then the server IVR message routine would accept values for self-order station location and order identifier verbally from the caller. Self-Order station location is same self-order station identifier. Then the server IVR message routine would verify the self-order station identifier by retrieving a row from parking lot we self-order station table using owner identifier for OWNER_ID, network identifier for NETWORK_ID and self-order station identifier for ORDER_STATION_ID. If the server IVR message routine retrieves a row from parking lot we self-order station table, the server IVR message routine would execute server signin process stored in the parking lot server using the values of owner identifier, network identifier, self-order station identifier and order identifier as input and receive a response, otherwise the IVR message routine will return an error message to the caller of the IVR call. The response will have 2 segments and the server IVR message routine may verbally deliver the text in the second segment to the caller of the IVR call.

The customer can also present an order identifier QR Code received from order management service provider or delivery management service provider to a scanner installed at a self-order station. Whenever a QR Code is presented to the scanner installed in a self-order station, the network self-order station scanner routine in the network controller would receive the scanned data and the network slot number connecting the self-order station to the network controller. Then the network self-order station scanner routine in the network controller would send network identifier, network password, network slot number and the scanned data to an url, also referred to as server slot scanner page, hosted by the parking lot server using an https post method and receive a response. The server slot scanner page would then verify the network password and the network identifier, by retrieving one row from parking lot we network table using network identifier for NETWORK_ID and network password for NETWORK_PASSWORD. If the server slot scanner page retrieves one row, then the server slot scanner page would save OWNER_ID as owner identifier, otherwise the input will not be processed. Since the network slot identifier is unique for each self-order station identifiers, the server slot scanner page would verify the network slot identifier, by retrieving one row from parking lot we self-order station table using owner identifier for OWNER_ID, network identifier for NETWORK_ID and network slot identifier for NETWORK_SLOT_ID. If the server slot scanner page retrieves one row, then the server slot scanner page would save ORDER_STATION_ID as self-order station identifier, otherwise the input will not be processed. Then the server slot scanner page would save scanned data as order identifier and execute server signin process stored in the parking lot server using the values of owner identifier, network identifier, self-order station identifier and order identifier as input and receive a response. Then the server slot scanner page would send the received response as a response to the request received by the server slot scanner page. When network self-order station scanner routine receives the response, the network self-order station scanner routine would parse the response. If the response has 2 segments, then the network self-order station scanner routine would convert the text in the second segment into voice and send the voice to the speaker in the help line connected to the same slot as the scanner was connected. If the response has 2 segments, and if the value in the first segment is 1, then the network self-order station scanner routine would execute network self-order station display routine to update ready indicator and mini screen in the self-order station.

Whenever a vehicle drives into a self-order station, the license plate reader installed at the self-order station will capture the vehicle's license plate and the network self-order station license plate routine in the network controller would receive the vehicle identifier and the network slot number connecting the self-order station to the network controller. Then the network self-order station license plate routine in the network controller would send network identifier, network password, network slot number and the vehicle identifier to an url, also referred to as server slot license plate page, hosted by the parking lot server using an https post method and receive a response. The server slot license plate page would then verify the network password and the network identifier, by retrieving one row from parking lot we network table using network identifier for NETWORK_ID and network password for NETWORK_PASSWORD. If the server slot license plate page retrieves one row, then the server slot license plate page would save OWNER_ID as owner identifier, otherwise the input will not be processed. Since the network slot identifier is unique for each self-order station identifier, the server slot license plate page would verify the network slot identifier, by retrieving one row from parking lot we self-order station table using owner identifier for OWNER_ID, network identifier for NETWORK_ID and network slot identifier for NETWORK_SLOT_ID. If the server slot license plate page retrieves one row, then the server slot license plate page would save ORDER_STATION_ID as self-order station identifier, otherwise the input will not be processed. Then the server slot license plate page would verify the license plate by retrieving one row from parking lot we merchant station status table using owner identifier for OWNER_ID, network identifier for NETWORK_ID, ORDER_IDENTIFIER is not blank, STATUS_SEQ is the most recent STATUS_SEQ for the same OWNER_ID, NETWORK_ID and ORDER_IDENTIFIER, ‘W’ for STATUS, ‘O’ for ORIGIN and vehicle identifier for ORDER_VEHICLE_ID. If the server slot license plate page retrieves one row, then the server slot license plate page would save ORDER_IDENTIFIER as order identifier, otherwise the input will not be processed. Then the server slot license plate page would execute server signin process stored in the parking lot server using the values of owner identifier, network identifier, self-order station identifier and order identifier as input and receive a response. Then the server slot license plate page would send the received response as a response to the request received by the server slot license plate page. When network self-order station license plate routine receives the response, the network self-order station license plate routine would parse the response. If the response has 2 segments, then the network self-order station license plate routine would convert the text in the second segment into voice and send the voice to the speaker in the help line connected to the same slot as the license plate reader was connected. If the response has 2 segments, and if the value in the first segment is 1, then the network self-order station license plate routine would execute network self-order station display routine to update ready indicator and mini screen in the self-order station.

When server signin process is executed, server signin process will receive values for 4 inputs namely owner identifier, network identifier, self-order station identifier and order identifier and will start building a response from blank response.

The server signin process would return a response in 2 segments. If the value in the first segment is 1, then the response is a successful response. If the value in the first segment is not 1, then the response is an error response. The text in the second segment will be text as a successful message if the response was a successful response. The text in the second segment will be reason for the error if the response was an error response.

The server signin process would verify self-order station identifier by retrieving one row from parking lot we self-order station table using owner identifier for OWNER_ID, network identifier for NETWORK_ID and self-order station identifier for ORDER_STATION_ID. If the server signin process retrieves one row then the process of building a response will continue, otherwise server signin process would return an error message and terminate.

Then the server signin process would verify that the self-order station is available by retrieving a row from we self-order station status table using owner identifier for OWNER_ID, network identifier for NETWORK_ID, self-order station identifier for ORDER_STATION_ID and ORDER_IDENTIFIER is blank in the most recent row of STATUS_SEQ for the same OWNER_ID, NETWORK_ID and ORDER_STATION_ID. If the server signin process retrieves one row then the process of building a response will continue, otherwise server signin process would return an error message and terminate.

Then the server signin process would verify that the order identifier does not exist in parking lot we self-order station status table by retrieving rows from parking lot we self-order station status table using owner identifier for OWNER_ID, network identifier for NETWORK_ID and order identifier for ORDER_IDENTIFIER. If the server signin process retrieves at least one row from parking lot we self-order station status table, then the server signin process would return an error message and terminate, otherwise the server signin process will continue.

Then the server signin process would verify that the order identifier does not exist in parking lot we merchant station status table as a manual order by retrieving at least one row from parking lot we merchant station status table using owner identifier for OWNER_ID, network identifier for NETWORK_ID, order identifier for ORDER_IDENTIFIER and ‘M’ for ORIGIN. If the server signin process retrieves at least one row from parking lot we merchant station status table, then the server signin process would return an error message and terminate, otherwise the server signin process will continue.

Then the server signin process would verify that the order identifier exists in parking lot we merchant station status table as an online order and waiting to be signed in by retrieving one row from parking lot we merchant station status table using owner identifier for OWNER_ID, network identifier for NETWORK_ID order identifier for ORDER_IDENTIFIER, ‘W’ for STATUS, ‘O’ for ORIGIN and blank for ORDER_STATION_ID in the most recent row of STATUS_SEQ for the same OWNER_ID, NETWORK_ID and ORDER_IDENTIFIER. If the server signin process retrieves one row from parking lot we merchant station status table, then the server signin process would save the value of ORIGIN from the retrieved single row as origin, save the value of ORDER_MOBILE_NO from the retrieved single row as order mobile number, save the value of ORDER_VEHICLE_ID from the retrieved single row as order vehicle identifier and save ‘M’ as source, otherwise server signin process would save blank for source.

If source is blank, then server signin process would verify that the order identifier is valid. To verify the validity of order identifier, server signin process would retrieve one row from parking lot we interface table using owner identifier for OWNER_ID and network identifier for NETWORK_ID. If the server signin process retrieves one row from parking lot we interface table, and the values of ORDER_SEND_URL and ORDER_SEND_URL_PW are not blank, then server signin process would save the values of ORDER_SEND_URL and ORDER_SEND_URL_PW as order send url and order send url password, otherwise save ‘S’ as source to indicate that verifying the order identifier with order management server is not required.

If source is blank, then server signin process would verify the order identifier by communicating with order management server using the format as shown in 10A. The server signin process would use network identifier for OrderSendNetworkId, ‘I’ for OrderSendRequestType because the process is an inquiry, order identifier for OrderSendOrderId, blank for OrderSendOneTimeCode, blank for OrderSendMobileNo, blank for OrderSendExternalId and blank for OrderSendInternalId and send the request to order send url using order send url password as password. If the server signin process receives a response and the response is in the format as shown in FIG. 10R and if the OrderSendResponseCode is ‘1’, then server signin process would save ‘S’ as source.

If source is blank, then server signin process would return an error message and terminate.

Then the server signin process would insert a row into parking lot we self-order station status table using owner identifier for OWNER_ID, network identifier for NETWORK_ID, self-order station identifier for ORDER_STATION_ID, 1 or the maximum value of STATUS_SEQ for the same OWNER_ID, for the same NETWORK_ID, for the same ORDER_STATION_ID plus 1 for STATUS_SEQ, order identifier for ORDER_IDENTIFIER, order mobile number for ORDER_MOBILE_NO, order vehicle identifier for ORDER_VEHICLE_ID, ‘N’ for READY_INDICATOR_YN and current server date and time for DATETIME. The value of 1 for STATUS_SEQ will be used when a row does not exist in parking lot we self-order station status table where OWNER_ID is equal to owner identifier, NETWORK_ID is equal to network identifier and ORDER_STATION_ID is equal to self-order station identifier at the time of inserting a row into parking lot we self-order station status table. If row insert into parking lot we self-order station status table is successful, then server signin process would continue, otherwise it would return an error message and terminate.

If source is ‘M’ and if row insert into parking lot we self-order station status table is successful, then server signin process would also insert a row into parking lot we merchant station status table to indicate that the order identifier has been moved from parking lot we merchant station status table to parking lot we self-order station status table.

If source is ‘M’ and if row insert into parking lot we self-order station status table was successful, then the server signin process would insert a row into parking lot we merchant station status table using owner identifier for OWNER_ID, network identifier for NETWORK_ID, order idetifier for ORDER_IDENTIFIER, the maximum value of STATUS_SEQ for the same OWNER_ID, for the same NETWORK_ID, for the same ORDER_IDENTIFIER plus 1 for STATUS_SEQ, ‘M’ for STATUS, origin for ORIGIN, order mobile number for ORDER_MOBILE_NO, order vehicle identifier for ORDER_VEHICLE_ID, self-order station identifier for ORDER_STATION_ID and current server date and time for DATETIME. If row insert into parking lot we merchant station status table is successful, then server signin process would continue, otherwise it would return an error message and terminate. The value of ‘M’ for STATUS would indicate the the order identifier has been moved from into parking lot we merchant station status table to into parking lot we self-order station status table.

If the process of building the response continued, the server signin process would respond with a successful response.

When a new row is inserted into parking lot we self-order station status table, then the order identifier and self-order station identifier will be displayed on the large screen when the large screen is refreshed as shown in FIG. 7A. The virtual terminal would refresh the content on the large screen whenever a row is inserted into parking lot we self-order station status table and/or based on LARGE_SCREEN_POLLING_TIME saved in parking lot we network table.

When a new row is inserted into parking lot we self-order station status table, then the ready indicator and display on the mini screen will be updated as shown in FIG. 6. The network self-order station display routine in the network controller would receive the data from parking lot server and would update ready indicator and the display on the mini screen in the self-order station whenever a row is inserted into parking lot we self-order station status table and/or based on ORDER_STATION_POLLING_TIME saved in parking lot we network table.

Those of ordinary skill in the art will readily recognize many possibilities exist in parking lot we automation and method for customers to send order identifier and self-order station location to parking lot server, especially considering the illustrations provided herein.

When an order is ready and before moving the order from drop-off point to pick up point, the merchant would send the order identifier and the transporter identifier to the parking lot server using a web site order drop request form in a web site as shown in FIG. 15A or using an app order drop request form in a merchant app provided by the parking lot server as shown in FIG. 15B.

To access web site order drop request form, merchant would use any mobile device or desktop computer or laptop computer to log into parking lot server using the values provided by the parking lot service provider to the merchant for owner identifier, network identifier and network password. After logging in, when website order drop request form is accessed, the order drop request form would also receive owner identifier and network identifier from parking lot server and the order drop request form would save ‘D’ as access type.

To access the app order drop request form in the merchant app, merchant would select order drop request option in the merchant app. When app order drop request form is accessed, the app order drop request form would also receive owner identifier and network identifier saved in the merchant app at the time of activating the merchant app and the app order drop request form would save ‘D’ as request type.

The merchant can use website order drop request form to select a locker that is currently available based on data in parking lot we transporter status table and enter the order identifier to receive permission to move the order from drop-off point to pickup point.

To get the list of locker that is currently available, the website order drop request form would retrieve all the rows from parking lot we transporter status table using owner identifier for OWNER_ID, network identifier for NETWORK_ID, TRANSPORTER_ID is not blank, the most recent sequence of STATUS_SEQ for the same OWNER_ID, NETWORK_ID and TRANSPORTER_ID for STATUS_SEQ and blank for ORDER_IDENTIFIER. The values of TRANSPORTER_ID of all the retrieved rows would be the list of lockers that is currently available. Then the website order drop request form would also retrieve the value of EXTERNAL_ID using the values of TRANSPORTER_ID from parking lot we transporter table.

When the merchant selects a locker that is currently available in website order drop request form, the parking lot server would display only the external identifier which is the number of the locker, but will capture the values of transporter identifier of the selected locker as shown in parking lot we transporter table. When the merchant clicks on taps on ‘Proceed’ button in the website order drop request form, the parking lot server would execute server order drop request routine programmed in the parking lot server using owner identifier, network identifier, transporter identifier, order identifier and request type as inputs for the server order drop request routine.

The merchant can use app order drop request form to scan a QR Code displayed at the drop-off point where the displayed QR Code will have an application identifier, network identifier and the transporter identifier, to scan the QR Code printed on the order receipt where the printed QR Code will have order identifier and save ‘D’ as request type. The mobile merchant app would compare the network identifier and the transporter identifier from the scanned QR Code displayed at the drop-off point and the owner identifier and network identifier saved in the app at the time of activating the merchant app. If they are not the same, then the merchant app will not process the app order drop request form. The QR Code printed on the receipt will have the order identifier. When the merchant clicks or taps on ‘Proceed’ button in the app order drop request form, the app would execute server order drop request routine programmed in the parking lot server using owner identifier, network identifier, transporter identifier, order identifier and request type.

When the server order drop request routine is executed, the server order drop request routine would verify the received inputs and if the received inputs are valid then the server order drop request routine would insert a row into parking lot we request queue table and send a success message as return response, otherwise the server order drop request routine would send an error message as response or will not sent any response. The success message may be a message granting permission for the merchant to drop the order at the drop-off point. The error message would depend on the type of error. The value of ‘D’ for request type would indicate that the request is from order drop request form.

The inputs and responses may be based on the specification provided by the parking lot service provider for server order drop request routine. The return response will have at a minimum 2 pieces of information where the first piece is return code and the second piece of information will be display message. The return code will be used for further processing whereas the display message will be displayed as a response.

If the server order drop request routine received 5 inputs, then the server order drop request routine would save the 5 inputs as owner identifier, network identifier, transporter identifier, order identifier and request type respectively, otherwise the server order drop request routine will end the routine execution and will not send any message as return response.

To verify the inputs, the server order drop request routine would confirm that the owner identifier and network identifier are valid, the transporter identifier is valid, the transporter identifier is empty, the order identifier is an order from manual order station and waiting to pick up or the order identifier is an online order and not signed in for pick up or the order identifier is an order placed and signed in at self-order station and waiting to pick up or an online order and signed in at a self-order station and waiting to pick up.

Then the server order drop request routine would try to retrieve a row from parking lot we transporter table using owner identifier for OWNER_ID, network identifier for NETWORK_ID and transporter identifier for TRANSPORTER_ID. This will ensure that the transporter identifier is valid. If the server order drop request routine retrieves a row, then the server order drop request routine will continue, otherwise it will return an error message and terminate.

Then the server order drop request routine would try to retrieve a row from parking lot we transporter status table using owner identifier for OWNER_ID, network identifier for NETWORK_ID, transporter identifier for TRANSPORTER_ID, the maximum row of STATUS_SEQ for the same OWNER_ID, NETWORK_ID and TRANSPORTER_ID for STATUS_SEQ and blank for ORDER_IDENTIFIER. This will ensure that the transporter identifier is empty. If the server order drop request routine retrieves a row, then the server order drop request routine will continue, otherwise it will return an error message and terminate.

Then the server order drop request routine would try to retrieve a row from parking lot we merchant station status table, using owner identifier for OWNER_ID, network identifier for NETWORK_ID, order identifier for ORDER_IDENTIFIER, the maximum row of STATUS_SEQ for the same OWNER_ID, NETWORK_ID and ORDER_IDENTIFIER for STATUS SEQ, ‘W’ for STATUS, ‘M’ or ‘O’ for ORIGIN and blank for ORDER_STATION_ID. This will ensure that the order identifier is from manual order station and waiting to pick up or the order identifier is an online order and not signed in for pick up. If the server order drop request routine is not able to retrieve a row then the server order drop request routine will try to retrieve a row from parking lot we self-order station status table using owner identifier for OWNER_ID, network identifier for NETWORK_ID, ORDER_STATION_ID is not blank, the maximum row of STATUS_SEQ for the same OWNER_ID, NETWORK_ID and ORDER_STATION_ID for STATUS_SEQ, order identifier for ORDER_IDENTIFIER and ‘N’ for READY_INDICATOR_YN’. This will ensure that the order identifier is an order placed and signed in at self-order station and waiting to pick up or an online order and signed in at a self-order station and waiting to pickup. If the server order drop request routine retrieves a row from parking lot we merchant station status table or retrieves a row from parking lot we self-order station status table then the server order drop request routine will save the value of ORDER_MOBILE_NO from the retrieved row as order mobile number and continue, otherwise it will return an error message and terminate.

Then the server order drop request routine will insert a new row in parking lot we request queue table using owner identifier for OWNER_ID, network identifier for NETWORK_ID, transporter identifier for TRANSPORTER_ID, 1 or maximum value of REQUEST_SEQ for the same OWNER_ID, for the same NETWORK_ID and for the same TRANSPORTER_ID plus 1 for REQUEST_SEQ, request type for REQUEST_TYPE, order identifier for ORDER_IDENTIFIER, ‘A’ for STATUS and server date & time for DATETIME. Note that, if the parking lot we request queue table does not have any row, then a row will be inserted using 1 as REQUEST_SEQ. If the parking lot server can insert a new row, then the server order drop request routine will respond with a success message otherwise it will report the problem to parking lot server administrator and respond with an error message. The success message will be 2 segments and the value of the first segment will be ‘1’ and the value of the second segment will be the order mobile number. The order mobile number can be blank.

When the merchant gets permission to move the order from drop-off point to pickup point using the selected locker, then the merchant would place the order on top of the mover and close the drop-off door. In some embodiments a drop-off switch ‘3’ will be mounted to the frame of the drop-off door and in others a drop-off switch ‘3’ will be mounted outside the drop-off door. If the drop-off switch ‘3’ is mounted to the frame of the drop-off door, then the drop-off switch ‘3’ will be activated when the drop-off door is closed. If the drop-off switch ‘3’ is not mounted to the frame of the drop-off door, then the drop-off switch ‘3’ will be activated manually by the merchant. When the drop-off switch ‘3’ is activated a signal through the connector ‘5’ will be sent to the transporter controller indicating that the order is dropped off. The transporter controller ‘17’ would then send a request to the network mover routine residing inside the programmable firmware that is embedded in the network controller ‘30’ through transporter connector ‘18’. The request would include the transporter identifier and a request type. If transporter controller ‘17’ received the signal thru the connector ‘5’ then the request type will be ‘D’ indicating that request is to move the transporter from drop-off point to pick up point. The transporter controller ‘17’ would receive a response from network mover routine. The response will be in a segmented format and if the value in the first segment is ‘1’, then the transporter controller would activate the mover forward drive switch ‘7’ using mover forward drive switch connector ‘9’ and the transporter fitted on a mover lift platform ‘11’ will move the order from drop-off point to pick up point. The transporter controller ‘17’ would also use up connector ‘12’ to raise mover lift platform as required in moving the transporter from drop-off point to pick up point. The transporter controller would also use down connector ‘13’ to lower mover lift platform as required in moving the transporter from drop-off point to pick up point.

If an interface to send data to order management server is set up and if order management server is set up to send data to smart lock management server, then smart lock management server would receive the locker internal identifier, one-time code and order mobile number when network mover routine is executed.

If an interface to send data to smart lock management server is set up and if last few digits of order identifier is one-time code, then smart lock management server would receive the locker internal identifier, one-time code and order mobile number when network mover routine is executed.

If an interface to send data to order management server and an interface to send data to smart lock management server are not set up, then the merchant would send the locker internal identifier, one-time code and order mobile number to the smart lock management server. Merchant may use an app provided by smart lock management service provider or a web site hosted by smart lock management server to send the smart lock internal identifier, one-time code and order mobile number to the smart lock management server.

When the smart lock management server receive smart lock internal identifier, one-time code and order mobile number, the smart lock management server may validate the smart lock internal identifier, one-time code and order mobile number, set the one-time code and the order mobile number as valid one-time code and valid one-time mobile number to unlock the smart lock. If one-time code is blank and if the order mobile number is valid the smart lock management server may even create a new one-time code, set the new one-time code and order mobile number as valid one-time mobile number respectively and text the new one-time code the order mobile number.

How the merchant would send the smart lock internal identifier, one-time code and order mobile number to smart lock management server or the internal details of operations of smart locks are beyond the scope of this invention.

A one-time code may also be printed on the receipt. The virtual terminal would also update the content of the display monitor accordingly.

When the locker is locked after an order has been picked up, if an interface to receive data from smart lock management server is set up, then smart lock management server would notify the parking lot server that the locker is locked after an order has been picked up and is available to load an order again. Then the parking lot server would activate the switch ‘34’ to move the transporter to drop-off point, if the transporter is still in the pickup point.

The smart lock management server would format data as shown in FIG. 11A using network identifier provided to the smart lock management service provider by the parking lot service provider for SmartLockReceiveNetworkld, the smart lock internal identifier known to the smart lock management server for SmartLockReceiveInternald and ‘P’ for SmartLockReceiveAction to indicate that the transporter needs to be moved from pickup point to drop-off point and communicate the formatted data in a secured communication to an url using an url password. The url and url password were provided to the smart lock management service provider in advance and saved in SMART_LOCK_RECEIVE_URL and SMART_LOCK_SERVICE URL_PW respectively in parking lot we interface table. The url is a page hosted by parking lot server and also referred to as server smart lock receive page.

When server smart lock receive page receives the data, the server smart lock receive page would validate the data and if the data is valid then insert a row into parking lot we merchant notification table. If the data is valid and a row has been inserted successfully, then server smart lock receive page would return a successful response, otherwise it will return an error response.

To validate SmartLockReceiveNetworkId, server smart lock receive page would retrieve a row from parking lot we network table using SmartLockReceiveNetworkld for NETWORK_ID. If server smart lock receive page retrieves one row, then server smart lock receive page would save the value of OWNER_ID in the retrieved row as owner identifier, otherwise the server smart lock receive page would return an error response and terminate.

To validate that the transporter has not moved from pick-up point, the server smart lock receive page would retrieve a row from parking lot we transporter status table using owner identifier for OWNER_ID, SmartLockReceiveNetworkld for NETWORK_ID. SmartLockReceiveInternald for TRANSPORTER_ID, maximum value of STATUS_SEQ for the same OWNER_ID, for the same NETWORK_ID and for the same TRANSPORTER_ID for STATUS_SEQ and ORDER_IDENTIFIER is not blank. If server smart lock receive page retrieves a row from parking lot we transporter status table, then server smart lock receive page would insert a row into parking lot we merchant notification table, otherwise server smart lock receive page would return an error response and terminate.

Then server smart lock receive page would insert a row into parking lot we merchant notification table using owner identifier for OWNER_ID, SmartLockReceiveNetworkld for NETWORK_ID, SmartLockReceiveInternalId for TRANSPORTER_ID, 1 or the maximum value of NOTIFICATION_SEQ for the same OWNER_ID, for the same NETWORK_ID, for the same ORDER_STATION_ID plus 1 for NOTIFICATION_SEQ and SmartLockReceiveAction for NOTIFICATION_ID indicating that the notification is active and server datetime for DATETIME.

If the insert of the row into parking lot we merchant notification table is successful, then server smart lock receive page would return a successful response, otherwise server smart lock receive page would return an error response. To return a successful response, server smart lock receive page would save ‘1’ for return code, a successful message for successful return message and a blank for error return message. To return an error response, server smart lock receive page would save a number other than ‘1’ for return code, a blank for successful return message and an error message for error return message.

The server smart lock receive page would format the response as shown in FIG. 11R using SmartLockReceiveNetworkId for SmartLockReceiveResponseNetworkId, SmartLockReceivelnternald for SmartLockReceiveResponselnternald, SmartLockReceiveAction for SmartLockReceiveResponseAction, return code for SmartLockReceiveResponseCode, success return message for SmartLockReceiveResponseSuccess and error return message for SmartLockReceiveResponseError.

The locker will have a pick up point switch ‘4’ attached to a pick up door at the pickup point or a pick up sensor ‘4’ attached to pick up point. Pick up point switch ‘4’ will be activated when the pickup door is closed. Pickup point sensor ‘4’ will be activated when a vehicle leaves the pickup point. The pickup point switch ‘4’ or the pickup point sensor ‘4’ will be connected to transporter controller using a pickup point switch or pickup point sensor connector ‘6’. The locker will also have a transporter return switch ‘34’ placed near drop-off point for the merchant to manually activate the transporter return switch ‘34’. The transporter return switch ‘34’ will be connected to transporter controller using a transporter return connector ‘35’. When a pickup point switch ‘4’ or pickup point sensor ‘4’ or transporter return switch ‘34’ is activated, the transporter controller ‘17’ will forward a signal to network controller through network connector ‘18’. The signal would include the value of the transporter identifier and ‘P’ as the value for request type.

When the merchant gets a notification in the virtual terminal that a locker has been locked after an order has been picked up and ready for the mover to move the transporter from pick up point to drop-off point, the merchant can activate the transporter return switch ‘34’ of transporter controller to move the transporter from pick up point to drop-off point.

The transporter controller ‘17’ would then send a request to the network mover routine residing inside the programmable firmware that is embedded in the network controller ‘30’ through transporter connector ‘18’. The request would include transporter identifier and a request type. If transporter controller ‘17’ received the signal thru the connector ‘6’ then the request type will be ‘P’ indicating that request is to move the transporter from pick up point to drop-off point. The transporter controller ‘17’ would receive a response from network mover routine. The response will be in a segmented format and if the value in the first segment is ‘1’, then the transporter controller would activate the mover backward drive switch ‘8’ using mover backward drive switch connector ‘10’ and the transporter fitted on a mover lift platform ‘11’ will move the transporter from pick up point to drop-off point. The transporter controller ‘17’ would also use an up connector ‘12’ to raise mover lift platform as required in moving the transporter from drop-off point to pick up point. The transporter controller would also use down connector ‘13’ to lower mover lift platform as required in moving the transporter from pick up point to drop-off point.

When the network mover routine receives a request with values for transporter identifier and the value for request type, then the network mover routine would use previously stored value of owner identifier, the value of network identifier, the value of network password, the value of server mover url. Then the network mover routine would use the server mover url to send the values of owner identifier, network identifier, network password, transporter identifier and request type to receive a response. The response will be in a segmented format and if the value in the first segment is ‘1’, then it will be a successful response, otherwise it will be an error response. If the response is a successful response, then network mover routine would execute network display routine. The network mover routine would return the response as a response to transporter controller.

When the server mover url page hosted by parking lot server receive values for parameters owner identifier, network identifier, network password, transporter identifier and request type, then the server mover url page would process the parameters and return a response, otherwise the server mover url page will terminate without sending any response.

Then the server mover url page would retrieve rows from parking lot we network table using owner identifier for OWNER_ID, network identifier for NETWORK_ID and network password for NETWORK_PASSWORD. If the server mover url page retrieves a single row from parking lot we network table, then server mover url page will save ONE_TIME_CODE_LENGTH in one time code length and continue the process, otherwise server mover url page will terminate without sending any response.

If request type is ‘D’ or ‘P’, then the server mover url page would continue the process, otherwise server mover url page will terminate without sending any response.

If server mover url page terminates with an error response, the error response will be a segmented response and the value in the first segment could be anything but ‘ ’1′ and the value in the second segment will be a reason for the error.

Then the server mover url page will retrieve rows from parking lot we request queue table using owner identifier for OWNER_ID, network identifier for NETWORK_ID, transporter identifier for TRANSPORTER_ID, maximum of REQUEST_SEQ for the same OWNER_ID, for the same NETWORK_ID, for the same TRANSPORTER_ID for REQUEST_SEQ, request type for REQUEST_TYPE and ‘A’ for STATUS. If the server mover url page retrieves a single row from parking lot we request queue table, then the server mover url page will save the value of ORDER_IDENTIFIER in the retrieved row as order identifier and continue the process, otherwise server mover url page will send an error response and terminate.

If request type is ‘D’ and if order identifier is blank then server mover url page will send an error response and terminate. If request type is ‘P’ and if order identifier is not blank then server mover url page will send an error response and terminate.

If request type is ‘D’, the server mover url page will determine the one time code. If the one time code length is 0, then the one time code will be blank. If the one time code length is above 0, then the one-time code will be the last one time code length of characters in the order identifier will be one time code.

Then the server mover url page will execute server mover forward routine or server mover backward routine. If request type is ‘D’, then the server mover url page will execute server mover forward routine with values for inputs owner identifier, network identifier, network password, transporter identifier, request type, order identifier and one time code and receive a response. If request type is ‘P’, then the server mover url page will execute server mover backward routine with values for inputs owner identifier, network identifier, network password, transporter identifier and request type and receive a response. If the server mover url page receives a response, then the server mover url page will return the response and end the process.

The server mover forward routine will verify whether it received values for inputs owner identifier, network identifier, network password, transporter identifier, request type, order identifier and one time code. If server mover forward routine did receive values for inputs owner identifier, network identifier, network password, transporter identifier, request type, order identifier and one time code, then the server mover forward routine will continue the process, otherwise it will terminate without sending any response. If request type is ‘D’, then server mover forward routine will continue the process, otherwise the server mover forward routine will terminate without sending any response.

Then the server mover forward routine will retrieve rows from parking lot we merchant station status table using owner identifier for OWNER_ID, network identifier for NETWORK_ID, order identifier for ORDER_IDENTIFIER, maximum of STATUS_SEQ for the same OWNER_ID, for the same NETWORK_ID, for the same ORDER_IDENTIFIER for STATUS SEQ, ‘W’ for STATUS and ‘M’ or ‘O’ for ORIGIN. If the server mover forward routine can retrieve a single row, then the server mover forward routine would save the value of ORIGIN as order identifier location type, value of ORDER_MOBILE_NO as order mobile number, and value of ORDER_VEHICLE_ID as order vehicle identifier from the retrieved row, otherwise the server mover forward routine would save ‘ ’ (blank value) for order identifier location type.

If order identifier location type is equal to ‘ ’, the server mover forward routine will retrieve rows from parking lot we self-order station status table using owner identifier for OWNER_ID, network identifier for NETWORK_ID, ORDER_STATION_ID is not blank, maximum of STATUS_SEQ for the same OWNER_ID, for the same NETWORK_ID, for the same ORDER_STATION_ID for STATUS_SEQ, order identifier for ORDER_IDENTIFIER and ‘N’ for READY_INDICATOR_YN. If the server mover forward routine retrieves a single row, then the server mover forward routine would save the value of ORDER_STATION_ID as self-order station identifier, value of ORDER_MOBILE_NO as order mobile number and value of ORDER_VEHICLE_ID as order vehicle identifier from the retrieved single row and ‘Q’ for order identifier location type.

If order identifier location type is not equal to ‘M’ and not equal to ‘O’ and not equal to ‘Q’, then the server mover forward routine will respond with an error message and terminate.

If order identifier location type is equal to ‘M’ or ‘O’, then the server mover forward routine will insert a new row into parking lot we merchant station status table, using owner identifier for OWNER_ID, network controller identifier for NETWORK_ID, order identifier for ORDER_IDENTIFIER, 1 or the maximum value of STATUS_SEQ for the same OWNER_ID, for the same NETWORK_ID, for the same ORDER_IDENTIFIER plus 1 for STATUS_SEQ, ‘L’ for STATUS, order identifier location type for ORIGIN, blank for ORDER_STATION_ID, order mobile number for ORDER_MOBILE_NO, order vehicle identifier for ORDER_VEHICLE_ID and server date and time for DATETIME. The value of ‘L’ for STATUS will indicate that the order is loaded into the locker. If the server mover forward routine cannot insert a new row, then the server mover forward routine will report the problem to the merchant, will respond with an error message and terminate.

If order identifier location type is equal to ‘Q’, then the server mover forward routine will insert a new row into parking lot we self-order station status table using owner identifier for OWNER_ID, network identifier for NETWORK_ID, self-order station identifier for ORDER_STATION_ID, 1 or the maximum value of STATUS_SEQ for the same OWNER_ID, for the same NETWORK_ID, for the same ORDER_STATION_ID plus 1 for STATUS_SEQ, order identifier for ORDER_IDENTIFIER, order mobile number for ORDER_MOBILE_NO, order vehicle identifier for ORDER_VEHICLE_ID, ‘Y’ for READY_INDICATOR_YN and server date and time for DATETIME. If the server mover forward routine cannot insert a new row, then the server mover forward routine will report the problem to the merchant, will respond with an error message and terminate.

Then the server mover forward routine would insert a new row into parking lot we transporter status table using owner identifier for OWNER_ID, network identifier for NETWORK_ID, transporter identifier for TRANSPORTER_ID, 1 or the maximum value of STATUS_SEQ for the same OWNER_ID, for the same NETWORK_ID, for the same TRANSPORTER_ID plus 1 for STATUS_SEQ, order identifier for ORDER_IDENTIFIER and server date and time for DATETIME. If the server mover forward routine cannot insert a new row, then the server mover forward routine will report the problem to the merchant, will respond with an error message and terminate.

Then the server mover forward routine would insert a new row into parking lot we request queue table using owner identifier for OWNER_ID, network identifier for NETWORK_ID, transporter identifier for TRANSPORTER_ID, the maximum value of REQUEST_SEQ for the same OWNER_ID, for the same NETWORK_ID, for the same TRANSPORTER_ID plus 1 for REQUEST_SEQ, ‘P’ for REQUEST_TYPE, blank for ORDER_IDENTIFIER, ‘A’ for STATUS and server date and time for DATETIME. ‘P’ for REQUEST_TYPE and ‘A’ for STATUS would indicate that the current request type ‘D’ (drop-off point to pick up point) has been processed and the new request type ‘P’ (pick up point to drop-off point) is active. If the server mover forward routine cannot insert a new row, then the server mover forward routine will report the problem to the merchant, will respond with an error message and terminate.

Then the server mover forward routine will notify the order management service provider, if an interface to send data to order management service provider is set up. The server mover forward routine would verify whether an interface with order management service provider is available by retrieving a single row from parking lot we interface table using owner identifier for OWNER_ID and network identifier for NETWORK_ID. If the server mover forward routine retrieves one row from parking lot we interface table and if the values of ORDER_SEND_URL and ORDER_SEND_URL_PW are not blank then the server mover forward routine would save the values of ORDER_SEND_URL, ORDER_SEND_URL_PW and ‘Y’ in order send url, in order send url password and in interface respectively, otherwise the server mover forward routine would save ‘N’ for interface. If the value of interface is ‘Y’, then the server mover forward routine would notify order management service provider that an order identifier has been moved from drop-off point to pick-up point of a transporter identifier. The server mover forward routine would get locker external identifier and locker internal identifier from parking lot we transporter table using owner identifier for OWNER_ID, network identifier for NETWORK_ID and transporter identifier for TRANSPORTER_ID. If server mover forward routine retrieves a single row from parking lot we transporter table, then the server mover forward routine would save the values of EXTERNAL_ID and PICKUP_LOCK_INTERNAL_ID into locker external identifier and locker internal identifier respectively and will send a notification as shown in FIG. 10A using order send url and order send url password, otherwise the server mover forward routine will report the problem to the merchant, will respond with an error message and terminate.

To send a notification to the order management service provider, the server mover forward routine would use network identifier for OrderSendNetWorkId, ‘L’ for OrderSendRequestType, order identifier for OrderSendOrderId, one time code for OrderSendOneTimeCode, order mobile number for OrderSendMobileNo, locker external identifier for OrderSendExternalId and locker internalal identifier for OrderSendInternalId. The value of ‘L’ for OrderSendRequestTye will indicate that the order identifier is loaded into locker. If the server mover forward routine receives a response, then the response will be in the format as shown in FIG. 10R. If the server mover forward routine receives a response and if the value for OrderSendResponseCode is not ‘1’ or if the server mover forward routine does not receive a response, then the server mover forward routine will report the problem to the merchant, will respond with an error message and terminate.

Then the server mover forward routine will notify the smart lock management service provider, if an interface to send data to smart lock management service provider is set up. The server mover forward routine would verify whether an interface with smart lock management service provider is available by retrieving one row from parking lot we interface table using owner identifier for OWNER_ID and network identifier for NETWORK_ID. If the server mover forward routine retrieves one row from parking lot we interface table and if the values of SMART_LOCK_SEND_URL and SMART_LOCK_SEND_URL_PW are not blank then the parking lot server would save the values of SMART_LOCK_SEND_URL, SMART_LOCK_SEND_URL_PW and ‘Y’ in smart lock send url, smart lock send url password and interface respectively, otherwise the server mover forward routine would save ‘N’ for interface. If the value of interface is ‘Y’, then the server mover forward routine would notify smart lock management service provider that an order identifier has been moved from drop-off point to pick-up point of a transporter identifier. The server mover forward routine would get locker external identifier and locker internal identifier from parking lot we transporter table using owner identifier for OWNER_ID, network identifier for NETWORK_ID and transporter identifier for TRANSPORTER_ID. If the server mover forward routine retrieves a single row from parking lot we transporter table, then the server mover forward routine would save the values of EXTERNAL_ID and PICKUP_LOCK_INTERNAL_ID into locker external identifier and locker internal identifier respectively, otherwise the server mover forward routine will report the problem to the merchant, will respond with an error message and terminate. Then server mover forward routine will send a notification as shown in FIG. 12A using smart lock send url and smart lock send url password to notify the parking lot service provider.

The server mover forward routine would use network identifier for SmartLockSendNetWorkId, locker internal identifier for InternalId, ‘L’ for SmartLockSendRequestType, one time code for SmartLockSendOneTimeCode and order mobile number for SmartLockSendOneTimeAuthId. If the server mover forward routine receives a response, then the response will be in the format as shown in FIG. 12R. If the server mover forward routine receives a response and if the value for SmartLockSendResponseCode is not ‘1’ or if the parking lot server does not receive a response, then the parking lot server will report the problem to the merchant, will respond with an error message and terminate.

If server mover forward routine is not terminated, the server mover forward routine will respond with a success message. The success message will be a segmented text with 2 nodes. The value in the first node will be ‘1’ and the value in the second node will be an informative success message.

The server mover backward routine will verify whether it received values for inputs owner identifier, network identifier, network password, transporter identifier and request type. If server mover backward routine did receive values for inputs owner identifier, network identifier, network password, transporter identifier and request type, then the server mover backward routine will continue the process, otherwise it will terminate without sending any response. If request type is ‘P’, then server mover backward routine will continue the process, otherwise the server mover backward routine will terminate without sending any response.

Then the server mover backward routine will retrieve rows from parking lot we merchant station status table using owner identifier for OWNER_ID, network identifier for NETWORK_ID, order identifier for ORDER_IDENTIFIER, maximum of STATUS_SEQ for the same OWNER_ID, for the same NETWORK_ID, for the same ORDER_IDENTIFIER for STATUS_SEQ, and ‘L’ for STATUS. If the server mover backward routine can retrieve a single row, then the server mover backward routine would save the value of ORIGIN as order identifier location type, value of ORDER_MOBILE_NO as order mobile number, and value of ORDER_VEHICLE_ID as order vehicle identifier from the retrieved row, otherwise the server mover backward routine would save ‘ ’ (blank value) for order identifier location type.

If order identifier location type is equal to ‘ ’, then the server mover backward routine will retrieve rows from parking lot we self-order station status table using owner identifier for OWNER_ID, network identifier for NETWORK_ID, ORDER_STATION_ID is not blank, maximum of STATUS_SEQ for the same OWNER_ID, for the same NETWORK_ID, for the same ORDER_STATION_ID for STATUS_SEQ, order identifier for ORDER_IDENTIFIER and ‘Y’ for READY_INDICATOR_YN. If the server mover backward routine can retrieve a single row, then the server mover backward routine would save the value of ORDER_STATION_ID as self-order station identifier, value of ORDER_MOBILE_NO as order mobile number and value of ORDER_VEHICLE_ID as order vehicle identifier from the retrieved single row and ‘Q’ for order identifier location type.

If order identifier location type is not equal to ‘M’ and not equal to ‘Q’, then the server mover backward routine will respond with an error message and terminate.

If order identifier location type is equal to ‘M’, then the server mover backward routine will insert a new row into parking lot we merchant station status table, using owner identifier for OWNER_ID, network controller identifier for NETWORK_ID, order identifier for ORDER_IDENTIFIER, 1 or the maximum value of STATUS_SEQ for the same OWNER_ID, for the same NETWORK_ID, for the same ORDER_IDENTIFIER plus 1 for STATUS_SEQ, ‘P’ for STATUS, ‘M’ for ORIGIN, blank for ORDER_STATION_ID, order mobile number for ORDER_MOBILE_NO, order vehicle identifier for ORDER_VEHICLE_ID and server date and time for DATETIME. The value of ‘P’ for STATUS will indicate that the order has been picked up from the locker. If the server mover backward routine cannot insert a new row, then the server mover backward routine will report the problem to the merchant, will respond with an error message and terminate.

If order identifier location type is equal to ‘Q’, then the server mover backward routine will insert a new row into parking lot we self-order station status table using owner identifier for OWNER_ID, network identifier for NETWORK_ID, self-order station identifier for ORDER_STATION_ID, 1 or the maximum value of STATUS_SEQ for the same OWNER_ID, for the same NETWORK_ID, for the same ORDER_STATION_ID plus 1 for STATUS_SEQ, blank for ORDER_IDENTIFIER, blank for READY_INDICATOR_YN, order mobile number for ORDER_MOBILE_NO, order vehicle identifier for ORDER_VEHICLE_ID and server date and time for DATETIME. If the server mover backward routine cannot insert a new row, then the server mover backward routine will report the problem to the merchant, will respond with an error message and terminate.

Then the server mover backward routine would insert a new row into parking lot we transporter status table using owner identifier for OWNER_ID, network identifier for NETWORK_ID, transporter identifier for TRANSPORTER_ID, 1 or the maximum value of STATUS_SEQ for the same OWNER_ID, for the same NETWORK_ID, for the same TRANSPORTER_ID plus 1 for STATUS_SEQ, blank for ORDER_IDENTIFIER and server date and time for DATETIME. If server mover backward routine cannot insert a new row, then the server mover backward routine will report the problem to the merchant, will respond with an error message and will terminate.

Then the server mover backward routine would retrieve a row from parking lot we merchant notification table using owner identifier for OWNER_ID, network identifier for NETWORK_ID, transporter identifier for TRANSPORTER_ID, maximum value of NOTIFICATION_SEQ for the same OWNER_ID, for the same NETWORK_ID and for the same TRANSPORTER_ID for NOTIFICATION SEQ, and ‘P’ for NOTIFICATION_ID. If server mover backward routine retrieves one row from parking lot we merchant notification table, then server mover backward routine would insert a row into parking lot we merchant notification table using owner identifier for OWNER_ID, network identifier for NETWORK_ID, transporter identifier for TRANSPORTER_ID, 1 or the maximum value of NOTIFICATION_SEQ for the same OWNER_ID, for the same NETWORK_ID, for the same TRANSPORTER_ID plus 1 for NOTIFICATION_SEQ, blank for NOTIFICATION_ID and server date and time for DATETIME.

Then the server mover backward routine would insert a new row into parking lot we request queue table using owner identifier for OWNER_ID, network identifier for NETWORK_ID, transporter identifier for TRANSPORTER_ID, the maximum value of REQUEST_SEQ for the same OWNER_ID, for the same NETWORK_ID, for the same TRANSPORTER_ID plus 1 for REQUEST_SEQ, blank for REQUEST_TYPE, blank for ORDER_IDENTIFIER, ‘I’ for STATUS and server date and time for DATETIME. Blank for REQUEST_TYPE, blank for ORDER_IDENTIFIER and ‘I’ for STATUS would indicate that the request type has been processed and is inactive. If the server mover backward routine cannot insert a new row, then the server mover backward routine will report the problem to the merchant, will respond with an error message and terminate.

Then the server mover backward routine will notify the order management service provider, if an interface to send data to order management service provider is set up. The server mover backward routine would verify whether an interface with order management service provider is available by retrieving one row from parking lot we interface table using owner identifier for OWNER_ID and network identifier for NETWORK_ID. If the server mover backward routine retrieves one row from parking lot we interface table and if the values of ORDER_SEND_URL and ORDER_SEND_URL_PW are not blank then the server mover backward routine would save the values of ORDER_SEND_UR, ORDER_SEND_URL_PW and ‘Y’ in order send url, in order send url password and in interface respectively otherwise the server mover backward routine would save ‘N’ for interface. If the value of interface is ‘Y’, then the server mover backward routine would notify order management service provider that an order identifier has been picked up from pickup point of a transporter identifier. The server mover backward routine would get locker external identifier and locker internal identifier from parking lot we transporter table using owner identifier for OWNER_ID, network identifier for NETWORK_ID and transporter identifier for TRANSPORTER_ID. If server mover backward routine retrieves a single row from parking lot we transporter table, then the parking lot server would save the values of EXTERNAL_ID and PICKUP_LOCK_INTERNAL_ID into locker external identifier and locker internal identifier respectively, otherwise the server mover backward routine will report the problem to the merchant, will respond with an error message and terminate. Then server mover backward routine will send a notification as shown in FIG. 10A using order send url and in order send url password to notify the order management service provider.

The server mover backward routine would use network identifier for OrderSendNetWorkId, ‘P’ for RequestType, order identifier for OrderSendOrderId, blank for OrderSendOneTimeCode, blank for OrderSendMobileNo, locker external identifier for OrderSendExternalId and locker internalal identifier for OrderSendInternalId. The value of ‘P’ for RequestTye will indicate that the order identifier has been picked up from locker. If the server mover backward routine receives a response, then the response will be in the format as shown in FIG. 10R. If the server mover backward routine receives a response and if the value for OrderSendResponseCode is not ‘1’ or if the server mover backward routine server does not receive a response, then the server mover backward routine will report the problem to the merchant, will respond with an error message and terminate.

Then the server mover backward routine will notify the smart lock management server, if an interface to send data to smart lock management server is set up. The server mover backward routine would verify whether an interface with locker server is available by retrieving one row from parking lot we interface table using owner identifier for OWNER_ID and network identifier for NETWORK_ID. If the server mover backward routine retrieves one row from parking lot we interface table and if the values of SMART_LOCK_SEND_URL and SMART_LOCK_SEND_URL_PW are not blank then the parking lot server would save the values of SMART LOCK SEND_URL, SMART LOCK SEND URL PW and ‘Y’ in smart lock send url and in smart lock send url password and interface respectively, otherwise the server mover backward routine would save ‘N’ for interface. If the value of interface is ‘Y’, then the server mover backward routine would notify smart lock management server that an order identifier has been picked from a transporter identifier. The server mover backward routine would get locker external identifier and locker internal identifier from parking lot we transporter table using owner identifier for OWNER_ID, network identifier for NETWORK_ID and transporter identifier for TRANSPORTER_ID. If server mover backward routine retrieves a single row from parking lot we transporter table, then server mover backward routine would save the values of EXTERNAL_ID and PICKUP_LOCK_INTERNAL_ID into locker external identifier and locker internal identifier respectively, otherwise the server mover backward routine will report the problem to the merchant, will respond with an error message and terminate. Then server mover backward routine will send a request as shown in FIG. 12A using smart lock send url and smart lock send url password to notify the parking lot service provider.

The server mover backward routine would network identifier for SmartLockSendNetWorkId, locker internal identifier for SmartLockSendInternalId, ‘P’ for SmartLockSendRequestType, blank for SmartLockSendOneTimeCode and blank for SmartLockSendOneTimeAuthId. If the server mover backward routine receives a response, then the response will be in the format as shown in FIG. 12R. If the server mover backward routine receives a response and if the value for SmartLockSendResponseCode is not ‘1’ or if the parking lot server does not receive a response, then the server mover backward routine will report the problem to the merchant, will respond with an error message and terminate.

If server mover backward routine is not terminated, the server mover backward routine will respond with a success message. The success message will be a segmented text with 2 nodes. The value in the first node will be ‘1’ and the value in the second node will be an informative message. An example of a success message could be ‘1,Request has been processed successfully’.

If an interface to send data to order management service provider is set up and if order management service provider is set up to send data to smart lock management service provider, then smart lock management server would receive the locker internal identifier and status.

If an interface to send data to smart lock management service provider is set up then smart lock management service provider would receive the locker internal identifier and status.

If for some reason parking lot server cannot send locker internal identifier and status to smart lock management service provider, then the merchant would send the locker internal identifier and status to the smart lock management service provider. Merchant may use an app provided by smart lock management service provider or a web site hosted by smart lock management server to send the smart lock internal identifier and status to the smart lock management server. The methods used by merchants to send locker internal identifier and the status to smart lock management service provider is beyond the scope of this invention.

The virtual terminal would also update the content of the large screens accordingly.

### Parking Lot Pickup Automation

### Without Network Controller

Lockers can be used with or without network controller and transporter controller. Lockers with network controller and transporter controllers will be referred to as parking lot we automation whereas lockers without network controller and transporter controllers will be referred to as parking lot nc automation. The word we refers to with controller and nc refers to no controller. Both automations can use smart locks with the same functionality. Both automations use many functions that are common and some that are distinctly different. For example, providing the directions for customers entering the parking lot, functions used at manual order station, functions interfaced with order management system and smart lock management system, locker display QR Code, functions linked to self-order station ordering QR Code, text message, IVR systems, ‘Scan & Add’ menus, functions displaying order status on large screens, functions related to online pickup and delivery orders and functions related to manual orders are all same. Functions that are related to network controller and transport controller will not be used in parking lot nc automation. When using functions that are common for both systems, the data used in each system will vary because of variations in the database. For example, the structure of parking lot we database as shown in FIGS. 2A and 2B and used in parking lot we automation is different from the structures of parking lot nc database as shown in FIGS. 17A and 17B and used in parking lot nc automation.

Since network identifiers of network controllers are unique for each network controller the tables used in parking lot we database use owner identifier and network identifier whereas the tables used in parking lot nc database use owner identifier and location identifier. Location identifiers may be unique within an owner identifier and not within the entire parking lot server. The same location identifier may be used under different owner identifiers. It is possible to identify owner identifiers from network identifiers, but it may not be possible to identify owner identifiers from location identifiers. Since transporter identifiers of transporter controllers are assigned by transporter controller manufacturers and not by merchants, merchants use external identifiers assigned by merchants to refer to transporter identifiers in parking lot we automation. External identifiers are displayed so that customers can identify lockers. Since transporter controllers are not used in parking lot nc automation external identifiers to refer to transporter identifiers are not required. In parking lot nc automation, transporter identifiers assigned by merchants themselves will be external identifiers. So, when merchants use parking lot we system, the parameter QAT_Code in the QR Code displayed at the self-order station will have 3 parameters namely application identifier, network identifier and self-order station identifier whereas when merchants use parking lot nc system, the parameter QAT_Code in the QR Code displayed at the self-order station will have 4 parameters namely application identifier, owner identifier, location identifier and self-order station identifier when merchants use parking lot nc system, but the parameter QAT_Code are used in similar functions. Also the format of the interfaces used in parking lot we automation as shown in FIGS. 9A, 9R, 10A, 10R, 11A, 11R, 12A and 12R are different from the format of the interfaces used in parking lot nc automation as shown in FIGS. 23A, 23R, 24A, 24R, 25A, 25R, 26A and 26R, but the interfaces are used in similar functions. For example, hardware used in self-order station such as ready indicator, tiny screen, scanner, help screen and plate reader will not be used in parking lot nc automation. For example, sensors used at pick up stations will not be used in parking lot nc automation. For example, routines stored in network controller such as network self-order station scanner routine, network self-order station display routine, network self-order station plate reader routine will not be used in parking lot nc automation. To avoid redundancy, functions that are common for both parking lot we automation and parking lot nc automation will not be described in full detail here. Only differences in those functions and routines will be described. Despite the differences, it is easier to convert parking lot ncs into self-order station parking lot wcs and vice versa. In at least some implementations of the present invention, where lockers used in parking lot nc automation can also be referred to as lockers nc. In at least some implementations of the present invention, where functions used in parking lot we automation and parking lot nc automation are same, the lockers nc can also be referred to as lockers.

Just like parking lot we automation, in parking lot nc automation lockers nc can be enclosed lockers nc or open lockers nc. Just like parking lot we automation, parking lot nc automation also uses bins or boxes as transporters to transport orders from drop-off point to pick up point. Upon orders being picked up, the transporters will be transported from pick-up point to drop-off point. Just like parking lot we automation, parking lot nc automation also uses movers to move the transporters. Just like parking lot we automation, in parking lot nc automation also transporters can be placed inside an enclosure or left open in a protected area. Just like parking lot we automation, in parking lot nc automation also when the lockers use an enclosure, the lockers are called enclosed lockers nc. Just like parking lot we automation, in parking lot nc automation also when the lockers do not use an enclosure, the lockers are called open locker nc.

Since there are no transporter controllers to guide the transports to move from drop-off points to pickup points and vice versa, enclosed lockers nc can be used only in above ground installation and uses a conveyor as shown in FIG. 18A and marked as ‘A’ or a linear actuator as shown in FIG. 18A and marked as ‘B’. Parking lots can be away from the barrier that separates the indoor from the parking lot with a walk-way or drive-way as shown in FIG. 18A and marked as ‘Detached Parking Lot’ or can be closer to the barrier that separates the indoor from the parking lot without a walk-way or drive-way as shown in FIG. 18A and marked as ‘Attached Parking Lot’.

Open lockers nc can be used with robots where order station and pickup station are segregated as shown in FIG. 18B and marked as ‘Self-Order Station and Pickup Station Segregated’. Open lockers nc can also be used with robots where ordering station and pickup station are integrated as shown in FIG. 18B and marked as ‘Self-Order Station and Pickup Station Integrated’. When self-order stations are integrated with pickup stations as shown in FIG. 18B, pickup stations can use the same parking space as self-order station. When self-order station and pickup station are integrated as shown in FIG. 18B, the parking lot would be referred to as integrated parking lot, otherwise the parking lot would be referred to as segregated parking lot. In both segregated and in integrated parking lots, in some embodiments where customers not be able to pick up orders, employees may move orders from lockers nc to customer vehicles. So, lockers nc can replace curbside delivery & pickup for merchants such as grocery stores, office supplies, building supplies and the like.

Before continuing, however, it is noted that while the database shown in class diagrams in FIGS. 17A and 17B are exemplary of the preferred embodiments of the present invention related to parking lot nc automation, it is in no manner meant to be all encompassing or otherwise limiting of the wide range of implementations as are possible.

Parking lot server (2), merchants (4), location (5), parking lot nc (6) parking lot nc station identifiers (7), order drop-off (8), order management (9), smart lock management (10) and robot management (11) as shown in FIG. 16A and in 16B are also referred as parking lot server, merchants, location, parking lot nc, parking lot nc station identifier, order drop-off, order management, smart lock management and robot management respectively. Parking lot nc station identifier may also be referred to as self-order station identifier.

Any merchant to install a parking lot nc automation would follow at least a minimum 3 steps namely setting up the database as shown in FIGS. 17A and 17B, setting up the parking lot as shown in FIG. 20A and setting up the lockers nc as shown in FIGS. 18A through 18C. The parts used for installing parking lot nc automation are listed in FIG. 18C. Although those of ordinary skill in the art will readily recognize that the parking lot set up as shown in FIG. 20A for open parking lot nc is for segregated setup where the ordering station and pickup station are segregated, those of ordinary skill in the art will also readily recognize that the parking lot set up as shown in FIG. 20A for open parking lot nc for segregated setup can be easily modified for an integrated setup where the ordering station and pickup station can be the same parking space using robots to carry the orders to pick up stations as shown in FIG. 18B and marked as ‘Ordering Station and Pickup Station Integrated’. Those of ordinary skill in the art will also readily recognize that parking lot can also be set for integrated setup when lockers with the controllers are used.

Any merchant to install a parking lot nc automation with extended barrier for enclosed lockers without controllers would follow at least a minimum 3 steps namely setting up the database as shown in FIGS. 17A and 17B, setting up the parking lot with extended barriers for enclosed lockers without controllers as shown in FIG. 20B and setting up the lockers nc as shown in FIGS. 18A through 18C. The parts used for installing parking lot nc automation are listed in FIG. 18C. Those of ordinary skill in the art will also readily recognize that parking lot with extended barrier for enclosed lockers without controllers can also be set up with the controllers.

Any structure that separates indoors from outdoors is referred to as barrier. The barrier area that can be used to pass the orders from indoor to outdoor will have a barrier beginning point and barrier ending point. For many locations the distance from the barrier beginning and ending points are very short and may not accommodate more than one or two lockers in an enclosed locker setup as shown in FIG. 20A. So, by extending the barrier either on the barrier beginning side or on the barrier ending side or on both sides, more enclosed lockers can be installed. The extended barrier does not separate indoors from outdoors, but an enclosure is placed in the outdoor. The layout of a parking lot without controllers using extended barrier with enclosed lockers is shown in FIG. 20B. The details of the enclosure and associated parts with the enclosure for enclosed lockers installed at ground level are shown in FIG. 20C. Even though the number of enclosed lockers shown in FIGS. 20B and 20C are only 4, the extended barrier can be extended to accommodate any number of enclosed lockers. Even though the extended barrier for enclosed lockers shown in FIGS. 20B and 20C are for segregated parking lot, the extended barrier for enclosed lockers can be used in integrated parking lots also. The details of the enclosure and associated parts with the enclosure for enclosed lockers installed at overheadl are shown in FIG. 20D. Even though the number of enclosed lockers shown in FIG. 20D are only 4, the extended barrier can be extended to accommodate any number of enclosed lockers. Even though the extended barrier for enclosed lockers shown in FIG. 20D are for segregated parking lot, the extended barrier for enclosed lockers can be used in integrated parking lots also.

The extended barrier consists of a transporter station, transporter conveyor, switch box, drop-off opening, drop-off conveyor fitted with entrance, diverter guides and exit sensors, diverter controller and pickup conveyors with entrance and exit sensors.

Each transporter will display a unique locker QR Code which can be downloaded by the merchants from parking lot server. As an example, the content of locker QR code can be 201-87098-4-7. The locker QR Code is also referred to as bin QR Code or transporter QR Code. The value in the first node is application identifier which is in the example ‘201’, the value in the second node is owner identifier which is in the example ‘87098, the value in the third node is location identifier which is in the example ‘4’ and the value in the fourth node is transporter identifier which is in the example ‘7’.

Each diverter guide can be in an ‘off’ or ‘on’ position. When the diverter guide is in ‘off’ position, the transporter will stay on the drop off conveyor without being diverted by the diverter guide and the transporter will pass the diverter guide. When the diverter guide is in ‘off’ position, the diverter guide will stay parallel to the frame of the drop off conveyor. When the diverter guide is in ‘on’ position, the transporter will be diverted from drop off conveyor to pick up conveyor by the diverter guide. When the diverter guide is in ‘on’ position, the diverter guide will stay perpendicular or at an angle to the frame of the drop off conveyor. Each diverter guide is dedicated to a single pickup conveyor and will divert all transporters destined to the dedicated single pickup conveyor. For example, diverter guide 3, dedicated to pickup conveyor 3, will divert all transporters destined to pick up conveyor 3 to pick up conveyor 3. All diverter guides are controlled by a diverter controller or by diverter switches placed in the switch box where a dedicated diverter switch is provided for each transporter. For example, a dedicated diverter switch 3 will be provided for a transporter destined to pick up conveyor 3. The diverter controller will be placed at the end of the transporter conveyor. As the transporter moves to the end of the transporter conveyor towards the drop-off conveyor, the diverter controller would scan the transporter QR Code displayed on the transporter and control the diverter guides. The diverter controller would keep one diverter guide in ‘on’ position and keep all other diverter guides in ‘off’ position. By scanning the QR Code, the diverter controller would get the destination of the transporter and will keep only the diverter guide appropriate for the destination of the transporter in ‘on’ position and keep all other diverter guides in ‘off’ position. For example, transporter destined to pickup conveyor 3, the diverter controller would keep the diverter guide 3 in ‘on’ position and keep all other diverter guides in ‘off’ position. Instead of using diverter controller, the merchant can also use diverter switches where a diverter switch will be dedicated to each transporter. For example, transporter destined to pickup conveyor 3, the diverter switch 3 would keep the diverter guide 3 in ‘on’ position and keep all other diverter guides in ‘off’ position. All the diverter switches will be placed inside the switch box for easy access. Before dropping off an order inside a transporter, the merchant can activate the switch dedicated to the specific transporter.

The enclosure and the barrier will have an opening for the merchants to drop the orders inside the transporter through the opening marked as drop-off opening as shown in the FIG. 20C. The switch box will be installed near the drop-off opening and accessible to the merchants. Just like in any other embodiment, before dropping the order inside the transporter to move the transporter from drop-off opening to pick up point, the merchant would send the order identifier and the transporter identifier to the parking lot server to get a permission to drop the order inside the transporter using a web site order drop update form in a web site as shown in FIG. 27A or using an app order drop update form in a merchant app provided by the parking lot server as shown in FIG. 27B. The drop-off opening will have a door. The door may also have a transporter send switch. If a diverter controller is not installed, then the merchant before dropping off an order into a transporter, would also activate a diverter switch dedicated to the transporter being used set the diverter guides to ‘on’ or ‘off’ position as needed. If a transporter send switch is not installed to the drop-off opening door, then the merchant would activate a transporter send switch installed in the switch box. When the merchant drops off the order in the transporter and closes the drop-off opening door or when the merchant activates the transporter send switch installed in the switch box, the process of moving the order from drop-off opening to the pickup point will start. When a switch to move orders from drop-off point to a pick-up point is automatically or manually activated the transporter conveyor will move for a distance equal to the size of the transporter to move the transporter from transporter conveyor to drop-off conveyor and also will move all transporters in line in the transporter station, if any, to move. This would enable the merchant to drop off the next order into the next transporter. If a diverter controller is installed, then the diverter controller would scan the QR Code displayed on the transporter and set the diverter guides to ‘on’ or ‘off’ position as needed. As the transporter moves over the drop-off conveyor the sensors mounted to the drop off conveyor at the entrance will be activated and the drop-off conveyor will move the transporter in the forward direction which will be towards the pick-up point. As the transporter moves on the drop-off conveyor, the transporter will be diverted, as needed, to a pick up conveyor. Once the transporter is diverted to a pickup conveyor, the drop-off conveyor will stop.

Once a transporter is moved to a pickup conveyor and when the pickup conveyor entrance sensor is activated, the pick up conveyor will move the transporter all the way to the end of the pickup conveyor where the pickup point is located. The sensors located at the end of pickup conveyor will stop the pickup conveyor. Each pickup point will be protected by doors fitted with smart locks. Each smart lock will have an internal and external identifier. The external identifiers are also referred to as locker numbers which will be displayed at the pickup point and will be clearly visible to customers. Customers can then enter a one-time code or use any authenticator such as fingerprint or face id or the like to unlock the smart lock and pick up the orders. When the smart lock is unlocked, the pickup point door placed at the pickup point and controlled by the smart lock will open so that the orders can be picked from the transporter. When the pickup point door is closed, a switch installed in the pickup point door will automatically be activated to return the transporter from pickup point to transporter station. If a switch is not installed in the pickup point door, then the merchant will activate a transporter return switch to return the transporter from pickup point to transporter station. The transporter station is the holding area to hold transporters that are not being used. Each transporter will have a dedicated transporter return switch placed inside the switch box. Just like in any other embodiment, before returning the transporter from pickup point, the merchant will also update the information using the form merchant order pickup update entry as shown in form 28A or 28B. To return the transporter from pick-up point to transporter station, the pickup conveyor will move the transporter from the pick-up point to the drop-off conveyor by moving the pick-up conveyor in the backward direction. Once the transporter is moved to the drop-off conveyor, the pickup conveyor will stop and the drop-off conveyor will start moving in the backward direction. Once the drop-off conveyor reaches the entrance of the drop-off conveyor, the transporter will move over the transport conveyor and the transporter conveyor will move for a distance of the size of the transporter and drop-off conveyor will stop moving.

The switch box will have send, diverter guide and return switches for each transporter. These switches will automatically return to non-activation state, once the task is completed after the switches are activated. Also, these switches will coordinate with each other so that the moving transporters will not clash with each other. For example when any send switch is active, no return switch can be activated and vice versa. Transporter conveyor, drop-off conveyor and pickup conveyor will coordinate with each so that the moving transporters will not clash with each other. For example, when a transporter is being sent from drop-off opening to a pickup point, the transporter conveyor, drop-off conveyor and pickup conveyor can only move forward and vice versa.

Even though the description for extended barrier for enclosed lockers as shown in FIGS. 20B and 20C are only for enclosed lockers installed at ground level, the extended barrier for enclosed lockers can also be used for enclosed lockers installed at overhead as shown in FIG. 20D. When enclosed lockers installed at overhead are used for extended barrier, an up conveyor in between transporter conveyor and drop-off conveyor and a down conveyor in between for each pickup conveyor and pickup point will be added as shown in FIG. 20D.

Setting up database, parking lot and locker ncs can be done concurrently.

All lockers nc use smart locks at pickup point to protect goods left inside the lockers nc. Some may also use smart locks instead of mechanical locks at drop-off point also.

Forms provided by parking lot server can be used to save data in parking lot nc database. Even though sample forms are not provided in this document, those of ordinary skill in the art providing locker services will readily be able to create forms based on the data to be saved in parking lot nc database. Those of ordinary skill in the art providing locker services will also readily be able to modify and/or create additional tables as needed in parking lot nc database to suit the needs of individual merchants.

Each parking lot can have one or more self-order stations for customers to place an order and sign-in or to sign-in to pick up an already placed order as shown in FIG. 21. Each self-order station will have a self-order station QR Code, a phone number for text and/or for IVR, a daily special display and a menu holder holding full version of ‘Scan & Add’ menu.

Just like parking lot we automation, in parking lot nc automation also merchants can use unlimited number of computers loaded with virtual terminal software to display order status on unlimited number of large screens as shown in FIG. 7A and a user screen visible only to merchants. Using the user screen, merchants can access merchant forms, view merchant notifications, setup filters to control the content displayed on the large screens and to manage refresh rate. When the virtual terminal is started the refresh rate will be the LARGE_SCREEN_POLLING_TIME saved in parking lot nc network table. Upon starting the virtual terminal refresh rate can be changed for the current session as needed.

Just like parking lot we automation, in parking lot nc automation also customers can use any desktop or mobile browser to view order status just by accessing the web page, entering an order identifier and selecting a merchant, if necessary, as shown in FIG. 7B. For example, a delivery service provider can view the order status before even coming to the merchant location.

Following is a step-by-step procedure to setup the database for parking lot nc automation:
1. Merchant would register as owner with the parking lot server using a merchant form provided by parking lot server. Merchant will provide business name, contact name, contact email, contact phone, and contact cell information and parking lot server would provide a unique owner identifier and a password. Parking lot server will save the information in parking lot nc owner table. Merchant would use owner identifier and owner password to access any merchant form provided by parking lot server.
2. Merchants can add unique locations through a merchant form provided by parking lot server. Each location can have a parking lot which may be segregated or integrated. Merchants can also set up location identifier, location password, large screen polling time, one time code length, phone number and parking lot type which can be ‘S’ for segregated parking lot and ‘I’ for integrated parking lot. Parking lot server will save location identifier, location password, large screen polling time, one time code length, a phone number and parking lot type in LOCATION_ID, LOCATION_PASSWORD, LARGE_SCREEN_POLLING_TIME, ONE_TIME_CODE_LENGTH. PHONE_NO and PARKING_LOT_TYPE respectively in parking lot nc location table.
3. Merchants can add self-order station identifiers through a merchant form provided by parking lot server. Self-Order station identifier cannot be added before adding location identifier. Merchants can add an unlimited number of unique self-order station identifiers in each location. The unique self-order station identifiers are provided by the merchant and will be displayed at self-order stations for customers to view. The parking lot server would save location identifier and self-order station identifier in LOCATION_ID and ORDER_STATION_ID respectively in parking lot nc self-order station table.
4. Merchants can use a form provided by parking lot server to download a unique QR Code which is also referred to as self-order station QR code for each self-order station which is a parking space where the customers can place an order or to sign-in to pick up an already placed order. Self-Order station QR codes can be printed on any medium such as paper, plastic, metal and the like. A sample self-order station is shown in FIG. 18C and marked as ‘G’ and in FIG. 21. A sample self-order station QR Code is shown in FIG. 18C and marked as ‘H’ and in FIG. 21. The content of the self-order station QR code in parking lot nc automation will be an url as a link of a page hosted by parking lot server and required parameters. An example of the content of a self-order station QR code may be https://www.parkonglotncautomation.com?QAT_Code=202-87098-920393-18 where https://www.parkonglotncautomation.com_is the parking lot server location and 202-87098-920393-18 is the value of the parameter QAT_Code. The QAT_Code is a ‘-’ delimited string with 4 nodes and the value in the first node of QAT_Code is an application identifier which is ‘202’ in the example, the value in the second node of QAT_Code is owner identifier which is ‘87098’, the value in the third node of the QAT_CODE is location identifier which is ‘920393’ and the value in the fourth node of QAT_Code is self-order station identifiers which is ‘18’ in the example. The functions associated with the self-order station QR code is the same for both parking lot we automation and parking lot nc automation.
5. Merchants can also display a phone number where customers can use text message to sign-in to pick up an already placed order and/or to connect to an IVR system to sign-in to pick up an already placed order. The functions associated with the text message system and the functions associated with the IVR system are the same for both parking lot we automation and parking lot nc automation.
6. Merchants can also store menus in menu holders accessible for the customers from their vehicles.
7. Merchants can add transporter identifiers and smart lock internal identifiers through a merchant form provided by parking lot server. The transporter identifier cannot be added before adding location. The transporter identifier is provided by the merchant will be referred to as locker number and displayed for customers to view. The locker number will be displayed at the order pickup point, and will be displayed on large order status screen as shown in FIG. 7A to broadcast that a particular order has been dropped off into a particular locker. Customers would use the locker number to locate the locker to pick up the orders. The smart lock internal identifiers are set by smart lock management service providers and will be provided by smart lock management service providers to merchants.
Transporters can be a bin in a segregated parking lot as shown in FIG. 19A and marked as 6 and placed inside an enclosure as shown in FIG. 19A and marked as 1 and will be referred to as enclosed parking lot nc or can be a box in a segregated parking lot as shown in FIG. 19A and marked as 9 loaded on a robot placed inside a protected area as shown in FIG. 19A and marked as 7 and will be referred to as open parking lot nc segregated or can be a box mounted on a robot in an integrated parking lot as shown in FIG. 19A and marked as 12-1 thru 12-N and placed inside a protected robot station as shown in FIG. 19A and marked as 10 and will be referred to as open parking lot nc integrated.
Each locker in an enclosed parking lot nc will have a forward switch as shown in FIG. 19A and marked as 3, to control the movement of the transporter from drop-off point as shown in FIG. 19A and marked as 5 to pick up point as shown in FIG. 19A and marked as 6 and a backward switch as shown in FIG. 19A and marked as 4, to control the movement of the transporter from pick up point as shown in FIG. 19A and marked as 6 to drop-off point as shown in FIG. 19A and marked as 5.
Each locker in an open parking lot nc segregated will have a protected area as shown in FIG. 19A and marked as ‘7’ and a robot to move the transporter from a drop-off point as shown in FIG. 19A and marked as ‘8’ to a pick up point as shown in FIG. 19A and marked as ‘9’ and to move the transporter from a pickup point as shown in FIG. 19A and marked as ‘9’ to a drop-off point as shown in FIG. 19A and marked as ‘8’ Each locker in an open parking lot nc integrated will have a robot station as shown in FIG. 19A and marked as ‘10’ and one or more robots as shown in FIG. 19A and marked as ‘12-1’ thru ‘12-N’ to move the transporters from robot station as shown in FIG. 19A and marked as ‘10’ to one or more drop-off points as shown in FIG. 19A and marked as ‘11-1’ thru ‘11-N’, to move the transporters from one or more drop-off points as shown in FIG. 19A and marked as ‘11-1’ thru ‘11-N’ to one or more pick up stations as shown in FIG. 19A and marked as ‘self-order station 1‘ through’self-order station N’, to move the transporters from one or more pick up stations as shown in FIG. 19A and marked as ‘self-order station 1 pickup 1‘ through’self-order station N pickup N’ to a robot station as shown in FIG. 19A and marked as ‘10’.
In an enclosed parking lot nc, the bin mounted on a conveyor or on a linear actuator will be moved only from a specific drop-off point to a specific pick up point and visa versa. In a open parking lot nc segregated, the box mounted on a robot will be moved only from a specific drop-off point to a specific pick up point and visa versa taking the robot path as shown in FIG. 19A and marked as ‘R’ under ‘Open and Segregated’ section. In an open parking lot nc integrated, the box mounted on a robot can be moved from any drop-off point to any pick up station, from any pick up station to a robot station and from the robot station to any drop-off point taking the robot path as shown in FIG. 19A and marked as ‘R’ under ‘Open and Integrated’ section. Customers driving vehicles to manual order station then to self-order station & order pickup station and then to exit or customers driving vehicles to self-order station & order pickup station and then to exit or customers driving vehicles to pickup only station and then to exit will use the vehicle path as shown in FIG. 19A and marked as ‘V’ under ‘Open and Integrated’ section.
Even though only one manual station, 6 self-order stations and 2 enclosed lockers are shown in enclosed parking lot nc in FIG. 19A, those of ordinary skill in the art providing locker services will readily be able to modify and/or create parking lot set up to use unlimited number of manual stations, unlimited number of self-order stations and unlimited number of enclosed lockers in any parking lot to suit the needs of individual merchants.
Even though only one manual station, 6 self-order stations and 2 open lockers are shown in open & segregated parking lot nc in FIG. 19A, those of ordinary skill in the art providing locker services will readily be able to modify and/or create parking lot set up to use unlimited number of manual stations, unlimited number of self-order stations and unlimited number of open lockers in any parking lot to suit the needs of individual merchants.
Even though only one manual station, 6 self-order stations with pickup lockers, 2 pickup only stations and 3 robots mounted with lockers are shown in open & integrated parking lot nc as shown in FIG. 19A, those of ordinary skill in the art providing locker services will readily be able to modify and/or create parking lot set up to use unlimited number of manual stations, unlimited number of self-order stations with pickup lockers, unlimited number of pickup only stations and unlimited number of robots mounted with lockers in any parking lot to suit the needs of individual merchants. Even though the transporters used in open & integrated parking lot nc are mounted on dedicated robots (movers) as shown in FIG. 19A those of ordinary skill in the art providing locker services will readily be able to use shareable robots as described in parking lot we automation. As a shareable mover the mover can be shared by more than one transporter.
In an enclosed parking lot nc the robot identifier (ROBOT_ID) in parking lot nc transporter table will be blank, otherwise the robot identifier (ROBOT_ID) will be a unique identifier of the individual robot provided by robot server provider to merchant. The same robot identifier cannot be used for more than one transporter identifier.
When open parking lot nc segregated or open parking lot nc integrated is used, merchants would use an app hosted by robot server provider to control the movement open parking lot nc.
When open parking lot nc segregated is used, merchants would program each robot used with transporter identifier with the position of respective transporter identifier drop-off point and pick up point with unique location numbers. Then merchants can use the app to move any transporter from its drop-off point to pick up point and visa versa using the robot path shown in FIG. 19A and marked as ‘R’ under ‘Open & Segregated’ section.
When open parking lot nc integrated is used, merchants would program each robot used with transporter identifier with the position of each drop-off point accessible to merchant as shown in FIG. 19A and marked as ‘11-1’ thru ‘11-N’ and the position of each pick up station accessible to customers as shown in FIG. 19A and marked as ‘self-order station 1 pickup 1‘ through’self-order station N pickup N’. The pickup station accessible to customers will be at the same station as self-order stations where the customers place an order to pick up or sign in to pick up an already placed order. The merchants would also program each robot used with transporter identifier with the position of robot station as shown in FIG. 19A and marked as ‘10’. Then merchants can use the app to move any transporter from any drop-off point to any pick up station, from any pick up station to robot station and from robot station to any drop-off point using the robot path shown in FIG. 19A and marked as ‘R’ under ‘Open & Integrated’ section. Those of ordinary skill in the art will readily recognize that there are many alternative ways in using robots to move the transporters, for example without attaching transporters to individual robots. Instead, robots and transporters can be separated, and any robot can be used to move any transporter.
The parking lot server would save location identifier, transporter identifier, smart lock internal identifier and robot identifier in LOCATION_ID, TRANSPORT_ID, PICKUP_LOCK_INTERNAL_ID and ROBOT_ID respectively in parking lot nc transporter table. Merchants can add an unlimited number of transporter identifiers in a location.
8. Merchants can setup one or more displays to direct the customers to manual order stations, self-serv stations, lockers and exit as shown in FIG. 22. In an integrated parking lot, the self-order stations and lockers will be at the same spot.
9. Merchants can setup interfaces for parking lot server to communicate with order management server and smart lock management server. The information included in the communication would be owner identifier and location identifier in addition to other required information. The functions associated with setting up the order management server interface and smart lock management server interface are the same for both parking lot we automation and parking lot nc automation. The interface data used parking lot nc automation would follow the specifications shown as example in XML format in FIGS. 23A, 23R, 24A, 24R, 25A, 25R, 26A and 26R. The request and response can be in any format, but only XML format is shown, as an example, in FIGS. 23A, 23R, 24A, 24R, 25A, 25R, 26A and 26R.
10. Merchants can start one or more self-updating virtual terminals provided by parking lot server using a computer. The functions associated with virtual terminals are the same for both parking lot we automation and parking lot nc automation.
11. Merchants can use a form provided by parking lot server to download a locker QR Code to print on any medium to be placed near the drop-off point of each locker as shown in FIG. 19A and marked as 5, 8 and 12-1 thru 12-N. The content of the locker QR Code will be application identifier, owner identifier, location identifier and transporter identifier. The function associated with locker QR Code is the same for both parking lot we automation and parking lot nc automation. As an example, the content of locker QR code can be 201-87098-4-7. The value in the first node is application identifier which is in the example 201, the value in the second node is owner identifier which is in the example ‘87098, the value in the third node is location identifier which is in the example ‘4’ and the value in the fourth node is transporter identifier which is in the example ‘7’.
12. In some parking lot nc integrated setup, parking lots can also have pickup only stations. Orders that are ready even before customers signin to pickup already placed orders can be placed inside lockers at pickup only stations. Customers whose orders have already been placed inside lockers at pickup only stations can see the pickup only station numbers at one or more large screens, so that customers can drive directly to the designated pickup station to pick up the orders. Customers whose orders have already been placed inside lockers at pickup only stations need not sign-in again and need not wait to get the orders at self-order stations.
13. While setting up the database, the merchants can also set up the parking lot for enclosed parking lot nc or for open parking lot nc segregated as shown in FIG. 20. Merchants can also modify open parking lot nc segregated setup as shown in FIG. 20 to parking lot nc integrated setup as shown in FIG. 18B.

Each parking lot can have one or more self-order stations for customers to place an order and sign-in or to sign-in to pick up an already placed order as shown in FIG. 21.

Each parking lot can have one or more manual order stations as shown in FIG. 5.

In some parking lot nc integrated setup, Each parking lot can also have one or more pick up only stations.

Each parking lot can have one or more locker. Each locker will have a transporter and a mover. Each locker will have a drop-off door at a drop-off point accessible to merchants dropping off orders and a pick-up door at a pickup point accessible to customers picking up orders. Each locker will have a smart lock at pick up point to protect goods left inside the lockers. Customers can drive in and drive out at order pick-up stations to pick up the orders at pickup points.

Each parking lot can have one or more large screens to display the status of orders as shown FIG. 7A.

Each parking lot can have one or more displays to direct the customers to manual order stations, self-order stations, lockers and exit as shown in FIG. 22. When the parking lot is set up for parking lot nc integrated setup, then the location of self-order station and the location of lockers for order pickup will be same. When the parking lot is set up for parking lot nc integrated setup, then the location can also have pick up only stations.

Although those of ordinary skill in the art will readily recognize many alternative parking lot layouts, especially considering the illustrations provided herein, this detailed description with the FIG. 20A is exemplary of the preferred embodiments of the present invention, the scope of which is limited only by the claims appended hereto.

Although those of ordinary skill in the art will readily recognize many alternative parking lot layouts, especially considering the illustrations provided herein, this detailed description with the FIG. 20B is exemplary of the preferred embodiments of the present invention, the scope of which is limited only by the claims appended hereto.

The installation of parking lot ncs in a parking lot will depend on the type of parking lot nc and the type of movers that move the bin or a box carrying the order from drop-off pint to pick-up point and move the bin or a box from pick-up point to a drop-off point.

Once the parking lot has been setup as per the parking lot setup diagram as shown in FIG. 19A, all the data in various setup tables has been setup, the virtual terminal displaying the order status on one or more display large screens have been setup, the parking lot nc automation would be ready for merchants and for customers to use.

Before every time the parking lot server is set to be available to customers and/or merchants, the merchant would start the virtual terminal/s.

All installation types in enclosed locker and in open locker work the same way except for minor variations.

To manage the parking lot nc automation, parking lot server may provide merchant forms. To access merchant forms, the merchants must log into parking lot server using a password set by the merchant. The merchants can also use an authentication method instead of using a password. It is beyond the scope of this invention to provide all the details about authentication and verification methods. It is sufficient to note that merchants can use finger print or face id or a password or two-factor authentication or any other method to log into parking lot server.

People entering the location, referred to as customers, can be buyers to place and pick up orders or buyers or employees of delivery service providers to pick up already placed orders. If customers have already placed an order with an order management service provider or with a delivery service provider, and if an interface has been set up for parking lot nc automation to receive the order identifier as per the specifications shown in FIG. 23A, then the order identifier data would have been automatically added into parking lot nc database, otherwise when merchants receive the order information would use merchant order entry form as shown in FIG. 13B, enter order identifier, enter mobile number if available, use the option “Online Order” and tap on “Save” button to add the order identifier data into parking lot nc database. The general procedure of handling online orders in parking lot nc automation is same as in parking lot we automation. Any online order added into parking lot nc database will be inserted into parking lot nc merchant station status table using order identifier for ORDER_IDENTIFIER, ‘W’ for STATUS, ‘O’ for ORIGIN, mobile number for ORDER_MOBILE_NO and blank for ORDER_STATION_ID in addition to using appropriate values for other fields such as OWNER_ID, LOCATION_ID, STATUS_SEQ and DATETIME.

When customers placing orders at manual order stations at the location if an interface has been set up for parking lot nc automation to receive the order identifier as per the specifications shown in FIG. 23A, then the order identifier data will be automatically added into parking lot nc database, otherwise merchants would use merchant order entry form as shown in FIG. 13B, enter order identifier, enter mobile number if available, use the option “Manual Ordering Station Order” and tap on “Save” button to add the order identifier data into parking lot nc database. The general procedure of handling manual order station orders in parking lot nc automation is same as in parking lot we automation. Any manual order station orders added into parking lot nc database will be inserted into parking lot nc merchant station status table using order identifier for ORDER_IDENTIFIER, ‘W’ for STATUS, ‘M’ for ORIGIN, mobile number for ORDER_MOBILE_NO and blank for ORDER_STATION_ID in addition to using appropriate values for other fields such as OWNER_ID, LOCATION_ID, STATUS_SEQ and DATETIME.

When customers scan self-order station QR Code server self-order station page hosted by parking lot nc automation would receive the value of the parameter QAT_Code for further processing just like in self-order station parking lot we automation. When customers scan self-order station QR Code, customers will be able to place an order and sign-in to pick up or sign-in to pickup already placed orders using forms 14A, 14B and 14C. When customers use the form 14A or 14B to place an order in parking lot nc automation, customers will be redirected to order url just like the way it is done in self-order station parking lot we automation. When customers use the form 14C to signin to pick up an already placed order parking lot nc automation, server nc signin process stored in parking lot server will be executed just like the server signin process stored in parking lot server was executed in parking lot we automation. The server nc signin process to insert rows into parking lot nc self-order station status table and parking lot nc merchant station status table is same as the server signin process to insert rows into parking lot we self-order station status table and parking lot we merchant station status table. Of course, the server signin process will be copied and modified accordingly as per the differences in the tables used in parking lot nc database and in parking lot we database to create server nc signin process. For example, the tables in parking lot nc database use OWNER_ID and LOCATION_ID whereas the tables in parking lot we database use OWNER_ID and NETWORK_ID. For example, the interface API used in parking lot nc database as shown in FIGS. 23A, 23R, 24A, 24R, 25A, 25R, 26A and 26R are different from interface API used in parking lot we database as shown in FIGS. 9A, 9R, 10A, 10R, 11A, 11R, 12A and 12R.

When merchants receive orders with identifiers from order management server, the merchant would verify whether the order identifier exists in parking lot nc self-order station status table or in parking lot nc merchant station status table using a merchant inquiry form provided by the parking lot server as shown in FIG. 13A. If order identifier does not exist in parking lot nc self-order station status table and in parking lot nc merchant station status table then the merchant would add the received order identifier and mobile number if received using the ‘Merchant Order Entry’ form as shown in FIG. 13B and by selecting the radio button ‘Online Order’ or ‘Manual Ordering Station Order’ as appropriate. The function receiving the values from ‘Merchant Order Entry’ form would receive values for owner identifier, location identifier, order identifier, mobile number, ‘O’ for origin if the merchant selected the radio button ‘Online Order’ or ‘M’ for origin if the merchant selected the radio button ‘Manual Ordering Station Order’. The function receiving the values from ‘Merchant Order Entry’ form would insert a row into parking lot nc merchant station status table, if a row for the requested order identifier does not exist in parking lot nc merchant station status table and does not exist in parking lot nc self-order station status table. A row will be inserted into parking lot nc merchant station status table using owner identifier for OWNER_ID, location identifier for LOCATION_ID, order identifier for ORDER_IDENTIFIER, 1 for STATUS_SEQ, ‘W’ for STATUS, origin for ORIGIN, mobile number for ORDER_MOBILE_NO, blank for ORDER_STATION_ID and server date time for DATETIME.

After placing an order at the manual order station in a segregated parking lot, the customers would be directed to wait in a waiting area until a locker number is displayed for the placed order on at least one of the large screens and then proceed to a locker identified by the locker number displayed on at least one of the large screens and pick up the order.

After placing an order and signing in to pick up the order or after signing in to pick up an already placed order at the self-order station in a segregated parking lot, the customers would be directed to wait at the self-order station until a locker number is displayed for the signed in order on at least one of the large screens and then proceed to a locker identified by the locker number displayed on at least one of the large screens and pick up the order.

After placing an order at the manual order station in an integrated parking lot, the customers would be directed to proceed to any self-order station and sign-in to pickup an already placed order and then wait for a robot to bring a locker to the self-order station.

After placing an order and signing in to pick up the order or after signing in to pick up an already placed order at the self-order station in an integrated parking lot, the customers would be directed to wait at the self-order station for a robot to bring a locker to the self-order station.

If the customers entering the location see their order and a locker number in one or more large screens then the customers can directly go to the locker.

Then, the customers would enter a one-time code in the locker key pad and then press unlock button or use an app provided by or interfaced with smart lock management service provider and scan the QR Code displayed on the locker with a biometric authentication such as finger print id or face id and then press the unlock button or use any generic QR Code reader app, scan the QR Code displayed on the locker, enter one-time code in the mobile device and press unlock button to access the locker and pick up the order.

If the entered code or biometric identifier is valid then the locker door will be unlocked so that the order from the transporter can be picked up. After a pre-determined time has passed the locker door will be automatically locked, one-time code and one-time biometric identifier will be cleared.

If the smart lock management server is provided with an interface to communicate with the parking lot server, then the smart lock management server would communicate with parking lot server to notify that the order has been picked from a specific transporter and the transporter is ready to be moved from pick up point to drop-off point. The smart lock management server would format the data for the communication as shown in FIG. 25A and send the data to an url using an url password set in the smart lock management server where the url is same as the value of SMART_LOCK_RECEIVE_URL and the url password is same as the value of SMART_LOCK_RECEIVE_URL_PW set in parking lot nc interface table for the required owner identifier and location identifier. To format the data as shown in FIG. 25A, the smart lock management server would use the values of owner identifier and location identifier that were previously provided to smart lock management service provider and saved in the smart lock management server for SmartLockReceiveOwnerld and for SmartLockReceiveLocationId respectively, use received internal identifier of the smart lock for SmartLockReceivelnternalld and ‘P’ for SmartLockReceiveActionld to indicate that the order has been picked up.

Server nc smart lock receive page hosted by parking lot server, which has the same url address as the one used by the smart lock management server to send the notification, will receive the data. The server nc smart lock receive page will have the same functionality as server smart lock receive page used in parking lot we automation except that server nc smart lock receive page will use the tables in parking lot nc database instead of the tables in parking lot we database. So the coding in server nc smart lock receive page will be different from the coding in server smart lock receive page based on the differences between the tables in parking lot nc database and in parking lot we database. If the received data is valid, then server nc smart lock receive page would insert a row into parking lot nc merchant notification table. The merchant would get the notification when the virtual terminal is refreshed. The virtual terminal would keep displaying the notification until the merchant update the information using the form merchant order pickup update entry as shown in form 28A and 28B and also referred to as form 28A and form 28B.

If the smart lock management server is not interfaced with parking lot server, then the merchant would manually monitor using a self-updating screen provided by the smart lock management server. The self-updating screen provided by the smart lock management server might display the smart lock internal identifiers that are locked without one-time code and without one-time biometric identifier as available for loading an order.

In an enclosed parking lot nc, if a smart lock internal identifier is displayed as available for loading an order on the self-updating screen provided by the smart lock management server and if the transporter of the locker holding that smart lock is not at the drop-off point as shown in FIG. 19A and marked as ‘5’, then the merchant would activate the switch shown in FIG. 19A and marked as ‘4’, to move the transporter of the locker from pick up point to drop-off point.

In an open parking lot nc segregated, if a smart lock internal identifier is displayed as available for loading an order on the self-updating screen provided by the smart lock management server and if the robot carrying the locker that is holding that smart lock is not at the drop-off point as shown in FIG. 19A and marked as ‘8’. then the merchant would use the app provided by the robot service provider to move the robot carrying the locker that is holding that smart lock from pick up point to drop-off point.

In an open parking lot nc integrated, if a smart lock internal identifier is displayed as available for loading an order on the self-updating screen provided by the smart lock management server and if the robot carrying the locker that is holding that smart lock internal identifier as shown in FIG. 19A and marked in between ‘12-1‘ and’12-N’ is not at the robot station as shown in FIG. 19A and marked as ‘10’ and is not at any one of the drop-off points as shown in FIG. 19A and marked in between ‘11-1‘ and’11-N’, then the merchant would use the app provided by the robot service provider to move the robot carrying the locker that is holding that smart lock from pick up station to robot station.

The merchant would know the transporter identifier and robot identifier for each smart lock internal identifier, because the merchant loaded the information into parking lot nc transporter table.

Whenever the merchant moves a transporter from pick up point to drop-off point or moves a robot carrying a locker from pick up point to drop-off point or moves a robot carrying a locker from pick up station to robot station, the merchant will also update the information using the form merchant order pickup update entry as shown in form 28A or 28B which are referred to as form 28A and 28B respectively.

To access web site order pickup update form, merchant would use any mobile device or desktop computer or laptop computer to log into parking lot server using the values provided by the parking lot service provider to the merchant for owner identifier, location identifier and location password. After logging in, when website order pickup update form as shown in FIG. 28A can be accessed, the order pickup update form would also receive owner identifier and location identifier and the order pickup update form would save ‘P’ as update type.

To access the app order pickup update form in merchant app, merchant would select order pickup update option in the app. When app order pickup update form as shown in FIG. 28B is accessed, the app order pickup update form would also receive owner identifier and location identifier saved in the merchant app at the time of activating the merchant app and the app order pickup update form would save ‘P’ as update type.

The merchant can use the website order pickup update form to select a transporter that is to be moved from pick up point to drop-off point using form 28A. To get the list of transporters that are to be moved, the website order pickup update form would retrieve all the most recent rows based on STATUS_SEQ for the same OWNER_ID, LOCATION_ID and TRANSPORTER_ID from parking lot nc transporter status table where the value of OWNER_ID is owner identifier, the value of LOCATION_ID is location identifier and the value of ORDER_IDENTIFIER is not blank. The values of TRANSPORTER_ID of all the retrieved rows would be the list of transporter identifier that can be moved. The list can also display smart lock internal identifier and robot identifier for each transporter identifier in the list by retrieving a row from parking lot nc transporter table using owner identifier for OWNER_ID, location identifier for LOCATION_ID and transporter identifier in the list TRANSPORTER_ID and saving the values of PICKUP_LOCK_INTERNAL_ID and ROBOT_ID from each row as smart lock internal identifier and robot identifier respectively.

When the merchant clicks or taps on ‘Proceed’ button in the website order pickup update form, the parking lot server would execute server nc order pickup update routine programmed in the parking lot server using owner identifier, location identifier, transporter identifier and update type as inputs for the server nc order pickup update routine.

The merchant can use app order pickup update form 28B to scan a QR Code displayed at the drop-off point where the displayed QR Code will have an application identifier, owner identifier, location identifier and the transporter identifier or select a transporter from a list of available transporters and save ‘P’ as update type. In an open parking lot nc integrated, the QR Code attached to the locker will not be accessible to the merchant to scan and the merchant will select from a list. To validate the scanned code, the mobile merchant app would compare the owner identifier and location identifier from the scanned QR Code displayed at the drop-off point and the owner identifier and location identifier saved in the app at the time of activating the merchant app. The mobile merchant app would also validate the application identifier and the transporter identifier. In an open parking lot nc integrated, to validate the entered code the mobile merchant app may require the merchant be authenticated using a biometric identifier or the merchant be required to be logged in. If the validation fails the merchant app will not process the app order pickup update form. When the merchant clicks or taps on ‘Proceed’ button in the app order pickup update form, the merchant app would execute server nc order pickup update routine programmed in the parking lot server using owner identifier, location identifier, transporter identifier and update type.

If the server nc order pickup update routine received 4 inputs, then the server nc order pickup update routine would save the 4 inputs as owner identifier, location identifier, transporter identifier and update type respectively, otherwise the server nc order pickup update routine will end the routine execution and will not send any message as return response.

If update type is ‘P’, then the server nc order pickup update routine would continue, otherwise the server nc order pickup update routine will terminate.

Then the server nc order pickup update routine would try to retrieve a row from parking lot nc transporter table using owner identifier for OWNER_ID, location identifier for LOCATION_ID and transporter identifier for TRANSPORTER_ID. If the server nc order pickup update routine retrieves a row, then the server nc order pickup update routine will continue, otherwise it will return an error message and terminate. This will ensure that the transporter identifier is valid.

Then the server nc order pickup update routine would try to retrieve a row from parking lot nc transporter status table using owner identifier for OWNER_ID, location identifier for LOCATION_ID, transporter identifier for TRANSPORTER_ID, the maximum row of STATUS_SEQ for the same OWNER_ID, LOCATION_ID and TRANSPORTER_ID for STATUS_SEQ and ORDER_IDENTIFIER is not blank. This will ensure that an order identifier loaded in the transporter identifier has not been set as picked up. If the server nc order pickup update routine retrieves a row, then the server nc order pickup update routine will save the value of ORDER_IDENTIFIER as order identifier from the retrieved one row and continue, otherwise it will return an error message and terminate.

Then the server nc order pickup update routine would save a blank as update table type.

If the parking lot is a segregated parking lot, then the server nc order pickup update routine would try to retrieve a row from parking lot nc merchant station status table, using owner identifier for OWNER_ID, location identifier for LOCATION_ID, order identifier for ORDER_IDENTIFIER, the maximum row of STATUS_SEQ for the same OWNER_ID, LOCATION_ID and ORDER_IDENTIFIER for STATUS SEQ, ‘L’ for STATUS, ‘M’ or ‘O’ for ORIGIN and transporter identifier for ORDER_STATION_ID. If the server nc order pickup update routine retrieves a row from parking lot nc merchant station status table then the server nc order pickup update routine will save ‘M’ as update table type and the value of ORIGIN from the retrieved row as update origin.

If update table type is blank then the server nc order pickup update routine will try to retrieve a row from parking lot nc self-order station status table using owner identifier for OWNER_ID, location identifier for LOCATION_ID, ORDER_STATION_ID is not blank, the maximum row of STATUS_SEQ for the same OWNER_ID, LOCATION_ID and ORDER_STATION_ID for STATUS_SEQ, order identifier for ORDER_IDENTIFIER and ‘Y’ for READY_INDICATOR_YN. If the server nc order pickup update routine retrieves a row from parking lot nc self-order station status table then the server nc order pickup update routine will save the value of ORDER_STATION_ID from the retrieved row as order station identifier and ‘S’ as update table type.

If update table is blank then the server nc order pickup update routine will return an error message and terminate.

If update table type is ‘M’, then server nc order pickup update routine will insert a row into parking lot nc merchant station status table using order identifier for ORDER_IDENTIFIER, ‘P’ for STATUS, update origin for ORIGIN, blank for ORDER_MOBILE_NO and blank for ORDER_STATION_ID in addition to using appropriate values for other fields such as OWNER_ID, LOCATION_ID, STATUS_SEQ and DATETIME. The value for will be carried forwarded from the previous row. The value of ‘P’ would indicate that the order has been picked up.

If update table type is ‘S’, then server nc order pickup update routine will insert a row into parking lot nc self-order station status table using order station identifier for ORDER_STATION_ID, blank space for ORDER_IDENTIFIER, blank space for ORDER_MOBILE_NO and ‘N’ for READY_INDICATOR_YN in addition to using appropriate values for other fields such as OWNER_ID, LOCATION_ID, STATUS_SEQ and DATETIME. The value of blank space for ORDER_IDENTIFIER would indicate that no order identifier is assigned to order station identifier.

Then the server nc order pickup update routine would retrieve a row from parking lot nc merchant notification table using owner identifier for OWNER_ID, location identifier for LOCATION_ID, transporter identifier for TRANSPORTER_ID, the maximum value of NOTIFICATION_SEQ for the same OWNER_ID, for the same NETWORK_ID and for the same TRANSPORTER_ID for NOTIFICATION_SEQ and ‘P’ for NOTIFICATION_ID. If the server nc order pickup update routine retrieves one row then the server nc order pickup update routine would insert a row into parking lot we merchant notification table using owner identifier for OWNER_ID, location identifier for LOCATION_ID, transporter identifier for TRANSPORTER_ID, 1 or the maximum value of NOTIFICATION_SEQ for the same OWNER_ID, for the same LOCATION_ID, for the same TRANSPORTER_ID plus 1 for NOTIFICATION_SEQ, blank for NOTIFICATION_ID and server date and time for DATETIME.

Then the server nc order pickup update routine would return a successful message to the merchant.

If the merchant receives an error response, then the merchant fix the problems as per the message included in the error response.

When an order is ready and at the time of moving the order from drop-off point to pick up point, the merchant would send the order identifier and the transporter identifier to the parking lot server using a web site order drop update form in a web site as shown in FIG. 27A or using an app order drop update form in a merchant app provided by the parking lot server as shown in FIG. 27B to update the move in parking lot nc transporter status table, parking lot nc self-order station status table or parking lot nc merchant station status table

To access web site order drop update form, merchant would use any mobile device or desktop computer or laptop computer to log into parking lot server using the values provided by the parking lot service provider to the merchant for owner identifier, location identifier and location password. After logging in, when website order drop update form as shown in FIG. 27A is accessed, the order drop update form would also receive owner identifier and location identifier and the order drop update form would save ‘D’ as access type.

To access the app order drop update form in the merchant app, merchant would select order drop update option in the merchant app. When app order drop update form as shown in FIG. 27B is accessed, the order drop update form would also receive owner identifier and location identifier saved in the merchant app at the time of activating the merchant app and the app order drop update form would save ‘D’ as update type.

The merchant can use website order drop update form to select an available locker and to enter the order identifier to update the move of the order from drop-off point to pick up point. To get the list of available lockers where the transporters are at the drop-off point and not loaded, the website order drop update form would retrieve all the most recent rows based on STATUS_SEQ for the same OWNER_ID, LOCATION_ID and TRANSPORTER_ID from parking lot nc transporter status table where the value of OWNER_ID is owner identifier, the value of LOCATION_ID is location identifier and the value of ORDER_IDENTIFIER is blank. The values of TRANSPORTER_ID of all the retrieved rows would be the list of lockers that is currently available. When the user selects a locker that is currently available in website order drop update form, the parking lot server would capture the values of transporter identifier of the selected locker as shown in parking lot nc transporter table. When the merchant clicks or taps on ‘Proceed’ button in the website order drop update form, the parking lot server would execute server nc order drop update routine programmed in the parking lot server using owner identifier, location identifier, transporter identifier, order identifier and update type as inputs for the server nc order drop update routine.

The merchant can use app order drop update form to scan a QR Code displayed at the drop-off point where the displayed QR Code will have an application identifier, location identifier and the transporter identifier and to scan the QR Code printed on the order receipt where the printed QR Code will have order identifier. The mobile merchant app would compare the owner identifier and location identifier from the scanned QR Code displayed at the drop-off point and the owner identifier and location identifier saved in the app at the time of activating the merchant app. If they are not the same, then the merchant app will not process the app order drop update form. The QR Code printed on the receipt will have the order identifier. When the merchant clicks or taps on ‘Proceed’ button in the app order drop update form, the app would execute server nc order drop update routine programmed in the parking lot server using owner identifier, location identifier, transporter identifier, order identifier and update type.

When the server nc order drop update routine is executed, the server nc order drop update routine would verify the received inputs and if the received inputs are valid then the server nc order drop update routine would insert a row into parking lot nc transporter status table, insert a row into parking lot nc self-order station status table or insert a row into parking lot nc merchant station status table and send a success message as return response, otherwise the server nc order drop update routine would send an error message as response or will not sent any response. The success message may be a message informing the merchant thar order drop update process is successful and the order can be dropped-off at the drop-off point. The error message would depend on the type of error. The value of ‘D’ for update type would indicate that the update is that the order is to be moved from drop-off point to pick up point.

The inputs and responses may be based on the specification provided by the parking lot service provider for server nc order drop update routine. The return response will have at a minimum 2 pieces of information where the first piece is a return code, and the second piece of information will be display message. The return code will be used for further processing whereas the display message will be displayed as a response.

If the server nc order drop update routine received 5 inputs, then the server nc order drop update routine would save the 5 inputs as owner identifier, location identifier, transporter identifier, order identifier and update type respectively, otherwise the server nc order drop update routine will end the routine execution and will not send any message as return response.

If update type is ‘D’, then the server nc order drop update routine would continue, otherwise the server nc order drop update routine will terminate.

Then the server nc order drop update routine would try to retrieve a row from parking lot nc transporter table using owner identifier for OWNER_ID, location identifier for LOCATION_ID and transporter identifier for TRANSPORTER_ID. If the server nc order drop update routine retrieves a row, then the server nc order drop update routine will continue, otherwise it will return an error message and terminate. This will ensure that the transporter identifier is valid.

Then the server nc order drop update routine would try to retrieve a row from parking lot nc transporter status table using owner identifier for OWNER_ID, location identifier for LOCATION_ID, transporter identifier for TRANSPORTER_ID, the maximum row of STATUS_SEQ for the same OWNER_ID, LOCATION_ID and TRANSPORTER_ID for STATUS_SEQ and blank for ORDER_IDENTIFIER. This will ensure that the transporter identifier is empty. If the server nc order drop update routine retrieves a row, then the server nc order drop update routine will continue, otherwise it will return an error message and terminate.

Then the server nc order drop update routine would try to retrieve a row from parking lot nc transporter status table using owner identifier for OWNER_ID, location identifier for LOCATION_ID, TRANSPORTER_ID is not blank, the maximum row of STATUS_SEQ for the same OWNER_ID, LOCATION_ID and TRANSPORTER_ID for STATUS_SEQ and order identifier for ORDER_IDENTIFIER. This will ensure that the order identifier is not loaded in any other transporter. If the server nc order drop update routine retrieves a row, then the server nc order drop update routine will return an error message and terminate.

Then the server nc order drop update routine would save a blank as update table type.

If the parking lot is a segregated parking lot, then the server nc order drop update routine would try to retrieve a row from parking lot nc merchant station status table, using owner identifier for OWNER_ID, location identifier for LOCATION_ID, order identifier for ORDER_IDENTIFIER, the maximum row of STATUS_SEQ for the same OWNER_ID, LOCATION_ID and ORDER_IDENTIFIER for STATUS SEQ, ‘W’ for STATUS, ‘M’ or ‘O’ for ORIGIN and blank for ORDER_STATION_ID. If the server nc order drop update routine retrieves a row from parking lot nc merchant station status table then the server nc order drop update routine will save ‘M’ as update table type, the value of ORIGIN from the retrieved one row as update origin and the value of ORDER_MOBILE_NO from the retrieved one row as order mobile number. This will ensure that the order having the order identifier was placed at manual station or online and is waiting to be moved from drop-off point to pick-up point.

If update table type is blank then the server nc order drop update routine will try to retrieve a row from parking lot nc self-order station status table using owner identifier for OWNER_ID, location identifier for LOCATION_ID, ORDER_STATION_ID is not blank, the maximum row of STATUS_SEQ for the same OWNER_ID, LOCATION_ID and ORDER_STATION_ID for STATUS SEQ, order identifier for ORDER_IDENTIFIER and ‘N’ for READY_INDICATOR_YN. If the server nc order drop update routine retrieves a row from parking lot nc self-order station status table then the server nc order drop update routine will save ‘S’ as update table type, the value of ORDER_STATION_ID in the retrieved row as self-order station identifier and the value of ORDER_MOBILE_NO from the retrieved one row as order mobile number. This would ensure that the customer has signed in at a self-order station and is ready to pick up.

If the update table is blank then the server nc order drop update routine will return an error message and terminate.

If update table type is ‘M’, then server nc order drop update routine will insert a row into parking lot nc merchant station status table using order identifier for ORDER_IDENTIFIER, ‘L’ for STATUS, update origin for ORIGIN, update order mobile number for ORDER_MOBILE_NO and blank for ORDER_STATION_ID in addition to using appropriate values for other fields such as OWNER_ID, LOCATION_ID, STATUS_SEQ and DATETIME.

If update table type is ‘S’, then server nc order drop update routine will insert a row into parking lot nc self-order station status table using self-order station identifier for ORDER_STATION_ID, order identifier for ORDER_IDENTIFIER, order mobile number for ORDER_MOBILE_NO and ‘Y’ for READY_INDICATOR_YN in addition to using appropriate values for other fields such as OWNER_ID, LOCATION_ID, STATUS_SEQ and DATETIME.

Then the server nc order drop update routine will notify the order management service provider, if an interface to send data to order management service provider is set up. The server nc order drop update routine would verify whether an interface with order management service provider is available by retrieving a single row from parking lot nc interface table using owner identifier for OWNER_ID and location identifier for LOCATION_ID. If the server nc order drop update routine retrieves one row from parking lot nc interface table and if the values of ORDER_SEND_URL and ORDER_SEND_URL_PW are not blank then the server nc order drop update routine would save the values of ORDER_SEND_URL, ORDER_SEND_URL_PW and ‘Y’ in order send url, in order send url password and in interface respectively, otherwise the server nc order drop update routine would save ‘N’ for interface. If the value of interface is ‘Y’, then the server nc order drop update routine would notify order management service provider that an order identifier has been moved from drop-off point to pick-up point of a transporter identifier.

To send a notification to the order management service provider, the server nc order drop update routine would get smart lock internal identifier from parking lot nc transporter table using owner identifier for OWNER_ID, location identifier for LOCATION_ID and transporter identifier for TRANSPORTER_ID. If server nc order drop update routine retrieves a single row from parking lot nc transporter table, then the server nc order drop update routine would save the value of PICKUP_LOCK_INTERNAL_ID as smart lock internal identifier and will send a notification as shown in FIG. 24A using order send url and order send url password, otherwise the server nc order drop update routine will report the problem to the merchant, will respond with an error message and terminate.

To send a notification to the order management service provider, the server nc order drop update routine would use owner identifier for OrderSendOwnerId, location identifier for OrderSendLocationId, ‘L’ for OrderSendRequestType, order identifier for OrderSendOrderId, one time code for OrderSendOneTimeCode, order mobile number for OrderSendMobileNo, transporter identifier for OrderSendExternalId and smart lock internal identifier for OrderSendlnternalId. The value of ‘L’ for OrderSendRequestTye will indicate that the order identifier is loaded into locker. If the server nc order drop update routine receives a response, then the response will be in the format as shown in FIG. 24R. If the server nc order drop update routine receives a response and if the value for OrderSendResponseCode is not ‘1’ or if the server nc order drop update routine does not receive a response, then the server nc order drop update routine will report the problem to the merchant, will respond with an error message and terminate.

Then the server nc order drop update routine will notify the smart lock management service provider, if an interface to send data to smart lock management service provider is set up. The server nc order drop update routine would verify whether an interface with smart lock management service provider is available by retrieving one row from parking lot nc interface table using owner identifier for OWNER_ID and location identifier for LOCATION_ID. If the server nc order drop update routine retrieves one row from parking lot nc interface table and if the values of SMART_LOCK_SEND_URL and SMART_LOCK_SEND_URL_PW are not blank then the parking lot server would save the values of SMART_LOCK_SEND_URL, SMART_LOCK_SEND_URL_PW and ‘Y’ in smart lock send url, smart lock send url password and interface respectively, otherwise the server nc order drop update routine would save ‘N’ for interface. If the value of interface is ‘Y’, then the server nc order drop update routine would notify smart lock management service provider that an order identifier has been moved from drop-off point to pick-up point of a transporter identifier. The server nc order drop update routine would get smart lock internal identifier from parking lot nc transporter table using owner identifier for OWNER_ID, location identifier for LOCATION_ID and transporter identifier for TRANSPORTER_ID. If the server nc order drop update routine retrieves a single row from parking lot nc transporter table, then the server nc order drop update routine would save the value of PICKUP_LOCK_INTERNAL_ID as smart lock internal identifier respectively, otherwise the server nc order drop update routine will report the problem to the merchant, will respond with an error message and terminate. Then server nc order drop update routine will send a notification as shown in FIG. 26A using smart lock send url and smart lock send url password to notify the parking lot service provider.

The server nc order drop update routine would use owner identifier for SmartLockSendOwnerId, location identifier for SmartLockSendLocationId, smart lock internal identifier for SmartLockSendlnternalId, ‘L’ for SmartLockSendRequestType, one time code for SmartLockSendOneTimeCode and order mobile number for SmartLockSendOneTimeAuthId. If the server nc order drop update routine receives a response, then the response will be in the format as shown in FIG. 26R. If the server nc order drop update routine receives a response and if the value for SmartLockSendResponseCode is not ‘1’ or if the parking lot server does not receive a response, then the parking lot server will report the problem to the merchant, will respond with an error message and terminate.

Then the server nc order drop update routine would return a successful message to the merchant. The successful message would also include the order mobile number. If the merchant receives a successful message, if the parking lot server is an open parking lot server and if the parking lot is an integrated parking lot, then the success message would also include the value of self-order station identifier.

If the merchant receives a successful message, then the merchant would drop the order inside the parking lot server at the drop-off point.

If the merchant receives a successful message and if the parking lot server is an enclosed parking lot server then the merchant would activate the forward switch as shown in FIG. 19A and marked as 3.

If the merchant receives a successful message, if the parking lot server is an open parking lot server and if the parking lot is a segregated parking lot, then the merchant would use an app or any other means provided by the robot management service provider to move the robot from drop-off point to pick up point.

If the merchant receives a successful message, if the parking lot server is an open parking lot server and if the parking lot is an integrated parking lot then the merchant would use an app or any other means provided by the robot management service provider to move the robot from drop-off point to the self-order station identifier received in the response.

If an interface to send data to order management server is set up and if order management server is set up to send data to smart lock management server, then smart lock management server would receive the locker internal identifier, one-time code and an order mobile number.

If an interface to send data to smart lock management server is set up, then smart lock management server would receive the locker internal identifier, one-time code and an order mobile number.

If an interface to send data to order management server is not set up or if an interface to send data to order management server is set up and if order management server is not set up to send data to smart lock management server or if an interface to send data to smart lock management server is not set up, then smart lock management server would not receive the locker internal identifier or one-time code or an order mobile number through an interface.

If order management server is not set up to receive locker internal identifier, one-time code and an order mobile number through an interface, then the merchant may use an app provided by smart lock management service provider or a web site hosted by smart lock management server to send the smart lock internal identifier, one-time code and an order mobile number to the smart lock management server. How the merchant would send smart lock internal identifier, one-time code and an order mobile number is beyond the scope of this invention.

A one-time code may also be printed on the receipt. The virtual terminal would also update the content of the display monitor accordingly.

### Pickup Automation

### Bin Pickup Automation

The purpose of any shelf order pickup system is to let the customers (buyers and delivery service persons) to pick up orders from shelves with or without permission from merchant. Buyers can place online orders with order management service providers or with delivery service providers. Online orders placed with order management service providers will be picked up by buyers whereas online orders placed with delivery service providers will be picked up by delivery service persons. Buyers can also place orders at the location to be picked up by buyers.

For the sake of convenience, especially for quick service restaurants, most prefer shelf pickup instead of counter pickup to save labor cost for the merchant and to save wait time for the customers. In the case of counter pickup, orders must be handed out across the counters to customers by merchants, whereas in shelf pickup merchants can leave the orders in a shelf and customers can pick up the orders themselves. For the most part, a shelf order pickup system is an unsecured manual process, where merchants leave orders on shelves and request customers to pick up the orders with or without merchant permission. Merchant permission cannot be enforced because the shelf pick up is not protected. Since the shelves are not protected, one or more video cameras may be installed near the shelves. Merchants also constantly monitor the shelves to protect the orders from shelf pirates. Shelf pirates are the unauthorized persons picking up the orders or handling the orders. Authorized customers are the buyers of the orders or authorized delivery persons picking up the orders. Even fellow customers can see the contents of the orders and even handle the products left on the shelves. For example, in a coffee shop or in a quick service restaurant, the drinks & food are left on the counters and shelves are accessible by all customers, not just authorized customers. Even if merchant permission is required for order pickup, it cannot be enforced, because the shelves are not protected. When merchant permission is required, the customers must wait until an employee shows up to give the permission. When merchant permission is required, additional human resources must be allocated by merchants.

Smart sensor bins can be used for order pick up where the orders have already been submitted, prepared and left inside the smart sensor bins. Smart sensor bins can also be used for merchandise pick up where individual items for sale are placed inside the smart sensor bins. When smart sensor bins are used for order pick up, the smart sensor bins are referred to as smart sensor order bins. When smart sensor bins are used for merchandise pick up, then the smart sensor bins are referred to as smart sensor merchandise bins. The same smart sensor bin can be used as smart sensor order bin or smart sensor merchandise bin depending on the set up. Smart sensor merchandise bins can be attached to stationary shelves or to moving platforms such as sushi conveyor belts.

If smart bins are used for order pick up where merchants can leave the orders in the smart bins and customers can pick up the orders from the smart bins, then unsecured shelves holding the orders can be secured. If smart bins are used for merchandise pick up where merchants can leave the items to be sold in the smart bins and customers can pick up the items from the smart bins, then unsecured shelves holding the merchandise can be secured.

By using bin pickup servers and smart sensor bins, order or merchandise pickup from bins can be secured. By using bin pickup servers and smart lock bins, order or merchandise pickup from bins can be secured. Bin automation is supported by bin pickup servers. Each bin pickup server can have an unlimited number of business owners, each business owner can have unlimited number of locations, each location can have unlimited number of smart sensor bins and unlimited number of smart lock bins.

In any event, customers will receive order receipts which will have a one-time code for pickup or attached to a mobile number or biometric identifier, such as fingerprint or face id and the like. If customers use a mobile wallet such as MySingleLink wallet, then the order can be attached to a biometric identifier or a mobile phone number. If one-time code is not included in the receipt, then a pre-determined number of digits from the order identifier printed on the receipt will be one-time code or one-time code may be sent to mobile phones.

In any event, shoppers can pick up the merchandise from bins with a valid purchase authorization. To get a valid purchase authorized shoppers can use a web site provided by bin pickup server or an app provided by bin pickup server or an app interfaced with bin pickup server and provide payment information. Instead of providing payment information every time, shoppers can also use a mobile wallet MySingleLink wallet, then the purchase authorization can be attached to a biometric identifier such as fingerprint or face id and the like or a mobile phone number.

Each smart sensor bin is fitted with an electronic scale and/or one or more sensors. Smart sensor bins can sense when an order or item is placed or picked up. Smart sensor bins are cloud based and controlled by smart bin management server providing authorization for merchants to leave the orders or merchandise and for the customers to pick up the orders or merchandise. At a minimum each smart sensor bin will have 2 statuses namely unblocked status and blocked status and the status can be changed by the smart sensor bin only with the permission from smart bin management server.

Smart sensor bins can be fitted with alarms to trigger the alarm when the smart sensor bins are accessed without authorization. Alarms can be part of keypad or controller or attached to keypad or controller. Smart sensor bins can also be fitted with indicators to trigger the indicator to green when the smart sensor bins are in unblocked status and to trigger the indicator to red when the smart sensor bins are in blocked status. Indicators can be part of keypad or controller or attached to keypad or controller. Merchants can get authorization before leaving the orders or merchandise inside the smart sensor bins and customers can get authorization before picking up the orders or merchandise from the smart sensor bins. Smart sensor bins can be any size and can be attached to any shelf or to any conveyor belts.

The various parts of smart sensor bins namely keypad, controller, connector, electronic weighing scale and sensors are connected as shown in FIG. 32A. At a minimum each smart sensor bin will have a unique smart sensor internal identifier provided by smart sensor bin manufacturer or by smart sensor bin management service provider and known to the operators such as merchants. At a minimum smart sensor bin management service provider will host a smart bin management server where all the smart sensor bins will be registered using smart sensor internal identifier. At a minimum each smart sensor bin will have a controller to receive data from keypad and sensors and to communicate with a smart bin management server using smart sensor internal identifier as an identifier. The controller will be connected to a cloud based smart bin management server. At a minimum each smart sensor bin will have 2 statuses namely blocked status and unblocked status and any change from one status to another status will be accepted by the smart sensor bin only with the permission from smart bin management server. When the smart sensor bin is in blocked status leaving any order or merchandise inside the smart sensor bin or picking up any order or merchandise from the smart sensor bin will be considered as shoplifting and an alarm attached to the controller will sound-off to get the attention of security personnel. Before leaving any order or merchandise inside the smart sensor bin, merchants would use a web site and/or an app to turn the status of the smart sensor bin from blocked status to unblocked status. Before picking up any order or merchandise from the smart sensor bin, customers would use a one-time code or an authentication identifier to turn the status of the smart sensor bin from blocked status to unblocked status. When the led indicator attached to the controller is green, the merchants can leave the orders or merchandise or the customers can pick up the orders or merchandise. When the status of the smart sensor bin is changed from blocked state to unblocked state, the smart sensor bin will remain in unblocked state only for a short period of time, enough for the merchants to drop the order or merchandise inside the smart sensor bin or for the customers to pick up the order or merchandise from the smart sensor bin. The status of the smart sensor bin will automatically turn from unblocked status to blocked status upon the expiration of a pre-determined period from the time the smart sensor bin was turned to unblocked status. Merchants and/or customers can also change the smart sensor bin status from unblocked status to blocked status just by pressing a block key on the keypad. If the change in the status is not acceptable by the smart bin management server, then the smart sensor bin will consider the request is due to unauthorized use of the smart sensor bin and the smart sensor bin will instantly trigger an alarm connected to the smart sensor bin.

At a minimum each smart sensor bin will have a keypad to accept one-time code, an unblock button and a block button to send an unblock or block request to smart bin management server through the controller. At a minimum controller will have a connector connected to the keypad to receive inputs from keypad. At a minimum each smart sensor bin will have an electronic weighing scale and have a connector connected to the weighing scale to automatically receive the weight of goods placed on the weighing scale whenever the weight changes. At a minimum each smart sensor bin will have at least one pair of infrared sensors that use a photo-eye system like the infrared sensors used in garage doors to prevent the garage door from closing on someone or something. Each infrared sensor in each pair will be placed against each other. The photo eyes on each sensor would send an infrared beam to each other in the pair. When the status of the infrared beam is changed from blocked status to unblocked status and vice versa a signal will be sent to the controller. When the status of the infrared beam from all sensors are unblocked, then the status of the smart sensor bin is in unblocked status. This will occur when the customers pick up an order or merchandise from the smart sensor bins with proper authorization. When the status of the infrared beam from even one sensor is blocked, then the status of the smart sensor bin is in blocked status. This will occur when the merchants leave the orders or merchandise inside the smart sensor bins with proper authorization.

At a minimum, smart sensor bins will always be in blocked status except for a brief period to be in unblocked status during which orders or merchandise can be dropped into smart sensor bins or orders or merchandise can be picked from smart sensor bins. At a minimum the smart bin management server will have a database to store unique smart sensor internal identifier, the current status and current value of one-time code of each registered smart sensor. At a minimum smart sensor bin management service provider will host online web sites or provide apps for merchants to inquire the current status and/or set one-time code of any smart sensor bin. Smart sensor bins can also have QR Code where an app provided by the smart bin management service provider or interfaced with smart bin management server or any generic QR Code reader app can be used to scan the QR Code instead of entering a one-time code in the keypad. Some smart bin management servers can also save one-time authenticated identifier such as mobile number, customer identifier and the like instead of or in addition to one-time code. One-time authenticated identifiers are the mobile numbers or identifiers of customers making payments for the orders using secured web sites or mobile payment apps. It is also possible for smart bin management server to generate a random number, use the generated random number as one-time code and text the one-time code to the mobile number that smart bin management server received, if the one-time code received by smart bin management server is blank. At a minimum when an auto-block request is approved, each smart bin management server will also be able to clear one-time code if one-time code is stored in smart bin management server and/or one-time authenticated identifier, if one-time authenticated identifier is stored in smart bin management server. When a smart sensor bin is in a blocked status and if the value of stored one-time code and/or one-time authenticated identifier is not blank then the smart sensor bin will be considered loaded. When a smart sensor bin is in a blocked status and if the value of stored one-time code and one-time authenticated identifier are blank then the smart sensor bin will be considered not loaded. When a smart sensor bin is in unblocked status because an authorization was granted to a merchant, then the smart sensor bin will be considered as being loaded. When a smart sensor bin is in unblocked status because an authorization was granted to a customer, then the smart sensor bin will be considered as being picked up.

Each smart lock bin is fitted with a cloud based smart lock. It may be beyond the scope of this invention to give details on the operation of smart locks but would be helpful. At a minimum each smart lock will have a unique smart lock internal identifier provided by smart lock manufacturer or by smart bin management service provider and known to the operators such as merchants. At a minimum smart bin management service provider will host a smart bin management server where all the smart locks will be registered using smart lock internal identifier. At a minimum each smart lock will be able to communicate with a smart bin management server using smart lock internal identifier as an identifier. At a minimum each smart lock will have 2 positions namely locked position and unlocked position and the position can be changed by the smart lock only with the permission from smart bin management server to change. At a minimum each smart lock will have a keypad to accept one-time code, an unlock button and a lock button to send unlock or lock request to smart bin management server. At a minimum each smart lock will also be able to send an auto-lock request after a pre-determined time from the time a smart lock position is changed to an unlock position. At a minimum, smart locks will always be in locked position except for a brief period to be in unlocked position during which orders from smart bins having the smart locks can be picked up. At a minimum the smart bin management server will have a database to store unique smart lock internal identifier, the current lock position and current value of one-time code of each registered smart lock. At a minimum smart bin management service provider will host online web sites or provide apps for merchants to inquire the lock status and/or set one-time code of any smart lock. Smart locks can also have QR Code where an app provided by the smart bin management service provider or interfaced with smart bin management server or any generic QR Code reader app can be used to scan the QR Code instead of entering a one-time code in the key pad. Some smart bin management servers can also save one-time authenticated identifier such as mobile number, customer identifier and the like instead of or in addition to one-time code. One-time authenticated identifiers are the mobile numbers or customer identifiers of customers making payments for the orders using secured web sites or mobile payment apps. It is also possible for smart bin management server to generate a random number, use the generated random number as one-time code and text the one-time code to the mobile number that smart bin management server received, if the one-time code received by smart bin management server is blank. At a minimum when an auto-lock request is approved, each smart bin will also be able to clear one-time code if one-time code is stored in smart bin management server and/or one-time authenticated identifier, if one-time authenticated identifier is stored in smart bin management server. When a smart lock bin is in locked position and if the value of stored one-time code and/or one-time authenticated identifier is not blank then the smart lock bin will be considered loaded. When a smart lock bin is in locked position and if the value of stored one-time code and one-time authenticated identifier are blank then the smart lock bin will be considered empty.

Smart sensor bins and smart lock bins are more affordable and a better alternative to smart lockers. Smart sensor bins and smart lock bins are open and does not require a box whereas smart lockers are boxes fitted with smart locks. Smart sensor bins and smart lock bins are ideal for indoor use because the orders placed in smart sensor bins or smart lock bins are exposed. Smart lockers are ideal for both indoor and outdoor use.

Smart sensor bins can be orders pickup bins where smart sensor bins are used for orders pick up or merchandise pickup bins where smart sensor bins are used for merchandise pick up.

The object of this invention is to provide a method for merchants to convert unprotected self-serv order pick up shelves into protected self-serv order pick up shelves and/or into self-serv merchandise pick up shelves.

The object of this invention is to provide a method for merchants to convert unprotected self-serv merchandise pick up conveyor belts into protected merchandise pick up conveyor belts.

The object of this invention is to provide a method for customers to pick up orders from smart sensor order bins.

The object of this invention is to provide a method for shoppers to pick up merchandise from smart sensor merchandise bins.

The object of this invention is to provide a method for merchants to drop orders into smart sensor order bins.

The object of this invention is to provide a method for merchants to drop merchandise into smart sensor merchandise bins.

The object of this invention is to provide a method for customers to pick up orders from smart lock order bins.

The object of this invention is to provide a method for shoppers to pick up merchandise from smart lock merchandise bins.

The object of this invention is to provide a method for merchants to drop orders into smart lock order bins.

The object of this invention is to provide a method for merchants to drop merchandise into smart lock merchandise bins.

Referring now to the FIGS. , and to FIG. 29A, the bin pickup automation (1) of the present invention is shown to generally comprise a plurality of bin pickup server (2) implemented use cases (3).

In particular, the bin pickup server (2) provides a means (4) for the owner client (4) to add or edit owner client (4) information. Owner clients are also referred to as merchants (4).

Additionally, bin pickup server (2) provides a means (5) for merchants (4) to add and edit locations.

Additionally, bin pickup server (2) provides a means (6) for merchants (4) to add and edit smart bins.

Additionally, bin pickup server (2) provides a means (7) for merchants (4) to drop-off orders or merchandise.

Additionally, bin pickup server (2) provides a means (8) for bidirectional communication with order management systems. Order management systems can in turn communicate with smart bin management systems.

Additionally, bin pickup server (2) provides a means (9) for bidirectional communication with smart bin management servers, if bin pickup server (2) is not able to interface with order management servers or order management servers cannot interface with smart bin management servers.

Additionally, bin pickup server (2) provides a means (10) for merchants (4) to display order status or merchandise details on large screens.

Bin pickup automation can use memory to store transient data and can use a database to store transaction data such as bin database with various tables such as bin owner table, bin location table, bin table, bin order identifier table and bin order status table, bin merchandise menu table, bin purchase identifier table and bin purchase content table as shown in a class diagram in FIGS. 30A and 30B.

Any merchant to install a bin pickup automation would follow at least a minimum of 2 steps namely setting up bin database as shown in FIGS. 30A and 30B and setting up smart sensor bins as shown in FIGS. 32A & 32B and/or setting up smart lock bins as shown in FIGS. 32C & 32D. Setting up database and smart sensor bins and/or smart lock bins, can be done concurrently.

Forms provided by bin pickup server can be used to save data in bin database. Even though sample forms are not provided in this document, those of ordinary skill in the art of providing bin pickup services will readily be able to create forms based on the data to be saved in bin database. Those of ordinary skill in the art providing bin pickup services will also readily be able to modify and/or create additional tables as needed in bin database to suit the needs of individual merchants.

Before continuing, however, it is noted that while the bin database shown in class diagrams in FIGS. 30A and 30B is exemplary of the preferred embodiments of the present invention related to bin pickup automation, it is in no manner meant to be all encompassing or otherwise limiting of the wide range of implementations as are possible.

Bin pickup server (2), merchants (4), locations (5), smart bins (6), order/merchandise drop-off (7), order management (8) and smart bin management (9) as shown in FIG. 29A are also referred as bin pickup server, merchants, locations, smart bins, order/merchandise drop-off, order management and smart bin management respectively.

A location can have unlimited number of smart bins. The smart bin can be smart sensor bin or smart lock bin. Smart sensor bins can be used for order or merchandise pickup. Smart lock bins can also be used for order or merchandise pickup. Each smart bin will have a unique internal identifier and a unique external identifier. Internal identifiers are unique assigned by smart sensor bin manufacturers or by smart lock bin manufacturers depending on the type of smart bin. External identifiers are unique in each location and assigned by merchants. The external identifiers are also referred to as bin locators and will be displayed on each smart bin and will be clearly visible to customers. If a smart bin is used for order pickup, then the bin locator will also be displayed on large order status screen as shown in FIG. 31A to broadcast that a particular order has been dropped off into a particular smart bin. Customers would use the bin locator to locate the bin to pick up the orders. If the smart bin is used for merchandise pickup, then the bin locator will also be displayed on large merchandise status screen as shown in FIG. 31B to broadcast the merchandise description in each bin locator. Customers would use the bin locator to locate the bin to purchase a particular merchandise.

It is beyond the scope of this invention how the bin database receive online orders placed with order management service providers or delivery service providers or orders placed at the location. The bin database may receive orders thru interfaces and/or through data entry by merchants. It is sufficient to note that bin database will receive order information. Bin database will also receive order information through a dedicated web page hosted by bin pickup server and having forms to accept data from merchants.

When placing an online order, Customers can also request freshly prepared orders or pre-prepared orders. Customers can also set up pick up time, if the order is for pre-prepared orders. In the case of freshly prepared orders, the merchant will prepare the orders only when the customers sign-in at the merchant location. In the case of pre-prepared orders, the merchant will prepare the orders in advance based on the requested pickup time and leave them on smart order bins. In the case of freshly prepared orders, customers must sign-in at a sign in station to pick up an already placed order. In the case of pre-prepared orders, customers can go directly to the smart order bin displayed on the order status display screen without signing in at self-order station. If the smart order bin locator for a pre-prepared order is not displayed on the order status display screen, then the customer would sign-in to pick up the previously placed order at any sign in station. Customers can also view the order status by accessing a web page that can display the order status of all merchant locations supported by the bin pickup server as shown in FIG. 33B. Customers simply access the web page and enter the order identifier to view the status. If there is more than one order with the same order identifier, then the customer would be requested to select a location. Then customers can view the status of the requested order identifier. This would help the customers to know the order status in advance for pre-prepared order instead of visiting the merchant location without knowing the order status. Customers can also leave a mobile number to receive a text or voice notification, if the pre-prepared order number is not already in a smart order bin.

Each location can have one or more posters for customers to signin to pick up an already placed orders as shown in FIGS. 33A, 33C and 33D. Eash poster will also have phone numbers for customers to signin to pick up already placed order using a text message or using an IVR system. An unlimited number of posters can be placed at merchant locations. Posters have QR Codes to sign-in, telephone numbers for texting or to connect with an IVR system. Posters can be printed on any medium such as paper, plastic, metal and the like.

Merchants can use an unlimited number of computers loaded with virtual order terminal software to display order pickup status on an unlimited number of large screens and a user screen, visible only to merchants. Using the user screen merchants can access merchant forms, set up filters to control the content displayed on the large screens and to manage refresh rate. When the virtual order terminal is started the refresh rate will be the LARGE_SCREEN_POLLING_TIME saved in bin location table. Upon starting the virtual order terminal refresh rate can be changed for the current session as needed.

Customers can use any desktop or mobile browser to view order status just by accessing a web page known to the merchant and provided to customers as shown in FIG. 33B, entering an order identifier and selecting a merchant, if necessary. When the order is ready even before the customers visit the merchant location, the merchant can place the orders inside a smart bin so that the smart bin locator will be visible in the order status screens. For example, a person picking up delivery orders or a buyer picking up a purchased order can view the order status before even coming to the merchant location and can directly go to the bin to pick up the order.

Each location can have one or more posters for customers to signin to purchase authorization as shown in FIGS. 33A, 33C, 33E and 33F. An unlimited number of posters can be placed at merchant locations. Posters have QR Codes to sign-in. Posters can be printed on any medium such as paper, plastic, metal and the like.

Bin database will receive merchandise information through dedicated web pages hosted by bin pickup server and having forms to accept data from merchants. Merchants can use an unlimited number of computers loaded with virtual merchandise terminal software to display merchandise information on an unlimited number of large screens and a user screen, visible only to merchants. Using the user screen merchants can access merchant forms, set up filters to control the content displayed on the large screens and to manage refresh rate. When the virtual merchandise terminal is started the refresh rate will be the LARGE_SCREEN_POLLING_TIME saved in bin location table. Upon starting the virtual merchandise terminal refresh rate can be changed for the current session as needed.

Following is a step-by-step procedure to setup the database for bin pickup automation:
1. Merchants would register as owner with the bin pickup server using a merchant form provided by bin pickup server. Merchant will provide business name, contact name, contact email, contact phone, and contact cell information and bin pickup service provider would provide a unique owner identifier and a password. Bin pickup server will save the information in bin owner table. Merchant would use owner identifier and owner password to access any merchant form provided by bin pickup server.
2. Merchants can add unlimited number of location identifiers through a merchant form provided by bin pickup server. The location identifier are provided by the merchant. Each location identifier is linked to a single merchant who is the owner identifier of the location. An owner identifier can have multiple location identifiers. Location identifiers may be unique within an owner identifier and not within the entire bin pickup server. The same location identifier may be used under different owner identifiers. It may not be possible to identify owner identifiers from location identifiers. Merchants can also set up a location password for the location identifier which could be used by the merchants to maintain the data in bin pickup server. In addition to setting up a location password, the merchant can also set up a large screen polling time, one time code length, phone number, order pickup option and purchase pickup option. The large screen polling time is the interval set for the bin pickup server to display up to date order status on large screen as shown in FIG. 31A. The one-time code length is the number of characters at the end in the order identifier used as one time code to access the pickup bin. When displaying the order number in the large screen, the bin pickup server would hide one time code. If the one-time code length is 0, then the entire order-identifier will be displayed on the large screen. Each location and will be assigned with a unique phone number to process incoming text messages and Interactive Voice Response (IVR) calls. The merchant can setup any location for the customers to pickup already placed order. When the location is setup for order pickup then the order pickup option will be set to ‘Y’, otherwise order pickup option will be set to ‘N’. The merchant can setup any location for the customers to purchase merchandise. When the location is setup for item purchase then the item purchase option will be set to ‘Y’, otherwise item purchase option will be set to ‘N’. The bin pickup server would save owner identifier, location identifier, location password, large screen polling time, one time code length, phone number, order pickup option and item purchase option as OWNER_ID, LOCATION_ID, LOCATION_PASSWORD, LARGE_SCREEN_POLLING_TIME, ONE_TIME_CODE_LENGTH, PHONE_NO, PICKUP_ALLOWED_YN and PURCHASE_ALLOWED_YN respectively in bin location table.
3. Merchants can add smart bin locators and corresponding internal identifiers through a merchant form provided by bin pickup server. The bin locator and smart bin internal identifier cannot be added before adding location identifier. The bin pickup server would save owner identifier, location identifier, bin locator, and smart bin internal identifier as OWNER_ID, LOCATION_ID, BIN_LOCATOR and BIN_INTERNAL_ID respectively in bin table. Merchants can add an unlimited number of bin locators in a location.
4. Merchants can download a sign-in poster which can be used by customers to self-siginin to pickup already placed orders and/or to self-signin to get a purchase authorization code. Merchants can use a form provided by bin pickup server to download sign-in poster. The sign-in poster will have a unique QR Code which is also referred to as self-signin QR code and a self-signin phone number for texting and/or for IVR as shown in FIG. 33A. The self-signin QR code and the self-signin phone number are unique for each location. The sign-in poster can be printed on any medium such as paper, plastic, metal and the like. The content of the self-signin QR code will be an url as a link to a page hosted by bin pickup server and required parameters. An example of the content of a self-signin QR code may be https://www.binpickupautomation.com?QAT_Code=202-87098-4 where https://www. binpickipautomation.com is the bin pickup server location and 202-87098-4 is the value of the parameter QAT_Code. The QAT_Code is a ‘-’ delimited string with 3 nodes and the value in the first node of QAT_Code is an application identifier which is ‘202’ in the example, the value in the second node of QAT_Code is owner identifier which is ‘87098’ and the value in the third node of the QAT_CODE is location identifier which is ‘4’ in the example. The link in the self-signin QR Code will open a page which will be referred to as server self-signin page and will be hosted or powered by bin pickup server. At least one parameter included in url will be unique for each location identifier. Server self-signin page would receive the value in the second node in the parameter QAT_Code as owner identifier and the value in the third node in the parameter QAT_Code as location identifier.

The server self-signin page will open one of the 3 forms provided by the bin pickup server based on the merchant setup in bin location table. The server self-signin page will get the values of PICKUP_ALLOWED_YN, PURCHASE_ALLOWED_YN from bin location table as order pickup option and item purchase option respectively. If order pickup option is ‘Y’ and item purchase option is ‘Y’, then server self-signin page will present the form as shown in FIG. 33C and also referred to as form 33C for the customer to choose either to signin to pickup an already placed order or to signin to get a purchase authorization code. When the customer selects ‘Pickup an Order’ and tabs or clicks on ‘Proceed’ button, then the customer will be presented with a form to signin to pickup an already placed order as shown in FIG. 33D. When the customer selects ‘Purchase Items’ and tabs or clicks on ‘Proceed’ button, then the customer will be presented with a form to get a purchase authorization code as shown in FIG. 33E. If order pickup option is ‘Y’ and item purchase option is ‘N’, then server self-signin page will present the form as shown in FIG. 33D and also referred to as form 33D for the customer to signin to pickup an already placed order. If order pickup option is ‘N’ and item purchase option is ‘Y’, then server self-signin page will present the form as shown in FIG. 33E and also referred to as form 33E for the customer to get a purchase authorization code or present the form as shown in FIG. 33F and also referred to as form 33F for the customer to close an existing purchase authorization code.

Customers who do not have an internet connection and if order pickup option is ‘Y’, then the customer can send the order identifier through a text message or verbally hand over through an IVR (Interactive Voice Response) system to the self-signin phone number to sign-in to pick up an order already placed.
5. Merchants can download a bin QR Code for each bin locator which can be used by merchants to identify any bin locator. An example of the content of a bin QR code may be https://www.binpickupautomation.com?QAT_Code=201-87098-4-7 where https://www. binpickupautomation.com is the bin pickup server location and 201-87098-4-7 is the value of the parameter QAT_Code. The QAT_Code is a ‘-’ delimited string with 4 nodes and the value in the first node of QAT_Code is an application identifier which is ‘201’ in the example, the value in the second node of QAT_Code is owner identifier which is ‘87098’, the value in the third node of the QAT_CODE is location identifier which is ‘4’ in the example and the value in the fourth node is bin locator which is ‘7’ in the example. Merchants can attach the bin QR Code to each bin.
6. When the customers place an online order for pick up or place an online order for delivery or place an order at the location, the order management server would receive order information and order pick up time and if needed, also customer mobile phone number. Then the order management server would create a unique order identifier and save the information. If an interface is established between order management server and bin pickup server, then the order information will be automatically loaded into bin order identifier table. If an interface is not established between order management server and bin pickup server, then the merchant would manually enter the order information using a form provided by bin pickup server to insert the order information into bin order identifier table. When the order is ready for pickup, the merchant would also use a form provided by bin pickup server to insert the order status information into bin order status table.
7. When the customer arrives at the location, if the bin locator is not displayed on the large screen, then the customer would sign-in to pick up an by scanning a QR Code displayed on any one of the posters displayed at the location or send a text message to a phone number displayed on the poster or access an IVR system by calling a phone number displayed on the poster. Once the bin locator is displayed on the large screen, the customer can move to the bin and pick up the order.
8. If item purchase option is ‘Y’, then merchants would add items that are available for purchase into bin item identifier table. Merchants can add new items or edit existing items in bin item identifier table. When a new item is added, bin pickup server would automatically create a unique item identifier. When adding or editing, merchants would provide the values for item identifier, item name, item description and item price. The bin pickup server would save owner identifier, location identifier, item identifier, item name, item description and item price in OWNER_ID, LOCATION_ID, ITEM_IDENTIFIER, ITEM_NAME, ITEM_DESCR and ITEM_PRICE respectively in bin item identifier table.
9. When a merchandise item is ready for sale, the merchant would create a unique one time code that can be used by the customers to pick up the merchandise item from the smart merchandise bin and use a form provided by bin pickup server or an app provided by bin pickup service provider or an app interfaced with bin pickup server to insert the merchandise item information into bin item content table using owner identifier for OWNER_ID, location identifier for LOCATION_ID, bin locator for BIN_LOCATOR, 1 or the maximum value of CONTENT_SEQ for the same OWNER_ID, for the same LOCATION_ID, for the same BIN_LOCATOR plus 1 for CONTENT_SEQ, item identifier for ITEM_IDENTIFIER, one time code for ONE_TIME_CODE and server date and time for DATETIME.
10. When the customer decides to purchase by item from merchandise pickup bins, then the customer can pick up the merchandise with valid purchase authorization code.
11. If order pickup option is ‘Y’, then merchants can start one or more self-updating virtual order terminals provided by bin pickup server using a computer. The virtual order terminal would display the order status information on all the large screens connected to the desktop computer. The virtual order terminal would also provide a user screen visible only to merchants to access merchant forms. Virtual order terminals use a pre-determined url, which is a page hosted by bin pickup server and referred to as server virtual order terminal page, to retrieve order status information and manage merchant forms from bin pickup server. The server virtual order terminal page will be programmed to display order status information on one or more order large screens automatically whenever order status information is changed and also periodically based on LARGE_SCREEN_POLLING_TIME saved in bin location table or based on the refresh rate set by the merchant. An example of order large screen is shown in FIG. 31A.
12. If item purchase option is ‘Y’, then merchants can start one or more self-updating virtual merchandise terminals provided by bin pickup server using a computer. The virtual merchandise terminal would display the merchandise information on all the large screens connected to the desktop computer. The virtual merchandise terminal would also provide a user screen visible only to merchants to access merchant forms. Virtual merchandise terminals use a pre-determined url, which is a page hosted by bin pickup server and referred to as server virtual merchandise terminal page, to retrieve order status information and manage merchant forms from bin pickup server. The server virtual merchandise terminal page will be programmed to display merchandise information on one or more large screens automatically whenever merchandise information is changed and also periodically based on LARGE_SCREEN_POLLING_TIME saved in bin location table or based on the refresh rate set by the merchant. An example of merchandise large screen is shown in FIG. 31B.

A location can have unlimited number of smart bins. The smart bin can be smart sensor bin or smart lock bin. Smart sensor bins and smart lock bins can be used for order pick up and for merchandise purchase. Smart sensor bins used for order pick up will be referred to as smart sensor order bins. Smart lock bins used for order pick up will be referred to as smart lock order bins. Smart sensor bins used for merchandise pick up will be referred to as smart sensor merchandise bins. Smart lock bins used for merchandise pick up will be referred to as smart lock merchandise bins.

Although those of ordinary skill in the art will readily recognize many alternative use for smart sensor bins and for smart lock bins, especially considering the illustrations provided herein, this detailed description with the FIGS. 32A, 32B, 32C and 32D is exemplary of the preferred embodiments of the present invention, the scope of which is limited only by the claims appended hereto.

Once the location has been setup, all the data in various setup tables has been setup, the virtual order terminal displaying the order status on one or more display large screens have been setup, the virtual merchandise terminal displaying the merchandise available on one or more display large screens have been setup, the bin automation would be ready for merchants and for customers to use.

Before every time the bin pickup server is set to be available to customers and/or merchants, the merchant would start the virtual order and/or virtual merchandise terminal/s.

To manage the bin automation, bin pickup server may provide merchant forms. To access merchant forms, the merchants must log into bin pickup server using a password set by the merchant. The merchants can also use an authentication method instead of using a password. It is beyond the scope of this invention to provide all the details about authentication and verification methods. It is sufficient to note that merchants can use finger print or face id or a password or two-factor authentication or any other method to log into bin pickup server.

People entering the location, referred to as customers, can be buyers to purchase items and/or to pick up orders or buyers or employees of delivery service providers to pick up already placed orders. If customers have already placed an order with an order management service provider or with a delivery service provider, and if an interface has been set up for bin automation to receive the order identifier, then the order identifier data would have been automatically inserted into bin order identifier table, otherwise when merchants receive the order information would use merchant order entry form as shown in FIG. 32E to insert a row into bin order identifier table.

When form 32E is opened, form 32E would automatically receive owner identifier and location identifier and save as Ownerld and LocationId respectively. Form 32E would capture and save the merchant entered values for order identifier, mobile number, name, preparation time and requested time as OrderId, MobileNo, NameId, PreparationTimeValue and RequestedTimeValue respectively. Merchant entered order identifier, mobile number, name, preparation time and requested time are the values passed on by order management service provider to the merchant. If the value for a particular piece of information is not received by the merchant, them the merchant may use a blank or 0 for that particular piece of information. Form 32E will pass the saved values when the user tabs or clicks on ‘Save’ button. Upon receiving the data from the merchant order entry form 32E, the bin pickup server would validate and then save the data in bin order identifier table. If the values of Ownerld and LocationId received from the order entry form are valid based on the data stored in bin location table, if the received OrderId does not exist in bin order identifier table, then the bin pickup server would insert a row into bin order identifier table using Ownerld for OWNER_ID, LocationId for LOCATION_ID, OrderId for ORDER_IDENTIFIER, 1 for STATUS_SEQ, ‘W’ for STATUS, blank for ONE_TIME_CODE, MobileNo for ORDER_MOBILE_NO, NameId for NAME, PreparationTimeValue for PREPATION_TIME, RequestedTimeValue for REQUESTED DATE TIME and current server date and time for DATETIME. The value ‘W’ for STATUS indicates that the order is in waiting status for the customer to signin or for the merchant to drop the order inside a smart order bin.

If the data validation is successful and if the row insert into bin order identifier table is successful, then bin pickup server would respond with a successful message. An example of a successful message may be “Order is accepted”. If the data validation is not successful or the row insert into bin order identifier table is not successful, then bin pickup server would respond with an error message depending on the type of error. An example of an error message may be “Order identifier already exists”.

If the data validation is successful and the row insert into bin order identifier table is successful, then the order identifier will be visible on the large screen/s, when the virtual order terminals provided refreshes itself next time.

When the customer signin to pickup the order, then the value for STATUS in bin order identifier table will be changed to ‘R’ to indicate that the customer is ready to pickup the order. When the merchant drops the order into a smart order bin, then the value for STATUS in bin order identifier table will be changed to ‘L’, the value of ONE_TIME_CODE will be changed and a row will be inserted into bin order status table to indicate that the order is ready to pickup from the smart order bin. When the customer picks up the order, then the value for STATUS in bin order identifier table will be changed to ‘P’ and a row will be inserted into bin order status table to indicate that the order has been picked up from the smart order bin and the smart order bin is empty.

When customers scan self-signin QR Code printed on sign-in poster, server self-signin page hosted by bin pickup server would receive the value of the parameter QAT_Code for further processing. If the QAT_Code is a ‘-’ delimited string with 3 nodes then server self-signin page will process the QAT_Code, otherwise it will error out. Then the self-signin page will save the value in the first node as application identifier, the value in the second node as ‘identifier and the value in the third node as location identifier. If the value of application identifier is valid then the server self-signin page will continue, otherwise it will error out. Then the self-signin page will try to retrieve a row from bin location table using owner identifier for OWNER_ID and location identifier for LOCATION_ID. If self-signin page retrieves one row from bin location table, then self-signin page will save the value of PICKUP_ALLOWED_YN as pickup allowed and the value of PURCHASE_ALLOWED_YN as purchase allowed. If pickup allowed is ‘Y’ and purchase allowed ‘Y’ then server self-signin page would display the form 33C as shown in FIG. 33C, so that the customer can select ‘Pickup an Order’ or ‘Purchase Items’. The form 33C would receive the values for owner identifier and location identifier. If the customer chooses ‘Pickup an Order’ option and tabs or clicks on ‘Proceed’ button then the self-signin page would display the form 33D as shown in FIG. 33D. If the customer chooses ‘Purchase Items’ option and tabs or clicks on ‘Proceed’ button then the self-signin page would display the form 33E as shown in FIG. 33E or the form 33F as shown in FIG. 33F. If pickup allowed is ‘Y’ and purchase allowed ‘N’ then server self-signin page would display the form 33D as shown in FIG. 33D. If pickup allowed is ‘N’ and purchase allowed ‘Y’ then server self-signin page would display the form 33E as shown in FIG. 33E or the form 33F as shown in FIG. 33F.

When a decision is required to decide whether to use form 33E or 33F, the decision will be made by server self-signin page based on whether a purchase authorization code already exists or not. When an app is used by the customer and if a purchase authorization code does not exist in the app then the server self-signin page would display the form 33E so that the customer can add a purchase authorization code in the app. When an app is used by the customer and if a purchase authorization code already exists in the app then the server self-signin page would display the form 33F so that the customer can close the purchase authorization code. When a browser is used by the customer and if a purchase authorization code does not exist in the bowser as a cookie, then the server self-signin page would display the form 33E so that the customer can add a purchase authorization code as a cookie to the browser. When a browser is used by the customer and if a purchase authorization code already exists in the browser as a cookie then the server self-signin page would display the form 33F so that the customer can delete the purchase authorization code cookie.

The forms 33D, form 33E and 33F would receive the values for owner identifier and location identifier.

When form 33D is presented the customers can enter an order identifier to signin to pickup the order already placed. When the customer enters an order identifier and clicks or tabs on “Save” button in form 33D, the form 33D would execute server signin process stored in bin pickup server using the values of owner identifier, location identifier and order identifier as input and receive a response. Order identifier is the data entered by the customer for order identifier in form 33D.

When server signin process is executed, server signin process will receive values for 3 inputs namely owner identifier, location identifier and order identifier and will start building a response from blank response. The server signin process would return a response in 2 segments. If the value in the first segment is 1, then the response is a successful response. If the value in the first segment is not 1, then the response is an error response. The text in the second segment will be text as a successful message if the response was a successful response. The text in the second segment will be the reason for the error if the response was an error response.

The server signin process would verify validity of the request by retrieving a row from bin location table using owner identifier for OWNER_ID, location identifier for LOCATION_TD and ‘Y’ for PICKUP_ALLOWED_YN. If the server signin process retrieves one row from bin location table, then the server signin process would continue, otherwise it will return an error response.

Then the server signin process would verify that the order identifier exists by retrieving a row from bin order identifier table using owner identifier for OWNER_ID, location identifier for LOCATION_ID and order identifier for ORDER_IDENTIFIER and ‘W’ for STATUS in the most recent row based on STATUS_SEQ for the same OWNER_ID, LOCATION_ID and ORDER_IDENTIFIER. If the server signin process retrieves one row from bin order identifier table, then the server signin process would save the values of ONE_TIME_CODE, ORDER_MOBILE_NO, NAME, PREPARATION_TIME, REQUESTED_DATETIME from the retrieved one row as one time code, order mobile number, name, preparation time and requested datetime respectively and continue, otherwise the server signin process would return an error message.

Then the server signin process would insert a row into bin order identifier table using owner identifier for OWNER_ID, location identifier for LOCATION_ID, order identifier for ORDER_IDENTIFIER, 1 or the maximum value of STATUS_SEQ for the same OWNER_ID, for the same LOCATION_ID, for the same ORDER_IDENTIFIER plus 1 for STATUS_SEQ,

‘R’ for STATUS, one time code for ONE_TIME_CODE, order mobile number for ORDER_MOBILE_NO, name for NAME, preparation time for PREPARATION_TIME, requested datetime REQUESTED_DATETIME and current server date and time for DATETIME. The value of 1 for STATUS_SEQ will be used when a row does not exist in bin order identifier table where OWNER_ID is equal to owner identifier, LOCATION_ID is equal to location identifier and ORDER_IDENTIFIER is equal to order identifier at the time of inserting a row into bin order identifier table. ‘R’ for STATUS would indicate that the customer is ready to pick up the order. If row insert into bin order identifier table is successful, then server signin process would respond with a successful response, otherwise it would return an error message. An example of a successful message may be “1|Signin is successful”.

After signing in to pick up already placed orders, the customers would be directed to wait until a smart bin locator is displayed for the placed order on at least one of the order large screens and then proceed to smart bin locator and pick up the order.

When the smart bin locator is displayed on one of the order large screen, the customers would enter a one-time code in the smart order bin keypad and then press unlock button or use an app provided by or interfaced with smart bin management server and scan the QR Code displayed on the smart order bin keypad with a biometric authentication such as finger print id or face id and then press the unlock button or use any generic QR Code reader app, scan the QR Code displayed on the smart order bin keypad, enter one-time code in the mobile device and press unlock button to access the smart order bin and pick up the order.

If the smart order bin is a smart sensor bin and if the entered code or biometric identifier is valid then the smart sensor bin will be unblocked, so that the order from smart order bin can be picked up. After a pre-determined time has passed the smart sensor bin will be automatically blocked, one-time code and one-time biometric identifier in the smart bin management server will be cleared.

If the smart order bin is a smart lock bin and if the entered code or biometric identifier is valid then the smart lock bin will be unlocked so that the order from smart order bin can be picked up. After a pre-determined time has passed the smart lock bin will be automatically locked, one-time code and one-time biometric identifier in the smart bin management server will be cleared.

If the smart bin management server is provided with an interface to communicate with the bin pickup server, then the smart bin management server would communicate with bin pickup server to notify that the order has been picked from a specific smart order bin and the smart order bin is empty. The interface will execute pickup update routine stored in bin pickup server. If the smart bin management server is not provided with an interface to communicate with the bin pickup server, then the merchant would use merchant order pickup update entry form 34A as shown in FIG. 34A or merchant order pickup update entry form 34B as shown in FIG. 34B. When form 34A or 34B is submitted, pickup update routine stored in bin pickup server will be executed. The purpose of using form 34A or 34B is to execute pickup update routine stored in bin pickup server for a specific smart order bin where the order from the specific smart order bin has already been picked up. The pickup update routine will insert rows into bin order status table and bin order identifier table so that the merchants can drop new orders into smart order bins that are empty.

To access order pickup update form in a browser, merchant would use any mobile device or desktop computer or laptop computer and log into bin pickup server using the values provided by the bin pickup service provider to the merchant for owner identifier, location identifier and location password. After logging in, the website order pickup update form as shown in FIG. 34A can be accessed, the order pickup update form would also receive owner identifier and location identifier and the order pickup update form would save ‘P’ as update type. The website order pickup update form will have a drop-down box where the merchants can select a smart order bin from a list of smart order bins. The list will be smart order bins that are marked as being loaded with orders in bin database. To get the list, the website order pickup update form would retrieve the value of BIN_LOCATOR from all rows from bin order status table using owner identifier for OWNER_ID, location identifier for LOCATION_ID, BIN_LOCATOR is not blank, STATUS_SEQ is equal to the most recent STATUS_SEQ based on OWNER_ID, LOCATION_ID and BIN_LOCATOR and ORDER_IDENTIFIER is not blank. The merchant would select a BIN_LOCATOR that is empty but marked as not empty in bin database.

When the merchant selects a BIN_LOCATOR and clicks on ‘Proceed’ button in the website order pickup update form, the bin pickup server would save the value of selected BIN_LOCATOR as bin locator and execute pickup update routine stored in bin pickup server using owner identifier, location identifier, bin locator and update type as inputs.

To access order pickup update form in an app, merchants would select order pickup update option in an app hosted by bin pickup server or in any app interfaced with bin pickup server. When app order pickup update form as shown in FIG. 34B is accessed, the app order pickup update form would also receive owner identifier and location identifier from the app and the app order pickup update form would save ‘P’ as update type. The merchant can use app order pickup update form 34B to scan a bin QR Code displayed on smart sensor order bins as shown in FIG. 32B or displayed on smart lock order bins as shown in FIG. 32D.

The displayed bin QR Code will have an application identifier, owner identifier, location identifier and bin locator. To validate the scanned code, the app would compare the owner identifier and location identifier from the scanned QR Code and the owner identifier and location identifier saved in the app. The mobile merchant app would also validate the application identifier. If the validation fails the app will not process the app order pickup update form. When the merchant clicks or taps on ‘Proceed’ button in the app order pickup update form, the merchant app would execute pickup update routine stored in bin pickup server using owner identifier, location identifier, bin locator and update type as inputs.

If the pickup update routine received 4 inputs, then the pickup update routine would save the 4 inputs as owner identifier, location identifier, bin locator and update type respectively, otherwise the pickup update routine will terminate.

If update type is ‘P’, then the pickup update routine would continue, otherwise the pickup update routine will terminate.

Then the pickup update routine would try to retrieve a row from bin location table using owner identifier for OWNER_ID, location identifier for LOCATION_ID and ‘Y’ for PICKUP_ALLOWED_YN. If the pickup update routine retrieves a row, then the pickup update routine will continue, otherwise it will return an error message and terminate. This will ensure that the bin locator is valid.

Then the pickup update routine would try to retrieve a row from bin table using owner identifier for OWNER_ID, location identifier for LOCATION_ID and bin locator for BIN_LOCATOR. If the pickup update routine retrieves a row, then the pickup update routine will continue, otherwise it will return an error message and terminate. This will ensure that the bin locator is valid.

Then the pickup update routine would try to retrieve a row from bin order status table using owner identifier for OWNER_ID, location identifier for LOCATION_ID, bin locator for BIN_LOCATOR, the maximum row of STATUS_SEQ for the same OWNER_ID, LOCATION_ID and BIN_LOCATOR for STATUS_SEQ and ORDER_IDENTIFIER is not blank. This will ensure that an order identifier loaded in the bin locator has not been set as picked up. If the pickup update routine retrieves a row, then the pickup update routine will save the value of ORDER_IDENTIFIER as order identifier from the retrieved one row and continue, otherwise it will return an error message and terminate.

Then the pickup update routine would try to retrieve a row from bin order identifier table, using owner identifier for OWNER_ID, location identifier for LOCATION_ID, order identifier for ORDER_IDENTIFIER, the maximum row of STATUS_SEQ for the same OWNER_ID, LOCATION_ID and ORDER_IDENTIFIER for STATUS_SEQ. If the pickup update routine retrieves a row from bin order identifier table and if the value of STATUS from the retrieved row is not ‘P’ then the pickup update routine will save the values ONE_TIME_CODE, ORDER_MOBILE_NO, NAME PREPARATION_TIME, and REQUESTED_DATETIME from the retrieved row as one time code, order mobile number, name, preparation time and requested datetime respectively, otherwise it will return an error message and terminate. This will ensure that an order identifier loaded in the bin locator has not been set as picked up.

Then the pickup update routine would insert a row into bin order status table using owner identifier for OWNER_ID, location identifier for LOCATION_ID, bin locator for BIN_LOCATOR, the maximum value of STATUS_SEQ for the same OWNER_ID, for the same LOCATION_ID, for the same BIN_LOCATOR plus 1 for STATUS_SEQ, blank for ORDER_IDENTIFIER and server date and time for DATETIME.

Then the pickup update routine would insert a row into bin order identifier table using owner identifier for OWNER_ID, location identifier for LOCATION_ID, order identifier for ORDER_IDENTIFIER, the maximum value of STATUS_SEQ for the same OWNER_ID, for the same LOCATION_ID, for the same ORDER_IDENTIFIER plus 1 for STATUS_SEQ, one time code for ONE_TIME_CODE, order mobile number for ORDER_MOBILE_NO, name for NAME, preparation time for PREPARATION_TIME, requested datetime for REQUESTED_DATETIME and server date and time for DATETIME.

If the insert of a row into bin order status table and insert of a row into bin order identifier table are successful, then pickup update routine would return a successful message. otherwise it will return an error message.

If the merchant receives an error response, then the merchant will fix the problems as per the message included in the error response.

When an order is ready and at the time of dropping the order into smart order bin which could be smart sensor order bin or smart lock order bin, the merchant would send the order identifier and the bin locator to the bin pickup server using a web site order drop update form in a web site hosted by bin pickup server as shown in FIG. 35A or using an app order drop update form in an app provided by the bin pickup server or in an app interfaced with bin pickup server, as shown in FIG. 35B to update the order drop in bin order identifier table and bin order status table.

To access web site order drop update form, merchant would use any mobile device or desktop computer or laptop computer to log into bin pickup server using the values provided by the bin pickup service provider to the merchant for owner identifier, location identifier and location password. After logging in, when website order drop update form as shown in FIG. 35A is accessed, the website order drop update form would also receive owner identifier and location identifier and the website order drop update form would save ‘D’ as access type.

To access the app order drop update form in the app, merchant would select order drop update option in the app. When app order drop update form as shown in FIG. 35B is accessed, the app order drop update form would also receive owner identifier and location identifier saved in the app and the app order drop update form would save ‘D’ as update type.

The merchant can use website order drop update form to select an available bin locator and to enter the order identifier to update the dropping of the order into smart order bin. To get the list of available bin locators where bin locators are not loaded, the website order drop update form would retrieve all the most recent rows based on STATUS_SEQ for the same OWNER_ID, LOCATION_ID and BIN_LOCATOR from bin order status table where the value of OWNER_ID is owner identifier, the value of LOCATION_ID is location identifier and the value of ORDER_IDENTIFIER is blank. The values of BIN_LOCATOR of all the retrieved rows would be the list of bin locators that is currently available. When the merchant selects a bin locator that is currently available in website order drop update form, the website order drop update form would save the value of BIN_LOCATOR of the selected bin locator from the list as bin locator and save the value entered by the merchant for order identifier as order identifier. When the merchant clicks or taps on ‘Proceed’ button in the website order drop update form, the bin pickup server would execute server order drop update routine programmed in the bin pickup server using owner identifier, location identifier, bin locator, order identifier and update type as inputs for the server order drop update routine.

The merchant can use app order drop update form to scan a QR Code displayed at the bin locator where the displayed bin QR Code will have an application identifier in the first node, owner identifier in the second node, location identifier in the third identifier and the bin locator in the fourth node and to scan the QR Code printed on the order receipt where the printed QR Code will have order identifier. The app would compare the owner identifier and location identifier from the scanned bin QR Code displayed at the bin locator and owner identifier and location identifier saved in the app. If they are not the same, then the app will not process the app order drop update form. When the merchant clicks or taps on ‘Proceed’ button in the app order drop update form, the app would execute server order drop update routine programmed in the bin pickup server using owner identifier, location identifier, bin locator, order identifier and update type.

When the server order drop update routine is executed, the server order drop update routine would verify the received inputs and if the received inputs are valid then the server order drop update routine would insert a row into bin order status table, insert a row into bin order identifier table and send a success message as return response, otherwise the server order drop update routine would send an error message as response or will not sent any response. The success message may be a message informing the merchant thar order drop update process is successful and the order can be dropped-off smart order bin. The error message would depend on the type of error.

The inputs and responses may be based on the specification provided by the bin pickup service provider for server order drop update routine. The return response will have at least 2 pieces of information where the first piece is a return code, and the second piece of information will be a display message. The return code will be used for further processing whereas the display message will be displayed as a response.

If the server order drop update routine received 5 inputs, then the server order drop update routine would save the 5 inputs as owner identifier, location identifier, bin locator, order identifier and update type respectively, otherwise the server order drop update routine will terminate

If update type is ‘D’, then the server order drop update routine would continue, otherwise the server order drop update routine will terminate.

Then the server order drop update routine would try to retrieve a row from bin location table using owner identifier for OWNER_ID, location identifier for LOCATION_ID and ‘Y’ for PICKUP_ALLOWED_YN. If the server order drop update routine retrieves a row, then the server order drop update routine will save the value of ONE_TIME_CODE_LENGTH from the retrieved row as one time code length and continue, otherwise it will return an error message and terminate. This will ensure that the bin locator is valid.

Then the server order drop update routine would verify that the format of order identifier is valid. If the one time code length is greater than 0 and if the length of order identifier is less than the one time code length, then server order drop update routine will return an error message and terminate.

Then the server order drop update routine would try to retrieve a row from bin table using owner identifier for OWNER_ID, location identifier for LOCATION_ID and bin locator for BIN_LOCATOR. If the server order drop update routine retrieves a row, then the server order drop update routine will save the value of BIN_INTERNAL_ID from the retrieved one row as bin internal identifier and continue, otherwise it will return an error message and terminate. This will ensure that the bin locator is valid.

Then the server order drop update routine would try to retrieve a row from bin order status table using owner identifier for OWNER_ID, location identifier for LOCATION_ID, bin locator for BIN_LOCATOR, the maximum row of STATUS_SEQ for the same OWNER_ID, LOCATION_ID and BIN_LOCATOR for STATUS_SEQ and blank for ORDER_IDENTIFIER. This will ensure that the bin locator is empty. If the server order drop update routine retrieves a row, then the server order drop update routine will continue, otherwise it will return an error message and terminate.

Then the server order drop update routine would try to retrieve a row from bin order status table using owner identifier for OWNER_ID, location identifier for LOCATION_ID, BIN_LOCATOR is not blank, the maximum row of STATUS_SEQ for the same OWNER_ID, LOCATION_ID and BIN_LOCATOR for STATUS_SEQ and order identifier for ORDER_IDENTIFIER. This will ensure that the order identifier is not loaded in any other bin locator. If the server order drop update routine retrieves a row, then the server order drop update routine will return an error message and terminate.

Then the server order drop update routine would try to retrieve a row from bin order identifier table, using owner identifier for OWNER_ID, location identifier for LOCATION_ID, order identifier for ORDER_IDENTIFIER, the maximum row of STATUS_SEQ for the same OWNER_ID, LOCATION_ID and ORDER_IDENTIFIER for STATUS SEQ and ‘W’ for STATUS. If the server nc order drop update routine retrieves a row from order identifier table then the server order drop update routine will save the value of ORDER_MOBILE_NO from the retrieved one row as update order mobile number, the value of NAME from the retrieved one row as update name, the value of PREPATION_TIME from the retrieved one row as update preparation time and the value of REQUESTED_DATETIME from the retrieved one row as update requested datetime, otherwise it will return an error message and terminate. This will ensure that the order having the order identifier was placed and is waiting to be dropped off into a smart order bin.

If one time code length greater then 0 then server order drop update routine will set the last one time code length characters in the order identifier as update one time code, otherwise the server order drop update routine will set a random number as update one time code. Then server order drop update routine will insert a row into bin order identifier table using order identifier for ORDER_IDENTIFIER, ‘L’ for STATUS, update one time code for ONE_TIME_CODE, update order mobile number for ORDER_MOBILE_NO, update name for NAME, update preparation time for PREPATION_TIME and update requested datetime for REQUESTED_DATETIME in addition to using appropriate values for other fields such as OWNER_ID, LOCATION_ID, STATUS_SEQ and DATETIME.

Then the server order drop update routine will notify the order management server, if an interface to send data to order management server from bin pickup server and an interface to send data to bin management server from order management server are set up, otherwise the server order drop update routine will notify the bin management server, if an interface to send data to bin management server from bin pickup server is set up. If an interface is set up server order drop update routine will send owner identifier, location identifier, bin internal identifier, update one time code and update order mobile number to order management server or to bin management server.

Then the server order drop update routine would return a successful message to the merchant. If an interface to send data to order management server is not set up and to bin management server is not set up, then the success message would also include the value of update one time code and update order mobile number. If the merchant receives a successful message, then the merchant would drop the order inside the bin locator. If the successful message received by the merchant also includes update one time code and update order mobile number, then the merchant would use a web site or an app provided by bin management server to send update one time code and update order mobile number to bin management server. How the merchant would send smart lock internal identifier, one-time code and an order mobile number is beyond the scope of this invention.

A one-time code may also be printed on the receipt. The virtual order terminals would also update the content of the display monitor accordingly.

If pickup allowed is ‘Y’ and purchase allowed ‘Y’ then server self-signin page would display the form 33C, so that the customer can select ‘Purchase Items’ to access the form 33E or 33F. If pickup allowed is ‘N’ and purchase allowed ‘Y’ then server self-signin page would display the form 33E or 33F.

Form 33E will be presented only when a purchase authorization code has not been set up. If a purchase authorization code has already been set up, then the customer will be directed to form 33F. When form 33E is presented, the customers can enter payment information to get a purchase authorization code. When form 33E or 33F is presented, the forms would automatically receive owner identifier and location identifier from bin pickup server. When the customer enters card number, expiration, name, security code, authorization amount and clicks or tabs on “Save” button in form 33E, the form 33E would execute server purchase authorization add process stored in bin pickup server using the values of owner identifier, location identifier, card number, expiration, name, security code and authorization amount as input and receive a response. Card number, expiration, name, security code and authorization amount are the data entered by the customer. Since the data entered by the customer is sensitive information, the form 33E and server purchase authorization add process will be encrypted.

When server purchase authorization add process is executed, server purchase authorization add process will receive values for 7 inputs namely owner identifier, location identifier, card number, expiration, name, security code and authorization amount and will start building a response from blank response. The server purchase authorization add process would return a response in 2 segments. If the value in the first segment is 1, then the response is a successful response. If the value in the first segment is not 1, then the response is an error response. If the response was an error response, then the text in the second segment will be the reason for the error.

The server purchase authorization add process would verify validity of the request by retrieving a row from bin location table using owner identifier for OWNER_ID, location identifier for LOCATION_ID and ‘Y’ for PURCHASE_ALLOWED_YN. If the server purchase authorization add process retrieves one row from bin location table, then the server purchase authorization add process would continue, otherwise it will return an error response.

If an app is used by the customer and if a purchase authorization code exists in the app, then the server purchase authorization add process will return an error response.

If a browser is used by the customer and if a purchase authorization code exists in the browser as a cookie, then the server purchase authorization add process will return an error response.

Then the server purchase authorization add process would communicate with a payment gateway using card number, expiration, name, security code and authorization amount to get a payment authorization code. If the server purchase authorization add process receives a payment authorization code from the payment gateway, then server purchase authorization add process will continue otherwise it will return an error response.

It may be beyond the scope of this invention to give details on the operation of payment gate. It is sufficient to note that a payment gateway can process a payment card to issue a payment authorization code for a requested amount as an authorized amount and later the payment gateway can accept the payment authorization code, process a used amount as captured amount and issue a payment captured code. The captured amount will be the actual final amount charged to the payment card.

Then the server purchase authorization add process would insert a row into bin purchase authorization table using owner identifier for OWNER_ID, location identifier for LOCATION_ID, payment authorization code for PURCHASE_AUTH_CODE, 1 or the maximum value of STATUS_SEQ for the same OWNER_ID, for the same LOCATION_ID, for the same PURCHASE_AUTH_CODE plus 1 for STATUS_SEQ, ‘A’ for STATUS, authorization amount for AUTHORIZED_AMOUNT, 0 for USED_AMOUNT and current server date and time for DATETIME. It is worth nothing that if payment authorization code is always unique, then the value of STATUS_SEQ will always be 1. If inserting a row into bin purchase authorization table is successful, then the server purchase authorization add process will continue, otherwise it will return an error response.

If an app is used by the customer, then the payment authorization code will be saved in the app. If a browser is used by the customer, then the payment authorization code will be saved in the browser as a cookie.

Then the server purchase authorization add process will return a successful message.

Form 33F will be presented only when a purchase authorization code has already been set up. If a purchase authorization code has not been set up, then the customer will be directed to form 33E. When form 33F is presented, the customers can delete an existing purchase authorization code. When the customer selects the option ‘Delete Purchase Authotization’ and tabs or clicks on ‘Save’ button in form 33F, the form 33F would execute server purchase authorization delete process stored in bin pickup server.

When server purchase authorization delete process is executed, server purchase authorization delete process will receive values for 2 inputs namely owner identifier and location identifier and will start building a response from blank response. The server purchase authorization delete process would return a response in 2 segments. If the value in the first segment is 1, then the response is a successful response. If the value in the first segment is not 1, then the response is an error response. If the response was an error response, then the text in the second segment will be the reason for the error.

The server purchase authorization delete process would verify validity of the request by retrieving a row from bin location table using owner identifier for OWNER_ID, location identifier for LOCATION_TD and ‘Y’ for PURCHASE_ALLOWED_YN. If the server purchase authorization delete process retrieves one row from bin location table, then the server purchase authorization delete process would continue, otherwise it will return an error response.

If an app is used by the customer and if a purchase authorization code exists, then the server purchase authorization delete process would save the value of purchase authorization code from the app as purchase authorization code, otherwise the server purchase authorization delete process will return an error response. If a browser is used by the customer and if a purchase authorization code exists in the browser as a cookie, then the server purchase authorization delete process would save the value of purchase authorization code cookie from the browser as purchase authorization code, otherwise the server purchase authorization delete process will return an error response.

Then the server purchase authorization delete process would verify the validity of purchase authorization code by retrieving a row from bin purchase authorization table using owner identifier for OWNER_ID, location identifier for LOCATION_ID, purchase authorization code for PURCHASE_AUTH_CODE, and ‘A’ for STATUS in the most recent row based on STATUS_SEQ for the same OWNER_ID, LOCATION_ID and PURCHASE_AUTH_CODE. If the server purchase authorization delete process retrieves one row from bin purchase authorization table, then the server purchase authorization delete process would save STATUS_SEQ, AUTHORIZED_AMOUNT and USED_AMOUNT from the retrieved row as status sequence, authorized amount and used amount respectively, otherwise it will return an error response.

Then the server purchase authorization delete process would communicate with a payment gateway using payment authorization code and used amount to get a payment captured code. If the payment authorization code and the used amount are valid then the payment gateway would verify the payment authorization code and set the used amount as captured amount and return a payment captured code. The captured amount is the actual amount charged to the payment card.

If the server purchase authorization delete process receives a payment captured code from the payment gateway, then server purchase authorization delete process will continue otherwise it will return an error response.

If an app is used by the customer and if a purchase authorization code exists, then the server purchase authorization delete process would delete the purchase authorization code from the app. If a browser is used by the customer and if a purchase authorization code exists in the browser as a cookie, then the server purchase authorization delete process would delete the purchase authorization code cookie from the browser.

Then the server purchase authorization delete process would add 1 to status sequence and insert a row into bin purchase authorization table using owner identifier for OWNER_ID, location identifier for LOCATION_ID, payment authorization code for PURCHASE_AUTH_CODE, status sequence for STATUS_SEQ, ‘I’ for STATUS, authorized amount for AUTHORIZED_AMOUNT, used amount for USED_AMOUNT and current server date and time for DATETIME.

If a row insert into bin purchase authorization table is successful, then server purchase authorization delete process will return a successful response, otherwise it will return an error response.

When a customer or merchant scans a bin QR Code displayed on smart merchandise bins, the customer or merchant will be directed to server consumer merchandise view page hosted by bin pickup server. Server consumer merchandise view page is the link used in the bin QR Code. When a merchant scans bin QR Code using a merchant app provided by bin pickup server or using a merchant app interfaced with bin pickup server then the merchant will be redirected to server app merchant merchandise view page hosted by bin pickup server including any parameter received by server consumer merchandise view page.

The server consumer merchandise view page will display the details of merchandise available for purchase from any smart merchandise bins which can be smart sensor merchandise bins or smart lock merchandise bins as shown in FIG. 36A which is also referred to as form 36A. Using form 36A, consumers will be able to purchase and pickup merchandise from smart merchandise bins. If the server consumer merchandise view page receives a parameter by name QAT_Code and if the content of QAT_Code is ‘-’ delimited string with 4 nodes then server consumer merchandise view page will continue, otherwise it will terminate. The server consumer merchandise view page will save the value in the first node as an application identifier, the value in the second node as owner identifier, the value in the third node as location identifier and the value in the fourth node as bin locator. If application identifier is valid then the server consumer merchandise view page will continue, otherwise it will terminate. Since customer scanned the QR Code ‘C’ will be saved as access type.

When a browser is used by the customer to scan the bin QR Code, then the server consumer merchandise view page will verify whether an authorization code exists in the browser as a cookie. If an authorization code exists in the browser as a cookie, then the server consumer merchandise view page would save the value of authorization code cookie as authorization code, otherwise a blank value will be saved as authorization code. The server consumer merchandise view page would execute server consumer merchandise view routine using owner identifier, location identifier, bin locator, authorization code and access type as input.

When a customer app provided by bin pickup server or a customer app interfaced with bin pickup server is used by the customer to scan the bin QR Code, then the customer app will verify the owner identifier and location identifier using the values stored in the customer app database. If the values of owner identifier and location identifier saved in the customer app database are same as owner identifier and location identifier received from QR Code, then server consumer merchandise view page will continue, otherwise it will terminate. If an authorization code exists in the customer app database, then the server consumer merchandise view page would save the value of authorization code saved in the customer app database as authorization code, otherwise a blank value will be saved as authorization code. The server consumer merchandise view page will execute server consumer merchandise view routine using owner identifier, location identifier, bin locator, authorization code and access type as input.

If server consumer merchandise view routine processes the input successfully, then server consumer merchandise view routine will display merchandise view form 36A, otherwise server consumer merchandise view routine will display an error message and terminate the process.

If the server consumer merchandise view routine receive 5 inputs, then the server consumer merchandise view routine would save the 5 inputs as owner identifier, location identifier, bin locator, authorization code, and access type respectively, otherwise server consumer merchandise view routine will terminate.

The server consumer merchandise view routine will verify the owner identifier and location identifier using bin location table and verify bin locator using bin table. To verify the owner identifier and location identifier, the server consumer merchandise view routine will retrieve a row from bin location table using owner identifier for OWNER_ID, location identifier for LOCATION_ID and ‘Y’ for PURCHASE_ALLOWED_YN. If the server consumer merchandise view routine retrieves own row from bin location table, then server consumer merchandise view routine will continue the process, otherwise it will terminate. To verify bin locator the server consumer merchandise view routine will retrieve a row from bin table using owner identifier for OWNER_ID, location identifier for LOCATION_ID and bin locator for BIN_LOCATOR. If the server consumer merchandise view routine retrieves one row from bin table, then server consumer merchandise view routine will continue the process, otherwise it will terminate.

The server consumer merchandise view routine will retrieve item name, description and price from bin database using bin item content table and bin item identifier table.

The server consumer merchandise view routine will retrieve one row from bin item content table using owner identifier for OWNER_ID, location identifier for LOCATION_ID, bin locator for BIN_LOCATOR and the maximum value of CONTENT_SEQ for the same OWNER_ID, for the same LOCATION_ID and for the same BIN_LOCATOR for CONTENT_SEQ. If server consumer merchandise view routine retrieves one row from bin item content table, then server consumer merchandise view routine will save the values of ITEM_IDENTIFIER and ONE_TIME_CODE as item identifier and one time code respectively and will continue the process, otherwise it will terminate.

The server consumer merchandise view routine will retrieve one row from bin item identifier table using owner identifier for OWNER_ID, location identifier for LOCATION_ID and item identifier for ITEM_IDENTIFIER. If server consumer merchandise view routine retrieves one row from bin item identifier table, then server consumer merchandise view routine will save the values of ITEM_NAME, ITEM_DESCR and ITEM_PRICE as item name, item description and item price respectively and will continue the process, otherwise it will terminate.

The server consumer merchandise view routine will retrieve one row from bin purchase authorization table using owner identifier for OWNER_ID, location identifier for LOCATION_ID and authorization code for PURCHASE_AUTH_CODE, the maximum value of STATUS_SEQ for the same OWNER_ID, for the same LOCATION_ID and for the same PURCHASE_AUTH_CODE for STATUS_SEQ and ‘A’ for STATUS. If server consumer merchandise view routine retrieves one row from bin purchase authorization table, then server consumer merchandise view routine will save the values of AUTHORIZED_AMOUNT and USED_AMOUNT as item authorized amount and item used amount respectively, otherwise it will save 0 as item authorized amount and 0 as item used amount.

The server consumer merchandise view routine will display bin locator for Bin Locator, item name for Name, item description for Description, item price for Price and ‘Quit’ button as shown in FIG. 36A. If the authorization amount is equal or greater than the used amount plus item price, then server consumer merchandise view routine will also display ‘Purchase’ button in form 36A and accompanying text, otherwise ‘Purchase’ button and the accompanying text will not be displayed.

If the ‘Purchase’ button is displayed and if the consumer wants to pick up the merchandise from the bin locator shown in the form 36A, then the consumer can click or tap on ‘Purchase’ button to pay for the merchandise to be picked up and to receive a one-time code as shown in FIG. 36B which is also referred to as form 36B.

When the ‘Purchase’ button is clicked or tapped, the form 36A will execute server consumer merchandise purchase routine using owner identifier, location identifier, bin locator, authorization code and access type as input.

If the server consumer merchandise purchase routine receive 5 inputs, then the server consumer merchandise purchase routine would save the 5 inputs as owner identifier, location identifier, bin locator, authorization code and access type respectively, otherwise server consumer merchandise purchase routine will terminate.

The server consumer merchandise purchase routine will verify the owner identifier and location identifier using bin location table and verify bin locator using bin table. To verify the owner identifier and location identifier, the server consumer merchandise purchase routine will retrieve a row from bin location table using owner identifier for OWNER_ID, location identifier for LOCATION_ID and ‘Y’ for PURCHASE_ALLOWED_YN. If the server consumer merchandise purchase routine retrieves own row from bin location table, then server consumer merchandise purchase routine will continue the process, otherwise it will terminate. To verify bin locator the server consumer merchandise purchase routine will retrieve a row from bin table using owner identifier for OWNER_ID, location identifier for LOCATION_ID and bin locator for BIN_LOCATOR. If the server consumer merchandise purchase routine retrieves one row from bin table, then server consumer merchandise purchase routine will continue the process, otherwise it will terminate.

The server consumer merchandise purchase routine will retrieve one row from bin item content table using owner identifier for OWNER_ID, location identifier for LOCATION_ID, bin locator for BIN_LOCATOR and the maximum value of CONTENT_SEQ for the same OWNER_ID, for the same LOCATION_ID and for the same BIN_LOCATOR for CONTENT_SEQ. If server consumer merchandise purchase routine retrieves one row from bin item content table, then server consumer merchandise purchase routine will save the values of ITEM_IDENTIFIER and ONE_TIME_CODE as item identifier and one time code respectively and will continue the process, otherwise it will terminate.

The server consumer merchandise purchase routine will retrieve one row from bin item identifier table using owner identifier for OWNER_ID, location identifier for LOCATION_ID and item identifier for ITEM_IDENTIFIER. If server consumer merchandise purchase routine retrieves one row from bin item identifier table, then server consumer merchandise purchase routine will save the values of ITEM_NAME, ITEM_DESCR and ITEM_PRICE as item name, item description and item price respectively and will continue the process, otherwise it will terminate.

The server consumer merchandise purchase routine will retrieve one row from bin purchase authorization table using owner identifier for OWNER_ID, location identifier for LOCATION_ID and authorization code for PURCHASE_AUTH_CODE, the maximum value of STATUS_SEQ for the same OWNER_ID, for the same LOCATION_ID and for the same PURCHASE_AUTH_CODE for STATUS_SEQ and ‘A’ for STATUS. If server consumer merchandise purchase routine retrieves one row from bin purchase authorization table, then server consumer merchandise purchase routine will save the values of AUTHORIZED_AMOUNT and USED_AMOUNT as item authorized amount and item used amount respectively, otherwise it will save 0 as item authorized amount and 0 as item used amount. If item authorization amount is equal or greater than the item used amount plus item price, then server consumer merchandise purchase routine will continue, otherwise it will be terminated.

The server consumer merchandise purchase routine will insert a row into bin purchase authorization table using owner identifier for OWNER_ID, location identifier for LOCATION_ID, authorization code for PURCHASE_AUTH_CODE, 1 or the maximum value of STATUS_SEQ for the same OWNER_ID, for the same LOCATION_ID, for the same PURCHASE_AUTH_CODE plus 1 for STATUS_SEQ, ‘A’ for STATUS, item authorized amount for AUTHORIZED_AMOUNT, item used amount plus item price for USED_AMOUNT and current server date and time for DATETIME.

The server consumer merchandise purchase routine will insert a row into bin purchase content table using owner identifier for OWNER_ID, location identifier for LOCATION_ID, authorization code for PURCHASE_AUTH_CODE, 1 or the maximum value of CONTENT_SEQ for the same OWNER_ID, for the same LOCATION_ID, for the same PURCHASE_AUTH_CODE plus 1 for CONTENT_SEQ, item identifier for ITEM_IDENTIFIER and current server date and time for DATETIME.

The server consumer merchandise purchase routine will insert a row into bin item content table using owner identifier for OWNER_ID, location identifier for LOCATION_ID, bin locator for BIN_LOCATOR, 1 or the maximum value of CONTENT_SEQ for the same OWNER_ID, for the same LOCATION_ID, for the same BIN_LOCATOR plus 1 for CONTENT_SEQ, blank for ITEM_IDENTIFIER, blank for ONE_TIME_CODE and current server date and time for DATETIME.

The server consumer merchandise purchase routine will display bin locator for Bin Locator, item name for Name, item description for Description, item price for Price, one time code for One Time Code and ‘Quit’ button as shown in FIG. 36B which is also referred to as form 36B. The instruction text displayed at the bottom can be a standard text or can be customized.

Upon receiving a valid one time code, the bin management server will instruct the smart merchandise bin to unlock or unblock so that the customer can pick up the merchandise. After a pre-determined time has passed the smart merchandise bin will be automatically locked or blocked and one-time code in bin management server database will be cleared.

Those of ordinary skill in the art will readily recognize that many methods can be used to change the status of smart merchandise bins such as finger print id, face id, biometric identifiers, mobile numbers, two-factor authentication and the like in addition to or instead of one time code.

When a merchandise item is ready for sale and at the time of dropping the merchandise item into a smart merchandise bin, the merchant would update the merchandise item drop in bin item content table using a browser merchandise drop update form hosted in a virtual merchandise terminal as shown in FIG. 37A or using an app merchandise drop update form in a merchant app provided by bin pickup server or in a merchant app interfaced with bin pickup server as shown in FIG. 37B.

To access browser merchandise drop update form, merchants would log into virtual merchandise terminal using owner identifier, location identifier and location password provided to the merchant by bin pickup service provider, and can select the option merchandise drop update form. Then the merchants will be directed to server browser merchandise view page hosted by bin pickup server which will display the browser merchandise drop update form as shown in FIG. 37A which is also referred to as form 37A. Form 37A will automatically receive owner identifier and location identifier. Then the merchants can select a merchandise identifier from a list of merchandise identifiers, select a bin locator from a list of available bin locators and click on ‘Save’ button. To get a list of merchandise identifiers, the browser merchandise drop update form would retrieve rows from bin item identifier table using owner identifier for OWNER_ID and location identifier for ‘LOCATION_ID’ and save the values of ITEM_IDENTIFIERS and ITEM_NAME as item identifiers and item name respectively in the list of merchandise identifiers. To get a list of available bin locators, the browser merchandise drop update form would retrieve rows from bin table using owner identifier for OWNER_ID and location identifier for ‘LOCATION_ID’ and save the values of BIN_LOCATOR in the list of available bin locators. Then the browser merchandise drop update form would get a list of loaded bin locators by retrieving rows from bin item content table using owner identifier for OWNER_ID, location identifier for ‘LOCATION_ID’ BIN_LOCATOR is not blank, the maximum value of CONTENT_SEQ for the same OWNER_ID, for the same LOCATION_ID, for the same BIN_LOCATOR for CONTENT_SEQ and ITEM_IDENTIFIER is not blank and saving the values of BIN_LOCATOR in the list of loaded bin locators. Then the browser merchandise drop update form would delete the bin locators in the list of available bin locators that exist in the list of loaded bin locators to get a final list of available bin locators. Form 37A would display the list of merchandise identifiers for ‘Select Merchandise Identifier’ option so that the merchant can select a merchandise identifier from the list of merchandise identifiers. Form 37A would display the list of available bin locators for ‘Select Bin Locator’ option so that the merchant can select a bin locator from the list of available bin locators. When the merchant selects a merchandise identifier, a bin locator and clicks on ‘Save’ button, the browser merchandise drop update form would execute server merchandise drop update routine using owner identifier, location identifier, the selected merchandise identifier and the selected bin locator as inputs. The browser merchandise drop update form would receive a response which may be ‘1’ delimited text. The value in the first node will be a return code and the value in the second node will be a message. If the return code is ‘1’ then the value in the second node will be a successful message, otherwise it will be an error message. The browser merchandise drop update form would display the message, so that the merchant can take further action. If the displayed message contains bin locator internal identifier and a one-time code, then the merchant would use an app or a web site provided by bin management service provider for the merchant to send the bin locator internal identifier and the one-time code to the bin management server.

When a customer or merchant scans a bin QR Code displayed on smart merchandise bins, the customer or merchant will be directed to server consumer merchandise view page hosted by bin pickup server. Server consumer merchandise view page is the link used in the bin QR Code. When a merchant scans bin QR Code using a merchant app provided by bin pickup server or using a merchant app interfaced with bin pickup server then the merchant will be redirected to server app merchant merchandise view page hosted by bin pickup server.

If the server app merchant merchandise view page receives a parameter by name QAT_Code and if the content of QAT_Code is ‘-’ delimited string with 4 nodes then server app merchant merchandise view page will continue, otherwise it will terminate. The server app merchant merchandise view page will save the value in the first node as an application identifier, the value in the second node as owner identifier, the value in the third node as location identifier and the value in the fourth node as bin locator. If application identifier is valid then the server app merchant merchandise view page will continue, otherwise it will terminate.

Then the app merchant merchandise view page will verify the owner identifier and location identifier using the values stored in the merchant app database. If the values of owner identifier and location identifier saved in the merchant app database are same as owner identifier and location identifier received by the app merchant merchandise view page, then server app merchant merchandise view page will continue, otherwise it will terminate.

Then the server app merchant merchandise view page will display the app merchandise drop update form as shown in FIG. 37B which is also referred to as form 37B. Form 37B will automatically receive owner identifier, location identifier and bin locator. Then the merchants can select a merchandise identifier from a list of merchandise identifiers and click on ‘Save’ button. To get a list of merchandise identifiers, the app merchandise drop update form would retrieve rows from bin item identifier table using owner identifier for OWNER_ID and location identifier for ‘LOCATION ID’ and save the values of ITEM_IDENTIFIERS and ITEM_NAME as item identifiers and item name respectively in the list of merchandise identifiers.

Form 37B would display the list of merchandise identifiers for ‘Select Merchandise Identifier’ option so that the merchant can select a merchandise identifier from the list of merchandise identifiers. Form 37B would display bin locator for ‘Bin Locator’. When the merchant selects a merchandise identifier and clicks on ‘Save’ button, the app merchandise drop update form would execute server merchandise drop update routine using owner identifier, location identifier, the selected merchandise identifier and bin locator as inputs. The app merchandise drop update form would receive a response which may be ‘l’ delimited text. The value in the first node will be a return code and the value in the second node will be a message. If the return code is ‘1’ then the message will be a successful message, otherwise it will be an error message. The browser merchandise drop update form would display the message, so that the merchant can take further action. If the displayed message contains bin locator internal identifier and a one-time code, then the merchant would use an app or a web site provided by bin management service provider for the merchant to send the bin locator internal identifier and the one-time code to the bin management server.

When the server merchandise drop update routine is executed, the server merchandise drop update routine will return a response which will be a ‘l’ delimited text where the content of the first node will be return code and the content of the second node will be a return message. If the return code is ‘1’ then the return message will be a successful message, otherwise it will be an error message. If server merchandise drop update routine terminates before successful completion, then the return code will be other than ‘1’ and the return message will be the reason for the termination.

When the server merchandise drop update routine is executed, the server merchandise drop update routine would verify the received inputs and if the received inputs are valid then the server merchandise drop update routine would insert a row into bin item content table and send a success message as return response, otherwise the server merchandise drop update routine would send an error message as response or will not sent any response.

If the server merchandise drop update routine received 4 inputs, then the server merchandise drop update routine would save the 4 inputs as owner identifier, location identifier, merchandise identifier and bin locator respectively, otherwise the server merchandise drop update routine will terminate.

Then the server merchandise drop update routine would try to retrieve a row from bin location table using owner identifier for OWNER_ID, location identifier for LOCATION_ID and ‘Y’ for PURCHASE_ALLOWED_YN. If the server merchandise drop update routine retrieves a row, then the server merchandise drop update routine will continue, otherwise it will terminate. This will ensure that the owner identifier and location identifier are valid.

Then the server merchandise drop update routine would try to retrieve a row from bin table using owner identifier for OWNER_ID, location identifier for LOCATION_ID and bin locator for BIN_LOCATOR. This will ensure that the bin locator is valid. If the server merchandise drop update routine retrieves a row, then the server merchandise drop update routine will continue, otherwise it will terminate.

Then the server merchandise drop update routine would try to retrieve a row from bin item identifier table using owner identifier for OWNER_ID, location identifier for LOCATION_ID and merchandise identifier for ITEM_IDENTIFIER. This will ensure that the merchandise identifier is valid. If the server merchandise drop update routine retrieves a row, then the server merchandise drop update routine will continue, otherwise it will terminate.

Then the server merchandise drop update routine would try to retrieve a row from bin item content table, using owner identifier for OWNER_ID, location identifier for LOCATION_ID, bin locator for BIN_LOCATOR, the maximum row of CONTENT_SEQ for the same OWNER_ID, LOCATION_ID and BIN_LOCATOR for CONTENT_SEQ and ITEM_IDENTIFIER is not blank. If the server merchandise drop update routine retrieves a row the server merchandise drop update routine will terminate, otherwise it will continue. This will ensure that the bin locator is empty.

Then server merchandise drop update routine will create a unique one time code that can be used by the customers to pick up the merchandise from the bin locator and will insert a row into bin item content table using owner identifier for OWNER_ID, location identifier for LOCATION_ID, bin locator for BIN_LOCATOR, 1 or the maximum value of CONTENT_SEQ for the same OWNER_ID, for the same LOCATION_ID, for the same BIN_LOCATOR plus 1 for CONTENT_SEQ, merchandise identifier for ITEM_IDENTIFIER, one time code for ONE_TIME_CODE and server date and time for DATETIME.

Then the server merchandise drop update routine will return a successful message which would be a ‘1’ delimited text have a return code, bin locator internal identifier and one time code. The example of a successful message would be ‘1|Bin Locator Internal Identifier: 23918310|One-Time Code: 4629’.

### Pickup Automation

### Self-Check-Out Automation

The purpose of any self-check-out is to let the customers (buyers) check-out without help from employees. At the self-check-out, customers are instructed to scan each item and place the scanned items inside a shopping bag whereas at employees operated check-out counters, employees scan each item and place the scanned item inside a shopping bag. Self-check-out are not a 100% employee free operation. Self-check-outs can reduce the number of employees required for check-out operation. To protect the store from self-check-out pirates, the self-check-out machines are constantly monitored by store employees and by video cameras. Self-check-out pirates are customers placing the items inside the shopping bag without scanning the item or placing more expensive items inside the shopping bag while scanning less expensive items. Even though weighing scales are used to check the weight of items placed in the bag, there is no method to check the item placed in the bag is the same item scanned before placing the item in the bag. Customers, even after checking out using self-check-out machines, can continue shopping, because customers after checking out at self-check-out machines are still inside shopping area. Additional manpower will be required to verify the items carried through the barrier separating secured areas from unsecured areas. For the sake of reducing employee cost, merchants prefer placing self-check-out machines rather than using fully employee operated self-check-out machines, but self-check-out machines are still vulnerable to self-check-out pirates.

The current self-check-out machines are decades old and at best is only semi-secured machines.

If self-check-out machines use sensors, chambers, scanners and conveyors where customers can load the items inside self-check-out machines from secured areas and pickup loaded items from self-check-out machines from unsecured areas, then self-check-out machines can be fully secured and monitoring self-check-out machines by employees and/or checking the shopping carts at the exit, which is a barrier separating secured areas from unsecured areas, may not be required. The self-check-out machines that do not require monitoring of self-check-out machines by employees and that do not require checking the shopping carts at the exit may be referred to as Automated Checkout Machines. In short Automated Checkout Machines may be referred to as ACM. ACM would be 100% free of employees. ACM uses the latest technology in internet, mobile technology, smart sensors, smart scanners, smart lock technology and are based on self-check-out automation of the present invention.

At a minimum ACM would use a controller embedded with a unique identifier assigned by ACM manufacturer that is known to the merchant, 4 chambers namely holding chamber, diverter chamber, reject chamber and pickup chamber and various hardware installed in various chambers and connected to the controller. The holding chamber is the entry point of all items to be checked out. If the item entry point is at the top of the holding chamber, then the ACM will be a vertical ACM. If the item entry point is at the side of the holding chamber, then the ACM will be a horizontal ACM. Both vertical and horizontal ACMs use sensors to sense the checkout items. Both vertical and horizontal ACMs use doors fitted with sensors to restrict the loading of the checkout items into holding chamber. Vertical ACM would also use a feeding conveyor to feed the checkout items into the holding chamber. Once the checkout items are loaded into the holding chamber, a weighing scale placed inside the holding chamber will weigh the checkout item and the scanners installed inside the holding chamber will scan the checkout item. Once the checkout item is weighed, scanned and verified, the checkout item will be moved to a pickup chamber through a diverter chamber. If the weighed and scanned checkout item is invalid or if the checkout item cannot be weighed or scanned, the checkout item will be moved to a reject chamber through a diverter chamber. The holding chamber and the diverter chamber will be fitted with conveyors to move the checkout items to a pickup chamber or to a reject chamber. The checkout items moved to a pickup chamber will be added to a virtual shopping cart which will be displayed on a point of sale (POS) screen. Upon checking out all the items, customers can use the pos screen to make a payment for the checkout items. The checkout items moved to a pickup chamber will be protected by a door fitted with a smart lock. The holding chamber, reject chamber and feeding conveyor, if any, will be accessible from a secured area whereas the pickup chamber will be accessible through the door fitted with smart lock will be accessible from an unsecured area.

The controller use unlimited number of connectors identified by unique connector identifiers to connect various hardware used by ACM, a firmware to store software routines, memory to store transient data, wi-fi connectivity to communicate with secured ACM management server and a database hosted in a secured ACM management server to store transaction data. Instead of storing the software routines in the controller firmware, it is also possible to store one or more software routines in the ACM management server and the controller can request the ACM management server to execute those routines by connecting to the ACM management server. Connectors used by ACM can be classified by function type namely read only, write only and display adapter. The various hardware connected to the connectors can be sensors, door operators, weighing scale, scanners, conveyors, diverter guides, pos screens and so on. Sensors, scanners and the weighing scale will be connected using read only connectors. Door operators, conveyors, diverter guides will be connected using write only connectors. The pos screen will be connected using display adapter connectors.

In all communications with ACM management server to accesss ACM database, the controller would include controller identifier which is also referred to as ACM identifier. It will be possible to identify owner identifier and location identifier from ACM identifier. The door protecting the holding chamber can be referred to as holding chamber door. Sensors connected to the controller can be classified by the function namely entry sensor group, door sensor group and feeding sensor group. Sensors used in sensing any entry into the holding chamber can be referred to as entry sensors and all the entry sensors grouped together can be referred to as entry sensor group. Sensors used in sensing any movement in the holding chamber door can be referred to as door sensors and all the door sensors grouped together can be referred to as door sensor group. Sensors sensing any item placed on the feeding conveyor can be referred to as feeding sensors and all the feeding sensors grouped together can be referred to as feeding sensor group. Feeding sensors would be used only with horizontal ACM. Smart locks protecting the pickup chamber can be referred to as pick up chamber locks. Virtual shopping carts used by ACM to track the loaded items can also be referred to as shopping carts. At a minimum each sensor group will have one or more sensors. The entry sensor group. entry doors and door sensor group protecting the holding chamber can be fitted at the top of the holding chamber or at the side of the holding chamber. The ACMs that are fitted with entry sensor group, entry door and door sensor group at the top are referred to as vertical ACMs, whereas the ACMs that are fitted with entry sensor group, entry door and door sensor group at the side are referred to as horizontal ACMs.

Conveyors connected to the controller can be feeding conveyor, holding conveyor and diverter conveyor. Feeding conveyor is used only in horizontal ACM and will feed one item at a time to the holding chamber. Holding conveyor will be used in holding chamber and will push one item at a time info diverter chamber. Diverter conveyor will move one item at a time to the pickup chamber or to the reject chamber based on the status of the diverter guide. If the diverter guide is activated then it will divert the item to the reject chamber, otherwise the item will move to pickup chamber. Smart locks protecting the pickup chamber can be referred to as pick up chamber locks. ACMs use virtual shopping carts which can also be referred to as shopping carts to store the valid items loaded into ACMs. ACMs can ensure that the items moved inside the pickup chamber is the same item scanned before being moved inside the pickup chamber. ACMs can ensure that the items moved inside the pickup chamber are added to a virtual shopping cart for payment. Even though feeding conveyor and feeding sensor group are used only for horizontal ACM, those of ordinary skill in the art will readily recognize that feeding conveyor and feeding sensor group can also be used for vertical ACM. If a feeding conveyor and feeding sensor group are used for a vertical ACM, then the feeding conveyor will feed the items vertically.

The sensors used in ACM are smart sensors. Smart sensors will have at least one pair of infrared sensors that use a photo-eye system like the infrared sensors used in garage doors to prevent the garage door from closing on someone or something. Each infrared sensor in each pair will be placed against each other. The photo eyes on each sensor would send an infrared beam to each other in the pair. When the status of the infrared beam is changed from blocked status to unblocked status and vice versa the status of the smart sensor may change. A group of sensors can be collectively called as a sensor group. Two sensor groups, namely entry sensor group and door sensor group are used in both vertical and horizontal ACMs. Feeding sensor group is used in horizontal ACM.

When the status of the infrared beam from all sensors in a feeding sensor group or in an entry sensor group are unblocked, then the feeding sensor group or the entry sensor group is in unblocked status. When the status of the infrared beam from even one sensor in a feeding sensor group or in a entry sensor group is blocked, then the status of the feeding sensor group or the entry sensor group is in blocked status. When the status of the infrared beam from all sensors in a door sensor group are blocked, then the door sensor group is in closed status. When the status of the infrared beam from even one sensor in a door sensor group is unblocked, then the door sensor group is in open status.

Both vertical and horizontal ACMs work the same way except for the entry point in loading the items into the holding chamber. In a vertical ACM, the entry point will be entry sensor group and an entry door fitted with door sensor group and placed at the top of the loading chamber. In a horizontal ACM, the entry point will be a feeding conveyor fitted with feeding sensor group, entry sensor group and an entry door fitted with door sensor group and placed at the side of the loading chamber. In a vertical ACM, customers would load one item at a time through the entry sensor group and then through an entry door placed above the holding chamber. In a vertical ACM, an item can be loaded into the holding chamber only when all the sensors in entry sensor group are in unblocked status, when all the sensors in door sensor group are in blocked status and when the holding chamber is empty. This will ensure that only one item at a time will be loaded into the holding chamber. In a horizontal ACM, customers would place items next to each other on a feeding conveyor and one item at a time would go from the feeding conveyor to the holding chamber through entry sensor group and through an entry door fitted with door sensor group placed at the side of the holding chamber. In a horizontal ACM, the feeding conveyor will feed an item into the holding chamber through entry senor group and through the entry door, only when at least one sensor in feeding sensor group is in blocked status, when all the sensors in entry sensor group are in unblocked status, when all the sensors in door sensor group are in blocked status and when the holding chamber is empty. This will ensure that only one item at a time will be fed into the holding chamber. Whether the item is loaded into the holding chamber through an entry door at the top or whether the item is loaded into the holding chamber through an entry door at the side, the process will be referred to as loading holding chamber.

In both vertical and horizontal ACMs, customers will not be allowed to load items when paid items are waiting in the pickup chamber to be picked up.

Both vertical ACM and horizontal ACM would be connected to a point of sale screen (pos screen) through a display adapter of a computer where the controller is installed. One of the many software routines stored in the controller would be pos routine. The pos routine will communicate with pos screen in both directions using the pos screen connector installed on the controller. The pos screen connector in turn will be connected to a display adapter. The pos routine will be responsible for displaying up to date virtual shopping cart content, displaying messages, accepting payment information from customers and processing the payment using a payment gateway. Pos routine can be executed from other routines stored in the controller to refresh the pos screen and/or to display messages. Pos routine can also be executed from pos screen when customers opt to check out.

Customers from inside secured areas can simply load one item at a time into a holding chamber of a vertical ACM or place items next to each other on a feeding conveyor that will be fed into a holding chamber of a horizontal ACM and pick up all the loaded items from the ACM from unsecured areas. Items will be displayed for sale and accessible to buyers in secured areas to pick up. Items processed thru ACM and paid thru the shopping cart are considered paid items. Paid items can be picked up from unsecured areas such as curbsides, walkways, parking lots and the like. Items can pass through the barrier that separates secured area from unsecured area only through ACM. Merchants can restrict customers from carrying items from secured areas to unsecured areas. Customers can start the process of self-checkout using any ACM that is available for check-out. Only ACMs where a virtual shopping cart has not been opened would be considered as available to start a check-out. An indicator at the ACM can indicate whether the ACM is available or not. Once the self-checkout process is started, the virtual shopping cart attached to the ACM and saved in the ACM database will be set to be opened and empty. The self check-out process can continue once the virtual shopping cart is saved until all the items are loaded into the holding chamber and moved to a pickup chamber or to a reject chamber. Only items moved to pickup chamber will be automatically added to the virtual shopping cart. The pos screen attached to the ACM will display the content of the virtual shopping cart instantly and can be used by the customers to make the payment. The loaded items will be moved to the pickup chamber or to the reject chamber. The rejected items in the reject chamber can be retrieved from the secured area by employees, if required. The bottom of the pick up chamber and the bottom of the reject chamber will be fitted with rollers so that the items can move freely inside the pickup chamber or the reject chamber.

Any individual sensor in an entry sensor group can be in unblocked or in blocked status. Entry status can be in unblocked or in blocked status. When all the sensors in the entry sensor group are in unblocked status then the entry status would be in unblocked status, otherwise the entry status would be in blocked status.

Any individual sensor in a feeding sensor group can be in unblocked or in blocked status. Feeding status can be in unblocked or in blocked status. When all the sensors in the feeding sensor group are in unblocked status then the feeding status would be in unblocked status, otherwise the feeding status would be in blocked status.

Any individual sensor in a door sensor group can be in unblocked or in blocked status. Door status can be in closed or in open status. When all the sensors in door sensor group are in blocked status then the door status would be in closed status, otherwise the door status would be in open status.

Holding chamber status can be in loaded or in unloaded status. When entry status changes from blocked status to unblocked status, the door status will change from open status to closed status and the holding chamber will be in loaded status.

Consumers can start loading an item into the holding chamber only when entry status is in unblocked status, the door protecting the holding chamber is closed, the holding chamber is empty and all the items moved into pick up chamber are picked up, if payment has been made. If customers have already paid for the loaded items, then the ACM will be unavailable until all the items from the pickup chamber is picked up. During loading of an item into the holding chamber, the entry status will be in blocked status, the door protecting the holding chamber will be open. Once loading of an item is completed, the entry status will change to unblocked status, the door protecting the holding chamber will be closed and the holding chamber will be loaded with an item.

In the case of horizontal ACM, the items are fed into the entry sensors from a feeding conveyor. When the feeding status is in unblocked status, there will not be any items on the feeding conveyor and the feeding conveyor will stop. When the feeding status is in blocked status, if the entry status is in unblocked status, if the door protecting the holding chamber is closed and if the holding chamber is empty then the feeding conveyor will feed the item into the entry sensors. When the entry status changes from blocked status to unblocked status, the feeding conveyor will stop and wait until the entry status is in unblocked status, door protecting the holding chamber is closed and holding chamber becomes empty. If customers have already paid for the loaded item, then the feeding conveyor will wait until all the items from the pickup chamber is picked up.

Once the holding chamber is loaded and the holding chamber door is closed, one or more scanners placed inside the holding chamber will scan the loaded item. If more than one item is loaded at a time, then an alarm attached to the ACM will be activated and employees will be notified. Once the single dropped item is scanned, weighed and the scanned item is verified, the destination of the dropped item will be marked as pickup chamber and the scanned and verified item will be moved from the holding chamber using holding conveyor to a diverter chamber and then to a pickup chamber using the diverter conveyor installed inside the diverter chamber. If the dropped item cannot be scanned or the scanned item is not valid, then the destination of the dropped item will be marked as reject chamber and the item will be moved from the holding chamber using holding conveyor to diverter chamber and then to a rejected chamber using the diverter conveyor and diverter guide installed inside the diverter chamber. The diverter guide attached to the diverter conveyor will divert the item to a reject chamber, only if an item is destined to a reject chamber. If the loaded item is moved to a pickup chamber, the loaded item will be added to the virtual shopping cart and the pos screen attached to the ACM will refresh with the content of the virtual shopping cart. Once all the items are loaded inside the ACM placed in a secured area, the customer can pay for the items that were moved to the pickup chamber using the pos screen attached to the ACM. The pos screen may be attached to a card reader or to a cash acceptor or display a QR Code to accept mobile wallet and the like. Once the payment is approved the customers can get a receipt which will include a one-time code and ACM external number. The ACM will communicate with the smart lock management server and pass the one-time code and the customer mobile number, if available, to the smart lock management server. The details of interface api for ACM management server to communicate with the smart lock management server is as shown in FIGS. 43A and 43R. Customers can use the one-time code to access the ACM from an unsecured area. If the payment is made using a mobile wallet, then the customer can also use any authenticator such as fingerprint or face identification or any biometric identification and the like to access the ACM from unsecured area. Customers can walk outside of secured area and pick up the items moved into pickup chamber from the ACM using a one-time code and/or an authenticator. The smart lock would accept the one-time code and an unlock request or an authenticator and an unlock request and would communicate with smart lock management server to get a permission to unlock the smart lock. If the smart lock receives an approval, then the smart lock would unlock the smart lock door. If the smart lock is unlocked, it would be automatically locked after a pre-set interval. Once the smart lock is locked automatically, the smart lock management server would communicate with ACM management server to indicate that the ACM is available for next customer. The details of interface api for smart lock management server to communicate with the ACM management server is as shown in FIGS. 42A and 42R. The ACM management server and the smart lock management server can be same or different servers. The ACM will have an external identifier such as a number to identify the self-check-out machine inside and outside of the secured area. Those of ordinary skill in the art will also readily recognize that the controller can get notification when the pickup chamber door is opened or closed, if sensors can be attached to the pickup chamber door.

The various parts of ACMs and their connections are shown in FIGS. 40, 41A, 41B and 41C. The details of the shopping cart is shown in FIG. 41D.

The function of the holding chamber is to weigh, scan and move the loaded item from the holding chamber to diverter chamber using a holding conveyor which has a moving platform. The individual parts of holding chamber are shown in FIGS. 41E and 41F.

In order to move a loaded item inside a holding chamber from the top of an electronic weighing scale to a diverter chamber by a holding conveyor platform without colliding the holding conveyor and the electronic weighing scale with each other a pusher will be used.

The electronic weighing scale and holding conveyor will be attached to the base of the holding chamber. The holding conveyor will be mounted below the weighing scale and the holding conveyor platform will move below the weighing scale.

The holding conveyor platform will have a starting point where the holding conveyor platform will start moving the item and an ending point where the holding conveyor platform will end moving the item.

The pusher will consist of 2 individual pusher rods made of any shape, any size and any material and a pusher connector made of any shape, any size and any material. Pusher rods will be attached to the holding conveyor platform one on each side at the holding conveyor platform starting point and the pusher connector will connect the pusher rods with each other and will be in contact with the item when item being pushed. The individual sections of a pusher rod and pusher rod connector are denoted by numbers 1 through 6 in FIG. 41F.

The pusher rod starting at the point where it is attached to the holding conveyor platform will be pointing upwards (1), then bent towards the diverter chamber parallel to the holding conveyor platform in between the top of the holding conveyor platform and bottom of the electronic weighing scale (2), then bent upwards after the pusher rod reaches the end of the electronic weighing scale (3), then bent parallel to the holding conveyor platform away from the diverter chamber and above the electronic weighing scale (4), then bent upwards after the pusher rod reaches the beginning of the electronic weighing scale (5) and end. The pusher rods from the front and from the back will be connected to each other with a pusher rod connector which can be a rectangular piece at the end of the pusher rods (6).

As the holding conveyor platform moves towards the diverter chamber, the pushers on both ends of the holder conveyor platform will also move, thereby pushing the item loaded on the weighing scale to the diverter chamber. As the holding conveyor platform moves away from the diverter chamber after reaching the end of the holding conveyor pushing the item into the diverter chamber, the pusher will also move with the holding conveyor platform, thereby bringing the holding conveyor platform and pusher to the starting position and be ready to push the next item.

In a horizontal ACM when items are fed from feeding conveyor to holding chamber, the pusher may obstruct the items from being moved. So, the top side of the feeding conveyor would be above the pusher in the holding conveyor so that the items will be placed on the electronic weighing scale in the holding chamber.

In any event, loading items into ACM from a secured area and picking up loaded items from the ACM from an unsecured area will prevent shop lifting and self-check-out piracy.

In some cases, merchants can also add parking lot pickup lockers to transport the items from ACM to parking lot pickup locker. This would eliminate the need for customers to take shopping carts to their vehicles.

The object of this invention is to provide a method for merchants to protect items from shop lifting and from self-check-out pirates.

The object of this invention is to provide a method for customers to pick up items from ACMs without the fear of items not being scanned inadvertently at the self-check-outs.

Referring now to the FIGS. , and to FIG. 38A, the self-check-out automation (1) of the present invention is shown to generally comprise a plurality of ACM management server (2) implemented use cases (3).

In particular, the ACM management server (2) provides a means (4) for the owner (4) to add or edit owner (4) information. Owner are also referred to as merchants (4).

Additionally, ACM management server (2) provides a means (5) for merchants (4) to add and edit ACM (Automated Check-Out Machine).

Additionally, ACM management server (2) provides a means (7) for customers (6) to load items.

Additionally, ACM management server (2) provides a means (8) for customers (6) to make a payment. ACM management server can in turn communicate with smart lock management server.

Additionally, ACM management server (2) provides a means (9) to display virtual shopping cart information on ACM pos screen.

At a minimum the ACM management server will have a database such as ACM database with various tables such as ACM owner table, ACM location table, ACM table, ACM item identifier table, ACM shopping cart table, ACM payment table, ACM status table, ACM interface table, ACM sensor table, ACM connector table, ACM conveyor table, ACM scale table, ACM scanner table, ACM alarm table, ACM door table, ACM pos screen table and ACM diverter guide table as shown in a class diagram in FIGS. 39A and 39B.

Any merchant to install an ACM would follow at least a minimum of 2 steps namely setting up ACM database as shown in FIGS. 39A and 39B and setting up ACM as shown in FIGS. 40, 41A, 41B, 41C, 41D, 41E and 41F. Setting up ACM database and ACMs can be done concurrently.

Forms provided by ACM management server can be used to save data in ACM database. Even though sample forms are not provided in this document, those of ordinary skill in the art of providing bin ACM services will readily be able to create forms based on the data to be saved in ACM database. Those of ordinary skill in the art providing ACM services will also readily be able to modify and/or create additional tables as needed in ACM database to suit the needs of individual merchants.

Before continuing, however, it is noted that while the ACM database shown in class diagrams in FIGS. 39A and 39B is exemplary of the preferred embodiments of the present invention related to self-check-out automation, it is in no manner meant to be all encompassing or otherwise limiting of the wide range of implementations as are possible.

ACM management server (2), merchants (4), ACM (5), customers (6), item load (7), ACM payment processing (8) and ACM pos screen (9) as shown in FIG. 38A are also referred as ACM management server, merchants, ACM, customer, item load, ACM payment processing and ACM pos screen respectively.

An owner can have an unlimited number of locations. A location can have an unlimited number of ACMs. Each ACM will have a unique internal identifier, a unique external identifier where the unique external identifier is unique only within a location and an ACM type. Internal identifiers are unique globally and assigned by ACM manufacturers. External identifiers are unique only in each location and assigned by merchants. ACM type depends on the type of ACM being used. The external identifiers are also referred to as ACM locators and will be displayed on each ACM where the items are loaded and where items are picked up and will be clearly visible to customers. Customers would use the ACM locator to locate the ACM to pick up the items from unsecured areas. When the customers start loading the items, a unique virtual shopping cart identifier will be created and will be kept open. Any loaded item from there on will be added to the virtual shopping cart. When the customers make the payment for the loaded items, the virtual shopping cart will be closed. When an item is loaded and if an open virtual shopping cart does not exist, then a new virtual shopping cart will be created and will be kept open. The payment receipts provided to the customers at the time of making payment for the loaded items will include the unique ACM locator and optionally a one-time code. The one-time code to unlock the smart lock protecting the ACM at the unsecured areas could be a few digits from the end of the unique shopping cart identifier or a random number. If the payment was made using a mobile wallet, then the authenticator such as fingerprint or face identifier and the like can be used by the customers to unlock the smart lock. If a few digits from the end of shopping cart is not used as one-time code then a random number will be created at the time of making the payment. If the one-time code is not printed on the receipt, then the one-time code will be provided to the customer via text or email or through any other means available to the ACM and the customer.

Merchants can use a web site or an app provided by ACM service provider to add, to edit or to view the data in the ACM database hosted in the ACM management server.

Following is a step-by-step procedure to setup the database and the hardware for self-check-out automation:
1. Merchants would register as owner with the ACM management server using a merchant form provided by ACM management server in a web site or in an app. Merchant will provide business name, contact name, contact email, contact phone, and contact cell information and ACM management server would provide a unique owner identifier and a password. ACM management server will save the information in ACM owner table. Merchant would use owner identifier and owner password to add or delete locations in a merchant form provided by ACM management server.
2. Merchants can add unlimited number of location identifiers through a merchant form provided by ACM management server. The location identifier are provided by the merchant. Each location identifier is linked to a single merchant who is the owner identifier of the location. An owner identifier can have multiple location identifiers. Location identifiers may be unique within an owner identifier and not within the entire ACM management server. The same location identifier may be used under different owner identifiers. It may not be possible to identify owner identifiers from location identifiers. Merchants can also set up a location password for the location identifier which could be used by the merchants to maintain the data in ACM management server database. The ACM management server would save owner identifier, location identifier and location password as OWNER_ID, LOCATION_ID and LOCATION_PASSWORD respectively in ACM location table.
3. Merchants can add unlimited number of Automated Check-out Machines (ACM) identifiers through a merchant form provided by ACM management server in a location. Each ACM is provided with a unique identifier provided by the ACM manufacturer and known to merchants. Each ACM is also provided with an external identifier assigned by the merchant. Each ACM identifier is linked to a single merchant and a single location. An owner identifier can have multiple location identifiers and a location can have multiple ACM identifiers. It will be possible to identify owner identifier and location identifier from an ACM identifier. ACM external identifiers are unique within each owner and within each location. Each ACM identifier can be either vertical ACM or horizontal ACM and will be identified as ‘V’ for vertical ACM and ‘H’ for horizontal ACM in ACM type. When the customers load all the items and pay for all the items, merchants need to send a one time code or biometric authentication such as a mobile phone number along with smart lock internal identifier to the smart lock management server. When customers completed picking up all the items from ACM pickup chamber smart lock management server need to send smart lock internal identifier to indicate that the items have been picked up from the ACM. The smart lock internal identifier is assigned by smart lock manufacturer or by smart lock management service provider and provided to ACM management service provider. The merchant would in turn receive the smart lock internal identifier. The ACM management server would save owner identifier, location identifier, ACM identifier, ACM external identifier, ACM type and smart lock internal identifier as OWNER_ID, LOCATION_ID, ACM_ID, EXTERNAL_ID, ACM_TYPE and SMART_LOCK_INTRNAL_ID respectively in ACM table.
4. Merchants can set the initial value for ACM status table and the ACM management server would insert a row into ACM status table using owner identifier for OWNER_ID, location identifier for LOCATION_ID, ACM identifier for ACM_ID, ‘U’ for ENTRY_STATUS_UB, ‘C’ for DOOR_STATUS_OC, ‘U’ for FEEDING_STATUS_UB and ‘N’ for HOLDING_LOADED_YN.
5. Merchants can add item identifiers through a merchant form provided by ACM management server. The item identifiers cannot be added before adding location identifier. The ACM management server would save owner identifier, location identifier, item identifier, item name, item description, item weight, item price and server date and time as OWNER_ID, LOCATION_ID, ITEM_IDENTIFIER, ITEM_NAME, ITEM_DESCR, ITEM_WEIGHT, ITEM_PRICE and DATETIME respectively in ACM item identifier table. Merchants can add an unlimited number of item identifiers in a location.
6. Merchants can add connectors through a merchant form provided by ACM management server. Unlimited number of connectors can be embedded in the controller and each connector will be assigned with a unique connector identifier by the ACM manufacturer, displayed on the controller and known to the merchant. Each connector can be one of 3 types namely read only, write only and pc connector. Read only connectors will be used to connect with sensors and scanners. Write only connectors will be used to connect with door operators, conveyors, diverter guide and alarm. PC connectors will be used to connect with pos screen. Connector type will also be displayed on the controller.
When a read only connector is connected to a sensor, a row will be inserted into ACM connector table and into ACM sensor table. Merchant would select a read only connector, get the connector identifier displayed on the controller, save ‘R’ as connector type and ‘S’ as hardware type. Then the merchant would identify the group to which the sensor belongs. If the sensor is used in feeding conveyor, then the sensor group would be feeding sensor group, and the merchant would use ‘F’ for sensor group. If the sensor is used as an entry sensor, then the sensor group would be entry sensor group and the merchant would use ‘E’ for sensor group. If the sensor is used in an entry door the sensor group would be door sensor group and the merchant would use ‘D’ for sensor group. The ACM management server would save owner identifier, location identifier, ACM identifier, connector identifier, connector type and hardware type as OWNER_ID, LOCATION_ID, ACM_ID, CONNECTOR_ID, CONNECTOR_TYPE and HARDWARE_TYPE respectively in ACM connector table. Then the ACM management server would save owner identifier, location identifier, ACM identifier, connector identifier, sensor group and ‘U’ as OWNER_ID, LOCATION_ID, ACM_ID, SENSOR_ID, SENSOR_GROUP and SENSOR_STATUS_UB respectively in ACM sensor table.
When a read connector is connected to a scanner a row will be inserted into ACM connector table and into ACM scanner table. Merchant would select a read connector, get the connector identifier displayed on the controller and save ‘R’ as connector type and ‘R’ as hardware type. The ACM management server would save owner identifier, location identifier, ACM identifier, connector identifier, connector type and hardware type as OWNER_ID, LOCATION_ID, ACM_ID, CONNECTOR_ID, CONNECTOR_TYPE and HARDWARE_TYPE respectively in ACM connector table. Then the ACM management server would save owner identifier, location identifier, ACM identifier, connector identifier and a blank as OWNER_ID, LOCATION_ID, ACM_ID, SCANNER_ID and SCANNED_VALUE respectively in ACM scanner table.
When a read only connector is connected to an electronic weighting scale a row will be inserted into ACM connector table and into ACM scale table. Merchant would select a read only connector, get the connector identifier displayed on the controller and save ‘W’ as connector type and ‘W’ as hardware type. The ACM management server would save owner identifier, location identifier, ACM identifier, connector identifier, connector type and hardware type as OWNER_ID, LOCATION_ID, ACM_ID, CONNECTOR_ID, CONNECTOR_TYPE and HARDWARE_TYPE respectively in ACM connector table. Then the ACM management server would save owner identifier, location identifier, ACM identifier, connector identifier and 0 as OWNER_ID, LOCATION_ID, ACM_ID, SCALE_ID and SCALE_WEIGHT respectively in ACM scale table.
When a write only connector is connected to a door operator a row will be inserted into ACM connector table and into ACM door table. Merchant would select a write only connector, get the connector identifier displayed on the controller, save ‘W’ as connector type and ‘D’ as hardware type. The ACM management server would save owner identifier, location identifier, ACM identifier, connector identifier, connector type and hardware type as OWNER_ID, LOCATION_ID, ACM_ID, CONNECTOR_ID, CONNECTOR_TYPE and HARDWARE_TYPE respectively in ACM connector table. Then the ACM management server would save owner identifier, location identifier, ACM identifier and connector identifier as OWNER_ID, LOCATION_ID, ACM_ID, and DOOR_ID respectively in ACM door table.
When a write only connector is connected to a conveyor a row will be inserted into ACM connector table and into ACM conveyor table. Merchant would select a write only connector, get the connector identifier displayed on the controller, save ‘W’ as connector type and ‘C’ as hardware type. If the connector is connected to the feeding conveyor, then the merchant would use ‘F’ as conveyor type. If the connector is connected to the holding conveyor, then the merchant would use ‘H’ as conveyor type. If the connector is connected to the diverter conveyor, then the merchant would use ‘D’ as conveyor type. The ACM management server would save owner identifier, location identifier, ACM identifier, connector identifier. connector type and hardware type as OWNER_ID, LOCATION_ID, ACM_ID, CONNECTOR_ID, CONNECTOR_TYPE and HARDWARE_TYPE respectively in ACM connector table. Then the ACM management server would save owner identifier, location identifier, ACM identifier, connector identifier and conveyor type as OWNER_ID, LOCATION_ID, ACM_ID, CONVEYOR_ID and CONVEYOR_TYPE respectively in ACM conveyor table.
When a write only connector is connected to a diverter guide a row will be inserted into ACM connector table and into ACM diverter guide table. Merchant would select a write only connector, get the connector identifier displayed on the controller, save ‘W’ as connector type and ‘G’ as hardware type. The ACM management server would save owner identifier, location identifier, ACM identifier, connector identifier, connector type and hardware type as OWNER_ID, LOCATION_ID, ACM_ID, CONNECTOR_ID, CONNECTOR_TYPE and HARDWARE_TYPE respectively in ACM connector table. Then the ACM management server would save owner identifier, location identifier, ACM identifier and connector identifier as OWNER_ID, LOCATION_ID, ACM_ID and DIVERTER_GUIDE_ID respectively in ACM diverter guide table.
When a write only connector is connected to an alarm a row will be inserted into ACM connector table and into ACM alarm table. Merchant would select a write only connector, get the connector identifier displayed on the controller, save ‘W’ as connector type and ‘A’ as hardware type. The ACM management server would save owner identifier, location identifier, ACM identifier, connector identifier connector type and hardware type as OWNER_ID, LOCATION_ID, ACM_ID, CONNECTOR_ID, CONNECTOR_TYPE and HARDWARE_TYPE respectively in ACM connector table. Then the ACM management server would save owner identifier, location identifier, ACM identifier and connector identifier as OWNER_ID, LOCATION_ID, ACM_ID and ALARM_ID respectively in ACM alarm table.
When a pc connector is connected to a pos screen a row will be inserted into ACM connector table and into ACM pos screen table. Merchant would select a pc connector, get the connector identifier displayed on the controller, save ‘B’ as connector type and ‘P’ as hardware type. The ACM management server would save owner identifier, location identifier, ACM identifier, connector identifier, connector type and hardware type as OWNER_ID, LOCATION_ID, ACM_ID, CONNECTOR_ID, CONNECTOR_TYPE and HARDWARE_TYPE respectively in ACM connector table. Then the ACM management server would save owner identifier, location identifier, ACM identifier and connector identifier as OWNER_ID, LOCATION_ID, ACM_ID and POS_SCREEN_ID respectively in ACM pos screen table.
7. When the customers load all the items and pay for all the items, customers will be ready to pick up the items from the ACM through a secured door attached to the pickup chamber and facing unsecured area, but need a one-time code or a biometric authenticator to access the smart lock attached to the pick up chamber. For the ACM to send one time code and/or a mobile number as a biometric authenticator, the ACM needs an interface to communicate with the smart lock management server. In order to protect the interface, the smart lock management service provider would provide the merchant a send url and a send url password and the merchant would save the send url and the send url password in the ACM interface table using SMART_LOCK_SEND_URL, SMART_LOCK_SEND_URL_PW respectively. The ACM management server would use the interface API as shown in FIG. 43A and receive the response as shown in FIG. 43R.
8. When customers completed picking up all the items from ACM pickup chamber smart lock management server would communicate with ACM management server to send smart lock internal identifier to indicate that the smart lock attached to the pickup chamber has been unlocked and locked. The smart lock management server would use the receive url and receive url password provided by the ACM management service provider. The receive url and receive url password provided to the smart lock management service provider is also saved in the ACM interface table as SMART_LOCK_RECEIVE_URL, SMART_LOCK_RECEIVE_URL_PW respectively. The smart lock management server would use the interface API as shown in FIG. 42A and receive the response as shown in FIG. 42R.
9. The entry doors protecting the holding chamber will be controlled by an open-close switch and also will be connected to the controller using a write connector. When the open-close switch receive a ‘O’ request from the controller, then the open-close switch will open the entry doors. When the open-close switch receive a ‘C’ request from the controller, then the open close switch will close the entry doors.
10. The diverter guide directing the item from the diverter chamber to pickup chamber or to reject chamber will be controlled by an open-close switch and also will be connected to the controller using a write connector. When the open close switch receive an ‘O’ request from the controller, then the open-close switch will open the diverter guide and the item will be moved to the pickup chamber. When the open-close switch receive a ‘C’ request from the controller, then the open-close switch will close the diverter guide and the item will be diverted to the reject chamber.
11. The feeding conveyor in a horizontal ACM will be controlled by a start-stop switch and also will be connected to the controller using a write connector. When the start-stop switch receive a ‘START’ request from the controller, then the start-stop switch will be set to start, and the feeding conveyor platform will start to move. When the start-stop switch receive a ‘STOP’ request from the controller, then the start-stop switch will be set to stop, and the feeding conveyor platform will stop from moving.
12. The holding conveyor in both horizontal and vertical ACM will be controlled by an activation switch and will be connected to the controller using a write connector. When the activation switch receive an ‘A’ request from the controller, then the activation switch will be activated. When the activation switch is activated the holding conveyor platform will move from starting end to finishing end and return back to the starting end. The starting end on the holding conveyor platform is the farthest point from the diverter chamber and the finishing end on the holding conveyor platform is the closest point to the diverter chamber. This will enable the holding conveyor to push the item into the diverter chamber using the pusher connected to the holding conveyor platform and be ready to move the next item.
13. The diverter conveyor in both horizontal and vertical ACM will be controlled by an activation switch and will be connected to the controller using a write connector. When the activation switch receive an ‘A’ request from the controller, then the activation switch will be activated. When the activation switch is activated the diverter conveyor platform will move from starting end to finishing end. The starting end on the diverter conveyor platform is the farthest point from the pickup chamber and the finishing end on the diverter conveyor platform is the closest point to the pickup chamber. This will enable the diverter conveyor to move the item to the pickup chamber or reject chamber depending on the status of the diverter guide.

Although those of ordinary skill in the art will readily recognize many alternative use for vertical ACMs and for horizontal ACMs, especially considering the illustrations provided herein, this detailed description with the FIGS. 38A, 38B, 39A, 39B, 40, 41A, 41B, 41C, 41D, 41E, 41F, 42A, 42R, 43A and 43R is exemplary of the preferred embodiments of the present invention, the scope of which is limited only by the claims appended hereto.

Once the controller and all the data in various setup tables have been setup in a location, the ACM would be ready for customers to use.

To manage ACM, self-check-out server may provide merchant forms. To access merchant forms, the merchants must log into ACM management server using a password set by the merchant. The merchants can also use an authentication method instead of using a password. It is beyond the scope of this invention to provide all the details about authentication and verification methods. It is sufficient to note that merchants can use finger print or face id or a password or two-factor authentication or any other method to log into ACM management server.

When any Automated Checkout Machines (ACM) is powered, the global routine saved in the controller firmware will be executed. The global routine will be pre-programmed to store the value of owner identifier, location identifier and ACM identifier. All the variables (transient data) stored in global routine are global in nature and will be available for all routines saved in controller firmware. The values stored in global routine cannot be altered by any other routine. When any data is modified by merchants using merchant forms in any table used in global routine, the ACM must be powered off and on.

The global routine will retrieve one row from ACM table using owner identifier for OWNER_ID, location identifier for LOCATION_ID and ACM identifier for ACM_ID. If global routine retrieves one row from ACM table, then global routine will save the values of EXTERNAL_ID, ACM_TYPE, SMART_LOCK_INTRNAL_ID from the retrieved one row as smart lock external identifier, ACM type and smart lock internal identifier, otherwise the global routine will terminate.

If ACM type is ‘H’ or ‘V’, then the global routine will continue, otherwise it will terminate.

The global routine will retrieve one row from ACM conveyor table using owner identifier for OWNER_ID, location identifier for LOCATION_ID, ACM identifier for ACM_ID and ‘H’ for CONVEYOR_TYPE. If global routine retrieves one row from ACM conveyor table the global routine will save the value of CONVEYOR_ID from the one retrieved row as holding conveyer connector identifier, otherwise global routine will terminate.

If the ACM type is ‘V’, then the global routine will save a blank as feeding conveyer connector identifier.

If the ACM type is ‘H’, then the global routine will retrieve one row from ACM conveyor table using owner identifier for OWNER_ID, location identifier for LOCATION_ID, ACM identifier for ACM_ID and ‘F’ for CONVEYOR_TYPE and if global routine retrieves one row from ACM conveyor table the global routine will save the value of CONVEYOR_ID from the one retrieved row as feeding conveyer connector identifier, otherwise global routine will terminate.

The global routine will retrieve one row from ACM conveyor table using owner identifier for OWNER_ID, location identifier for LOCATION_ID, ACM identifier for ACM_ID and ‘D’ for CONVEYOR_TYPE. If global routine retrieves one row from ACM conveyor table the global routine will save the value of CONVEYOR_ID from the one retrieved row as diverter conveyer connector identifier, otherwise global routine will terminate.

The global routine will retrieve one row from ACM diverter guide table using owner identifier for OWNER_ID, location identifier for LOCATION_ID and ACM identifier for ACM_ID. If global routine retrieves one row from ACM diverter guide table the global routine will save the value of DIVERTER_GUIDE_ID from the one retrieved row as diverter guide connector identifier, otherwise global routine will terminate.

The global routine will retrieve one row from ACM alarm table using owner identifier for OWNER_ID, location identifier for LOCATION_ID and ACM identifier for ACM_ID. If global routine retrieves one row from ACM alarm table the global routine will save the value of ALARM_ID from the one retrieved row as alarm connector identifier, otherwise global routine will terminate.

The global routine will retrieve one row from ACM door table using owner identifier for OWNER_ID, location identifier for LOCATION_ID and ACM identifier for ACM_ID. If global routine retrieves one row from ACM door table the global routine will save the value of DOOR_ID from the one retrieved row as door connector identifier, otherwise global routine will terminate.

The global routine will retrieve one row from ACM scale table using owner identifier for OWNER_ID, location identifier for LOCATION_ID and ACM identifier for ACM_ID. If global routine retrieves one row from ACM scale table the global routine will save the value of SCALE_ID from the one retrieved row as scale connector identifier, otherwise global routine will terminate.

The global routine will retrieve one row from ACM pos screen table using owner identifier for OWNER_ID, location identifier for LOCATION_ID and ACM identifier for ACM_ID. If global routine retrieves one row from ACM pos screen table the global routine will save the value of POS_SCREEN_ID from the one retrieved row as pos screen connector identifier, otherwise global routine will terminate.

When customers select Chcck-Out option on the pos screen or when any routine saved in the controller firmware needs to refresh and/or to display a message on the pos screen, the pos routine saved in the controller firmware will be executed.

Any routine saved in the controller firmware can execute pos routine with input parameters refresh and message. If the pos routine received a request from any routine saved in the controller firmware, the pos routine would receive parameters refresh and message. If refresh is ‘Y’ then the pos routine will continue to refresh pos screen and display the message in the message window as shown in FIG. 41D. If refresh is ‘N’ then the pos routine will not refresh pos screen but replace the message in the message window with the message received as input as shown in FIG. 41D and the pos routine will terminate.

If the pos routine continues, the pos routine will retrieve one row from ACM shopping cart table using owner identifier for OWNER_ID, location identifier for LOCATION_ID, ACM identifier for ACM_ID, the maximum value of SHOPPING_CART_ID for the same OWNER_ID, for the same LOCATION_ID, for the same ACM_ID for SHOPPING_CART_ID and the maximum value of ITEM_SEQ for the same OWNER_ID, for the same LOCATION_ID, for the same ACM_ID and for the same SHOPPING_CART_ID for ITEM_SEQ. If pos routine retrieves one row from ACM shopping cart table, then pos routine will save the value of SHOPPING_CART_ID from the retrieved one row as shopping cart identifier, otherwise the pos routine will save ‘ ’ as shopping cart identifier.

If the pos routine continues and if shopping cart identifier is not blank, then the pos routine will retrieve one row from ACM payment table using owner identifier for OWNER_ID, location identifier for LOCATION_ID, ACM identifier for ACM_ID, shopping cart identifier for SHOPPING_CART_ID and blank for ONE_TIME_CODE. If shopping cart identifier is not blank, and pos routine does not retrieve a row from ACM payment table, then the pos routine will save ‘ ’ as shopping cart identifier.

If the pos routine continues and if shopping cart identifier is blank, then the pos routine will display only the column titles without any data, the message in the message window and the pos routine will terminate.

If the pos routine continues and if shopping cart identifier is not blank, then the pos routine will retrieve all rows from ACM shopping cart table using owner identifier for OWNER_ID, location identifier for LOCATION_ID, ACM identifier for ACM_ID and the maximum value of SHOPPING_CART_ID for the same OWNER_ID, for the same LOCATION_ID, for the same ACM_ID for SHOPPING_CART_ID.

If the pos routine continues and if shopping cart identifier is not blank and the number of rows retrieved from ACM shopping cart table is 0, then the pos routine will display only the column titles without any data, the message in the message window and the pos routine will terminate.

If the pos routine continues and if shopping cart identifier is not blank and the number of rows retrieved from ACM shopping cart table is not 0, then the pos routine will retrieve one row from ACM item identifier table for each row retrieved from ACM shopping cart table using owner identifier for OWNER_ID, location identifier for LOCATION_ID, ACM identifier for ACM_ID and the value of ITEM_IDENTIFIER from each row retrieved from ACM shopping cart table for ITEM_IDENTIFIER and use the values of ITEM_NAME, ITEM_DESCR and ITEM_PRICE from each retrieved row from ACM item identifier table to refresh the pos screen, display the message in the message window and terminate pos routine.

When customers have loaded all the items into the holding chamber and viewed the shopping cart details on pos screen, the customers will be ready to check-out. To check-out, the customers will use the check-out option and make the payment using the pos screen. When the check-out option is selected in the pos screen, the pos routine will capture payment information and/or mobile number from the customers and process the payment.

Upon receiving payment information and/or mobile number, the pos routine would clear the existing message window, verify the shopping cart, process the payment and display a message with or without refreshing the pos screen.

The pos routine would clear the message window in the pos screen.

The pos routine would retrieve one row from ACM shopping cart table using owner identifier for OWNER_ID, location identifier for LOCATION_ID, ACM identifier for ACM_ID and the maximum value of SHOPPING_CART_ID for the same OWNER_ID, for the same LOCATION_ID and for the same ACM_ID for SHOPPING_CART_ID. If pos routine retrieves one row from ACM shopping cart table, then pos routine will save the value of SHOPPING_CART_ID from the retrieved one row as shopping cart identifier, otherwise the pos routine will save ‘ ’ as shopping cart identifier.

If shopping cart identifier is ‘ ’, the pos routine will display the message ‘Unable to locate shopping cart’ in the pos screen message window and terminate.

If pos routine continues, the pos routine will retrieve one row from ACM payment table using owner identifier for OWNER_ID, location identifier for LOCATION_ID, ACM identifier for ACM_ID and shopping cart identifier for SHOPPING_CART_ID. If pos routine retrieves one row from ACM payment table, the pos routine will save the values of PURCHASED_AMOUNT, ONE_TIME_CODE and MOBILE_NO as purchased amount, one time code and mobile number, otherwise the pos routine will terminate.

If pos routine continues and if the one time code and mobile number are blank, then the pos routine will continue, otherwise pos routine will display the message ‘Payment has already been processed’ in the pos screen message window and the pos routine will terminate.

If pos routine continues, the pos routine will use the received payment information and a payment gateway to process the payment or use mobile number and a mobile payment gateway to process the payment for an amount of purchased amount. If payment processing failed, then the pos routine will display the message ‘Payment rejected’ in the pos screen message window and the pos routine will terminate.

It is beyond the scope of this invention to provide all the details about payment gateway and mobile payment gateway that merchants can use to process payment. It is sufficient to note that merchants can use payment information or mobile wallet such as apple pay, samsung pay, google pay, mysinglelink wallet and the like to process the payment.

If pos routine continues, pos routine will save last few digits from the credit/debit used for the payment as one-time code or last few digits from the mobile number or any other code known to the customer or create a random number as one-time code. If the pos routine used a mobile number and a mobile payment gateway for payment processing then pos routine will save mobile number as payment mobile number, otherwise the pos routine will use a blank for payment mobile number.

If pos routine continues, pos routine will update a row in ACM payment table by setting the value of one-time code for ONE_TIME_CODE, the value of payment mobile number for MOBILE_NO, ‘N’ for PICKED_YN and server date and time for DATETIME using owner identifier for OWNER_ID, location identifier for LOCATION_ID, ACM identifier for ACM_ID, shopping cart identifier for SHOPPING_CART_ID.

If pos routine continues, pos routine will print a receipt that will include the purchased items and ACM external identifier on the printer attached to the pos screen. The one-time code will also be printed on the receipt, if the one-time code is a random number that is not known to the customer.

If pos routine continues, pos routine will retrieve one row from ACM interface table using owner identifier for OWNER_ID, location identifier for LOCATION_ID.

If pos routine continues and if pos routine retrieves one row from ACM interface table, then pos routine will save the values of SMART_LOCK_SEND_URL and SMART_LOCK_SEND_URL_PW as smart lock send url and smart lock send url password and will send a notification to smart lock management server using the api as shown in FIG. 43A as an example using owner identifier for SmartLockSendOwnerId, location identifier for SmartLockSendLocationId, smart lock internal identifier for SmartLockSendlnternalId, ‘L’ for SmartLockSendRequestType, one-time code for SmartLockSendOneTimeCode and payment mobile number for SmartLockSendOneTimeAuthId. The value of ‘L’ for SmartLockSendRequestType will indicate that the pickup chamber is loaded. The response from the smart lock management server will be as shown in FIG. 43R. If pos routine receives a response with an error return code. then the pos routine would forward the response to the merchant for further action and terminate.

If pos routine continues, pos routine will clear the pos screen and display only the message ‘Payment has been processed successfully. Please pick up your receipt for instructions on picking up the items from the other end of the Automated Self Check Out Machine.’ in the pos screen message window and the pos routine will terminate.

Upon receipt of the information, the smart lock management server would set one-time code and payment mobile number as access code to unlock the smart lock fitted to the pick up chamber.

When customers pickup the items from the pick up chamber facing unsecured area and when the smart lock fitted to the pick up chamber locks itself to secure the pickup chamber, the smart lock management server managing the smart lock fitted to the pickup chamber will send a notification to ACM management server using the api shown as example in FIG. 42A. The smart lock management server would use the values of SMART_LOCK_RECEIVE_URL and SMART_LOCK_RECEIVE_URL_PW saved in ACM interface table and provided to the smart lock management service provider by the ACM management service provider or by the merchant. The SMART_LOCK_RECEIVE_URL is a link to execute picked up routine saved in the controller. When picked up routine is executed, the picked up routine would receive SmartLockReceiveOwnerld, SmartLockReceiveLocationId, SmartLockReceivelnternalld and SmartLockReceiveActionld as input, otherwise it will be terminated. If SmartLockReceiveOwnerld is equal to owner identifier and SmartLockReceiveLocationId is equal to location identifier, then picked up routine will continue, otherwise it will be terminated.

If picked up routine continues, picked up routine would retrieve one row from ACM table using owner identifier for OWNER_ID, location identifier for LOCATION_ID and ACM SmartLockReceiveInternalId for SMART_LOCK_INTERNAL_ID. If picked up routine retrieves one row from ACM table and if the value of SmartLockReceiveActionld is ‘P’, then picked up routine will continue, otherwise the picked up routine will terminate.

If picked up routine continues, picked up routine would retrieve one row from ACM shopping cart table using owner identifier for OWNER_ID, location identifier for LOCATION_ID, ACM identifier for ACM_ID, the maximum value of SHOPPING_CART_ID for the same OWNER_ID, for the same LOCATION_ID and for the same ACM_ID for SHOPPING_CART_ID and the maximum value of ITEM_SEQ for the same OWNER_ID, for the same LOCATION_ID, for the same ACM_ID and for the same SHOPPING_CART_ID for ITEM_SEQ. If picked up routine retrieves one row from ACM shopping cart table, then picked up routine will save the value of SHOPPING_CART_ID from the retrieved one row as shopping cart identifier, otherwise the picked up routine will terminate.

If picked up routine continues, picked up routine will update a row in ACM payment table by setting the value ‘Y’ for PICKED_YN and server date and time for DATETIME using owner identifier for OWNER_ID, location identifier for LOCATION_ID, ACM identifier for ACM_ID, shopping cart identifier for SHOPPING_CART_ID.

When controller receives any input from any hardware connected to any read only connectors, the connector read routine saved in the controller firmware will be executed. The connector read routine will receive the connector identifier and connector value.

The connector read routine will retrieve one row from ACM shopping cart table using owner identifier for OWNER_ID, location identifier for LOCATION_ID, ACM identifier for ACM_ID and the maximum value of SHOPPING_CART_ID for the same OWNER_ID, for the same LOCATION_ID and for the same ACM_ID for SHOPPING_CART_ID and the maximum value of ITEM_SEQ for the same OWNER_ID, for the same LOCATION_ID, for the same ACM_ID and for the same SHOPPING_CART_ID for ITEM_SEQ. If connector read routine retrieves one row from ACM shopping cart table, then connector read routine will save the value of SHOPPING_CART_ID from the retrieved one row as shopping cart identifier, otherwise the connector read routine will save ‘ ’ as shopping cart identifier.

If shopping cart identifier is not ‘ ’, then connector read routine will retrieve one row from ACM payment table using owner identifier for OWNER_ID, location identifier for LOCATION_ID, ACM identifier for ACM_ID and shopping cart identifier for SHOPPING_CART_ID.

If shopping cart identifier is not ‘ ’ and connector read routine retrieves one row from ACM payment table, the value of ONE_TIME_CODE from the retrieved row is not blank and the value of PICKED_YN from the retrieved row is ‘N’, then connector read routine will save ‘Please wait, the self service check-out is not available’ as error message, otherwise connector read routine will save ‘ ’ as error message.

If shopping cart identifier is not ‘ ’ and error message is not ‘ ’ then the connector read routine will execute pos routine using ‘N’ and the error message for refresh and message respectively as input and connector read routine will terminate.

The connector read routine will retrieve one row from ACM connector table using owner identifier for OWNER_ID, location identifier for LOCATION_ID, ACM identifier for ACM_ID and connector identifier for CONNECTOR_ID. If connector read routine retrieves one row from ACM connector table, then connector read routine will save the values of CONNECTOR_TYPE and HARDWARE_TYPE from the retrieved one row as connector type and hardware type respectively, otherwise the connector read routine will terminate.

If the connector type is ‘R’ and hardware type is ‘S’, then the connector read routine will execute connector sensor routine using owner identifier, location identifier, ACM identifier, ACM type, connector identifier, connector value and shopping cart identifier as input.

If the connector type is ‘R’ and hardware type is ‘R’, then the connector read routine will execute connector scanner routine using owner identifier, location identifier, ACM identifier, ACM type, connector identifier, connector value and shopping cart identifier as input.

If the connector sensor routine receives 7 inputs namely owner identifier, location identifier, ACM identifier, ACM type, connector identifier, connector value and shopping cart identifier the connector sensor routine will continue, otherwise it will terminate. The connector sensor routine will save connector identifier and connector value as sensor identifier and sensor new status respectively.

If shopping cart identifier is ‘ ’, then connector sensor routine will retrieve server date and time from ACM management server and save the retrieved server date and time as new shopping cart identifier.

If shopping cart identifier is ‘ ’, then connector sensor routine will insert a row into ACM shopping cart table using owner identifier for OWNER_ID, location identifier for LOCATION_ID, ACM identifier for ACM_ID, new shopping cart identifier for SHOPPING_CART_ID, 0 for ITEM_SEQ, blank space for ITEM_IDENTIFER, blank space for DESTINATION and server date and time for DATETIME.

If shopping cart identifier is ‘ ’, then connector sensor routine will insert a row into ACM payment table using owner identifier for OWNER_ID, location identifier for LOCATION_ID, ACM identifier for ACM_ID, new shopping cart identifier for SHOPPING_CART_ID, 0 for PURCHASED_AMOUNT, blank space for ONE_TIME_CODE, blank space for MOBILE NO, ‘N’ for PICKED_YN and server date and time for DATETIME.

If shopping cart identifier is ‘ ’, then connector sensor routine will save new shopping cart identifier as shopping cart identifier.

The connector sensor routine will retrieve one row from ACM status table using owner identifier for OWNER_ID, location identifier for LOCATION_ID and ACM identifier for ACM_ID. If connector sensor routine retrieves one row from ACM status table, then connector sensor routine will save the values of ENTRY_STATUS_UB, DOOR_STATUS_OC, FEEDING_STATUS_UB and HOLDING_LOADED_YN from the retrieved one row as entry status, door status, feeding status and holding loaded respectively, otherwise the connector sensor routine will terminate.

The connector sensor routine will retrieve one row from ACM sensor table using owner identifier for OWNER_ID, location identifier for LOCATION_ID, ACM identifier for ACM ID and sensor identifier for SENSOR ID. If connector sensor routine retrieves one row from ACM sensor table, then connector sensor routine will save the values of SENSOR_GROUP and SENSOR_STATUS_UB from the retrieved one row as sensor group and sensor previous status respectively, otherwise the connector sensor routine will terminate.

If sensor group is ‘E’ and sensor new status is ‘B’, then connector sensor routine will save ‘N’ as new load and blank as error message.

If sensor group is ‘E’ and sensor new status is ‘B’ then the connector sensor routine will retrieve a row from ACM payment table using owner identifier for OWNER_ID, location identifier for LOCATION_ID, ACM identifier for ACM_ID, SHOPPING_CART_ID is not blank and ONE_TYPE_CODE is blank. If connector sensor routine retrieves one row from ACM payment table, then the indication will be that the customer has opened a shopping cart which has not been closed and the connector sensor routine will save the value of SHOPPING_CART_ID from the retrieved row as shopping cart identifier, otherwise the connector sensor routine will save ‘Please open a shopping cart before loading items’ as error message.

If sensor group is ‘E’, sensor new status is ‘B’ and error message is not blank, then the connector sensor routine will execute pos routine using ‘N’ and the error message for refresh and message respectively as input and connector sensor routine will terminate.

If sensor group is ‘E’, sensor new status is ‘B’ and entry status is ‘U’ then the indication would be that the all the entry sensors are in unblocked status and the customer is starting to load an item into holding chamber and the connector sensor routine will save ‘Y’ as new load.

If sensor group is ‘E’, sensor new status is ‘B’, new load is ‘Y’, door status is ‘O’ or holding loaded is ‘Y’ then the connector sensor routine will save ‘Processing previous item, please wait’ as error message.

If sensor group is ‘E’, sensor new status is ‘B’ and error message is not blank, then the connector sensor routine will execute pos routine using ‘N’ and the error message for refresh and message respectively as input and connector sensor routine will terminate.

If sensor group is ‘E’, sensor new status is ‘B’ and new load is ‘Y’ will be an indication that the all the entry sensors are in unblocked status, the entry door is closed, the holding chamber is empty and the customer is loading an item into holding chamber and the connector sensor routine will send a request to the entry door to open so that the item will be loaded into the holding chamber. Then the connector sensor routine will send a value of ‘O’ as a request to open the entry door through the door connector identifier. Upon receiving a value of ‘O’ from the controller, the open close switch connected to the entry door would open the entry door.

If sensor group is ‘E’ and sensor new status is ‘B’ or ‘U’ then the connector sensor routine will update one row in ACM sensor table by setting the value of SENSOR_STATUS_UB to sensor new status using owner identifier for OWNER_ID, location identifier for LOCATION_ID, ACM identifier for ACM_ID and sensor identifier for SENSOR_ID.

If sensor group is ‘E’, sensor new status is ‘U’ and entry status is ‘B’ then the indication would be customer may have or may have not completed loading an item into holding chamber.

If sensor group is ‘E’, sensor new status is ‘U’ and entry status is ‘B’ then the connector sensor routine will retrieve at least one row from ACM sensor table using owner identifier for OWNER_ID, location identifier for LOCATION_ID, ACM identifier for ACM_ID, SENSOR_ID is not blank, sensor group for SENSOR_GROUP and SENSOR_STATUS_UB is ‘B’. If connector sensor routine retrieves at least one row from ACM sensor table, then the indication will be that the customer has not completed loading the item into holding chamber and the connector sensor routine will save ‘N’ as item completed, otherwise the indication will be that the customer has completed loading the item into holding chamber and the connector sensor routine will save ‘Y’ as item completed.

If sensor group is ‘E’, sensor new status is ‘U’, entry status is ‘B’ and item completed is ‘Y’, then the connector sensor routine will send a request to the entry door to close so that no item will be loaded into the holding chamber until the item already loaded into the holding chamber is processed. Then the connector sensor routine will send a value of ‘C’ as a request to close the entry door through the door connector identifier. Upon receiving a value of ‘C’ from the controller, the open close switch connected to the entry door would close the entry door.

If sensor group is ‘D’ then connector sensor routine will save ‘N’ for read scanner and blank for error message.

If sensor group is ‘D’ then the connector sensor routine will update one row in ACM sensor table by setting the value of SENSOR_STATUS_UB to sensor new status using owner identifier for OWNER_ID, location identifier for LOCATION_ID, ACM identifier for ACM_ID and sensor identifier for SENSOR_ID.

If sensor group is ‘D’ and sensor new status is ‘B’ then the connector sensor routine will retrieve a row from ACM payment table using owner identifier for OWNER_ID, location identifier for LOCATION_ID, ACM identifier for ACM_ID, SHOPPING_CART_ID is not blank and ONE_TYPE_CODE is blank. If connector sensor routine retrieves one row from ACM payment table, then the indication will be that the customer has opened a shopping cart which has not been closed and the connector sensor routine will save the value of SHOPPING_CART_ID from the retrieved row as shopping cart identifier, otherwise the connector sensor routine will save ‘Please open a shopping cart before loading items’ as error message.

If sensor group is ‘D’, sensor new status is ‘B’ and error message is not blank, then the connector sensor routine will execute pos routine using ‘N’ and the error message for refresh and message respectively as input and connector sensor routine will terminate.

If sensor group is ‘D’, sensor new status is ‘U’ and door status is ‘C’, then the connector sensor routine will retrieve at least one row from ACM sensor table using owner identifier for OWNER_ID, location identifier for LOCATION_ID, ACM identifier for ACM_ID, SENSOR_ID is not blank, sensor group for SENSOR_GROUP and SENSOR_STATUS_UB is ‘B’.

If sensor group is ‘D’, sensor new status is ‘U’, door status is ‘C’, and connector sensor routine does not retrieve even one row from ACM sensor table then the indication would be that the entry door has opened completely.

If sensor group is ‘D’, sensor new status is ‘U’, door status is ‘C’, and connector sensor routine does not retrieve even one row from ACM sensor table then the connector sensor routine will update ACM status table setting a value of ‘0’ for DOOR_STATUS_OC in ACM status table using owner identifier for OWNER_ID, location identifier for LOCATION_ID, ACM identifier for ACM_ID.

If sensor group is ‘D’, sensor new status is ‘B’ and door status is ‘O’, then the connector sensor routine will retrieve at least one row from ACM sensor table using owner identifier for OWNER_ID, location identifier for LOCATION_ID, ACM identifier for ACM_ID, SENSOR_ID is not blank, sensor group for SENSOR_GROUP and SENSOR_STATUS_UB is ‘U’.

If sensor group is ‘D’, sensor new status is ‘B’, door status is ‘O’ and connector sensor routine does not retrieve at least one row from ACM sensor table then the indication would be that the entry door has closed completely.

If sensor group is ‘D’, sensor new status is ‘B’, door status is ‘O’, and connector sensor routine does not retrieve at least one row from ACM sensor table then the connector sensor routine will update ACM status table setting a value of ‘C’ for DOOR_STATUS_OC using owner identifier for OWNER_ID, location identifier for LOCATION_ID, ACM identifier for ACM_ID and the connector sensor routine will save ‘Y’ for read scanner.

If sensor group is ‘D’ and read scanner ‘Y’ then connector sensor routine will update ACM status table setting HOLDING_LOADED_YN to ‘Y’ using owner identifier for OWNER_ID, location identifier for LOCATION_ID, ACM identifier for ACM_ID.

If sensor group is ‘D’ and read scanner ‘Y’ then connector sensor routine will update ACM scanner table setting SCANNED_VALUE to ‘ ’ using owner identifier for OWNER_ID, location identifier for LOCATION_ID, ACM identifier for ACM_ID and SCANNER_ID is greater than ‘ ’.

If sensor group is ‘D’ and read scanner ‘Y’ then connector sensor routine will wait for a previously set time which may be short for scanners to scan the items loaded into holding chamber.

If sensor group is ‘D’ and read scanner ‘Y’ then connector sensor routine will retrieve rows from ACM scanner table using owner identifier for OWNER_ID, location identifier for LOCATION_ID, ACM identifier for ACM_ID, SCANNER_ID is greater than ‘ ’ and SCANNED_VALUE is greater than ‘ ’. If the number of rows retrieved from ACM scanner table is greater than 0 and if the values of SCANNED_VALUE is same in all rows, then connector sensor routine will save the value of SCANNED_VALUE in one of the retrieved row as scanned value, otherwise the connector sensor routine will save ‘ ’ as scanned value.

If sensor group is ‘D’, read scanner ‘Y’ and scanned value is not ‘ ’, then the connector sensor routine will retrieve one row from ACM item identifier table using owner identifier for OWNER_ID, location identifier for LOCATION_ID and scanned value for ITEM_IDENTIFIER. If connector sensor routine retrieves one row from ACM item identifier table, then the connector sensor routine will save ITEM_IDENTIFIER, ITEM_WEIGHT and ITEM_PRICE from the one retrieved row from item identifier table as item identifier, item weight and item price respectively, otherwise the connector sensor routine will save ‘ ’ as item identifier, 0 as item weight, 0 for item price and ‘ ’ as scanned value.

If sensor group is ‘D’, read scanner ‘Y’ and scanned value is not ‘ ’, then the connector sensor routine will retrieve one row from ACM scale table using owner for OWNER_ID, location identifier for LOCATION_ID, ACM identifier for ACM_ID and scale connector identifier for SCALE_ID. If connector sensor routine retrieves one row from ACM scale table, then the connector sensor routine will save SCALE_WEIGHT from the one retrieved row from ACM scale table as scale weight, otherwise the connector sensor routine will save 0 as scale weight and ‘ ’ as scanned value.

If sensor group is ‘D’, read scanner ‘Y’, scanned value is not ‘ ’ and item weight is not equal to scale weight, then the connector sensor routine will save ‘ ’ as scanned value.

If sensor group is ‘D’, read scanner ‘Y’ and scanned value is not ‘ ’, then connector sensor routine will insert a row into ACM shopping cart table using owner identifier for OWNER_ID, location identifier for LOCATION_ID, ACM identifier for ACM_ID, shopping cart identifier for SHOPPING_CART_ID, 1 or the maximum value of ITEM_SEQ for the same OWNER_ID, for the same LOCATION_ID, for the same ACM_ID, for the same SHOPPING_CART_ID plus 1 for ITEM_SEQ, scanned value for ITEM_IDENTIFIER, ‘P’ for DESTINATION and server date and time for DATETIME.

If sensor group is ‘D’, read scanner ‘Y’ and scanned value is not ‘ ’, then connector sensor routine will update PURCHASED_AMOUNT in ACM payment table by adding item price to PURCHASED_AMOUNT using owner identifier for OWNER_ID, location identifier for LOCATION_ID, ACM identifier for ACM_ID, shopping cart identifier for SHOPPING_CART_ID and server date and time for DATETIME.

If sensor group is ‘D’, read scanner ‘Y’ and scanned value is not ‘ ’, then the connector sensor routine will send a request to the diverter guide to open so that item will be passed through divider guide to pick up chamber, otherwise the connector sensor routine will send a request to the diverter guide to close so that item will be diverted by diverter guide to reject chamber.

If sensor group is ‘D’, read scanner ‘Y’ and scanned value is not ‘ ’, then the connector sensor routine will send a value of ‘O’ as a request to open the diverter guide through the diverter guide connector identifier.

If sensor group is ‘D’, read scanner ‘Y’ and scanned value is ‘ ’, then the connector sensor routine will send a value of ‘C’ as a request to close the diverter guide through the diverter guide connector identifier.

If sensor group is ‘D’, read scanner ‘Y’, then the connector sensor routine will send an activation request which is ‘A’ to holding conveyer through holding conveyer connector identifier so that the item will be moved from holding chamber and an activation request which is ‘A’ to diverter conveyer through diverter conveyer connector identifier so that the item will be moved from diverter chamber.

If sensor group is ‘D’ and read scanner ‘Y’ then connector sensor routine will update ACM status table setting HOLDING_LOADED_YN to ‘N’ using owner identifier for OWNER_ID, location identifier for LOCATION_ID, ACM identifier for ACM_ID.

If sensor group is ‘D’, read scanner ‘Y’ and scanned value is not ‘ ’, then connector sensor routine will execute pos routine using ‘Y’ and blank for refresh and message respectively as input.

If sensor group is ‘D’, read scanner ‘Y’ and scanned value is ‘ ’, then the connector sensor routine will execute pos routine using ‘N’ and ‘Unable to validate the item’ for refresh and message respectively as input.

If sensor group is ‘F’ and ACM type is not ‘H’, then connector sensor routine will terminate.

If sensor group is ‘F’ and ACM type is ‘H’ then the connector sensor routine will update one row in ACM sensor table by setting the value of SENSOR_STATUS_UB to sensor new status using owner identifier for OWNER_ID, location identifier for LOCATION_ID, ACM identifier for ACM ID and sensor identifier for SENSOR ID.

If sensor group is ‘F’, ACM type is ‘H’ and sensor new status is ‘U’ then the connector sensor routine will send a ‘STOP’ request to feeding conveyer through feeding conveyor connector identifier so that the feeding conveyor will stop. This will ensure that the feeding conveyor will stop after feeding an item into holding chamber. It is possible to get a sensor new status of ‘U’ when a customer picks up an item from the feeding conveyor. The merchant may request the customers not to pick up any item after placing an item on the feeding conveyor. Once connector sensor routine sends a stop request to feeding conveyer, the connector sensor routine will terminate.

If sensor group is ‘F’ and ACM type is ‘H’ then the connector sensor routine will retrieve at least one row from ACM sensor table using owner identifier for OWNER_ID, location identifier for LOCATION_ID, ACM identifier for ACM_ID, sensor group for SENSOR_GROUP and ‘B’ for SENSOR_STATUS_UB. This will be an indication that at least one item is ready to be fed into the holding chamber through entry sensors and through the door protecting the holding chamber.

If sensor group is ‘F’, ACM type is ‘H’ and the connector sensor routine retrieved at least one row from ACM sensor table then the connector sensor routine will save ‘Y’ for feed item, otherwise the connector sensor routine will save ‘N’ for feed item.

If sensor group is ‘F’, ACM type is ‘H’ and feed item is ‘Y’, then the connector sensor routine will repetitively try to retrieve one row from ACM status table until feed item is ‘N’ using owner identifier for OWNER_ID, location identifier for LOCATION_ID, ACM identifier for ACM_ID, ‘U’ for ENTRY_STATUS_UB, ‘C’ for DOOR_STATUS_OC and ‘N’ for HOLDING_LOADED_YN for a present time which will be very short. When the connector sensor routine retrieves one row from ACM status table, then connector sensor routine will send a ‘START’ request to feeding conveyor through feeding conveyor connector identifier and save ‘N’ for feed item. When the connector sensor routine does not retrieve one row from ACM status table within a pre-set time, then connector sensor routine will save ‘N’ for feed item. This will ensure that the items placed on feeding conveyor will be fed one at a time into the holding chamber without the connector sensor routine going into an endless loop.

If the connector scanner routine receives 7 inputs namely owner identifier, location identifier, ACM identifier, ACM type, connector identifier, connector value and shopping cart identifier, then the connector scanner routine will continue, otherwise it will terminate. The connector scanner routine will save connector identifier and connector value as scanner identifier and scanner value respectively.

The connector scanner routine will retrieve one row from ACM scanner table using owner identifier for OWNER_ID, location identifier for LOCATION_ID, ACM identifier for ACM_ID and scanner identifier for SCANNER_ID. If connector scanner routine retrieves one row from ACM scanner table, then connector scanner routine will continue, otherwise the connector scanner routine will terminate.

If shopping cart identifier is blank, then the connector scanner routine will terminate.

The connector scanner routine will update ACM scanner table setting SCANNED_VALUE to scanner value using owner identifier for OWNER_ID, location identifier for LOCATION_ID, ACM identifier for ACM_ID and scanner identifier for SCANNER_ID.

The description of the present invention has been presented for purposes of illustration and description and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated. It will be understood by one of ordinary skill in the art that numerous variations will be possible to the disclosed embodiments without going outside the scope of the invention as disclosed in the claims.

I claim:

1. A goods pickup automation system comprising
a box having a smart lock;
a means to scan or enter an order identifier such as order number or tracking number;
a means to drop orders inside the box based on the order identifier, and
a means for an authenticated or verified person to open the box and pick up the orders while the verified person is in a parked vehicle.
